(19) United States
(12) Patent Application Publication
(10) Pub. No.: US 2012/0028816 A1
(43) Pub. Date: Feb. 2, 2012

(54) METHODS AND SYSTEMS FOR SCREENING FOR AND DIAGNOSING DNA METHYLATION ASSOCIATED WITH AUTISM SPECTRUM DISORDERS

(76) Inventors: Stephen T. Warren, Atlanta, GA (US); Reid S. Alisch, Stone Mountain, GA (US)

(21) Appl. No.: 13/260,836

(22) PCT Filed: Mar. 31, 2010
(86) PCT No.: PCT/US10/29417

§ 371 Date: Sep. 28, 2011

Related U.S. Application Data
(60) Provisional application No. 61/164,923, filed on Mar. 31, 2009.
(60) Provisional application No. 61/164,963, filed on Mar. 31, 2009.

(51) Int. Cl. C40B 20/00; C40B 40/06

(52) U.S. Cl. 506/2; 506/16

(57) ABSTRACT

Methods and systems for population screening and diagnostics are provided. In particular methods and systems for population screening of individuals for genetic disorders due to alterations in DNA methylation and for the diagnostic testing for such disorders are provided.

### CROSS-REFERENCE TO RELATED APPLICATION

This application claims priority to copending U.S. provisional patent applications: Ser. No. 61/164,963, entitled “METHODS AND COMPOSITIONS FOR THE EPIGENETIC DIAGNOSIS OF AUTISM” filed on Mar. 31, 2009, and Ser. No. 61/164,923, entitled “METHODS AND COMPOSITIONS FOR THE EPIGENETIC DIAGNOSIS OF AUTISM” filed on Mar. 31, 2009, each of which is entirely incorporated herein by reference.

### STATEMENT REGARDING FEDERALLY SPONSORED RESEARCH

This invention was made with Government support under contract MH089606 awarded by the National Institutes of Health. The government has certain rights in the invention.

### BACKGROUND

The autism spectrum disorders (ASD) affect as many as 1 in 150 children in the United States and comprise a broad group of behaviorally related neurodevelopmental disorders, that include autism, Asperger's disorder, pervasive developmental disorder-not otherwise specified and childhood disintegrative disorder. The hallmark features of ASD appear around three years of age as impaired social and communication interactions, pronounced repetitive behaviors and restricted pattern of interests. Family, twin and epidemiological studies suggest a polygenetic and epistatic susceptibility model involving the interaction of 2-15 genes. However, these and many other studies have identified mutations in only a few candidate genes (e.g. NLGN3, NLGN4 and CACNA1C) that independently associate with an increased risk of disease, suggesting a complex etiology for ASD that may include epigenetic and environmental factors.

Epigenetic modifications provide a mechanism for modulation of gene expression that can be influenced by exposure to environmental factors and that may show parent of origin effects. DNA methylation and histone modifications are essential epigenetic components in the establishment of the transcriptional state of eukaryotic genes throughout the genome. The best understood of these epigenetic modifications is DNA methylation, which occurs primarily at cytosines located 5′ to guanosine in the CpG dinucleotide. This modification, when found in CpG rich areas, known as CpG islands, located in the promoter regions of many genes, is associated with transcriptional repression. Extensive methylation of CpG islands has been associated with transcriptional silencing of imprinted genes (genes that are differentially expressed based on their parent of origin), and also plays an essential role in the maintenance of the, transcriptionally silent, inactive X chromosome in females.

Consistent with an epigenetic contribution to the ASD etiology, the most common cytogenetic abnormality associated with the ASD involves the duplication of a known imprinted region (15q11-13). In addition, several single gene disorders, including Fragile X syndrome and Rett syndrome, have an epigenetic pathogenesis and are associated with an increase risk for ASD. Fragile X syndrome results due to a combination of genetic and epigenetic mutation, wherein expansion of a tri-nucleotide repeat (CGG) in the 5′-untranslated region of the FMR1, leads to an increase in DNA methylation and to epigenetic silencing of the FMR1 gene. In contrast, Rett syndrome is a complex neurological disorder that arises from a mutation in the gene that encodes the methyl-CpG-binding protein 2 (MeCP2). MeCP2 is a key epigenetic regulator of gene expression, as it binds to methylated DNA throughout the genome and interacts with chromatin remodeling complexes to repress expression of genes in the surrounding DNA region. While the genetic and epigenetic origins of these disorders are unique, their affect may impact the epigenetic equilibrium of the entire genome, which would suggest that unidentified aberrantly methylated loci exist that are associated with the ASD. Thus, we employed an established method that interrogates DNA methylation levels throughout the entire genome to determine if aberrant DNA methylation is associated with the ASD.

### SUMMARY

The present disclosure provides methods and assays for detecting and quantifying methylation of nucleic acid-containing samples. The present disclosure further provides methods and assays for screening members of a population for disorders associated with abnormal DNA methylation. Methods and assays of the present disclosure are able to detect the presence of such disorders in a subject directly from a crude DNA extract from blood or tissue sample from the subject.

An embodiment of methods of detecting and quantifying abnormal methylation in a nucleic acid-containing sample, among others, include methyl-sensitive PCR, sodium bisulfate sequencing, and array-based hybridization. An embodiment of the present disclosure includes screening for a condition associated with abnormal methylation of a target nucleic acid sequence in a specific gene indicated by the amount of a methylated version of the target nucleic acid. In embodiments, the condition is selected from at least one of the following: autism, Asperger's disorder, pervasive developmental disorder-not otherwise specified and childhood disintegrative disorder.

Embodiments of the methods of the present disclosure also provide for screening samples from more than one individual (e.g., more than 10, more than 50, and more than 100) for abnormal methylation of a target nucleic acid sequence in a single assay. In embodiments, the methylation status of more than one target nucleic acid sequence can be tested in a single assay. In some embodiments of the disclosure, methods and assays are provided for analyzing and quantifying DNA methylation.

Embodiments of the present disclosure provide methods of screening members of a population for conditions associated with ASD including autism, Asperger's disorder, pervasive developmental disorder-not otherwise specified and childhood disintegrative disorder.

An embodiment of the method, among others, includes: contacting a sample including one or more target nucleic acid sequences with an agent that modifies unmethylated cytosine to uracil to form a number of methylated target nucleic acids, while still including a number of unmethylated target nucleic acids, wherein the sample is from a subject; contacting the methylated target nucleic acids and the unmethylated target nucleic acids with a pool of allele-differentiating probes, wherein the allele-differentiating probes include: a first allele-differentiating probe specific for the unmethylated target nucleic acid sequence, and a second allele-differentiating probe specific for the methylated target nucleic acid sequence; quantifying an amount of the methylated target nucleic acid sequence and an amount of the unmethylated target nucleic acid sequence using the first and second allele-differentiating probes, wherein the first allele-differentiating probe has a first characteristic and the second allele-differentiating probe has a second characteristic, wherein the first characteristic and the second characteristic are different and are detectably distinguishable; and screening for a condition associated with abnormal methylation of the target nucleic acid sequence in at least one specific gene indicated by the ratio of the methylated target nucleic acid compared to the total target nucleic acid, for example.

The present disclosure also includes kits for screening subjects for conditions associated with abnormal DNA methylation. An embodiment of the kit for screening or diagnosing subjects for at least one condition associated with abnormal DNA methylation, among others, includes: a plurality of sets of probes that include a first allele-differentiating probe and a second allele-differentiating probe; for each set of probes the first allele-differentiating probe has a first characteristic and the second allele-differentiating probe has a second characteristic, wherein the first characteristic and the second characteristic are different and are detectably distinguishable from one another and from other sets of probes; for each set of probes the first allele-differentiating probe and the second allele-differentiating probe are complementary to a target nucleic acid sequences, such as those numbered 1-2338 in Table 4, wherein the first allele-differentiating probe is complementary to the unmethlyated target nucleic acid sequence and the second allele-differentiating probe is complementary to methylated target nucleic acid sequence; and wherein each target nucleic acid sequence is associated with a condition.

The details of some exemplary embodiments of the methods, kits, and systems of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure.

FIG. 1 illustrates that multiple analyses indicate that discordant ASD sib-pairs have unique DNA methylation profiles. FIG. 1(a) illustrates a box-and-whisker plot shows the comparison of the average overall DNA methylation level between discordant sib-pairs. The y-axis denotes the methylation index. The x-axis compares the differences between ASD males (A) and unaffected sibs (U). The comparison yields a significant finding. FIG. 1(b) illustrates a histogram of the average difference in MI between discordant sibs. The y-axis represents the difference in MI and the x-axis the ascending MI differences among sib-pairs. The line represents the expected distribution of beta-value differences for these 110 pairs under the null hypothesis that differences between sib pairs are unrelated to autism. FIG. 1(c) illustrates a principal component analysis of all 27,578 loci in 220 individuals. Here the comparison of principal components one (PC1) and two (PC2) for ASD vs. non-ASD sibs is shown. Each colored circle represents an individual (dark grey=non-ASD sib; light grey=ASD). The ellipses represent 95% confidence intervals of the center of each distribution (dark grey=non-ASD sib; light grey=ASD).

FIG. 2 illustrates an unsupervised hierarchical cluster analysis. FIGS. 2(a-b) illustrates unsupervised hierarchical clusters and heatmaps of methylation indices (MIs) of all loci (FIG. 2(a)) or of the differentially methylated loci (FIG. 2(b)). The cluster tree indicates the relatedness of the 110 ASD males and their non-ASD brothers based on their MIs at 27,578 (FIG. 2(a)) or 2,338 (FIG. 2(b)) CpG loci. The heatmap uses a color scale to indicate the relative MI at each locus. Each horizontal colored line (n=27,578 (a) or 2,338(b)) represents the MI for each CpG locus: dark grey for hypermethylated and light grey for hypomethylated (see legend). Each vertical set of horizontal colors (n=220) corresponds to each individual. The horizontal dark grey and light grey bars indicate the known ASD status for each individual (dark grey=non-ASD sib; light grey=ASD; see legend).

FIG. 3 illustrates the unexpected genomic location of the differentially methylated loci. FIG. 3(a) illustrates a comparison of the CpG dinucleotides that reside on islands (CGI). The y-axis denotes the % of CpG dinucleotides (loci) in CpG islands. The x-axis compares the differences between CGIs interrogated on the BeadChip (All.Loci) to the CGIs that are differentially methylated (Differential.Loci). The comparison yields a significant finding. FIG. 3(b) illustrates a comparison of the distance each CpG dinucleotide is from the transcription start site (TSS) of the nearest annotated gene. The y-axis shows the distance that each CpG dinucleotide is from the TSS in base-pairs. The x-axis compares the difference between the CpG dinucleotides interrogated on the BeadChip (All Loci) to the CpG dinucleotides that are differentially methylated (Differential Loci). The comparison yields a significant finding.

FIG. 4 shows Table 1. Table 1 is a model summary statistics from classifying the ASD and non-ASD individuals. The left side of the table shows the summary statistics for the Random Forest prediction algorithm. The right side of the table shows the summary statistics for the consensus of three independent models (3-model Consensus). “Actual Classification” refers to the precise classification reported by the Simons Foundation. “Observed Classification” refers to the classification given by each respective prediction algorithm. The red numbers indicate when both the actual and the observed agree on a classification. The “% called correct” column refers to the accuracy of each model within each disease state. The overall percent called correct by each model is listed next to the model name (e.g., Random Forest 64.1%). The prediction algorithms were run with four different data sets that include the following: 1) All 27,578 loci (All Data); 2) All CpG dinucleotides that reside in ‘CpG island shores’ (CpG Island Shores); 3) All CpG dinucleotides that reside in a ‘CpG island’ (CpG Island); and 4) Only the CpG dinucleotides that are located near the transcription start site of the 330 differentially expressed genes identified by Kong et al.

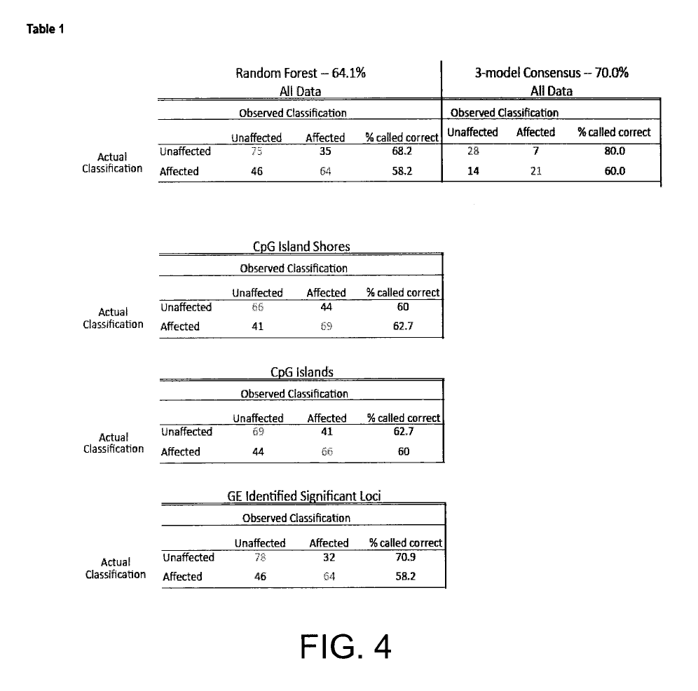

FIG. 5 illustrates that the first principal component contributes the largest amount of variance to the data matrix. Histogram generated by a principal component assay showing the first ten principal components (x-axis) and the variance (y-axis) that each one contributes to the data matrix.

FIG. 6 illustrates a representative example of the independent assessment of the extent that the SEPT9 region is differentially methylated. Each circle represents the methylation status of an independent clone (open circle=unmethylated; closed circle=methylated). The top panel represents the methylation status of 25 loci in the brother of the ASD proband below. The vertical rectangles indicate the two loci interrogated by the Illumina methylation assay. The numbers along the top of each panel of loci represent the relative locations of each CpG interrogated in the region. The vertical numbers beside each panel of loci indicate the clone number.

FIG. 7(a) illustrates a graphic representation of the Weighted Voting scores calculated as the sum of each loci t-stat by the MI of each locus. Samples are ordered from smallest score (likely to be non-autistic) to greatest score (likely to be autistic). ASD individuals are depicted in light grey and non-ASD in dark grey. FIG. 7(b) illustrates the hierarchical clustering of loci used for the shrunken centroid prediction model (optimized to 41 loci using cross-validation on the training set). Hierarchical clustering displays ASD (light grey) and non-ASD (dark grey). FIG. 7(c) illustrates the hierarchical clustering of 1,000 loci used for the k-nearest neighbor (KNN) prediction model.

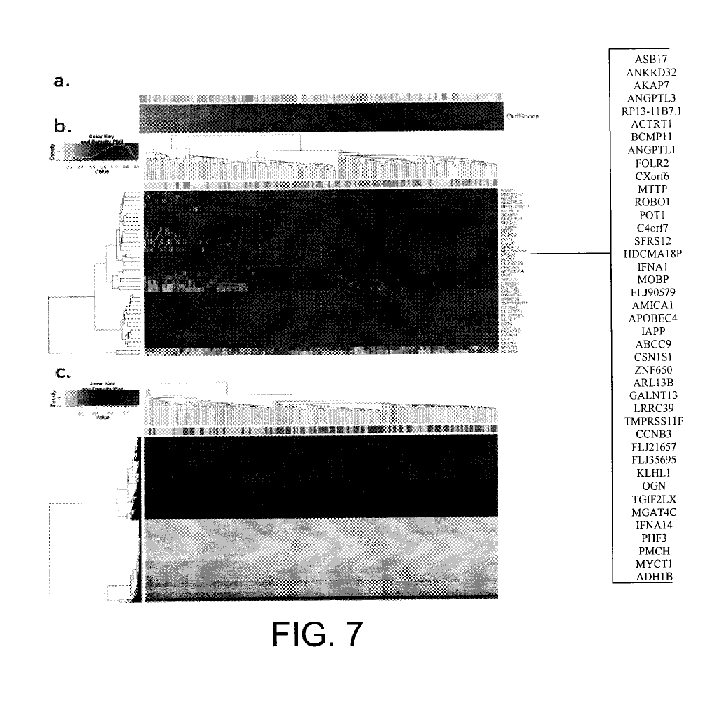

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere. Experimental hypoxia was obtained by growing cells in culture medium in an incubator under an environment of 1% partial pressure of oxygen unless otherwise indicated.

Embodiments of the present disclosure will employ, unless otherwise indicated, techniques of synthetic organic chemistry, biochemistry, molecular biology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. Patent law and can mean “includes,” “including,” and the like; “consisting essentially of or “consists essentially” or the like, when applied to methods and compositions encompassed by the present disclosure refers to compositions like those disclosed herein, but which may contain additional composition components or method steps. Such additional composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Prior to describing the various embodiments, the following definitions are provided and should be used unless otherwise indicated.

### Definitions:

The term “nucleic acid” or “polynucleotide” is a term that generally refers to a string of at least two base-sugar-phosphate combinations. As used herein, the term includes deoxyribonucleic acid (DNA) and ribonucleic acid (RNA) and generally refers to any polyribonucleotide or polydeoxyribonucleotide, which may be unmodified RNA or DNA or modified RNA or DNA. RNA may be in the form of a tRNA (transfer RNA), snRNA (small nuclear RNA), rRNA (ribosomal RNA), mRNA (messenger RNA), anti-sense RNA, RNAi, siRNA, and ribozymes. Thus, for instance, polynucleotides as used herein refers to, among others, single-and double-stranded DNA, DNA that is a mixture of single-and double-stranded regions, single- and double-stranded RNA, and RNA that is mixture of single- and double-stranded regions, hybrid molecules comprising DNA and RNA that may be single-stranded or, more typically, double-stranded or a mixture of single- and double-stranded regions. The terms “nucleic acid sequence” or “oligonucleotide” also encompasses a nucleic acid or polynucleotide as defined above.

It will be appreciated that a great variety of modifications have been made to DNA and RNA that serve many useful purposes known to those of skill in the art. The term polynucleotide as it is employed herein embraces such chemically, enzymatically or metabolically modified forms of polynucleotides, as well as the chemical forms of DNA and RNA characteristic of viruses and cells, including simple and complex cells, inter alia.

For instance, the term polynucleotide includes DNAs or RNAs as described above that contain one or more modified bases. Thus, DNAs or RNAs comprising unusual bases, such as inosine, or modified bases, such as tritylated bases, to name just two examples, are polynucleotides as the term is used herein.

The term also includes PNAs (peptide nucleic acids), phosphorothioates, and other variants of the phosphate backbone of native nucleic acids. Natural nucleic acids have a phosphate backbone, artificial nucleic acids may contain other types of backbones, but contain the same bases. Thus, DNAs or RNAs with backbones modified for stability or for other reasons are “nucleic acids” or “polynucleotides” as that term is intended herein.

As used herein “modifies” refers to the conversion of an unmethylated cytosine to another nucleotide (uracil), which distinguishes the unmethylated from the methylated cytosine in a target nucleic acid, for example. Preferably, the agent modifies unmethylated cytosine to uracil. Preferably, the agent used for modifying unmethylated cytosine is sodium bisulfite, however, other agents that similarly modify unmethylated cytosine, but not methylated cytosine, can also be used in the method of the disclosure. Sodium bisulfite (NaHSO₃) reacts readily with the 5,6-double bond of cytosine, but poorly with methylated cytosine. Cytosine reacts with the bisulfite ion to form a sulfonated cytosine reaction intermediate which is susceptible to deamination, giving rise to a sulfonated uracil. The sulfonate group can be removed under alkaline conditions, resulting in the formation of uracil. Uracil is recognized as a thymine by Taq® polymerase and therefore upon PCR, the resultant product contains cytosine only at the position where 5-methylcytosine occurs in the starting template DNA.

As used herein “primer” generally refers to polynucleotides (e.g., oligonucleotides) of sufficient length and appropriate sequence so as to provide specific initiation of polymerization on a significant number of nucleic acids in the polymorphic locus. Specifically, the term “primer” refers to a polynucleotide sequence including two or more deoxyribonucleotides or ribonucleotides, preferably more than three, and most preferably more than 8, which sequence is capable of initiating synthesis of a primer extension product, which is substantially complementary to a polymorphic locus strand. Environmental conditions conducive to synthesis include the presence of nucleoside triphosphates and an agent for polymerization, such as DNA polymerase, and a suitable temperature and pH. The primer is preferably single stranded for maximum efficiency in amplification, but may be double stranded. If double stranded, the primer is first treated to separate its strands before being used to prepare extension products. Preferably, the primer is an oligo deoxyribonucleotide. The primer is sufficiently long to prime the synthesis of extension products in the presence of the inducing agent for polymerization. The exact length of primer depends on many factors, including temperature, buffer, and nucleotide composition. The oligonucleotide primer typically contains 12-20 or more nucleotides, although it may contain fewer nucleotides.

Primers of the present disclosure are designed to be “substantially” complementary to each strand of the genomic locus to be amplified and include the appropriate G or C nucleotides as discussed above. Thus, the primers are sufficiently complementary to hybridize with their respective strands under conditions that allow the agent for polymerization to perform. In other words, the primers should have sufficient complementarity with the 5′ and 3′ flanking sequences to hybridize therewith and permit amplification of the genomic locus.

Oligonucleotide primers of the present disclosure are employed in the amplification process, which is an enzymatic chain reaction that produces exponential quantities of target locus relative to the number of reaction steps involved. Typically, one primer is complementary to the negative (−) strand of the locus and the other is complementary to the positive (+) strand. Annealing the primers to denatured nucleic acid followed by extension with an enzyme, such as the large fragment of DNA Polymerase I (Klenow) and nucleotides, results in newly synthesized + and − strands containing the target locus sequence. Because these newly synthesized sequences are also templates, repeated cycles of denaturing, primer annealing, and extension results in exponential production of the region (e.g., the target locus sequence) defined by the primer. The product of the chain reaction is a discrete nucleic acid duplex with termini corresponding to the ends of the specific primers employed.

The oligonucleotide primers of the present disclosure may be prepared using any suitable method, such as conventional phosphotriester and phosphodiester methods or automated embodiments thereof. In one such automated embodiment, diethylphosphoramidites are used as starting materials and may be synthesized as described by Beaucage, et al. (Tetrahedron Letters, 22:1859-1862, 1981, which is hereby incorporated by reference in its entirety). One method for synthesizing oligonucleotides on a modified solid support is described in U.S. Pat. No. 4,458,066, which is hereby incorporated by reference herein.

As used herein “allele-differentiating probes” generally refer to polynucleotides (e.g., oligonucleotides) of sufficient length and appropriate sequence designed for binding to a target DNA or RNA for a variety of purposes (e.g., identification of a specific target sequence). As used herein “allele-differentiating probes” differ from primers in that although allele-differentiating probes may sometimes be capable of priming if used in an amplification process, the allele-differentiating probes of the present disclosure are not used for priming purposes in an amplification process according to the methods of the present disclosure, but are instead used for identifying/distinguishing specific target sequences (e.g., in DNA array hybridization or in a real-time PCR process). In embodiments of the present disclosure the allele-differentiating probes are used as an array of allele-differentiating probes in a primer extension assay. In embodiments of the present disclosure the allele-differentiating probes can be Taqman® probes for use in real time PCR. An embodiment of an allele-differentiating probe set for use according to the present disclosure for distinguishing between a methylated and unmethylated target nucleic acid sequence includes a first allele-differentiating and second allele-differentiating probe, where the first allele-differentiating probe is specific for the unmethylated target sequence and, optionally, has a first reporter molecule (e.g., a reporter dye such as a fluorophore), and the second allele-differentiating probe is specific for the methylated target sequence and, optionally, has a second reporter molecule that is distinguishable from the first reporter molecule. In an embodiment, the allele-differentiating probes can also include a quencher (e.g., a quencher dye) for suppressing the detectable signal of the reporter molecule in the absence of the target sequence. In this way, detection of the signal of the reporter molecule indicates the presence of the target sequence in the sample. In an embodiment, the a first allele-differentiating and second allele-differentiating probe are complementary and hybridize to the corresponding target sequences such as those described in Example 1, Table 4.

Also, although “primers” as used herein are not typically used for detection purposes, primers may sometimes be labeled for detection purposes in addition to amplification purposes, when used as such they are referred to herein as “labeled primers”.

“Real-time PCR” and “kinetic PCR” are used herein to refer to a polymerase chain reaction (PCR) technique in which probes, as described above, are included in the reaction mixture during the amplification process, allowing real-time detection and quantification of target products of the amplification process. The detection and quantification of the amplified target sequence(s) is achieved by the use of real-time PCR instrumentation capable of detecting and quantifying the signal from the probes. One example of real-time PCR is the Taqman® technique, which is known to those of skill in the art, and described in greater detail in the examples below.

As used herein “population screening” and “screening” are methods used to identify, within a population or group of individuals, asymptomatic or presymptomatic individuals at risk of developing a disorder (e.g., autism spectrum disorders (ASD)), whereas “diagnosis” generally refers to the process of testing symptomatic individuals for the presence of a disorder. In contrast to clinical diagnostic testing, where typically only symptomatic individuals are tested, in population screening all individuals within a population or other defined group are screened for a disorder. If an individual screens positive, a follow-up visit is scheduled where additional samples are obtained for confirmatory testing. Thus, the primary goal of screening is not the clinical diagnosis of disease, but to identify those who are at risk. After confirmation appropriate medical management decisions can then be instituted to prevent or ameliorate symptoms of the disease. Newborn screening for genetic disorders is such a program that identifies individuals at risk of metabolic genetic disorders. This disclosure relates to the population screening of individuals for alterations in normal patterns of DNA methylation.

The term “distinguishable” in reference to detecting or measuring a signal from a reporter or label refers to a signal that is detectable and distinguishable from other background signals that may be generated from the host and/or other reporters or labels. In other words, there is a measurable and statistically significant difference (e.g., a statistically significant difference is enough of a difference to distinguish among the detectable signal and the background, such as about 0.1%, 1%, 3%, 5%, 10%, 15%, 20%, 25%, 30%, or 40% or more difference between the detectable signal and the background and/or other reporters or labels) between detectable signal and the background and/or other reporters or labels. Standards and/or calibration curves can be used to determine the relative intensity of the detectable signal and/or the background.

As used herein, the term “host,” “subject,” “patient,” or “organism” includes humans and mammals (e.g., mice, rats, pigs, cats, dogs, and horses). Typical hosts to which compounds of the present disclosure may be administered will be mammals, particularly primates, especially humans. For veterinary applications, a wide variety of subjects will be suitable, e.g., livestock such as cattle, sheep, goats, cows, swine, and the like; poultry such as chickens, ducks, geese, turkeys, and the like; and domesticated animals particularly pets such as dogs and cats. For diagnostic or research applications, a wide variety of mammals will be suitable subjects, including rodents (e.g., mice, rats, hamsters), rabbits, primates, and swine such as inbred pigs and the like. The term “living host” refers to a host noted above or another organism that is alive. The term “living host” refers to the entire host or organism and not just a part excised (e.g., a liver or other organ) from the living host.

### Description:

Embodiments of the present disclosure provide for methods, assays, and kits that incorporate and encompass the concept that aberrant DNA methylation is associated with the autism spectrum disorders (ASD). Embodiments of the present disclosure relates to the field of population screening and diagnostics, particularly to the population screening and/or diagnosis of individuals for genetic disorders due to alterations in DNA methylation and diagnostic testing for such disorders. More particularly, it relates to screening or diagnosis for ASD, which are characterized by aberrant patterns of DNA methylation, and to use known aberrant patterns of DNA methylation as a diagnostic testing for such disorders.

ASD can include conditions or disorders such as autism, Asperger's syndrome, Childhood disintegrative disorder and Pervasive developmental delay not otherwise specified (also referred to as atypical autism). In particular, embodiments of the present disclosure are directed to screening and diagnosis for autism.

Embodiments of the present disclosure describe the identification and genomic location of CpG nucleotides (e.g., 2338) in or near one or more genes (e.g., See Table 4) that represent metastable epialleles (i.e., loci susceptible to changes in their DNA methylation status) that are predictive of the ASD disease state, making them biomarkers for presymptomatic population-based screening and diagnosis. Such changes in DNA methylation can be assessed directly from a cell line, tissue, or blood sample of a subject. Embodiments of the present disclosure include methods, assays, and kits that can be used to test for alterations in DNA methylation for ASD within the population-screening and diagnosis paradigms (e.g., infants) by screening CpG nucleotides (e.g., 2338) in or near one or more genes (e.g., See Table 4) using allele-differentiating probes specific for methylated and unmethlayted nucleic acid sequences (e.g., See Table 4).

As noted herein, embodiments of the present disclosure include using aberrant patterns of DNA methylation of the human genome for screening or the diagnosis of ASD. In this regard, additional target nucleic acid sequences corresponding to CpG dinucleotides in the human genome may be used to construct the allele-differentiating probes for screening or the diagnosis of ASD, and Table 4 is not an exhaustive list of target nucleic acid sequences that can be used.

The present disclosure provides methods, assays, and kits that detect changes in DNA methylation that lead to a disease or a condition such as ASD. The methods, assays, and kits of the present disclosure can detect such changes in DNA methylation directly from a cell line, tissue, or blood sample, following a standard isolation of the DNA, in a high-throughput format. Methods, assays, and kits of the present disclosure also allow quantitative analysis of the DNA methylation status (e.g., quantify the amount of methylated vs unmethylated sites or determining the methylation index (MI; ratio of methylated cytosines to total cytosines)) of a nucleic acid-containing sample, which provides more detailed diagnostic information as well as the ability to diagnose and screen for disorders (ASD) not identifiable by mere qualitative detection of DNA methylation. This disclosure describes methods used to test for alterations in DNA methylation for such disorders within the population screening paradigm (e.g., infants or a population that may be susceptible to having ASD (those having a family history of such conditions)).

### Methods, Assays, and Kits for Detecting and Quantifying DNA Methylation

Briefly described, methods for screening and/or diagnosing members of a population for disorders associated with abnormal DNA methylation according to the present disclosure can include the following general steps: obtaining a nucleic-acid sequence (DNA) containing sample (e.g., blood) from one or more subjects; optionally, purifying the DNA from the sample by a standard DNA isolation procedure; contacting the DNA with an agent (e.g., sodium bisulfide) that modifies unmethylated cytosines, and hybridizing the DNA (e.g., unmodified and modified nucleic-acid (DNA)) to a pool of allele-differentiating probes to quantify the amount of methylated and unmethylated nucleic-acid sequence; optionally and alternatively, amplifying the DNA in the sample by PCR can be used to discriminate between and quantifying the methylated and unmethylated target nucleic acid; and determining the amount or relative amount of the methylated and unmethylated DNA, the methylated cytosines to total cytosines, or other measurement basis to screen and/or diagnose members of a population for disorders associated with abnormal DNA methylation.

Embodiments of the present disclosure include a pair of allele-differentiating probes capable of distinguishing (e.g., able to identify one from the other) an unmethylated from a methylated target nucleic acid sequence for each of the CpG nucleotides (e.g., 2338) in or near one or more genes such as those described in Table 4 or in the human genome. The CpG nucleotides and the corresponding target nucleic acid sequence (e.g., Table 4) can be within about 5, about 4, about 3, about 2, or about 1 kilobase from a corresponding gene (e.g., Table 4). In other words, these target nucleic acid sequences may be found upstream or downstream of a gene's transcription start site, including the promoter, the exonic and/or the intronic sequences as well as sequences 3′ of the gene. In addition, the target sequences may reside on the opposite DNA strand to the gene. The allele-differentiating probes have a nucleic acid sequence that is complementary (e.g., can hybridize with the corresponding sequence so as to accomplish its function) with a target nucleic acid sequence that includes the CpG nucleotide of interest. In particular, the allele-differentiating probes have a nucleic acid sequence that is complementary and hybridizes with a target nucleic acid sequence such as those shown in Table 4. As noted above, a difference between each of the allele-differentiating probes in a pair is that one is specific for the unmethylated target nucleic acid sequence and the other is specific for the methylated target nucleic acid sequence. In an embodiment, each of the allele-differentiating probes in a pair can include a reporter (e.g., such as a fluorophore or fluorescent dye), where the reporter for one of the allele-differentiating probe is different than the reporter for the other allele-differentiating probe so that the two detected characteristics of the reporters can be detectably distinguishable, thus providing a way to differentiate unmethylated and methlyated target nucleic acid sequences. Other techniques for detectably distinguishing the allele-differentiating probes can be used.

In another embodiment, in addition to including the reporters, each of the allele-differentiating probes in a pair can include a quencher for suppressing the detectable signal of the reporter in the absence of the sequence being targeted. The reporter/quencher pair can operate according to FRET or BRET. In an embodiment, the allele-differentiating probes can be Taqman® probes and can be used in real time PCR.

Embodiments of the present disclosure include a plurality of sets of probes that include a first allele-differentiating probe and a second allele-differentiating probe. For each set of probes, the first allele-differentiating probe has a first characteristic (e.g., fluorescence (a first reporter molecule)) and the second allele-differentiating probe has a second characteristic (e.g., fluorescence (a second reporter molecule)). The first characteristic and the second characteristic are different and are detectably distinguishable from one another and from other sets of probes. For each set of probes the first allele-differentiating probe and the second allele-differentiating probe are complementary to one of the target nucleic acid sequences such as those numbered 1-2338 in Table 4, but embodiments are not restricted to this list of target nucleic acid sequences. In each set the first allele-differentiating probe is complementary to the unmethlyated target nucleic acid sequence and the second allele-differentiating probe is complementary to methylated target nucleic acid sequence so that they are detectably distinguishable. Each target nucleic acid sequence in Table 4 is associated with a gene and can be associated with a condition such as autism. Additional details about the allele-differentiating probes are described in Example 1 and Table 4.

Embodiments of the present disclosure include using aberrant patterns of DNA methylation of the human genome for screening or the diagnosis of ASD. Table 4 identifies 2338 loci, but additional methylated loci in the human genome can be used in combination, in part or in whole, with the 2338 loci described in Table 4 to screen for or the diagnosis of ASD. In this regard, additional target nucleic acid sequences corresponding to CpG dinucleotides in the human genome may also be used to construct the allele-differentiating probes for screening or the diagnosis of ASD, and Table 4 is not an exhaustive lists of target nucleic acid sequences.

In an embodiment of this method, the modification of unmethylated cytosines is a sodium bisulfite/hydroquinone mediated chemical conversion of cytosines in DNA to uracil. 5-methylcytosines in DNA are resistant to this conversion, thus allowing the distinction between methylated and unmethylated DNAs. The discordant change in nucleic acid sequence between affected and unaffected individuals after bisulfate treatment may be monitored by methods such as, but not limited to, solution or array based hybridization, sequencing based methods, methylation specific PCR and methylation specific probes for use in real-time PCR. If conventional methylation sensitive PCR is used, other detection methods may be used during or after the completion of the PCR reaction to determine the relative amounts of methylated and unmethylated DNAs in the original sample (e.g., capillary electrophoresis, or other separation techniques).

Another advantage of the methods and assays of the present disclosure is that any locus that has alterations in DNA methylation can be assessed by this method. In addition, multiple loci (e.g., 2338) can be examined simultaneously for DNA methylation alterations. Moreover, both qualitative and quantitative DNA methylation analysis can be obtained in the same assay. Additionally, methods according to the present disclosure can be used for high-throughput analysis. The extract preparation, sodium bisulfite/hydroquinone treatment, clean-up and quantitative methylation detection can be done in 96 or 384 well formats allowing for the processing of large numbers of samples. For instance, in ASD screening, up to 96 DNA samples can be assayed simultaneously for their methylation index (MI; ratio of methylated cytosines to total cytosines at any one or a combination of the 2338 described in Table 4. If aberrant MIs are detected then these samples can be analyzed individually for these disorders.

The methods of the present disclosure provide the ability to detect autism in a population by quantitating the ratio of methylated and unmethylated genes alleles, for example and as described in greater detail in the example below. This quantitation can be done with solution or assay based hybridization, a kinetic method, or by end point analysis. Examples of kinetic methods are real-time PCR, pyro sequencing, etc (e.g., by the use of quantitative methylation specific PCR employing methylation-specific probes). An example of end-point analysis is separation and quantitation of fluorescently labeled MSP products (e.g., conventional methylation specific PCR using labeled primers and followed by capillary electrophoresis for quantitative end-point analysis).

In one embodiment of the present disclosure, a DNA methylation profiling method (e.g., array or sequencing based) is provided to determine if a subject has an elevated risk of having autism. This method may be performed diagnostically, after presence of the disease is suspected, or may be used as a screening tool, to screen members of a population for presence of the disorder, before symptoms of the disorder have manifested. For instance, the method may be used for systematic newborn screening, as is done for other disorders.

In an embodiment of the present disclosure, discriminating between methylated and unmethylated DNA and determining the relative amount of methylated and unmethylated DNA to the total number of cytosines can be accomplished by the optional use of a first and second set of primers, a first set specific for the unmethylated DNA and the second set specific for the methylated DNA.

In a preferred embodiment, discriminating between methylated and unmethylated DNA and quantification of methylated and unmethylated DNA is accomplished by contacting a small amount of DNA (about 0.5 μg) with sodium bisulfite for C-to-T conversion. The converted DNA is purified and prepped for analysis on the Illumina HumanMethylation27 BeadChip™ following the manufacturer's guidelines or another suitable system that accomplishes the same goal. The BeadChip™ technology can interrogate 27,578 highly informative CpG dinucleotides per sample at single nucleotide resolution. The CpG dinucleotides span 14,495 genes derived from the well-annotated National Center for Biotechnology Information Consensus Coding Sequence Regions (NCBI CCDS) database. Briefly, converted DNA is amplified, fragmented, and hybridized to the humanmethylation27 pool of allele-differentiating probes. After a series of extension, ligation, and cleanup reactions, the methylated and unmethylated DNA can each be labeled with a detectably distinguishable reporter such as a fluorescent dye (e.g., fluorescein, rhodamine, Cy3, Cy5, Alexa Fluor®, and the like). The labeled methylated and unmethylated DNA is then scanned and image analysis and beta score calculation are performed using established software.

In an embodiment, discriminating between methylated and unmethylated DNA and quantification of methylated and unmethylated DNA is accomplished by contacting the sample during the amplification process with at least a first and a second allele-differentiating probe, where the first allele-differentiating probe is specific for unmethylated DNA and the second allele-differentiating probe is specific for methylated DNA and where the two probes are distinguishable (e.g., the label of the first allele-differentiating probe produces a distinguishable signal from the signal produced by the second allele-differentiating probe) and allow quantification of the relative amounts of methylated and unmethylated DNA. In an embodiment, the first and second allele-differentiating probes can be labeled prior to introduction to the methylated and unmethylated DNA or after introduction to the methylated and unmethylated DNA.

In bisulfite modification of the nucleic acid (DNA), unmethylated cytosine residues are converted to uracil, while methylated residues remain unconverted. The subsequent change in the sequence between affected and unaffected individuals after bisulfite treatment may be monitored, for example by real time PCR or methylation-specific PCR.

A real time PCR detection method, such as Taqman®, can be used to detect and quantify methylated and unmethylated alleles of the interrogated genes (e.g., the genes and the corresponding sequence listed in Table 4) after sodium bisulfite treatment in a single step. In the Taqman® method the methylated and unmethylated strands are amplified by a single primer pair, avoiding the bias in PCR due to preferential binding of oligonucleotides in PCR. This is accomplished by avoiding CpG dinucleotides in the primer binding sites. The distinction between the methylated and unmethylated strands is made by the Taqman® probes targeting a specific CpG within the amplicon, one Taqman® allele-differentiating probe for the methylated strand and a second different (e.g., different fluorochrome) Taqman® allele-differentiating probe for the unmethylated strand. The targeting Taqman® allele-differentiating probes can be developed from the sequences noted in Table 4. Not only is the Taqman® method faster than the PCR and capillary electrophoresis method in that it detects and quantitates the amount of methylated and unmethylated DNA in a single step, it is also a more robust method for quantitation allowing the better distinction between methylated and unmethylated DNA.

Methylation-specific PCR is a rapid assay that can be completed in two days and requires very little DNA for analysis, two important factors for prenatal diagnosis. Other advantages of the test are that it is non-radioactive, cost and labor efficient, making it amenable for routine diagnostics and screening studies. The methylation-specific PCR assay produces amplification specific for either presence or absence of methylation (or both), and thus provides an advantage over other screening methods where a positive result is dependent on an absence of product. The chemical modification of cytosine to uracil by bisulfite treatment provides a useful modification of traditional PCR techniques which eliminates the need for methylation specific restrictions enzymes.

Briefly described, in an embodiment of the present disclosure using methylation-specific PCR, after sodium bisulfite treatment, the sequence under investigation is then amplified by PCR with two sets of strand-specific primers (one set specific for the methylated DNA and the other specific for the unmethylated DNA) to yield a pair of fragments, one from each strand, in which all uracil and thymine residues have been amplified as thymine and only 5-methylcytosine residues have been amplified as cytosine. The PCR products can be sequenced directly to provide a strand-specific average sequence for the population of molecules or can be cloned and sequenced to provide methylation maps of single DNA molecules. This assay requires only small quantities of DNA, is sensitive to 0.1% methylated alleles of a given CpG island locus, and can be performed on DNA extracted from paraffin-embedded samples. Methylation-specific PCR eliminates the false positive results inherent to previous PCR-based approaches which relied on differential restriction enzyme cleavage to distinguish methylated from unmethylated DNA. However, such methylation specific PCR assays do not allow for simultaneous quantitation of the ration of methylated to unmethylated DNA. Instead, in embodiments of the present disclosure, quantitative analysis can be performed after the completion of the PCR step by end-point analysis techniques, as discussed above.

As is known to those of skill in the art, PCR typically employs two primers that bind to a selected nucleic acid template. The primers are combined with the other PCR reagents under conditions that induce primer extension, e.g., with four different nucleoside triphosphates (or analogues thereof), an appropriate polymerase and an appropriate buffer (“buffer” includes pH, ionic strength, cofactors, etc.) at a suitable temperature. In some embodiments the primers are labeled primers (e.g., primers or short nucleotide sequences that are 5′ end-labeled with a reporter molecule (e.g., a fluorophore)) to allow for detection and quantification of bound probe after the PCR process. In exemplary embodiments of the present disclosure, PCR primers are prepared from the genes or sequences noted in Table 4 and PCR is carried out generally as described in the examples below.

In an embodiment, real-time PCR is used to detect and quantify methylated and unmethylated DNA in a single step (quantitative methylation sensitive PCR (Q-PCR)). Q-PCR involves the use of a single primer pair to amplify the target polynucleotide and a set of allele-differentiating probes capable of distinguishing methylated from unmethylated DNA loci on the target polynucleotide (more than one primer pair and more than one set of allele-differentiating probes may be used if more than one DNA loci is being analyzed in a single assay).

In an embodiment, the method of amplifying is by PCR, as described herein and as is commonly used by those of ordinary skill in the art. Alternative methods of amplification have been described and can also be employed as long as the methylated and non-methylated loci are similarly amplified by the alternative method and the distinction between amount methylated and unmethylated DNA can be determine.

Optionally, the methylation pattern of the nucleic acid can be confirmed by restriction enzyme digestion and Southern blot analysis. Examples of methylation sensitive restriction endonucleases that can be used to detect 5′CpG methylation include SmaI, SaclI, EagI, MspI, HpalI, BstUI and BssHII, for example.

Embodiments of a kit according to the present disclosure include reagents for treating a sample (e.g., blood derived DNA) to modify unmethylated cytosine (e.g. a solution of sodium bisulfite and/or hydroquinone). In one embodiment of a kit according to the present disclosure, the kit includes the appropriate reagents, one or more sets of allele-differentiating probes for discriminating methylated and unmethylated nucleic acid sequences. For example, such a kit may contain an allele-differentiating probe specific for a methylated nucleic acid sequence selected from one or more of the genes or the corresponding sequences in Table 4 and an allele-differentiating probe specific for an unmethylated nucleic acid sequence selected from one or more of the genes or the corresponding sequences in Table 4.

Embodiments of a kit according to the present disclosure include reagents for treating a sample (e.g., blood derived DNA) to modify unmethylated cytosine (e.g. a solution of sodium bisulfite and/or hydroquinone). In one embodiment of a kit according to the present disclosure, the kit includes the appropriate reagents, one or more sets of allele-differentiating probes for discriminating methylated and unmethylated nucleic acid sequences being screened for the preferred assays, and a set of primers (or random hexamers) for amplifying both the methylated and unmethylated nucleic acid sequence being screened. For example, such a kit may contain an allele-differentiating probe specific for a methylated nucleic acid sequence selected from one or more of the genes or the corresponding sequences in Table 4 and an allele-differentiating probe specific for an unmethylated treated nucleic acid sequence selected from one or more of the genes or the corresponding sequences in Table 4 as well as primers specific for a methylated and unmethylated nucleic acid sequences from one or more of the genes or the corresponding sequences in Table 4.

In embodiments of a kit for use in quantitative methylation specific PCR methods of the present disclosure, the kit includes reagents for treating a sample (e.g., blood derived DNA) to modify unmethylated cytosine (e.g. a solution of sodium bisulfite and/or hydroquinone), one or more sets of primers for amplifying both the methylated and unmethylated nucleic acid sequence being screened, and one or more sets of allele-differentiating probes for discriminating and providing for the real-time quantification of the methylated and unmethylated nucleic acid sequences being screened. For example, such a kit may contain a pair of primers for amplifying the methylated and unmethylated nucleic acid sequence from one or more of the genes or the corresponding sequences in Table 4 and a pair of allele-differentiating probes capable of distinguishing the unmethylated from the methylated nucleic acid sequence from one or more of the genes or the corresponding sequences in Table 4.

The specific examples below are to be construed as merely illustrative, and not limitative of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

### EXAMPLE

It should be emphasized that the above-described embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

### Example 1

Introduction

The autism spectrum disorders (ASD) comprise a broad group of behaviorally related neurodevelopmental disorders affecting as many as 1 in 110 children^{1,2}. The hallmarks of ASD consist of impaired social and communication interactions, pronounced repetitive behaviors and restricted patterns of interests. Family, twin and epidemiological studies reveal a strong familial component to ASD risk, suggesting a polygenetic and epistatic susceptibility model involving the interaction of many genes; however, despite great effort only a few genes have been linked conclusively to ASD risk and, even then, in just a handful of ASD cases, which means the etiology of ASD is likely to be complex and include both epigenetic and environmental factors³. Here we provide evidence for an epigenetic component to ASD by showing statistically significant genome-wide methylation changes in whole blood DNA from individuals with ASD. Furthermore, the DNA methylation profiles allowed prediction algorithms to correctly classify 110 discordant male sib-pairs with ˜70% accuracy. These data indicate that subtle methylation differences at a large number of loci are associated with autism, suggesting epigenetic alterations may play a role in the etiology of ASD and pointing to potential ASD peripheral biomarkers.

### Discussion

Several lines of evidence argue that epigenetic variation may contribute to ASD. For example, the most common cytogenetic abnormality associated with ASD, a maternally inherited duplication of 15q11-13, results in aberrant DNA methylation and gene expression in a known imprinted region^{4,5}. Similarly, Prader-Willi and Angelman syndromes, which often result from epigenetic abnormalities in 15q, are also associated with ASD⁶⁻⁸. Another strong indicator that genome-wide epigenetic alterations can cause aberrant gene regulation comes from Rett syndrome, a pervasive developmental disorder with features of autism that is caused by decreased expression of the methyl DNA binding protein MeCP2^{9,10}. Indeed, Nagarajan et al. reported 79% of ASD cases exhibit altered DNA methylation and reduced expression of the MeCP2 gene in the brains of ASD patients¹¹. Moreover, differences in ASD susceptibility among girls with Turner syndrome (XO), depending on the parental origin of the X chromosome, hints at a role for X-linked epigenetic variation in ASD¹² Finally, epigenetic misregulation of the oxytocin receptor gene has been linked recently to ASD¹³. Taken together, these data point to the emergence of genome-wide epigenetic variation as another mechanism of ASD susceptibility besides sequence variation.

To determine whether aberrant genome-wide DNA methylation is associated with ASD, we employed a high-throughput BeadChip technology to generate a methylation profile of DNA extracted from the whole blood of 110 male sib-pairs who are discordant for ASD. This approach determines the methylation index (MI; ratio of methylated cytosines to total cytosines) of 27,578 CpG dinucleotides per sample, of which 20,006 (˜73%) are found in canonical “CpG islands” near the transcriptional start site of 14,495 well-annotated genes. The discordant ASD male sib-pairs are a random sample of the simplex families collected as part of the Simons Foundation Autism Research Initiative, which ascertains and rigorously phenotypes simplex ASD families¹⁴. The probands have the following ASD classifications: 64 autistic (58%); 17 pervasive developmental disorder not otherwise specified (PDD-NOS; 15.5%); and 12 Asperger's disorder (10.9%). The precise classifications of the remaining 17 are awaiting release by the Simons Foundation (15.5%; Table 2).

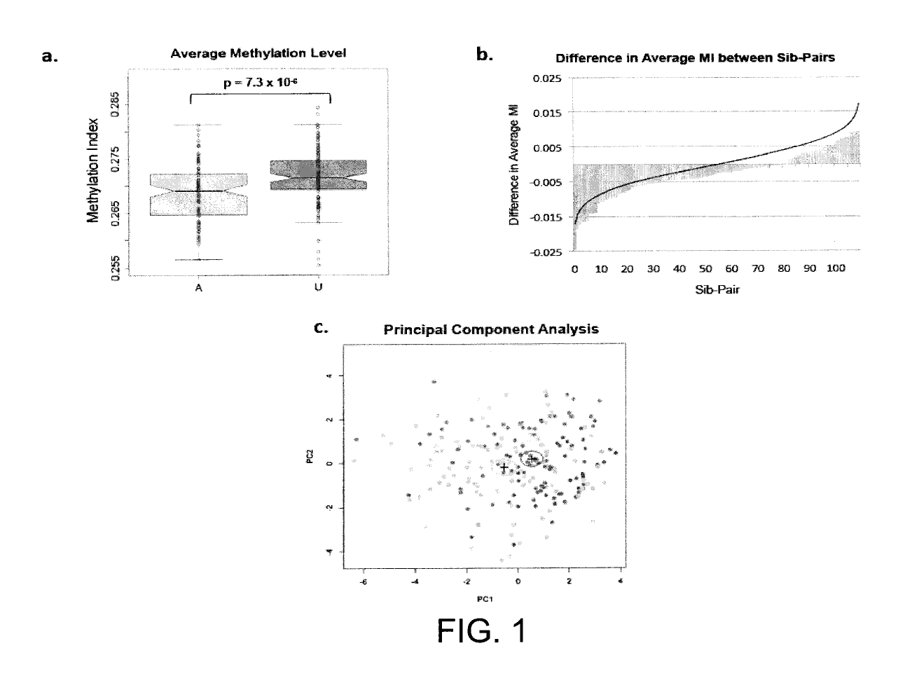

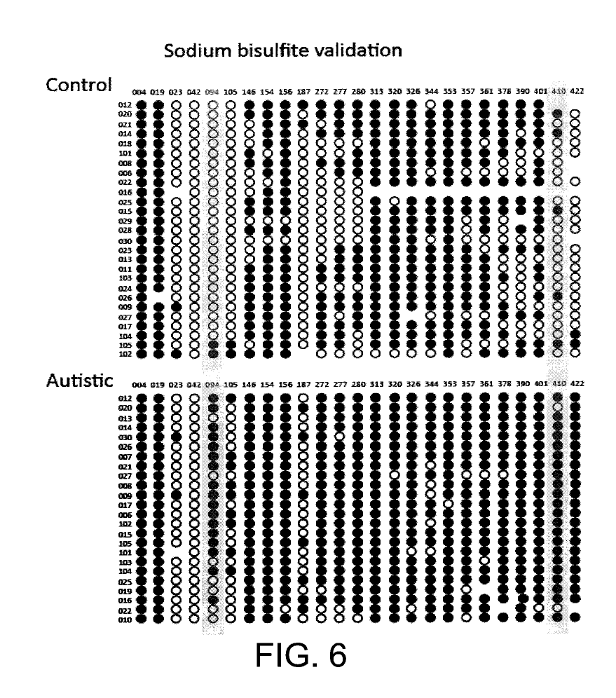

A comparison of average genome-wide methylation levels between the discordant sib-pairs revealed that the extent of methylation differs significantly between ASD and unaffected sibs. Average genome-wide MI levels were significantly lower in ASD males than their discordant brothers (FIG. 1a), with the majority of ASD cases (81/110; ˜75%) having an overall decrease in genome-wide MI levels compared with their sibs (FIG. 1b); the extent of differential methylation of several loci was subsequently validated by sequencing sodium bisulfite-treated DNA (FIG. 6). Trivial explanations to account for the differences we found between brothers, such as proband age, appear unlikely, as 56 probands of the 110 sib-pairs were firstborn children. Likewise, parental age and medication history were also ruled out (Table 2), and since we compared sibs rather than unrelated controls, the impact of environmental causes should be minimized.

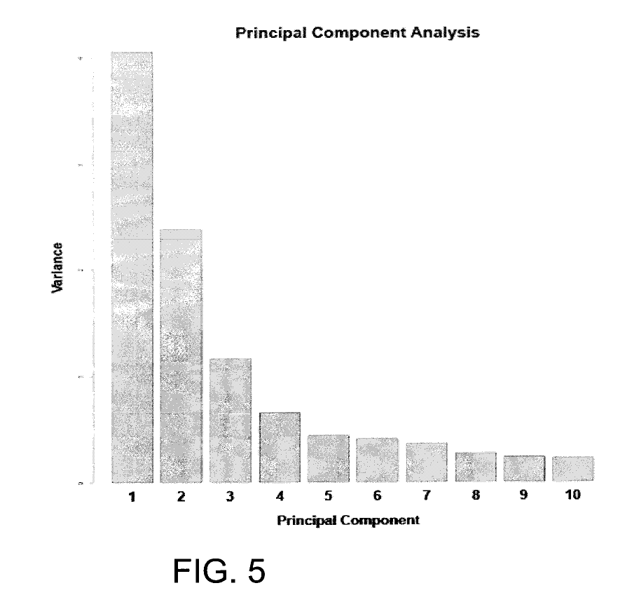

The difference in MI levels can be visualized with the aid of a principal components analysis using all 27,578 MIs of all 220 individuals. The first two principal components (PC) were significant according to a Tracy-Widom test¹⁵ and explained 24% of the variance in the complete data matrix (FIG. 5). Although there is substantial overlap in the distribution of the first two PC between the discordant sibs (FIG. 1c), there is a distinct trend with ASD boys more prevalent in the lower left corner and non-ASD boys more prevalent in the upper right corner. In fact, 61.8% of individuals could be correctly classified as ASD or non-ASD in a logistic regression model based on just the first two principal components. These data reveal distinct epigenetic differences between sib-pairs discordant for autism.

The above data suggest there is predictive information on ASD status in the epigenome. To test this hypothesis, we performed two analyses. First, we randomly divided our data into a training set, consisting of full data from 75 sib-pairs, and a test set that included de-identified data (i.e., data stripped of information about sib relationships and disease status) from the remaining 35 sib-pairs. Then we fit three different prediction algorithms to the training set data; ASD status was determined using the consensus of these three algorithms. The predictive ability of this approach was then tested by a blinded analyst on data from the 35 sibs in the test set. Using all 27,758 MIs, this approach was able to correctly classify ˜70% of the individuals in the test set by disease state, significantly better than chance alone (p<0.001; Table 1). We also used Random Forest (RF)¹⁶ to determine the ability of the MI data to correctly classify probands as ASD or unaffected. Using data from all 27,758 MIs, we found a prediction rate of 64.1%, again significantly better than chance alone (p<0.001).

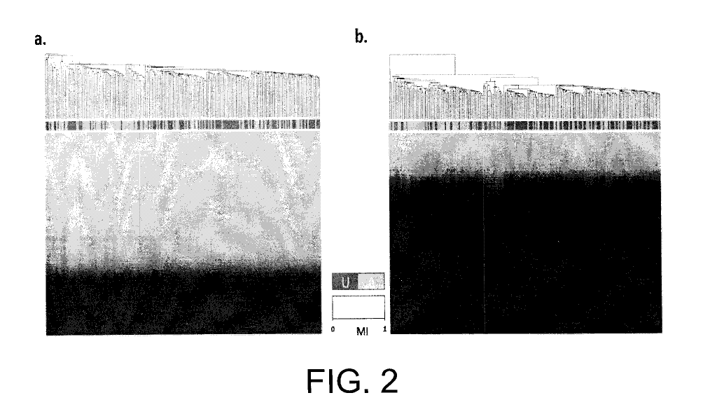

To identify loci with significant DNA methylation differences between discordant sib-pairs, we next subjected the MI of each locus to a mixed-model version of the paired t-test, allowing for possible array effects¹⁷. This analysis revealed 2,338 differentially methylated loci (DML) in ASD males compared with their discordant brothers (2,229 hypomethylated and 109 hypermethylated; false discovery rate<0.05; Table 3). We then performed two unsupervised hierarchical cluster analyses, the first using all 27,758 MIs (FIG. 2a) and the second using only the 2,338 differentially methylated loci (FIG. 2b). While the analysis using only the DML appears to be more successful at differentiating ASD from unaffected sibs, use of them did not dramatically improve the cluster of individuals by disease status. These data suggest DNA methylation differences between sib-pairs discordant for autism are subtle and not carried by just a few significantly differentially methylated loci, but rather are spread across the entire genome.

To further explore the reliability of short lists of loci in predicting ASD status, we repeated our RF analysis, but this time we allowed RF to select the 25, 50 or 100 most predictive” loci for a second-stage classification. Although this did improve the prediction error rate (˜21%), permutation analyses revealed that null simulations had a similar error rate, suggesting that lists with only a small number of variables “overfit” the data. This is another indicator that that the distinguishing information in DNA methylation differences between sib-pairs discordant for autism is spread across the entire genome.

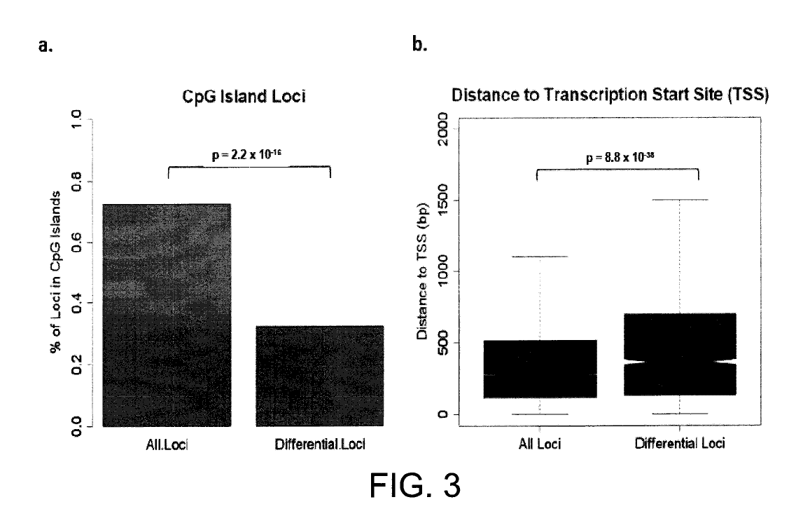

The DML we identified were found in an unexpected genomic location. Whereas the majority of CpG dinucleotides interrogated in this study reside in canonical “CpG islands” (˜73%), less than 29% of the DML we observed here are within these islands (FIG. 3a). Instead, most of the ASD-associated DML are located on “CpG island shores,” within two kilobases of a canonical CpG island (FIG. 3b). CpG island shores were recently found to be the primary location of DNA methylation differences between various types of tissue and between normal cells and cancer cells¹⁸. Moreover, differential methylation in CpG island shores is known to be strongly associated with differential gene expression. Thus the 2,338 DML we observed are largely confined to genomic regions lying outside CpG islands and have the potential to influence gene expression. However, when we used Random Forest to test the ASD prediction rate of CpG island shores loci alone, the prediction rate (˜61%), was about the same as what we obtained using Random Forest to assess the CpG island loci alone (˜61%). This suggests the epigenetic information that distinguishes ASD status is not contained solely in either of these CpG locations.

Elsewhere in this issue, Kong et al. report independent studies comparing gene expression profiles in whole blood between ASD males and unrelated non-ASD males. They find 330 differentially expressed genes associated with ASD; a list that overlaps significantly with our DML reported above (p=2.7×10⁻⁴), providing more evidence that these DML may indeed influence gene expression. Moreover, if we use the MIs of 378 CpG dinucleotides from our dataset that are located near the transcription start site of the 330 differentially expressed genes identified by Kong et al., the prediction algorithms again correctly classified ˜65% of the individuals by disease state (p<0.001; Table 1). These data provide compelling evidence for an epigenetic component in a substantial proportion of ASD cases, and this is reflected in both DNA methylation and gene expression differences.

We also examined the rank correlations between 63 clinical variables assessed in the Simons Simplex Collection and the rank (i.e., percent called correctly by Random Forest) of each ASD individual. Following a Bonferroni correction for the 63 tests, no variable correlated significantly to the rank of the ASD individual, suggesting the DNA methylation differences noted above appear not to correlate with any ASD clinical indices; however, we did find 13 variables with appreciable differences between the two groups, and the phenotype scores for these variables indicated that the higher-ranked probands exhibit a less severe psychopathology than the lower-ranked probands. This finding might mean that aberrant genome-wide methylation is associated with a more modest ASD phenotype. One possible explanation for this observation is that a quarter of ASD cases with no substantial methylation differences reflect those with underlying, but yet to be discovered, large-effect mutations, such as small chromosomal deletions/duplications or multiple but individually rare single gene causes of autism. In general, these forms of autism may result in a more severe form of ASD.

We describe here DNA methylation differences between 110 ASD discordant sib-pairs using DNA isolated from peripheral blood and identify 2,338 differentially methylated loci. Gene ontology (GO) analysis with permutations finds >200 significant GO terms (Table 4; p<0.05) that fall into a variety of categories. However, of the top 20 genes showing the most significant methylation differences between the discordant sib-pairs, eight have already been implicated in autism. For example, MAB21L2 and TDRD3 both fall within deletion intervals found in patients with autism or mental retardation, and the TDRD3 protein has been associated with FMRP, the protein absent in fragile X syndrome^{19,20}. Furthermore, the MGAT4C locus is found to be interrupted by a balanced translocation in a patient with developmental delay, and C20orf7 is responsible for some forms of Leigh syndrome, a mitochondrial disorder linked to autism²¹⁻²³. The axon guidance receptor ROBO1 has been linked to autism by several groups²⁴. Whether or not the methylation differences detected in our blood-derived DNA samples of these genes reflect differences in neuronal expression remains to be established. Regardless, the ability to assess ASD cases by DNA methylation analysis of blood could lead to a peripheral biomarker for autism, assuming the DNA methylation differences are present in presymptomatic individuals.

With regard to mechanism, our data are consistent with an earlier study which demonstrated that ASD males have a lower ratio of S-adenosylmethionine (SAM)/S-adenosylhomocysteine (SAH) than non-ASD males, and this lower ratio results from an overall increase in SAH^{25,26}. Since SAH is a potent competitor of DNA methyltransferases, this may explain the relative hypomethylation we observe in these patients. Whether or not this is secondary to other genetic variation or due to environmental variables, including prenatal variables, remains to be investigated. Indeed, linking autism to epigenetics, as we do above, brings together two sometimes contentious etiologies: genetics and the environment.

### Analysis of Methylation Profiling Data

Methylation profiling data was interpreted using BeadStudio²⁷. Average methylation across all 27,578 loci was compared via a paired t-test. A mixed-model version of the paired t-test was used to investigate locus-specific differences in methylation between ASD and unaffected sibs, allowing for possible array effects²⁷. Principal component analysis of the standardized MIs from 27,578 loci was conducted using the prcomp( ) function in R (http://www.r-project.org/)²⁷. Among the 27,578 loci tested, a set of differentially methylated loci was defined with the false-discovery rate controlled at 0.05 based on the q value of Storey¹⁷. Heatmaps and hierarchical clustering were generated in R using the heatmap.2 function of the gplots package where Euclidean distance was used to calculate a dissimilarity matrix, and clustering used an average linkage algorithm.

The three model consensus prediction was composed of the following models: 1) the Weighted Voting model whereby each locus was weighted by the t-statistic of differential analysis; 2) the K-Nearest Neighbor (KNN) prediction algorithm²⁸, and 3) the shrunken centroid classifier²⁹.

Random Forest analysis was performed using the Fortran program r5new.f available at http://www.stat.berkeley.edu/˜breiman/RandomForests/cc_examples/prog.f. Random Forest builds a classification tree based on a bootstrap sample taken from the data; the prediction error rate for this tree can then be evaluated using those samples not in the bootstrap sample. This process is repeated jbt times (we used jbt=5,000). The final prediction error is the average prediction rate among bootstrap iterates²⁷.

### DNA Methylation Profiling

Five hundred nanograms (ng) of human genomic DNA was sodium bisulfite-treated for CT conversion using the EZ DNA Methylation-Gold kit (Zymo Research, Orange, Calif.). The converted DNA was purified and prepped for analysis on the Illiumina HumanMethylation27 BeadChip following the manufacturer's guidelines. Briefly, converted DNA was amplified, fragmented and hybridized to the humanmethylation27 pool of allele-differentiating oligonucleotides. After a series of extension, ligation and cleanup reactions, the DNA was labeled with a fluorescent dye. The labeled DNA was then scanned using a BeadStation 500GX scanner. Image analysis and beta score calculation was performed using the BeadStudio software, Methylation Module.

### Analysis of Methylation Profiling Data

BeadStudio first quantifies signal intensities for probes corresponding to methylated and unmethylated genomic DNA for a specific CpG locus. Overall methylation levels were assigned a β-value, which ranges from 0 (unmethylated) to 1 (methylated) and is calculated as a function of the competing methylated and unmethylated probes for a given locus. Possible array effects were assessed using a linear regression of log(β(1−β)) on autism status with a fixed effect for family-id and a random effect for chip. A Tracy-Widom test¹⁵ was performed to determine how many principal components to consider in a predictive model.

Using Random Forest, the proportion of times each sample is classified as ASD or unaffected is computed for each bootstrap iterate, and the final ASD classification for each sample is the ASD status assigned most frequently. In all analyses, the number of variables available for each branch (mtry0, the primary tunable parameter in Random Forest) was taken to be the square root of the total number of available predictor variables. Permutation analysis was performed by randomly assigning ASD status within each sibship in such a way that each sibship retained one affected and one unaffected sib.

### Independent Validation of Differential Methylation Status

Sodium bisulfite treatment of genomic DNA was via EpiTect Bisulfite Kit (Qiagen Cat. #59104). Briefly, 0.5 μg of genomic DNA, isolated from lymphoblastoid cells or from peripheral blood lymphocytes in 20 μl of distilled water, was mixed with sodium bisulfite mix and DNA protect buffer (Qiagen kit contents). Sodium bisulfite DNA conversion was conducted in a thermocycler with the following parameters: 95° C. for 5 min, 60° C. for 25 min, 95° C. for 5 min, 60° C. for 85 min, 95° C. for 5 min, 60° C. for 175 min and a final hold at 20° C. for 10 h. The conversion reactions were cleaned up using the kit-provided columns and wash buffer, and the samples were eluted with 40 μl of kit-provided elution buffer.

The bisulfite-converted DNAs were amplified in an MJ Research PCR machine and the following cycling parameters: 1 cycle at 94° C. for 3 min, followed by 30 cycles at 94° C. for 10 s, 55-62° C. (depending on primer melting temperature) for 30 s, and 68° C. for 1 min, with a final extension at 68° C. for 10 min. The resultant PCR products were size-fractionated on a 1% agarose gel, excised from the gel and purified using a GeneClean III kit following the manufacturer's protocol. Purified products were cloned into a TOPO TA cloning vector (Invitrogen Cat. #K4530-20) and sequenced using a universal T7 primer. All sequences were aligned to their respective converted reference sequence, and all original CpG dinucleotides were scored either methylated or unmethylated based on the presence of a CpG or a TpG, respectively.

### Gene Ontology Method

Gene Ontology analysis was conducted in R using the GOstats package³⁰ and the lumiHumanAll.db annotation file for IIlumina probes. Significance was assessed using the hypergeometric test with p<0.01. Results were further assessed by 100 permutations of random autistic and non-autistic class assignment to each sib-pair. Then the DML were recalculated and the subsequent gene ontology annotation was given a permutation p-value, which is listed in Table 4.
References for Example 1, each of which are incorporated herein by reference.
1 Center for Disease Control and Prevention, Available at http://www.cdc.gov/ncbddd/features/counting-autism.html, (2009).
2 Association, A. P., Diagnostic and statistical manual of mental disorders. (Washington, D.C., 1994).
3 Abrahams, B. S. & Geschwind, D. H., Advances in autism genetics: on the threshold of a new neurobiology. Nat Rev Genet 9 (5), 341-355 (2008).
4 Cook, E. H., Jr. et al., Autism or atypical autism in maternally but not paternally derived proximal 15q duplication. Am J Hum Genet 60 (4), 928-934 (1997).
5 Schroer, R. J. et al., Autism and maternally derived aberrations of chromosome 15q. Am J Med Genet 76 (4), 327-336 (1998).
6 Descheemaeker, M. J., Govers, V., Vermeulen, P., & Fryns, J. P., Pervasive developmental disorders in Prader-Willi syndrome: the Leuven experience in 59 subjects and controls. American Journal of Medical Genetics 140A (11), 1136-1142 (2006).
7 Holland, A. J. et al., Behavioural phenotypes associated with specific genetic disorders: evidence from a population-based study of people with Prader-Willi syndrome. Psychological Medicine 33 (1), 141-153 (2003).
8 Steffenburg, S., Gillberg, C., Steffenburg, U., & Kyllerman, M., Autism in Angelman syndrome: a population-based study. Pediatric Neurology 14 (2), 131-136 (1996).
9 Samaco, R. C., Hogart, A., & LaSalle, J. M., Epigenetic overlap in autism-spectrum neurodevelopmental disorders: MECP2 deficiency causes reduced expression of UBE3A and GABRB3. Hum Mol Genet 14 (4), 483-492 (2005).
10 Amir, R. E. et al., Rett syndrome is caused by mutations in X-linked MECP2, encoding methyl-CpG-binding protein 2. Nat Genet 23 (2), 185-188 (1999).
11 Nagarajan, R. P., Hogart, A. R., Gwye, Y., Martin, M. R., & LaSalle, J. M., Reduced MeCP2 expression is frequent in autism frontal cortex and correlates with aberrant MECP2 promoter methylation. Epigenetics 1 (4), e1-11 (2006).
12 Skuse, D. H. et al., Evidence from Turner's syndrome of an imprinted X-linked locus affecting cognitive function. Nature 387 (6634), 705-708 (1997).
13 Gregory, S. G. et al., Genomic and epigenetic evidence for oxytocin receptor deficiency in autism. BMC Med 7, 62 (2009).
14 The Simons Foundation, Available at http://www.simonsfoundation.org/.
15 Patterson, N., Price, A. L., & Reich, D., Population structure and eigenanalysis. PLoS Genet 2 (12), e190 (2006).
16 Breiman, L., Random Forests. Machine Learning 45, 5-32 (2001).
17 Storey, J. D., A direct approach to false discovery rates. Journal of the Royal Statistical Society, Series B 64, 479-498 (2002).
18 Irizarry, R. A. et al., The human colon cancer methylome shows similar hypo- and hypermethylation at conserved tissue-specific CpG island shores. Nat Genet 41 (2), 178-186 (2009).
19 Smith, M. et al., Molecular genetic delineation of a deletion of chromosome 13q12→q13 in a patient with autism and auditory processing deficits. Cytogenet Genome Res 98 (4), 233-239 (2002).
20 Filges, I. et al., Familial 14.5 Mb interstitial deletion 13q21.1-13q21.33: clinical and array-CGH study of a benign phenotype in a three-generation family. Am J Med Genet A 149A (2), 237-241 (2009).
21 Chen, W. et al., Mapping translocation breakpoints by next-generation sequencing. Genome Res 18 (7), 1143-1149 (2008).
22 Gerards, M. et al., Defective complex I assembly due to C20orf7 mutations as a new cause of Leigh syndrome. J Med Genet (2009).
23 Graf, W. D. et al., Autism associated with the mitochondrial DNA G8363A transfer RNA(Lys) mutation. J Child Neurol 15 (6), 357-361 (2000).
24 Anitha, A. et al., Genetic analyses of roundabout (ROBO) axon guidance receptors in autism. Am J Med Genet B Neuropsychiatr Genet 147B (7), 1019-1027 (2008).
25 James, S. J. et al., Metabolic biomarkers of increased oxidative stress and impaired methylation capacity in children with autism. Am J Clin Nutr 80 (6), 1611-1617 (2004).
26 James, S. J. et al., Metabolic endophenotype and related genotypes are associated with oxidative stress in children with autism. Am J Med Genet B Neuropsychiatr Genet 141B (8), 947-956 (2006).
27 See “Additionsl Methods” as described herein
28 Reich, M. et al., GenePattern 2.0. Nat Genet 38 (5), 500-501 (2006).
29 Tibshirani, R., Hastie, T., Narasimhan, B., & Chu, G., Diagnosis of multiple cancer types by shrunken centroids of gene expression. Proc Natl Acad Sci USA 99 (10), 6567-6572 (2002).
30 Falcon, S. & Gentleman, R., Using GOstats to test gene lists for GO term association. Bioinformatics 23 (2), 257-258 (2007).

TABLE 2
Table 2: Individuals epityped in this study.

| Individual | Date of | Birth | SF | Age at | Mother | Father's |
|---|---|---|---|---|---|---|
| Id. | Birth | order | diagnosis | Measure | age | age |
| 11031.p1 | 1994/07 | 1 | Asperger's | 165 | 387 | 408 |
| 11168.p1 | 1996/05 | 1 | Asperger's | 138 | 387 | 484 |
| 11298.p1 | 1992/08 | 1 | Asperger's | 190 | 380 | 361 |
| 11300.p1 | 1997/10 | 1 | Asperger's | 125 | 385 | 432 |
| 11383.p1 | 2001/03 | 1 | Asperger's | 86 | 359 | 366 |
| 11504.p1 | 1999/12 | 1 | Asperger's | 99 | 424 | 442 |
| 11511.p1 | 1997/10 | 1 | Asperger's | 127 | 320 | 316 |
| 11546.p1 | 1995/11 | 1 | Asperger's | 151 | 437 | 406 |
| 11008.p1 | 1991/02 | 2 | Asperger's | 205 | 431 | 436 |
| 11028.p1 | 1999/05 | 2 | Asperger's | 109 | 378 | 452 |
| 11094.p1 | 2001/09 | 2 | Asperger's | 78 | 385 | 382 |
| 11561.p1 | 2002/07 | 2 | Asperger's | 71 | 431 | 429 |
| 11004.p1 | 1992/08 | 1 | Autism | 190 | 359 | 391 |
| 11009.p1 | 1999/03 | 1 | Autism | 108 | 332 | 317 |
| 11011.p1 | 1999/11 | 1 | Autism | 100 | 442 | 623 |
| 11013.p1 | 1998/06 | 1 | Autism | 120 | 322 | 321 |
| 11014.p1 | 1998/05 | 1 | Autism | 118 | 337 | 332 |
| 11046.p1 | 2001/10 | 1 | Autism | 80 | 320 | 343 |
| 11054.p1 | 1995/06 | 1 | Autism | 156 | 228 | 277 |
| 11057.p1 | 1999/10 | 1 | Autism | 104 | 344 | 326 |
| 11063.p1 | 1998/07 | 1 | Autism | 113 | 366 | 378 |
| 11096.p1 | 1994/08 | 1 | Autism | 163 | 383 | NA |
| 11113.p1 | 1992/09 | 1 | Autism | 186 | 277 | 375 |
| 11146.p1 | 1997/04 | 1 | Autism | 131 | 243 | 275 |
| 11156.p1 | 1995/05 | 1 | Autism | 157 | 364 | 424 |
| 11178.p1 | 1998/09 | 1 | Autism | 114 | 310 | 450 |
| 11218.p1 | 1997/12 | 1 | Autism | 126 | 405 | 407 |
| 11227.p1 | 1998/10 | 1 | Autism | 116 | 294 | 332 |
| 11235.p1 | 2001/05 | 1 | Autism | 82 | 364 | 393 |
| 11251.p1 | 2000/09 | 1 | Autism | 90 | 446 | 481 |
| 11257.p1 | 2001/08 | 1 | Autism | 80 | 470 | 423 |
| 11282.p1 | 1999/07 | 1 | Autism | 105 | 397 | 415 |
| 11296.p1 | 1994/06 | 1 | Autism | 168 | 391 | 400 |
| 11307.p1 | 1991/11 | 1 | Autism | 196 | 413 | 427 |
| 11325.p1 | 1992/11 | 1 | Autism | 187 | 355 | 382 |
| 11333.p1 | 1998/03 | 1 | Autism | 118 | 323 | 298 |
| 11334.p1 | 1993/07 | 1 | Autism | 176 | 346 | 437 |
| 11370.p1 | 1993/08 | 1 | Autism | 175 | 339 | 405 |
| 11404.p1 | 2000/11 | 1 | Autism | 89 | 288 | 375 |
| 11452.p1 | 1999/11 | 1 | Autism | 102 | 303 | 313 |
| 11462.p1 | 1999/04 | 1 | Autism | 110 | 477 | 457 |
| 11488.p1 | 1996/12 | 1 | Autism | 133 | 445 | 443 |
| 11597.p1 | 1995/11 | 1 | Autism | 148 | 343 | 339 |
| 11599.p1 | 2001/11 | 1 | Autism | 79 | 322 | 318 |
| 11641.p1 | 1999/08 | 1 | Autism | 103 | 248 | 319 |
| 11052.p1 | 2002/09 | 2 | Autism | 68 | 430 | 469 |
| 11075.p1 | 2001/10 | 2 | Autism | 80 | 324 | 308 |
| 11093.p1 | 2000/02 | 2 | Autism | 97 | 336 | NA |
| 11108.p1 | 2000/02 | 2 | Autism | 97 | 324 | 348 |
| 11124.p1 | 1996/12 | 2 | Autism | 133 | 351 | 359 |
| 11199.p1 | 1997/07 | 2 | Autism | 128 | 405 | 489 |
| 11201.p1 | 2000/01 | 2 | Autism | 101 | 401 | 426 |
| 11242.p1 | 2002/07 | 2 | Autism | 70 | 306 | 316 |
| 11245.p1 | 1997/04 | 2 | Autism | 131 | 374 | 390 |
| 11256.p1 | 1996/11 | 2 | Autism | 136 | 304 | 339 |
| 11289.p1 | 2002/04 | 2 | Autism | 72 | 333 | 413 |
| 11305.p1 | 1993/06 | 2 | Autism | 175 | 405 | 420 |
| 11312.p1 | 1998/06 | 2 | Autism | 120 | 424 | 390 |
| 11345.p1 | 2001/12 | 2 | Autism | 73 | 281 | 391 |
| 11346.p1 | 1997/03 | 2 | Autism | 132 | 433 | 438 |
| 11349.p1 | 2000/11 | 2 | Autism | 84 | 361 | 403 |
| 11366.p1 | 2003/06 | 2 | Autism | 60 | 354 | 436 |
| 11381.p1 | 2002/11 | 2 | Autism | 67 | 359 | 374 |
| 11398.p1 | 1995/11 | 2 | Autism | 148 | 326 | 335 |
| 11417.p1 | 2000/04 | 2 | Autism | 98 | 449 | 456 |
| 11429.p1 | 1997/01 | 2 | Autism | 137 | 432 | 442 |
| 11435.p1 | 1990/08 | 2 | Autism | 212 | 391 | 417 |
| 11437.p1 | 1991/06 | 2 | Autism | 201 | 380 | 382 |
| 11459.p1 | 1997/03 | 2 | Autism | 135 | 350 | 313 |
| 11484.p1 | 1997/09 | 2 | Autism | 129 | 417 | 416 |
| 11520.p1 | 1998/10 | 2 | Autism | 115 | 398 | 389 |
| 11544.p1 | 1992/09 | 2 | Autism | 186 | 385 | 375 |
| 11545.p1 | 2000/03 | 2 | Autism | 95 | 382 | 440 |
| 11580.p1 | 1998/08 | 2 | Autism | 118 | 312 | 450 |
| 11584.p1 | 1996/10 | 2 | Autism | 138 | 353 | 378 |
| 11696.p1 | 1994/11 | 2 | Autism | 163 | 432 | 448 |
| 11005.p1 | 1998/10 | 1 | NA | NA | NA | NA |
| 11026.p1 | 1993/03 | 1 | NA | NA | NA | NA |
| 11149.p1 | 1992/12 | 1 | NA | NA | NA | NA |
| 11226.p1 | 1998/02 | 1 | NA | NA | NA | NA |
| 11260.p1 | 1999/01 | 1 | NA | NA | NA | NA |
| 11271.p1 | 1999/06 | 1 | NA | NA | NA | NA |
| 11402.p1 | 1999/05 | 1 | NA | NA | NA | NA |
| 11553.p1 | 1994/11 | 1 | NA | NA | NA | NA |
| 11076.p1 | 1994/09 | 2 | NA | NA | NA | NA |
| 11102.p1 | 1997/12 | 2 | NA | NA | NA | NA |
| 11138.p1 | 1998/05 | 2 | NA | NA | NA | NA |
| 11186.p1 | 1995/09 | 2 | NA | NA | NA | NA |
| 11192.p1 | 2002/05 | 2 | NA | NA | NA | NA |
| 11293.p1 | 1999/06 | 2 | NA | NA | NA | NA |
| 11377.p1 | 2001/07 | 2 | NA | NA | NA | NA |
| 11492.p1 | 1996/02 | 2 | NA | NA | NA | NA |
| 11596.p1 | 2002/02 | 2 | NA | NA | NA | NA |
| 11008.s1 | 1981/12 | 1 | Non-ASD | 323 | 313 | 318 |
| 11028.s1 | 1995/06 | 1 | Non-ASD | 159 | 328 | 402 |
| 11041.s1 | 1992/07 | 1 | Non-ASD | 195 | 370 | 313 |
| 11052.s1 | 2000/04 | 1 | Non-ASD | 101 | 397 | 436 |
| 11075.s1 | 1998/03 | 1 | Non-ASD | 125 | 279 | 263 |
| 11076.s1 | 1992/05 | 1 | Non-ASD | NA | NA | NA |
| 11077.s1 | 1993/09 | 1 | Non-ASD | 179 | 414 | 411 |
| 11089.s1 | 1999/02 | 1 | Non-ASD | 114 | 375 | 395 |
| 11093.s1 | 1998/04 | 1 | Non-ASD | 127 | 306 | NA |
| 11094.s1 | 1996/01 | 1 | Non-ASD | 154 | 309 | 306 |
| 11102.s1 | 1996/03 | 1 | Non-ASD | NA | NA | NA |
| 11108.s1 | 1997/08 | 1 | Non-ASD | 135 | 286 | 310 |
| 11124.s1 | 1994/10 | 1 | Non-ASD | 171 | 313 | 321 |
| 11138.s1 | 1991/01 | 1 | Non-ASD | NA | NA | NA |
| 11186.s1 | 1991/08 | 1 | Non-ASD | NA | NA | NA |
| 11192.s1 | 2000/08 | 1 | Non-ASD | NA | NA | NA |
| 11194.s1 | 1997/06 | 1 | Non-ASD | 138 | 331 | 448 |
| 11199.s1 | 1994/05 | 1 | Non-ASD | 175 | 358 | 442 |
| 11201.s1 | 1997/10 | 1 | Non-ASD | 126 | 376 | 401 |
| 11216.s1 | 2002/01 | 1 | Non-ASD | 79 | 310 | 343 |
| 11242.s1 | 1997/10 | 1 | Non-ASD | 131 | 245 | 255 |
| 11245.s1 | 1994/02 | 1 | Non-ASD | 177 | 328 | 344 |
| 11252.s1 | 1996/11 | 1 | Non-ASD | 142 | 380 | 537 |
| 11256.s1 | 1994/03 | 1 | Non-ASD | 176 | 264 | 299 |
| 11282.s1 | 1999/07 | 1 | Non-ASD | 111 | 391 | 409 |
| 11289.s1 | 2000/05 | 1 | Non-ASD | 100 | 305 | 385 |
| 11293.s1 | 1993/07 | 1 | Non-ASD | NA | NA | NA |
| 11296.s1 | 1994/06 | 1 | Non-ASD | 170 | 389 | 398 |
| 11305.s1 | 1989/10 | 1 | Non-ASD | 231 | 349 | 364 |
| 11312.s1 | 1995/11 | 1 | Non-ASD | 153 | 391 | 357 |
| 11345.s1 | 2000/01 | 1 | Non-ASD | 108 | 246 | 356 |
| 11346.s1 | 1995/04 | 1 | Non-ASD | 163 | 402 | 407 |
| 11349.s1 | 1999/04 | 1 | Non-ASD | 95 | 350 | 392 |
| 11366.s1 | 1997/09 | 1 | Non-ASD | 131 | 283 | 365 |
| 11370.s1 | 1993/08 | 1 | Non-ASD | 183 | 331 | 397 |
| 11377.s1 | 1998/02 | 1 | Non-ASD | 129 | NA | NA |
| 11378.s1 | 1997/03 | 1 | Non-ASD | 138 | 388 | 398 |
| 11381.s1 | 2001/01 | 1 | Non-ASD | 91 | 335 | 350 |
| 11398.s1 | 1994/06 | 1 | Non-ASD | 173 | 301 | 310 |
| 11399.s1 | 1994/12 | 1 | Non-ASD | 164 | 291 | 342 |
| 11415.s1 | 1994/11 | 1 | Non-ASD | 166 | 448 | 370 |
| 11417.s1 | 1998/07 | 1 | Non-ASD | 121 | 426 | 433 |
| 11429.s1 | 1989/10 | 1 | Non-ASD | 227 | 342 | 352 |
| 11435.s1 | 1984/12 | 1 | Non-ASD | 288 | 315 | 341 |
| 11437.s1 | 1989/10 | 1 | Non-ASD | 231 | 350 | 352 |
| 11459.s1 | 1994/02 | 1 | Non-ASD | 175 | 310 | 273 |
| 11484.s1 | 1994/01 | 1 | Non-ASD | 175 | 371 | 370 |
| 11492.s1 | 1993/09 | 1 | Non-ASD | NA | NA | NA |
| 11520.s1 | 1997/06 | 1 | Non-ASD | 135 | 378 | 369 |
| 11522.s1 | 1992/11 | 1 | Non-ASD | 192 | 344 | 327 |
| 11544.s1 | 1990/07 | 1 | Non-ASD | 220 | 351 | 341 |
| 11545.s1 | 1996/11 | 1 | Non-ASD | 146 | 331 | 389 |
| 11561.s1 | 1999/04 | 1 | Non-ASD | 112 | 390 | 388 |
| 11580.s1 | 1996/06 | 1 | Non-ASD | 148 | 282 | 420 |
| 11584.s1 | 1994/07 | 1 | Non-ASD | 171 | 320 | 345 |
| 11596.s1 | 1993/08 | 1 | Non-ASD | NA | NA | NA |
| 11696.s1 | 1991/08 | 1 | Non-ASD | 204 | 391 | 407 |
| 11004.s1 | 1997/12 | 2 | Non-ASD | 128 | 421 | 453 |
| 11005.s1 | 2000/03 | 2 | Non-ASD | NA | NA | NA |
| 11009.s1 | 2000/08 | 2 | Non-ASD | 99 | 341 | 326 |
| 11011.s1 | 2002/03 | 2 | Non-ASD | 80 | 462 | 643 |
| 11013.s1 | 2000/12 | 2 | Non-ASD | 92 | 350 | 349 |
| 11014.s1 | 2002/10 | 2 | Non-ASD | 52 | 403 | 398 |
| 11018.s1 | 2003/06 | 2 | Non-ASD | 65 | NA | 574 |
| 11026.s1 | 1997/10 | 2 | Non-ASD | 135 | 448 | NA |
| 11031.s1 | 1996/04 | 2 | Non-ASD | 150 | 402 | 423 |
| 11046.s1 | 2002/09 | 2 | Non-ASD | 72 | 328 | 351 |
| 11054.s1 | 1997/11 | 2 | Non-ASD | 129 | 255 | 304 |
| 11057.s1 | 2002/07 | 2 | Non-ASD | 73 | 375 | 357 |
| 11063.s1 | 2000/09 | 2 | Non-ASD | 77 | 402 | 414 |
| 11096.s1 | 1996/07 | 2 | Non-ASD | 148 | 398 | NA |
| 11113.s1 | 1998/11 | 2 | Non-ASD | 101 | 362 | 460 |
| 11131.s1 | 2002/05 | 2 | Non-ASD | 76 | 385 | 443 |
| 11146.s1 | 1998/07 | 2 | Non-ASD | 104 | 270 | 302 |
| 11149.s1 | 1994/07 | 2 | Non-ASD | NA | NA | NA |
| 11156.s1 | 1998/03 | 2 | Non-ASD | 125 | 396 | 456 |
| 11168.s1 | 1999/10 | 2 | Non-ASD | 89 | 436 | 533 |
| 11178.s1 | 2002/10 | 2 | Non-ASD | 75 | 349 | 489 |
| 11197.s1 | 2000/09 | 2 | Non-ASD | 95 | 384 | 382 |
| 11218.s1 | 1999/12 | 2 | Non-ASD | 104 | 427 | 429 |
| 11226.s1 | 2002/05 | 2 | Non-ASD | NA | NA | NA |
| 11227.s1 | 2001/09 | 2 | Non-ASD | 83 | 327 | 365 |
| 11235.s1 | 2003/03 | 2 | Non-ASD | 69 | 377 | 406 |
| 11251.s1 | 2002/12 | 2 | Non-ASD | 73 | 463 | 498 |
| 11257.s1 | 2004/02 | 2 | Non-ASD | 57 | 493 | 446 |
| 11260.s1 | 2001/03 | 2 | Non-ASD | NA | NA | NA |
| 11271.s1 | 2000/11 | 2 | Non-ASD | NA | NA | NA |
| 11298.s1 | 1995/01 | 2 | Non-ASD | 163 | 407 | 388 |
| 11299.s1 | 2004/01 | 2 | Non-ASD | 56 | 369 | 339 |
| 11300.s1 | 1999/10 | 2 | Non-ASD | 89 | 421 | 468 |
| 11303.s1 | 2003/10 | 2 | Non-ASD | 60 | 415 | 517 |
| 11307.s1 | 1994/10 | 2 | Non-ASD | 148 | 461 | 475 |
| 11318.s1 | 2002/08 | 2 | Non-ASD | 72 | 495 | 471 |
| 11325.s1 | 1996/02 | 2 | Non-ASD | 150 | 392 | 419 |
| 11333.s1 | 2001/02 | 2 | Non-ASD | 95 | 346 | 321 |
| 11334.s1 | 1995/06 | 2 | Non-ASD | 162 | 360 | 451 |
| 11383.s1 | 2002/10 | 2 | Non-ASD | 71 | 374 | 381 |
| 11402.s1 | 2000/10 | 2 | Non-ASD | NA | NA | NA |
| 11404.s1 | 2003/07 | 2 | Non-ASD | 64 | 313 | 400 |
| 11441.s1 | 2003/11 | 2 | Non-ASD | 61 | 417 | 393 |
| 11452.s1 | 2001/07 | 2 | Non-ASD | 86 | 319 | 329 |
| 11462.s1 | 2001/12 | 2 | Non-ASD | 80 | 507 | 487 |
| 11488.s1 | 2000/02 | 2 | Non-ASD | 107 | 471 | 469 |
| 11504.s1 | 2002/04 | 2 | Non-ASD | 80 | 443 | 461 |
| 11511.s1 | 1999/04 | 2 | Non-ASD | 113 | 334 | 330 |
| 11546.s1 | 1997/04 | 2 | Non-ASD | 136 | 452 | 421 |
| 11553.s1 | 1996/11 | 2 | Non-ASD | NA | NA | NA |
| 11597.s1 | 1999/02 | 2 | Non-ASD | 118 | 373 | 369 |
| 11599.s1 | 2004/03 | 2 | Non-ASD | 53 | 348 | 344 |
| 11641.s1 | 2002/01 | 2 | Non-ASD | 83 | 268 | 339 |
| 11018.p1 | 2000/08 | 1 | PDD-NOS | 99 | NA | 540 |
| 11131.p1 | 2000/10 | 1 | PDD-NOS | 92 | 369 | 427 |
| 11197.p1 | 1998/04 | 1 | PDD-NOS | 122 | 357 | 355 |
| 11299.p1 | 2001/12 | 1 | PDD-NOS | 77 | 348 | 318 |
| 11303.p1 | 2002/07 | 1 | PDD-NOS | 70 | 405 | 507 |
| 11318.p1 | 2000/04 | 1 | PDD-NOS | 98 | 469 | 445 |
| 11441.p1 | 2000/05 | 1 | PDD-NOS | 94 | 384 | 360 |
| 11041.p1 | 1995/03 | 2 | PDD-NOS | 156 | 409 | 352 |
| 11077.p1 | 1996/04 | 2 | PDD-NOS | 146 | 447 | 444 |
| 11089.p1 | 2002/08 | 2 | PDD-NOS | 70 | 419 | 439 |
| 11194.p1 | 2002/10 | 2 | PDD-NOS | 65 | 404 | 521 |
| 11216.p1 | 2003/10 | 2 | PDD-NOS | 56 | 333 | 366 |
| 11252.p1 | 2001/12 | 2 | PDD-NOS | 77 | 445 | 602 |
| 11378.p1 | 1998/07 | 2 | PDD-NOS | 118 | 408 | 418 |
| 11399.p1 | 1996/07 | 2 | PDD-NOS | 143 | 312 | 363 |
| 11415.p1 | 1996/10 | 2 | PDD-NOS | 140 | 474 | 396 |
| 11522.p1 | 1996/12 | 2 | PDD-NOS | 138 | 398 | 381 |

Individual identification (Individual Id.) is the identification given by the Simons Foundation.
Date of birth is listed as year/month.
The birth order column is in relation to the discordant sib.
SF = Simons Foundation.
Age at measure is listed in months, and this is the child's age when history and blood were taken.
Mother age and Father age refer to the ages of the parents when the child was born.

TABLE 3
Table 3: Differentially methylated loci identified in this study.

| | | | | | |
|---|---|---|---|---|---|
| Gene | | | | Proband | CpG |
| Symbol | Unique Id. | Chr | Source Sequence to be interrogated (sequences 1 to 2338) | MI | Island |

| | | | | | |
|---|---|---|---|---|---|
| ALDH9A1 | cg11373746 | 1 | CGGTGGTTTAGCAGTGAAGTAACCACCAAAGACTCTTGGCACTCCAATCC | Hyper | FALSE |
| CD48 | cg05200628 | 1 | CGGAAACTGAGAACAATTTTGTTTGAAGGTACATGAGTGCTTTTTTGTAG | Hyper | FALSE |
| DNAJB4 | cg21968580 | 1 | CGCTGTCTGCTTGCTGCCTTAAGACAGCTAGCTGAATTGCTGATTAACTT | Hyper | FALSE |
| IFI16 | cg07463059 | 1 | CGCTAAGAAAATGAAGTATCTGCAAAGATAACAAGGAAAAAAGGCCTTGG | Hyper | FALSE |
| LCK | cg01525376 | 1 | CGGCCCCTGCTGTAGTCAGAGGCCAGGACAACACCCATTAATCATGGTTG | Hyper | FALSE |
| PTPN22 | cg14385738 | 1 | CGGCAGCAGTGGCTTTTTGGAGGTGTCTCGGCCATGACACACATTTGACA | Hyper | FALSE |
| RGS1 | cg10861751 | 1 | CGAGAACAGGTCACTTGATTAGAAAGAAAGAAAATTAAACATACAGAGGT | Hyper | FALSE |
| GPATC4 | cg14277848 | 1 | CGCGGCGCCAGAACTCAAGAATACATTCAGTCGTTATTTGTTGAACTGAA | Hyper | TRUE |
| HIST2H2AB | cg08934443 | 1 | CAGTTTAGAGCTCAAGGGGATCATCGGCTTCAGAATCCCCTACTCTTTCG | Hyper | TRUE |
| KCTD3 | cg12133444 | 1 | CGATCTACGGATCTTTATGACCCACTTTGTCAACATGGATTGGGAAAGGA | Hyper | TRUE |
| RAB4A | cg03825921 | 1 | TTCAGCTGCGATATTATCCCCAGCGAGCCTGTGAAGGGCTTAGGGCGACG | Hyper | TRUE |
| SCAMP3 | cg24034289 | 1 | AGTCATTAGGCCGCGGCCCAGTATAGAGCCAGAAACTCAGGTTGAAAACG | Hyper | TRUE |
| ABCA4 | cg04592706 | 1 | CCTCAGCTCTGACCAATCTGGTCTTCGTGTGGTCATTAGCATGGGCTTCG | Hypo | FALSE |
| ADORA3 | cg25674286 | 1 | CGACAGAATAGCAGAATGACCAGACATACAGAAAGAAGGGAAAAGAACGT | Hypo | FALSE |
| AHCTF1 | cg27050763 | 1 | GTTTACCTGCAGCAAACTTTCCACGAAGCACAGATTCTAATGTTATTTCG | Hypo | FALSE |
| AKT3 | cg22637834 | 1 | TGAGCCACCACAACCAGTCGTGAATACTTTAAGTGATATAAAATACAACG | Hypo | FALSE |
| AMPD1 | cg15740508 | 1 | GGTTGGTGAATATGCTGGTACATTCATCAAGCTCTCAACAGACACACACG | Hypo | FALSE |
| AMPD1 | cg23523368 | 1 | TGAAGTCTTTCCGGTTTCTGAAGCTATGATCCTCAGGGTTTCACATCACG | Hypo | FALSE |
| AMY2B | cg13908518 | 1 | CCTTAATGCACTACCCTTAGTGGGCATTATGTGTTCTCCCCTCTATTACG | Hypo | FALSE |
| AMY2B | cg23707905 | 1 | TCACTGCAATGTGCAGCCAAGACTGAGAACCACTGTTCTTGGTGATTACG | Hypo | FALSE |
| ANGPTL1 | cg07044282 | 1 | CAGCTGGTTACTGCATTTCTCCATGTGGCAGACAGAGCAAAGCCACAACG | Hypo | FALSE |
| ANGPTL3 | cg02218214 | 1 | CGAGCACATGGTAAAGAGCCTAGAACACAGAGACACAGAACACAGTGGAG | Hypo | FALSE |
| ANGPTL3 | cg21409833 | 1 | AAAACACTTTCTCTCTGAAGCCTTTCTCCACTCCCTCAGGTGGTGTTACG | Hypo | FALSE |
| ANGPTL7 | cg04508649 | 1 | CAGCATGGATTACATTAACAGGCCTCCCTGGGTGAGTAGCGTCTCTTTCG | Hypo | FALSE |
| APOBEC4 | cg11505048 | 1 | CGCAGGCAACAGAACCGCCAGGCCTGGCACCTACTCTAGACCAGGAGAAA | Hypo | FALSE |
| APOBEC4 | cg20579480 | 1 | CGGTCCCAGTCCAGGGGCCACTCACAGCCAGATGCAGAGAGCCCTCCAGC | Hypo | FALSE |
| ASB17 | cg17041296 | 1 | CGAACCAAGGATTTACAGATCACTGGCAAAAATTCTGAGGTATGTGGACT | Hypo | FALSE |
| ATP6V1G3 | cg12958813 | 1 | AATCCAAAAGTCTATGCTTATCCCTGCATTCCACTGCTTTGTTTATTTCG | Hypo | FALSE |
| BCL10 | cg05475904 | 1 | CGCCATAGTAGTTAAAATACGGTCTGGGGATAGTCGTCTCTTCATCAGTC | Hypo | FALSE |
| BLZF1 | cg14287742 | 1 | CGCACAGGAAAGAAAAAAACAACTGGAAGCGAAATGTAACAGATGGAAGC | Hypo | FALSE |
| BNIPL | cg10895130 | 1 | CTCCCACTAACTTGTTCTGCATGTGTAGAGTCTCCCCATTTTTTTTAACG | Hypo | FALSE |
| BNIPL | cg11584936 | 1 | CGAGAACCTGGACCTAAACTCGGTTCTGGTTCAGCTTTCCTGATGGCCAT | Hypo | FALSE |
| C1orf105 | cg25208892 | 1 | CGTGCATGGAGAACAATCAGTGAAGGCTTCTGTTTGGCCATCTTGCTCTG | Hypo | FALSE |
| C1orf127 | cg00912942 | 1 | TGGTGGGGGCTGAGCTTCCAGAGCCAGACCCAAGCTCCGTGTTGGTGTCG | Hypo | FALSE |
| C1orf182 | cg24042452 | 1 | ACCTTGGCAGCATTGATGTTTCCAGATTGAACTTTTCTTCCGGATTCACG | Hypo | FALSE |
| C1orf201 | cg13980834 | 1 | CGCACTGGCAAACATCCCAGACGTGCCAGTGAAGTACAGAAAGGTACATG | Hypo | FALSE |
| C1orf24 | cg25182523 | 1 | GGTCCTGCAATATACTCCCAGCCCTGAAACTTCCTAAGACTTGATGAACG | Hypo | FALSE |
| C1orf33 | cg10748867 | 1 | TCAGATTTCTCCTCCTCTGAAGTATTTTCTGTCTTGGAAAAGTTGATTCG | Hypo | FALSE |
| C1orf33 | cg18224761 | 1 | CGGGTGATATGTGTATCTAATTTTGCAGAATACTTGATATATGCAATTTT | Hypo | FALSE |
| C1orf62 | cg22726338 | 1 | CGGTAAGAGTTGGCTGTTGGAGGCAATGATTCAACAATCTAAATTCTGAT | Hypo | FALSE |
| C1orf90 | cg12278770 | 1 | CGTGGCTCCCAAGTTAGCAGTCCAGGAAAATTCCAGCCCTTGCATACTTG | Hypo | FALSE |
| C4BPA | cg17803430 | 1 | AGGACACTGGCCAGCCTCCAGTTGGTTTCTGAAGCTAGCAGTCTTAGTCG | Hypo | FALSE |
| C8B | cg10620457 | 1 | TATCTGAGCGCTGAACATAGGCCTGTTCTAAACATTTCCTTATATTAACG | Hypo | FALSE |
| CA6 | cg02981703 | 1 | TAAGACACTGAACAACCAAACCCATGGACTGACCGGATATGAAATTGACG | Hypo | FALSE |
| CCDC17 | cg16907488 | 1 | ATTCTGTTCGCCCACAGCTTTCATTTCTTGGGCTGTGCTGATTATCTTCG | Hypo | FALSE |
| CCDC23 | cg19101893 | 1 | CAACTGATAGATGCTAAGCAAGCAATGAACTCAGCCCAGATGGACACACG | Hypo | FALSE |
| CD5L | cg01637734 | 1 | CGGCTTTTTAAGGATTAGAATAGTTACCAAATGTAAAAAGGAGGAAGAAG | Hypo | FALSE |
| CD84 | cg02945019 | 1 | CGAGTCCTCATGCTAGCTAGCTCATTCCTAGGTAACCTGGCCTCTAGAGT | Hypo | FALSE |
| CEP170 | cg18184219 | 1 | ACCTGCAACATGAGCTCACAGTCATCTCTTCCAACAAAAATCATTTCTCG | Hypo | FALSE |
| CFH | cg24974599 | 1 | GAACATTATTACATCCCAGAAAACCCCAGTACTCCTTTTCAGTCAATACG | Hypo | FALSE |
| CFHR5 | cg25840094 | 1 | TTCTCTGATTGTTTCCCACTGTAATCTCTTTGTATTCAATAGGATCCTCG | Hypo | FALSE |
| CHI3L2 | cg10045881 | 1 | GCTTCTTCTGGGATACACATTCTCTAGGTCTTTTATCCACTGAGGTTTCG | Hypo | FALSE |
| CIAS1 | cg21991396 | 1 | CGGGACAAAAATTTTCTTGCTGATGGGTCAAGATGGCATCGTGAAGTGGT | Hypo | FALSE |
| CLCA2 | cg13693652 | 1 | CGGGGCCACAGCAGGGAAGAGTCACAGGTTTTGCTTGCTGTGGACCTCTG | Hypo | FALSE |
| COPA | cg08015496 | 1 | CGGGTCAGTTAATTTAACATCAGCAGGTCATTTGTGTGCCCACAGTGTGG | Hypo | FALSE |
| CRB1 | cg00321478 | 1 | ACACTGTGTGCTAATGCCAAGTTGTCTTGTTCAACGGCAGCTGCTCTACG | Hypo | FALSE |
| CRNN | cg16713808 | 1 | CGGAGACGGTGCTGGACTAGAGCCCCTCAGACTCCAGGCCTGTGTTCTCT | Hypo | FALSE |
| CRYZ | cg09142399 | 1 | CGGGAGTAATGATGCTGGCGATTTGGATCTGCCAACAGTAAGTTTTAAAG | Hypo | FALSE |
| CTSK | cg11946165 | 1 | CGGCATTGATTCAAGTGCTGTCATAAATAACCAGGACTGCTGTTTTTGGT | Hypo | FALSE |
| DDR2 | cg17496788 | 1 | CGCGGAGCTGACCTTTAGTATTTTGACCATGAAAGCCTAGAGCTGAGCTC | Hypo | FALSE |
| DPT | cg10835876 | 1 | CTTATGCAACTTATGAGTTCTCAGAGTAGCCCTGCAAACTGGTATACCCG | Hypo | FALSE |
| EGLN1 | cg16855929 | 1 | CGTGTGCATCTGGCAGAACCCCCAGTACAGAGACAAGCAGGTGCTGTTTT | Hypo | FALSE |
| EGLN1 | cg18979762 | 1 | GTGAACAATCTTGTCACCAACACGATTCTGGAACTCCAGTAGCATTGTCG | Hypo | FALSE |
| EIF2C1 | cg27094188 | 1 | CGCGGCCTACCCTGGAAGATGTCACAGTTTGAACTTAAGTGCAGCTACAG | Hypo | FALSE |
| EIF4G3 | cg13149996 | 1 | CGGAAAGGAAAACTCATGATCTTTATGGAAGAGCTATGTATAATAATGAA | Hypo | FALSE |
| EVI5 | cg00519208 | 1 | CGCTGAGGCATTGGCTAGAAACTTCTATAATTAGGTGTTTTCTGACACTA | Hypo | FALSE |
| EXTL2 | cg04870470 | 1 | CGGGAGAAGTAATAGAAATAATTAAATTTCAGCAACTGATTTCCAGCATA | Hypo | FALSE |
| FAM71A | cg01342792 | 1 | GGCGCCATACTATGTATCAAACTCCATTCCAGTTTGATACTATTGCAACG | Hypo | FALSE |
| FBXO44 | cg15746187 | 1 | CGGCAGGAAGACAGAGGAAAATGCCAGGCCCTGAAGTCACATCACCTGCC | Hypo | FALSE |
| FCER1A | cg14696870 | 1 | AATAACATGTCTTCCCCAAGTCACTTCTAACAAATATCCCATGGTTATCG | Hypo | FALSE |
| FCRL4 | cg01612158 | 1 | CGCCCACAGCAGCATGGAAGCCTGCTCCAGGATTGGAGAAGGAGTTCTGA | Hypo | FALSE |
| FCRL4 | cg17281600 | 1 | AATTTAATAGAATTATTTAAATACCCACTCTGACTTCCTGACGTGAATCG | Hypo | FALSE |
| FCRL5 | cg03329572 | 1 | CGCACATAATTCTGTTGGGTATATATCTGGGAGTGGAAGTCCTGGCTCAT | Hypo | FALSE |
| FLG | cg13447818 | 1 | ACTAGCCTCTCTCTCTACTATTAAGCTGGCTTACCATCTTATGTCATTCG | Hypo | FALSE |
| FLG | cg26390526 | 1 | CGCAAAGATTTTGAACAGTAGTGGACCAATATGGGCTCGTCCAAGAAATA | Hypo | FALSE |
| FLJ20054 | cg13463167 | 1 | CGGTTAATGAACAAAACTAATTGAGATGAGTTGTATAGGACAATACAATA | Hypo | FALSE |
| FLJ20972 | cg17994910 | 1 | TTTCTCATGTTCCACCCTGAGATGAGATCAGTACAGTTAAAGCATGATCG | Hypo | FALSE |
| FMO3 | cg18063149 | 1 | TTTTAATTTTCCTACCCGTTCTTTGTCTTCTTTTCTTCTGTGTGTCTACG | Hypo | FALSE |
| FMO3 | cg25778166 | 1 | CGCCAACCCTCTGTGATGGATGGGACTGTAGGCCAGTCTCCCATGGCCAC | Hypo | FALSE |
| FNDC7 | cg03301801 | 1 | CGGTAACTCTTAAGAAAGGAAGGTATATTTACAAGAATGTAGGGTTAAGT | Hypo | FALSE |
| FNDC7 | cg11481351 | 1 | CAGGCCTCCTAATTTTCCAAAAAGTGCTTTTTGCAATACACAATATCTCG | Hypo | FALSE |
| FOXE3 | cg18983672 | 1 | CGGCCGCTTTAAATGAAGAGCCCCCAGGAAATCCACAACTTGGAGCTGCC | Hypo | FALSE |
| GBP6 | cg24959428 | 1 | CGCCCACCAGGGCTCATTCCAGGCCACTCACTGCTGTCCTGAGTTGATGA | Hypo | FALSE |
| GBP7 | cg25463135 | 1 | TTCTGTAGCATATACTATGCTACCATAACATAGGAATCAATCAGTCACCG | Hypo | FALSE |
| GBP7 | cg26247501 | 1 | CGGGTAATTAATATGTCTAACTAAAGCCATTGAGCTACACACCAAGGTAG | Hypo | FALSE |
| GLRX2 | cg15361231 | 1 | CTATTATTACCACCACTGAGTGGCTTAAATAATCCTGTCAACAGCAATCG | Hypo | FALSE |
| GPA33 | cg24987706 | 1 | ACACAGTTACCAAGTGTTTATGACACAGTTATCAAACTTTCTGCTCATCG | Hypo | FALSE |
| GPBP1L1 | cg21942576 | 1 | CGTGTGGCCTTTCAAATGATTGTGAAGTGGTGGAAATGGATCCAAAATAA | Hypo | FALSE |
| GPR61 | cg00521434 | 1 | CGCATTAGGCAGCTTCCAAAGGGGCCAAACCTTGGACCATCCCCTGGAGC | Hypo | FALSE |
| HAO2 | cg03762535 | 1 | CGCAGCCACTCAAAGCCTGGCTCACTGCCGGAGGTGTTAGGAAACACACC | Hypo | FALSE |
| HORMAD1 | cg20767356 | 1 | CGGACGGCGAATTCAGGATTTGTCAGGATAAATTTAAACGTTTAACGTAA | Hypo | FALSE |
| HSD11B1 | cg04732193 | 1 | TACAGTCCTTCCTCGGAGTTTGTGTCCCCAAATCTCAGAGGGGCCAGTCG | Hypo | FALSE |
| HSD3B1 | cg16579646 | 1 | TCATCATGTTGACCAGCTGGTATCAAACTCCTGACTTTGTGATCTGCACG | Hypo | FALSE |
| IARS2 | cg13530946 | 1 | CCATTTGGCTTAATGGATTTGGCTATCATCTCTCCTGATTTCCTGGAACG | Hypo | FALSE |
| INSL5 | cg04979933 | 1 | CGGACAGTCATCTATATCTGTGCTAGCTCCAGGTGGAGAAGGCATCAGGA | Hypo | FALSE |
| ITGA10 | cg04126335 | 1 | AATGCACAAGGACACAGACACACATACAAGAAATGTACAACCAGTGTTCG | Hypo | FALSE |
| ITLN1 | cg08356693 | 1 | AGAAAGGCACAAAAACCCAAAACCAACACCAACTCTTGTTAATCTCTTCG | Hypo | FALSE |
| JAK1 | cg15997411 | 1 | CGCGTTTTTGGGTGTCTTAAACTATTGTTCACACAATCAGGAGAGGGGCT | Hypo | FALSE |
| KCNA2 | cg16773028 | 1 | CGTCACACCTCCTGAGGACAGCCAGGACTCCAGCTTTTGCTGAGCTTTGC | Hypo | FALSE |
| LCE1B | cg21434954 | 1 | ATAGGTACATAACTTGGTGAGACTCTCCCACAAATACACAAGTAGACACG | Hypo | FALSE |
| LEFTY1 | cg12319004 | 1 | CGGGGCAAGGGAATGAGTGATCCCTACCCTGACTCAGAGCACATTTGGAC | Hypo | FALSE |
| LOC116123 | cg24272559 | 1 | CGCCCAGAATAGGTACCATGTCACAACTTGTATTAAGAGAACAGTTAGGC | Hypo | FALSE |
| LOR | cg17761453 | 1 | CGTGGGAAGCTACTTTGATTCATCCCCAGAGACAGCAGGCATTTGAGACA | Hypo | FALSE |
| LRRC39 | cg07232688 | 1 | ATATTGCTGAGATGTCCAAATGACTACATAAATTATGATCCACCTACACG | Hypo | FALSE |
| LRRC39 | cg26117431 | 1 | CGGGGTGTTCATGGTCACTCATATAATTGTGCTCCTCTGGAAGATAGATT | Hypo | FALSE |
| LRRC7 | cg09768051 | 1 | TCAGGTAGGCCCCAGTGTCTATTGTTCCCTTCTTAGTGGCCATGTTTGCG | Hypo | FALSE |
| LRRC8C | cg06641366 | 1 | TTATCAATGCCAGCTATTTGAAGAGCACCCAAAGTCAAACTAGTGCTCCG | Hypo | FALSE |
| MATN1 | cg14183455 | 1 | GCCATTGGACTCAGGTATGCCTAGGCTTGGGGTGGAGCTTCAAGGCAGCG | Hypo | FALSE |
| MATN1 | cg18084114 | 1 | CGCCTCCTAGGGTTGATTCAAGGAGCAAAGGAGTTAGATGAGGTTTCTCA | Hypo | FALSE |
| MPZ | cg00101227 | 1 | CGGGGAAAAAAACTCCCATAGGACTTGGTCATCTCAAGAAGTCTGTAATG | Hypo | FALSE |
| MTHFR | cg14472778 | 1 | CGGCCTGAAGTGACCAGGCCACTCACTACTTTAGTTGCCCAAGCAGTATC | Hypo | FALSE |
| NBL1 | cg19136075 | 1 | CGGTCATAGTTACCATTAAGGGAAGACCTATCTGTGCTACATTAATGGGG | Hypo | FALSE |
| NCF2 | cg01579216 | 1 | TCCCCTCTGAACTTCATGAATGTTCATAAAAGTTATTTCGGCTGGGCACG | Hypo | FALSE |
| NCSTN | cg00689010 | 1 | CGCCTGGTGTAGACTCAGTAGCTCAAAAACTGGAGGTTGTTATCAATGTG | Hypo | FALSE |
| NEK7 | cg04223956 | 1 | CGGTGTATGATGAATGATGTGAATTGGTAATGATTACATTATTTAAATTT | Hypo | FALSE |
| NEK7 | cg09321965 | 1 | AAATTTAAACTTAAAAGGCCAGTCGTCATATGAGTGTCTACTCTTTTACG | Hypo | FALSE |
| NID1 | cg20234959 | 1 | CGCTGAGAAGGACACCCCGTGAGTTTTGTAGCATTCCTGCCAGATTGCAT | Hypo | FALSE |
| NID1 | cg22879289 | 1 | CGGGGTGTCCTTCTCAGCGCATCTCATCAGGAGATCCATGATGCCACTGT | Hypo | FALSE |
| NPL | cg00548060 | 1 | CGTGTTGTCTTTCTACTGAAAACAGTCAGTGTTTCTCAAGGGCTTACCTG | Hypo | FALSE |
| NR5A2 | cg20406878 | 1 | CGGGCCTATTCATTAGATGAGGAGTTAACCTTAGCTTGTTTCTACATTGG | Hypo | FALSE |
| OVGP1 | cg22997415 | 1 | GATGTCAAAAGGGTTGCCCAGCAGAGCAGAGTTCTCAAACTCAGATGACG | Hypo | FALSE |
| PDC | cg12723191 | 1 | CAGTGATTTCCACCAGTCATCTTCACTAATACAGATTCAGAGTAAACACG | Hypo | FALSE |
| PDZK1 | cg10321723 | 1 | CGAGCAGTTCTTACCTGGAGATGGAAGAGGAGCTGCTCTGTTCGTTCACT | Hypo | FALSE |
| PGBD5 | cg01671575 | 1 | CGGCATTCATAATGATGGCCAGTGCTTATCCCAAATGTATGAGCCGGATG | Hypo | FALSE |
| PGBD5 | cg19560210 | 1 | CCTGTTCGGTAGGTCAGATATGCCTGACTACAGAACTCGAGCTCTCTTCG | Hypo | FALSE |
| PLA2G2D | cg07142319 | 1 | CGGGACCACAGAGGGACGTACACCAAAATGTCAATGGTGCTTAATAGGTT | Hypo | FALSE |
| PLA2G5 | cg19521927 | 1 | CGGCTTCCAGGAGGCAACACATTGGAAAACAAGACAACAAGTGTTTGCTA | Hypo | FALSE |
| PPAP2B | cg16505550 | 1 | CGCTAGATTTTGAGAATACTAAAATGAAAAAGACTGCACGACTGTGGAAC | Hypo | FALSE |
| PRDM2 | cg12379145 | 1 | CGGAATGTATTGATAAATAAAACGTGAAAAGAGATGTGCTTTTGGAGCTA | Hypo | FALSE |
| PRDM2 | cg19324313 | 1 | CGCCTGGCCAGTGAGCTCCATTTTACTGACTCTAAGGAGATGCCCGACCT | Hypo | FALSE |
| PRDM2 | cg25402049 | 1 | GTGTGACAGCCAGTAAAATCTCCAGACATTTCCAAATAGCACTTGAACCG | Hypo | FALSE |
| PRDM2 | cg25450806 | 1 | AAAACTAAGTCTTTCAGAATTATAGCAAAGTCCCTAAAAAATAAGCCTCG | Hypo | FALSE |
| PRELP | cg05955301 | 1 | ACTGGATGGCTGGGTCCAGCACTAGCCTGTTTAATTCCTCCTAACAATCG | Hypo | FALSE |
| PRELP | cg07947930 | 1 | CGCACACACCACTGGGAGATCAGATCTTCTAGCTGGCTCTCTGCTGCCAC | Hypo | FALSE |
| PRG4 | cg04788442 | 1 | AATTGGTTCATCCCACTGTATTTGCACTGATATATAAGACTCCCAGGACG | Hypo | FALSE |
| PRG4 | cg12626411 | 1 | CGTGGCTGAGGGTGACTTGATTTGTTCTGCATAAGATTAAGTCTAATGGC | Hypo | FALSE |
| PTAFR | cg24354652 | 1 | GGGAGGATCACCTGAGCCTGGCAGGTCCAGGCTGCAGCGAGCCATGATCG | Hypo | FALSE |
| PYHIN1 | cg19884600 | 1 | CGCTGTATATGCATAACATGGATACGGCTAGAGAACATTACCCTAAGTGA | Hypo | FALSE |
| REG4 | cg00808492 | 1 | CGCTTTGTGACTAAAGTAAAGATTATTAATTCCTGAGGCAAGAAGATATA | Hypo | FALSE |
| RGS13 | cg05023691 | 1 | CGTGTGTGTAAAAACAGAACATTCATACTGAGGCCAGAGTGCCATCGAAG | Hypo | FALSE |
| RGS13 | cg19984039 | 1 | CGGATCATAACAAAGAGGAGATCAAATTTAGCATGGTGGACTGCTCGACA | Hypo | FALSE |
| RGSL1 | cg01939443 | 1 | CGCTGGAAGCTGAGCTCCTTATAGCGACACTTGCAGCATGTTGATCTCTA | Hypo | FALSE |
| RGSL1 | cg16478792 | 1 | TCTACCTGGAGAGAGCCTCCTTGCTTCAGGTCCTCAGTAGCTATCTTTCG | Hypo | FALSE |
| RNASEL | cg26532905 | 1 | CGAATGCTATGCTGAAATAAAAAACAGAATGGTTGTATGTGTACTTGAAG | Hypo | FALSE |
| RPE65 | cg11724759 | 1 | GAATGGTGCCAAGGTCCAGTGGGGTGACTGGGATCAGCTCAGGCCTGACG | Hypo | FALSE |
| RPE65 | cg26555310 | 1 | AATGGTTACAGTGAACTTAATCCTGTCCTCTGCAGTTTTTCCTTACTTCG | Hypo | FALSE |
| RSC1A1 | cg09559551 | 1 | CGCTGTTTAGATTTGTATCCTCTGGTAATTTAGTGGCATTAGTCACCTGC | Hypo | FALSE |
| S100A5 | cg08823182 | 1 | TAAATGAACGATTTCTTCTAGGCCTCACTGCTCTTCACAGGAAAGGCTCG | Hypo | FALSE |
| S100A8 | cg20070090 | 1 | CGGGGCCAACCCAGACAGTCCCACTTACCAGGTCTTCTGAAAGACAGCTG | Hypo | FALSE |
| SAC | cg06933072 | 1 | CGTGAGAAACTGCAGAAAAGAGGCAAATAAAGAAAGTAAGCTAGAAAGAC | Hypo | FALSE |
| SCNM1 | cg11928198 | 1 | ACAGCTCCTATTTTATTATGCCAGACACTGTGCTGAGGGCTTCACATACG | Hypo | FALSE |
| SDC3 | cg07689731 | 1 | GACTCTGGCTATGGCATCAGGCAGTGTGCCAGTAAACTCTCCACATGACG | Hypo | FALSE |
| SEC63D1 | cg03714397 | 1 | CTATTCAAAAATTATCTCTAAACCTACCTCTCAGTTTTGAATCTCTTACG | Hypo | FALSE |
| SELL | cg24597988 | 1 | TCTCTACCTCCTATGGTTCTGCTCTGATCTTAGTTATTTCTTGTCTTTCG | Hypo | FALSE |
| SELP | cg09060914 | 1 | CTGTTCCCACATTGCTCAGCCTGGGATATCCAGGAGTAATTCACCTTGCG | Hypo | FALSE |
| SERPINC1 | cg01770400 | 1 | TGTGATCTGAGGCAATCCGCCTGAAAACTGGTTCTTTCCTCTAAATCTCG | Hypo | FALSE |
| SFRS11 | cg11201288 | 1 | CGGAAGCAATAAGTAAGTGAATGAGTATTCTCAAATCATAAGTGGTGTGC | Hypo | FALSE |
| SLAMF8 | cg18084791 | 1 | CGCCCGGTGTGGAGGAGACCCCGTGTATCAGCCATCCCAACATCACACCA | Hypo | FALSE |
| SLC9A11 | cg15975283 | 1 | TCCCCCTCAAATAGTTCAGCCCATCAAATATTTTTGGACAGCCTATCTCG | Hypo | FALSE |
| SMCP | cg21948655 | 1 | CGGTATGGACTAGGATATTTACACTCATGCACGCCCGAGGTCCCTCGTGA | Hypo | FALSE |
| SPHAR | cg01320507 | 1 | CGGCCCCAGCTTACATGGTCTATTGTATTTGATCAACTGCTGAGAGAAGT | Hypo | FALSE |
| SPHAR | cg17653969 | 1 | CGGCTCCACAGCATGGAATCTGATGTATGATATGATAGAATGTGGCACTA | Hypo | FALSE |
| SPOCD1 | cg17803965 | 1 | ATTGCGGTAGGATCAAGTTAAACTCTCAGGCAGGCAGCCAAGGCCCCTCG | Hypo | FALSE |
| SPRR2A | cg18766755 | 1 | AAACCCCTGGTACCTGAGCACTGATCTGCCTTGGAGAACCTGGTGAGTCG | Hypo | FALSE |
| SPRR2E | cg00152644 | 1 | CGTATCGAGTGAACAATGTGTACTAAAATGAACAGATGAGAGGTATACAT | Hypo | FALSE |
| SPRR4 | cg02202484 | 1 | CGGATGGTCCTGGTGCTAGCCTCACAGTGAGTGCTCAAGAAATGGCAGCA | Hypo | FALSE |
| STX12 | cg26106720 | 1 | AATAAATTACTGAGACATGCAAAAACACGGATGAATCTCAAACACATACG | Hypo | FALSE |
| TBX19 | cg01732037 | 1 | AGGGGTGTCATCCTAGGAGCTTAGGCAAGAGCCAGGGTATCTTCTCTCCG | Hypo | FALSE |
| TNFRSF9 | cg08840010 | 1 | TGCACCCTCAAACTTTGGCAAACCGGCACAAAGCTGTGTGTTTAATCACG | Hypo | FALSE |
| TNFSF18 | cg05936800 | 1 | AGTTTGAGATTAATCCCCCTACCATACTCCAGATATCATGTACATGAGCG | Hypo | FALSE |
| TNFSF18 | cg19589427 | 1 | AGCATTTTCTGATACCTTTTATCTCAAAACCTTTAGATAAACTTCAAACG | Hypo | FALSE |
| TSHB | cg09058542 | 1 | CGGGAATGTTAGAGCAAATTCATTTTTGAGTACCTGCTGGGGTAATGTAC | Hypo | FALSE |
| TTLL7 | cg17237813 | 1 | GTCCTAACACATGAATTCCTTAGACTTTTGTGGTCCCTGCTTCTGTCACG | Hypo | FALSE |
| UTS2 | cg10500283 | 1 | AAAGCAAACAGCAGGAGGCCAGCTTATACATGATCGCCACAAGATAGACG | Hypo | FALSE |
| VANGL1 | cg08157638 | 1 | AACCTACAGGTTGGTGGGGTTCTCTACACTCACTTTTCAGTGACTCAGCG | Hypo | FALSE |
| VCAM1 | cg04743650 | 1 | CGACTCCAAAAGGCTATCTTTACTGGAAAGATAAAGGACAATGCTGATTG | Hypo | FALSE |
| WDR77 | cg10500716 | 1 | TTCACAGCAATTGTCTCTTAATTCTCAAAAGCCACAATGCACTATTATCG | Hypo | FALSE |
| ZC3H11A | cg04902405 | 1 | CGGGCCTTGACCGAATGACTAAAATGATGACAAGTTTTCCTGGCAGCCAC | Hypo | FALSE |
| ZNF364 | cg02245418 | 1 | GCCTGAGCCACCGCGCCAGCCTATTATGAATAATTTTCTACATGAATACG | Hypo | FALSE |
| ZNF683 | cg08109646 | 1 | CGCCACCCTGGTGTCCCAGAATATACAGGGACATCTCAGGCTGTGCACCA | Hypo | FALSE |
| ZP4 | cg03673470 | 1 | TTGATTCAGTCTTTACTCAGAGAACACTGAGTACATACATCCAAGGCACG | Hypo | FALSE |
| AKR7A3 | cg07447773 | 1 | CGCAGCCTTGGGAACACCAGGCTCCTTAGGCACGTCTAGCTCCGGACAAC | Hypo | TRUE |
| ANKRD38 | cg07558455 | 1 | AGGGCGGGTGTTGAACACCCCAGCAGACGCACTGCGGGGGACTGGGGTCG | Hypo | TRUE |
| ARTN | cg22930187 | 1 | TTCTCTCAGCGGCCAGTTCACCTGCCTTGTTGGGTTGCTTAGCCTCTGCG | Hypo | TRUE |
| B3GALNT2 | cg03209127 | 1 | CGCTTTGCCTCAGATTTGAAGGAAATCCGAGTGGCTCTTGTGTGAAATCA | Hypo | TRUE |
| C1orf135 | cg02327719 | 1 | AATTGGGTGGAAACAGACCCCGGGGTGAGAATTTCCCCAATTTGCATTCG | Hypo | TRUE |
| C1orf75 | cg25923018 | 1 | AAGGCTGGGCCTCAGGTAGCTTCAATCATTCACCTGCTGGTTACGGGTCG | Hypo | TRUE |
| CACHD1 | cg20876010 | 1 | GCCTTGGCCTGCATTTTATTTTCAACCAAGGTTGAAATGGTAGCCCCACG | Hypo | TRUE |
| CCDC19 | cg09451092 | 1 | ATGACTTACCCACAGTCACCTTGCTAGTTAGTGGCAAAACAGGTACCACG | Hypo | TRUE |
| CDC20 | cg16109297 | 1 | GGGGATGGGTGCATCCAGCTGAAGCAGCGAGTGCAGGTCACTCTCGAACG | Hypo | TRUE |
| CDCP2 | cg26185508 | 1 | GAGCTGGCGCTGCAGAAATGCCCCGGGGACTTTGTGTCCAACAGGAAGCG | Hypo | TRUE |
| CR1 | cg14726637 | 1 | AGGGTGTTTGGAGGCGAGCTGCCATCATCCACCGCCTTTGTCTGGAAGCG | Hypo | TRUE |
| CSF3R | cg09088576 | 1 | CTCTTGGCGAGTCTCTCTGTCGTTTCAGTCTGTGTGGATTTCAGTCACCG | Hypo | TRUE |
| DDEFL1 | cg11155265 | 1 | CGGGCATCAGGCTTCCCATTGTACAGATAAGGAAACTGAGGTTCCAGAAG | Hypo | TRUE |
| DIRAS3 | cg05392265 | 1 | CGCTTGCGCAATACGTGGTAAGAAACCAGCTGTGAGGGGCTGGCCCAACG | Hypo | TRUE |
| DIRAS3 | cg12986021 | 1 | CGTCTAAAATCAGTTGGACCGGTTTTTGTTGGCAAAGTTTTGCCTGAAGC | Hypo | TRUE |
| DNAJC11 | cg20668607 | 1 | CGCCACTGCACACACACCAGGCTGGGCGACAGAGTATGACTCCGTCTCAA | Hypo | TRUE |
| DNALI1 | cg21488617 | 1 | GGCAAACAAGGCCCACACTGGACAGGGCAGCTGCTGGGTTGCTACTCTCG | Hypo | TRUE |
| DNTTIP2 | cg22807700 | 1 | ATGCCGTCCCTAAAGACATGCACACAATTTATACCTAATTGGCTAAAACG | Hypo | TRUE |
| EIF2C4 | cg16019273 | 1 | GAATGGACCCTGATGAATGATGCATTCCCTCCCTGGTCCCATGACAAGCG | Hypo | TRUE |
| ENSA | cg26087862 | 1 | CGCTGCTGCTTCGGCTCCTGTCACTAGGGTTGCTCAGTCAAAATGGCGGC | Hypo | TRUE |
| ERRFI1 | cg19560758 | 1 | CGCGGGATTTCCCATAAATTCAGGCTCCGGGCAAGATTGTGTGTTTTTTC | Hypo | TRUE |
| EXOC8 | cg23213688 | 1 | GGAAGCTAGTTTCAGCCTTTACTCTTTGCCGGTTATTTCAAACCTCAACG | Hypo | TRUE |
| FLJ35530 | cg19399532 | 1 | ATGCTCCAAAGCTGTCCACAAGGCCTCTGGTACAGGCTTCCAGGTCTACG | Hypo | TRUE |
| FLJ45717 | cg23695504 | 1 | AACCGCGGGCACGAGGGCAGCGTGGGGGCAGTGGTGGCTGTCAGTCCACG | Hypo | TRUE |
| GIPC2 | cg24496666 | 1 | TAGTGCCACGGGCCGAGTGGAGGGCTTCTCCAGCATCCAGGAGCTCTACG | Hypo | TRUE |
| GLRX2 | cg10704545 | 1 | GGGTCAGCGGGCAGTCCTGTAATGGCCACATTACAGGACAGGCCATCGCG | Hypo | TRUE |
| GOLT1A | cg20867633 | 1 | CGGGAAGCTGACCCTTGGTTAAGTTGCGAAATGAGCCTGTGGCAAATCAT | Hypo | TRUE |
| GPSM2 | cg01969748 | 1 | AAAAAGCAGCAACTCCTCAAGCCGAGTTTCTGGTTTCTTGAGCATCGACG | Hypo | TRUE |
| HMGCL | cg18888403 | 1 | CGGTGTAGCATTCGCAATGGCCCTGAGGCAAAGAAAATGCTGAGAACACT | Hypo | TRUE |
| HSPG2 | cg12274479 | 1 | CGGGAGGACGCCTTTTCACATAGATTCCTCGCAGGCACGCACATTTCACA | Hypo | TRUE |
| ID3 | cg22258437 | 1 | TTTTGAATAAAGAGGCGTGCCTTCCAGGCAGGCTCTATAAGTGACCGCCG | Hypo | TRUE |
| IL28RA | cg07509155 | 1 | AAGGCTGTGGTGTTCACCTGGACAGCAGTAGCTTCCCAGTAAGGCACACG | Hypo | TRUE |
| IL6R | cg04185861 | 1 | TCAGAGCGGCGGACGGTCCTGGCAACGCAGGAAAACATTTGAGGAACTCG | Hypo | TRUE |
| INSL5 | cg08983259 | 1 | CGCCTGGCCTATTAGCTGTTTATTGTACCAAGTGGGACGCATGTTATCAC | Hypo | TRUE |
| IRF2BP2 | cg26840318 | 1 | ATCATGGCCCAGGGCATGCGGGGCAGGTCACACAGGTAGCACGACTGCCG | Hypo | TRUE |
| KCNK1 | cg14249872 | 1 | CGCCACATCATCTGGGCTTTTTATATTGCAAGGAAACAGGAAAAGAAGGA | Hypo | TRUE |
| MSTO1 | cg18528640 | 1 | AAGGATGTGTTTGCGGGCCAATAAGTAGCCGAGAATAACACCCGCCCACG | Hypo | TRUE |
| MUC1 | cg24512973 | 1 | GGGCGGTGGAGCCCGGGGCTGGCTTGTTGTCCGGGGCTGAGGTGACATCG | Hypo | TRUE |
| MYCL1 | cg08063724 | 1 | CGACTCGTACCAGCACTATTTCTACGACTATGACTGCGGGGAGGATTTCT | Hypo | TRUE |
| NEK2 | cg12820481 | 1 | CGGCCGTAGGAGCCTGTGCCAATGGTGTACAACACTTCATAGTCCTCAGC | Hypo | TRUE |
| NVL | cg22762951 | 1 | TTTTGCAGGCCTGCCCAGTGGACCCTGGAAGATTAGGACCCCTTTGAACG | Hypo | TRUE |
| PDIK1L | cg16233998 | 1 | CGGTGGCGCGGAACGTCCCGGCTCGCGCTACGGAAAGCCGGAGGGGGGCG | Hypo | TRUE |
| PUSL1 | cg24497877 | 1 | GAAACCTACTTAAAGTCGGTGCCCACGTACTGGAAGTACACAAGATAGCG | Hypo | TRUE |
| RAB42 | cg02525756 | 1 | GGGAGGTTCTGGCCCCAGTGGACCGGGCGGGACCCAGGGCAGGGACCTCG | Hypo | TRUE |
| RALGPS2 | cg10559803 | 1 | AGAACAAAGTCTGGAAGCACTTGGCCCCAAGATCAAATATCCAGCCCACG | Hypo | TRUE |
| RAP1GA1 | cg07138512 | 1 | GTCCAGAGACAAAGTCCAAGAGCCGCGAATGGGCTGGCGAGGGTCAACCG | Hypo | TRUE |
| RPA2 | cg05871607 | 1 | GCTGGCAGAGCGGTATCGCAAGAAATCAACCAATCAGAACAATACTACCG | Hypo | TRUE |
| RUNX3 | cg18231267 | 1 | CGCTGCCAACCCTCACGGAGAGCCGCTTCCCAGACCCCAGGATGCATTAT | Hypo | TRUE |
| SFT2D2 | cg12739647 | 1 | CTTCTGCAGGGCTCCGCGAAGAGGTCTGGCACTACACGGGGCAGTGGCCG | Hypo | TRUE |
| SLC45A1 | cg11283860 | 1 | TGTGTGTGTGGAGCACTGACCCTCTGATTGCACGGTGCTGCACACTTACG | Hypo | TRUE |
| SPSB1 | cg13724813 | 1 | GGGGGAGCGGGTGGAGTACGGGATGGGGACTCGGGGCGCGGCCCCTCCCG | Hypo | TRUE |
| SSU72 | cg20755353 | 1 | CGGGAGAGGGAGTGATAATGATTGTCAACCTAATAACAGGCTAACTGAAA | Hypo | TRUE |
| ST6GALNAC3 | cg26363196 | 1 | TCCTCAGTGCCTGCTACTTCTTTCTCTTGTTTTCTTCTGTGAACCTTTCG | Hypo | TRUE |
| SYT11 | cg25446086 | 1 | CGACATGGCTGAGATCACCAATATCCGACCTAGCTTTGGTAAGTAGACTC | Hypo | TRUE |
| TMOD4 | cg02301754 | 1 | CGGCCCCCAAAAGTCCCTGTTCGTGAGGTCTGTCCAGTGACCCATCGTCC | Hypo | TRUE |
| UBE2U | cg10753073 | 1 | CGGTACCAAGATAAGCGGCTTCTAAAGTTGGGATATAACAATGACTTTTT | Hypo | TRUE |
| WDR65 | cg03574115 | 1 | GGGTAAGACTGCAAGCACTGCGGCCTGGGCTTGGCGATAGCTGAGAATCG | Hypo | TRUE |
| WDTC1 | cg21824902 | 1 | CGGCGAAAAACTACGACTCCCAGGGTGCCCCAGGGCTTAGCCCAGCTTTC | Hypo | TRUE |
| ZBTB17 | cg07437033 | 1 | GGGCGGAGATGCTACCAGCTGGGGTGTCATCCAGCCCGGGAGGTGACACG | Hypo | TRUE |
| ZNF326 | cg00077457 | 1 | AAGCAGGCCATGTTTTAGAATTCTTTCCAGGCGGGTCGCATTGGCTCACG | Hypo | TRUE |
| ARHGAP15 | cg27365426 | 2 | CGGCGTGGCTCTGGGCTGTGTTTTCTGAAGTTCTAATGCAACCCTCCCAA | Hyper | FALSE |
| FLJ41327 | cg05020203 | 2 | AATAGACATAGAGCAGATGCTCAGAGCCATGCAGTGCAGGAGCAGCCACG | Hyper | FALSE |
| PDE1A | cg09845785 | 2 | CACATCAGAATTCCTACAGTTTACGAGCTCTATTATGCACAAGAGAAACG | Hyper | FALSE |
| TANK | cg23871659 | 2 | CGTGCCATGATTGGCTGTTGCTAGCTACAAATAAGGAAGTCTTCAAGTTG | Hyper | FALSE |
| TFPI | cg23477967 | 2 | CGCAATCTGATCTTACTAGCAGTGAAAGAGCGAGGTAAGAATTTGACTAT | Hyper | FALSE |
| DGUOK | cg03839972 | 2 | CGGTGCGAGTGGTTTTTGTTCATTGGACAAATAACATTTTAAAAGACGTA | Hyper | TRUE |
| PSCDBP | cg12177677 | 2 | ACAAAGGCTCCTGCAACACAGCAGCAATGGCAATTTGGCGGACTTCTGCG | Hyper | TRUE |
| ABCB11 | cg00295325 | 2 | TAAGGATCAATGTCCCTAAGGGCAGCCCAAGCACAGTTCAGTGACATACG | Hypo | FALSE |
| ABCB11 | cg20118424 | 2 | CGGTGTTGGAGAAAAGATAAAGTCGGTGTAGTTCTGCATTAAACCAGCTT | Hypo | FALSE |
| ACMSD | cg02812142 | 2 | CCCTACACTTTAGGATATGTATCATCTTTCTCTCAGTCAACCTTACATCG | Hypo | FALSE |
| ACMSD | cg18766847 | 2 | CGTGTTGAAAAGTTATGGGGAGGTTTCACATTTTAAATCACAGAAAGAGT | Hypo | FALSE |
| ACOXL | cg01494593 | 2 | CGGGAATTATGCAGCTGTCTTTGCCCAGCTCATCATAGATGGAAGATCTC | Hypo | FALSE |
| ACVR1 | cg16682903 | 2 | AGTGCGACTGGAACTGTACTTTCTCCTGCTCTCCCTCTAAATCTGTTTCG | Hypo | FALSE |
| ALPP | cg13605579 | 2 | TTAATTCATTGATTCACTCTAAAGTCAAGGCCAGTCAGGAGCTTTTGCCG | Hypo | FALSE |
| ALS2CR12 | cg14272706 | 2 | CGCAAGAACTCCACAGGGAGTTCCAAGTAAGAATTATCTGGGATGGGGTA | Hypo | FALSE |
| ALS2CR14 | cg14367014 | 2 | AAAATTAAACTGGTAATTAGAACACTGCCTTCCACATAGCTGTTTCAACG | Hypo | FALSE |
| ANXA4 | cg05155595 | 2 | TGTGTGTGTAATGACAGGCCGGCAGCCCAACCAACATTAGAATCTTTTCG | Hypo | FALSE |
| ATP6V1E2 | cg27485921 | 2 | CCCAGACAGACGAGAAGTTACATCTGCTAGACACATTACATGGGCACACG | Hypo | FALSE |
| B3GNT1 | cg09390932 | 2 | CGCCTAGTCCTGTGCTGCATCTAGAGGATGGCCAGTACATTTTTGTTGAA | Hypo | FALSE |
| BAZ2B | cg01416012 | 2 | CTAGCATAACACTATAAAACTGTTATTAAGGCCGGGTGTGGTGGCCTACG | Hypo | FALSE |
| BMP10 | cg11308639 | 2 | CGCAGGATTCAGCCAAGGTGGACCCACCAGAGTACATGTTGGAACTCTAC | Hypo | FALSE |
| BMP10 | cg12711530 | 2 | CGGTTATTACAGGAGCACACTTGATGATAGGTGTAAAGCACTCAGTACAA | Hypo | FALSE |
| BRE | cg18712919 | 2 | CGTGGAACTAAACAAAAAGGCTTTGGGACAATCAAAATAAGTCACCAAAT | Hypo | FALSE |
| C2orf33 | cg13406768 | 2 | CCTTGAAATGTGCTTTCTCTGCATTCCATTCATTGCATTTCAGTCTTACG | Hypo | FALSE |
| C2orf33 | cg19504888 | 2 | TCCTGTCTGATAGAGCTGCCTCCTTTCAGAATTGCAAAGTTTAGTCTTCG | Hypo | FALSE |
| CAPG | cg04881903 | 2 | CGGAGGCCACCACACTGCTCCTGAAGGCCCTCAGCCAGACTGGAGGTGAA | Hypo | FALSE |
| CASP10 | cg16745604 | 2 | CTTTCTTATGTCCACATGCAAATAAACAATGGAGCGATCTCCACTTACCG | Hypo | FALSE |
| CCDC74B | cg20614736 | 2 | CGGGGCTCCTGTATAATAACAGGGGATACAAGTGAAAGAACTGCTCATCT | Hypo | FALSE |
| CD8B1 | cg10198837 | 2 | CGCTGAGTCAAAGAAGCCATTCGCTAAAGACCACACATTGTATGGGAGCC | Hypo | FALSE |
| CHRNA1 | cg05649009 | 2 | ACACTTTTTCCCAATAATTACTCTTCGCTTGAATCACAGTGCATAGGACG | Hypo | FALSE |
| CHRNA1 | cg22925639 | 2 | TCGGCACCATTTGTAGGACCTGGACCACTTGTGGATCATGGTAGTGTCCG | Hypo | FALSE |
| CIR | cg14138171 | 2 | TTTCATGTGAGTATCTACTATGTTCTATGCACTGTGCAAAACACTTTACG | Hypo | FALSE |
| COL3A1 | cg20770175 | 2 | TACAAGAACATCTTATCTTAACCACAGAACTCTTAAAAACACACATAACG | Hypo | FALSE |
| CPO | cg06194186 | 2 | TGAGCAGTGAAGACAGTTTCAATCCTTTCCCATGTGGATTTTACCCCACG | Hypo | FALSE |
| CPS1 | cg21165909 | 2 | AAAAAATATACCACATGACTTCATGCCTCTAGGCTATTGCTCATGCCACG | Hypo | FALSE |
| CRYGC | cg05619712 | 2 | CGCTGTCCTGTACATACTGCTCTGTGTTGCTTTTATTTGGATTGTTAGTG | Hypo | FALSE |
| ECRG4 | cg11024597 | 2 | AGTTACTGGGATGCAGTTCTGCGTTTCCCTTGGGTCTCACCTTAACATCG | Hypo | FALSE |
| FABP1 | cg05301852 | 2 | ATACACATGTGTGTGCACATATACACATACCTGCATATACACACATTTCG | Hypo | FALSE |
| FAP | cg08826839 | 2 | GAAGTTTTATAGCCTTCTCATCCTTGTAACTACACCAACATCTGCTTACG | Hypo | FALSE |
| FLJ13096 | cg14444244 | 2 | GCCAGAATGCCTGTTCCTGCACACCATTTATCACAGTGTTTTTACCTTCG | Hypo | FALSE |
| FLJ13646 | cg04551655 | 2 | AGGATCACTTGAGCCTGGGATGTTGAGGCTGCAGTGACCTGTGAATCACG | Hypo | FALSE |
| FLJ25084 | cg09948350 | 2 | CGCCCATCAGCTCAGAGACCGGGGAAGCCGCCATTGGCCTCCCCAACAAG | Hypo | FALSE |
| FLJ30294 | cg01243790 | 2 | CGTCACTTTTCACCATGAAGGGTTCTTCTGGAGGTGTTGGTTTAATGGGA | Hypo | FALSE |
| FLJ30294 | cg26514942 | 2 | CTTCTTGAGAAGGCTGTCCTAGCTCATGTTTTGGTGGCTTCTCGCTCACG | Hypo | FALSE |
| FLJ33534 | cg18854045 | 2 | TCCTGGGGGGTCCTTGCTGTGTGTCCTGGGAGGCTTTGTCAGGCTGACCG | Hypo | FALSE |
| G6PC2 | cg07338205 | 2 | CGGTGGGAATCAGAGCACTTCAGCTCCAATTGCTCTATGTTTAGAATTGC | Hypo | FALSE |
| GALNT13 | cg01161611 | 2 | TATCTTTTTCACTTAACATACAGCCAGCAATCTGGTAAATCTGCATACCG | Hypo | FALSE |
| GALNT3 | cg15739581 | 2 | CGTGGGGAAGCTAAACACTGCTTTAATGCTTTCGCAAGTGACAGGATTTC | Hypo | FALSE |
| GCG | cg26266326 | 2 | CGTGTACTTTAATATAGCGAAGCCGCAAAGCGAGTTGGAAAAATAATTAT | Hypo | FALSE |
| GCKR | cg20022122 | 2 | CGAGGCAGCTGTGCCAATCACGGAGAAGTCAAACCCACTGACCCAGGATC | Hypo | FALSE |
| GDF8 | cg18862260 | 2 | ACAAGTGTCGTCAGGATCTATGATTGGCTCTTGCTCCACAATGAATCTCG | Hypo | FALSE |
| GKN1 | cg13877895 | 2 | ACCCTGAGGTTGTCTTTCTGAAGTGCATAGATAGACATGACTCTATCACG | Hypo | FALSE |
| GPD2 | cg24579667 | 2 | CCTACCGCTAAGAGCAGTAGCCAGTAAGTGTAAAAACTCAAAACAAAGCG | Hypo | FALSE |
| GTDC1 | cg17717588 | 2 | CGCCCTGTTGCATCCTGCCACGTGGCCTTTGCACATGCTGCTCCCACTGG | Hypo | FALSE |
| GYPC | cg17105014 | 2 | CGGCCGCGCAGCCAGCCAAGATTTCAACACAGGTCTGCCCTATTTGGTCA | Hypo | FALSE |
| HNMT | cg02906939 | 2 | CGCGCTTAGGGAAGGATTCTATGGACTGCACTTTTACCCTGGTGTCCTGC | Hypo | FALSE |
| IL18R1 | cg17869167 | 2 | ACTTTCTCCCCCAAAGCCTAAGGAATGCCTTGCTATTCAATCATGGAACG | Hypo | FALSE |
| IL1F10 | cg05949173 | 2 | CGGTTTGAATACCATTGGCCCAGATGGTTTCTTTTGAGATTACTTTCTAA | Hypo | FALSE |
| IL1F7 | cg02229946 | 2 | CGTGAGTCAATCCTACCCTAAGATATTAGGGATTGAGCCTCCTGGGACAT | Hypo | FALSE |
| IL1F8 | cg09995854 | 2 | TTTCTTGTCAGCAAATTTAAAACCTCACAGCATATTCTGCACTCATTACG | Hypo | FALSE |
| IL1F9 | cg26759925 | 2 | GAGGAAAATTCTACCTGTTCTCCCTTTGCTGATGCTTCCTTCAAGTTTCG | Hypo | FALSE |
| IL1RL1 | cg11916609 | 2 | CGAGGCATCAGTTACAAAACTTGCTGCAGAGTGAGCTGATATTGTGCCAC | Hypo | FALSE |
| IL1RL1 | cg16386158 | 2 | CGCAATCCTCAGAAGCTGACAGGAGCTTCAGAGAGGAGAATTACCTTACC | Hypo | FALSE |
| IL8RA | cg21004129 | 2 | CTCCTATGGGGGACTCCTTCTGAAGTCTCTGCTGTAAGTCAAATCCTTCG | Hypo | FALSE |
| IL8RB | cg14150666 | 2 | CGGAGCACTTGAAATGTGACTAGTGTGACTGCGGATCTCAATTTTTATTT | Hypo | FALSE |
| INPP4A | cg01169610 | 2 | CTGTCCTTGGGTTAATTCACCAAACAACTTACTGGACATGTTTGCTCTCG | Hypo | FALSE |
| ITGB6 | cg18437633 | 2 | TGTGCAGACCGATTAAAAAATGAATTACCTTCAGCGTTACAAGACCAACG | Hypo | FALSE |
| ITGB6 | cg21105318 | 2 | AGCATACCACGAAAGTAATATATCAGAGAACGCAGGTCTTACCTTGTACG | Hypo | FALSE |
| KBTBD10 | cg12694555 | 2 | CGGAAGTAAGGACTACAAGCTGACAAAATCAATCTGTGGCAAGGAAGACT | Hypo | FALSE |
| KCNJ13 | cg13982505 | 2 | CGTGCTGTGGTATGGCTTTGTGCAGTGCCTTAGTGAACAGTACTTTTCTC | Hypo | FALSE |
| KIAA1641 | cg22149792 | 2 | CGTGCAAAGTGAGCTAAAGCAAAAACAGAGTCAAATGAAGGACATTGAAA | Hypo | FALSE |
| KYNU | cg11134443 | 2 | CGCCTCAAGCTTACCAGCTAGGATCCCAATGGAGTGTTTGGCTCCCAGAA | Hypo | FALSE |
| LOC129530 | cg02947354 | 2 | CTACAAATCTTTTCAAACTTGGGTTTTCTTTGCAAGGTCCTTAAGTTTCG | Hypo | FALSE |
| LONRF2 | cg05998244 | 2 | CGGGCGGAGTTATATTTGACCATGAAGAACTATGAGCAAGCTCTCCAAGA | Hypo | FALSE |
| LOXL3 | cg15989091 | 2 | CGGATAGAAAGTGATAGGCAAAGAACTAAGCACTCAGTATAGGGGAACCA | Hypo | FALSE |
| MYL1 | cg11059341 | 2 | AATCTACCAGCTCACTAAATAATGCTATTCCTCTCAATGAAAAATACACG | Hypo | FALSE |
| MYL1 | cg12339029 | 2 | CGGCATAAGGGCATGCATATATATTTCACTTAGTGCCTAATAGAATCTTG | Hypo | FALSE |
| NCOA1 | cg18128666 | 2 | CGATTATCCTTCCTGCCTTTATTAACCACAATTATCTCTCTACTTATACG | Hypo | FALSE |
| NEB | cg16753209 | 2 | ATCTGATTGGTTGCTCTTGCCACATGATAATTCGGAGCCCAGGCATCACG | Hypo | FALSE |
| NEU2 | cg20795863 | 2 | AGCTTTTGCCCTTCTCAGTTTTATTTTCTCACATCGTCCTAATATTAACG | Hypo | FALSE |
| NGEF | cg19485804 | 2 | CGCTGATTTGAGTTTTATATAAAGATGGATGATGTAGCAATTAAACTTGG | Hypo | FALSE |
| No Gene | cg23984130 | 2 | CAGGGCCCCTGAGGAGCAGCCTCTAGTTCAGCTCTCAGAGATAGGGTCCG | Hypo | FALSE |
| present | | | | | |
| PDE1A | cg26465666 | 2 | TCCCCCCAAAAGATTTGACTATTAACGTGACTAATTGTTGGTGCTATCCG | Hypo | FALSE |
| PELI1 | cg15309578 | 2 | ACAGGCTAATACTTGCTAGCCATGTGATATACTAATGTCAGCCAAATACG | Hypo | FALSE |
| PLCL1 | cg02833180 | 2 | CGAGAGACCCCCAGCTGTGGAACTGAAGAACTGGTCTCCCACAAAGCTGA | Hypo | FALSE |
| PLCL1 | cg27609819 | 2 | CGCTTGAAAATTTCAGGGGAAGAGCCAGCTTAATTCAGGTACCCAACCTG | Hypo | FALSE |
| PLEK | cg04872689 | 2 | CTCCTCTGCATGCTGAGGTGGCTGTGGGCCGCCTTTTCTACAGCAGGTCG | Hypo | FALSE |
| PREPL | cg03894103 | 2 | AGTTACTCTGAGAACCCACTACTCTGTAATCATACCTATAAAATCATTCG | Hypo | FALSE |
| PRKD3 | cg09212058 | 2 | CGGGAGAGTGTTACCATTGAAGCCCAGGAACTGTCTTTATCTGCTGTCAA | Hypo | FALSE |
| PROC | cg26718585 | 2 | TAGCCCTGGTGGCCAGAGATCAAGGAACCCTCCCCAGTGGATAGGCCACG | Hypo | FALSE |
| PUM2 | cg08659707 | 2 | CGCCTGAACTGCACATATGTGAGACAGACTCCAAGGAGCTCAATTAAGGC | Hypo | FALSE |
| RASGRP3 | cg10031456 | 2 | TATCCATTGTCTGTGGCTAATATCCATAGTTCATGAAGTGCATTAAGACG | Hypo | FALSE |
| REG1A | cg05828624 | 2 | CGGGAAGATACAGCATGAGTTTCTGTCCAAGAGGTTTTAGCTGTAATGAA | Hypo | FALSE |
| REG1B | cg00579393 | 2 | GCTAGCTACTTATGCTGAAACCTTGCTGGAAACGCTGGCTTAAATTTACG | Hypo | FALSE |
| REG3A | cg27342801 | 2 | CGGGAATTATAAGTATCATGGACAGTTGAGGACATAGATGGTACTGAAGC | Hypo | FALSE |
| REG3G | cg00627233 | 2 | CTTAACATCAATCAAGGCAGTGGCACCAAATTGCATTGCTCATATCCACG | Hypo | FALSE |
| RGPD5 | cg11314271 | 2 | CGTGAATGGAGTCTCTCGTTGGGGTGATAGAGATATTTTGGAATTAGATT | Hypo | FALSE |
| RNF25 | cg04430204 | 2 | CGGTGGAGATGGAATTTGCACCCAAATAATCCAACTTCAAAGCTTATACT | Hypo | FALSE |
| SAG | cg00539322 | 2 | ACAGTGAACTGGTAGTTTCAGCAGTTCTAAGCATTAAGCAACACCCCCCG | Hypo | FALSE |
| SAG | cg08096010 | 2 | CGGTACCAGCTTGCTCAGAACAGGGGCTGGCTATTCATCATCTCAGAGCA | Hypo | FALSE |
| SCN7A | cg25995212 | 2 | CAGATATAACAGTGTCAAATCTGCAGTTCCCAAGTCCTGGAGCTTCTACG | Hypo | FALSE |
| SCN9A | cg19320612 | 2 | CAGAGCTTTGTCCATTTCACAAAACAGTCTCTTGCCCTCATTGAACAACG | Hypo | FALSE |
| SLC11A1 | cg07719512 | 2 | CGAGGGGTCTTGGAACTCCAGATCAAAGAGAATAAGAAAGACCTGACTCT | Hypo | FALSE |
| SP110 | cg26614346 | 2 | ACTGCACTATAGAAATCTGTGTAACTTTGGGCCAGGCTCGGTGGCTCACG | Hypo | FALSE |
| SP3 | cg14114267 | 2 | TCCATTTGTGAGATACTGAGTTTACATCCCAGTTCCAAAGCACTTAACCG | Hypo | FALSE |
| SPP2 | cg19099213 | 2 | CGCATAAGAAGCTGTGTTTTGTCTCAGAAAGACCTGGACTGAGATCTTGG | Hypo | FALSE |
| SPP2 | cg21137417 | 2 | CCAGTAGTTCATTCCAAGAGCAAACATAATCAATATCTTCATCATCATCG | Hypo | FALSE |
| TAIP-2 | cg11712199 | 2 | ATGATATCAACATTTCTCTGTCACATCTGACTACATCGACAATTTAATCG | Hypo | FALSE |
| TAIP-2 | cg26853855 | 2 | CGGCATCAGCCTCACTGAGGCTGCCTATATGTGATCACATGGAGTTTTGT | Hypo | FALSE |
| TFPI | cg16478145 | 2 | CAGGACCCAGCATGTAGCAAACCTCCAATAATTGTTGGCTATCATTATCG | Hypo | FALSE |
| TNFAIP6 | cg01035238 | 2 | CCTTTGTGTAGAATCCTTGGGTAACATATCTGATAATACTCCCACTACCG | Hypo | FALSE |
| TNP1 | cg10376763 | 2 | GGCAGTTCCCCTTCTGCTGTTCTTGTTGCTGCTTGGTGCTGTGTGAAGCG | Hypo | FALSE |
| TRIM43 | cg15495837 | 2 | ATTTGGCTTCGCTGTCCAGTGCCTGCAGATGAAGTTGCTTCTCCTCATCG | Hypo | FALSE |
| TSGA10 | cg09298484 | 2 | CGGTACTGAAGATTATTTGGAAAGAATATAAGGAAATGATCATTTTAAGG | Hypo | FALSE |
| UGT1A1 | cg07823755 | 2 | CGAGCACGCGCCATGAGGTGAGCCAGACTCACAATTTAAACACATGAGCA | Hypo | FALSE |
| UGT1A10 | cg18098286 | 2 | CGTCAAAGGCAAAGCATGGCTACTGTGAAAGAAGGGTAAAAACACAGAGA | Hypo | FALSE |
| UGT1A10 | cg26238727 | 2 | TAAATACACGCCCTCTATTGGGGTCAGGTTTTGTGCCTGTACTTCTTCCG | Hypo | FALSE |
| UGT1A7 | cg05961827 | 2 | TTGCAGAGACACAGGTGAGCCGCAATTTCCTCCCAGTTAGGAGGTCAACG | Hypo | FALSE |
| UGT1A7 | cg10432859 | 2 | CGAGCCATCAGAGAACTTCAGCCCAGAGCCAGCAGCTGGGATTCTAAGCT | Hypo | FALSE |
| UGT1A9 | cg15559700 | 2 | AATGTGCAAGTTGAGCGGTCACTGAGAGGCAGCTCAGCAGAGTGCTCTCG | Hypo | FALSE |
| UPP2 | cg03520136 | 2 | CGGGCCCATGAAGCCAGTCCTGAGTTTTAGAGTCAGGTAGATATGGGATC | Hypo | FALSE |
| USP34 | cg17214210 | 2 | ATTTTTTCCTTCCTGCTGGGGTACACCTTAATAACATAAAGATAGCATCG | Hypo | FALSE |
| VAMP8 | cg23752985 | 2 | CGCAGAGGTAATTGATCCCAGTCAGTGATCAGAGGACTGCCCCAGTGAAC | Hypo | FALSE |
| XDH | cg16862361 | 2 | CGCCTCCCAATAAAATGAAATAAGGTCCACCAATGGGAGGGAACCAGCTC | Hypo | FALSE |
| XDH | cg26767897 | 2 | TGTCCCCTCTTACTTGTTCTGTCTTTCTCTCTCTCGCTTTAAAGGTGTCG | Hypo | FALSE |
| YSK4 | cg15527554 | 2 | CGGCTATTTATGGAGCAGTGACTCTGTACAAGGCCCACGACTAGGTGCTC | Hypo | FALSE |
| ZNF650 | cg13328485 | 2 | TTTGCTTCACTGCTACTGCGATTGATGATTTCCTGAAATTTCTTTCTACG | Hypo | FALSE |
| ALK | cg18277754 | 2 | TGAGAGCAAGGACGCTGCAAACTTGCGCAGCGCGGGGGCTGGGATTCACG | Hypo | TRUE |
| B3GALT1 | cg25427580 | 2 | CGCTGGGCTGCATAACTGAGAAACGTGTTTCTCGCCTACCTGGTTTCTCG | Hypo | TRUE |
| BBS5 | c905847778 | 2 | CGCAGTGAGTTTCCAAGATTCCCGAGGGATCTTCAACCCTGTAGAGGGCG | Hypo | TRUE |
| BUB1 | cg06983551 | 2 | ACGGACACTTACTGAAGGACATTTTCCGGGGTGTCCATGGCCAGAGGACG | Hypo | TRUE |
| CAB39 | cg06874144 | 2 | CGTCAGGGATGGGGCAGTGAGCGAAACAGTCCATGCTCCTAGCACAAACA | Hypo | TRUE |
| CAPN10 | cg24767315 | 2 | AGGTGCATGCTGGGAGCGGCGGCGCATGCTGGGAGCTGTAGTCTGCGACG | Hypo | TRUE |
| CRIM1 | cg00850538 | 2 | AAGCTGAATCTTTCTCCCTGGAGTAAGGCCGAAGACTGGATTACTACACG | Hypo | TRUE |
| DOK1 | cg22238923 | 2 | GTGATGTCATGGCTTTCACTCTGACGTCACCTTGGGCATATGACGTCACG | Hypo | TRUE |
| FLJ10916 | cg07952391 | 2 | GACTTCAGTTTCGGGGTTCTCAAAGGACTGCTCAAATCCCGCAGAAAACG | Hypo | TRUE |
| FLJ22746 | cg26154999 | 2 | CGGGCCAGTCCTGTGAAATACTGTGAAAAGTCCCATTCCAAGCGGTCCCG | Hypo | TRUE |
| FLJ39822 | cg04143809 | 2 | CGACGAGTGAAAATTTGGGACTTTTATTGTAAATGGAAATGGAAAGACTC | Hypo | TRUE |
| HAT1 | cg24611092 | 2 | TTTTGCTGTAAACTTTAACACCTTTTTTCCTTTCTCCCCTGTTTTTAACG | Hypo | TRUE |
| HOXD10 | cg21591742 | 2 | CGGGCCCTGAGACATCCCACCCCAGGGGTCCAAAGGAAAGATCCCTTGGG | Hypo | TRUE |
| HOXD11 | cg08806153 | 2 | CGTGCAATTCATCTTGATTGATTCTGGTGGTAATTATGTCACGTGACGCC | Hypo | TRUE |
| HOXD8 | cg15520279 | 2 | CGCCCCAATGAGTTCGTACTTCGTGAACCCGCTGTACTCCAAGTACAAGG | Hypo | TRUE |
| HPCAL1 | cg25124636 | 2 | AGTCCAAAATGTGCACACCTAAGGCACACATGGATGCCCACGAGTACACG | Hypo | TRUE |
| IL1R2 | cg20340242 | 2 | CGGGTGACACCACCCGGTTAGGAAATCCCAGCTCCCAAGAGGGTATAAAT | Hypo | TRUE |
| KHK | cg14527441 | 2 | CGCTTAGCCGCGCTTTAAAAAGGTTTGCATCAGCTGTGAGTCCATCTGAC | Hypo | TRUE |
| KIF1A | cg14662379 | 2 | ATTCAGGGGTGTCCGCCCTTCAGGTGCCGCTGGAAAAGGTCCCTTTGCCG | Hypo | TRUE |
| KLF7 | cg08478189 | 2 | CGCTGCAGAAATAGATGGCAGCTTCGTGTCAGTGAGTTTGCATCCCCCTT | Hypo | TRUE |
| LIMS3 | cg18879041 | 2 | CGGACGACATGATGAAAATGCAGTTAGTTACCAAGTGATCAGGAACCTAC | Hypo | TRUE |
| LOC51315 | cg11142466 | 2 | GGCAGACGGACAGGATCAAAACCAGTCGCGCCAGCAAGACATTAGAGCCG | Hypo | TRUE |
| LOC51315 | cg12885244 | 2 | TCAGCCCCTCAACTCCTGCGCTCCAGGACAGGCCTCGCGCGCCCAGCCCG | Hypo | TRUE |
| LRRFIP1 | cg20732367 | 2 | CGCCTGGCCTGGAGTCACAGGGAGCTGCTAGTTTGCTATTTTACAAAATA | Hypo | TRUE |
| LYCAT | cg10995359 | 2 | CGGAGGTTGTGACCCCTACGGAGCCCCAGCTTGCCCACGCACCCCACTCG | Hypo | TRUE |
| MAPRE3 | cg19306990 | 2 | CGCCACAATGCCTGGCAAAGTTTTTGTATTATTAGTAGAGACAGGGGTTT | Hypo | TRUE |
| MRPL30 | cg15612847 | 2 | CGCCCGGCCGGTAGAGTTTGTAGTTCTGACCAAAGCACCAAACCATAAAG | Hypo | TRUE |
| PTMA | cg13921319 | 2 | GGTGATTTCGGAGCTGGTGTCTACGGCTGCGTCTGACATGGTGGGGCACG | Hypo | TRUE |
| RASGRP3 | cg01109219 | 2 | CGTGAGTAACACTTTGAGAAGAAGCACAAGGAATTTCTCCATAGGAGGGG | Hypo | TRUE |
| RHOB | cg19594691 | 2 | ACTTTCTTAATATAGCCGTCCAATGGGAAACCAGCCGGCTGAGCTCATCG | Hypo | TRUE |
| RPL31 | cg22809047 | 2 | CGCGACAGCCCTGTGGCTCCACCGCACAGGACAGCCACGACTGGCAATCC | Hypo | TRUE |
| RPS7 | cg17159242 | 2 | CCTGGAGGGGCGAGCCTTGCTCACAGGGTGGGGATACAGCCGATTACCCG | Hypo | TRUE |
| SFXN5 | cg03077062 | 2 | CGACCACGGGCCACCCCTCGCTGCTTAGTTGCCCCCAGAAGTTAGAGTTG | Hypo | TRUE |
| SOX11 | cg20008332 | 2 | CGGCTCAAGCACATGGCCGACTACCCCGACTACAAGTACCGGCCCCGGAA | Hypo | TRUE |
| TPO | cg16016036 | 2 | CGCCGGGCCTCTTGTGTGTCCTGACTGGTCAGAAACAAAGTGCCATGTCA | Hypo | TRUE |
| UNC50 | cg14471560 | 2 | CGGCTAAAATGAAAGGACGCCCAGTTACATTTGCATCGTAGATAAAGAAA | Hypo | TRUE |
| YWHAQ | cg19081759 | 2 | GGGTCCTCAGCTAAAGCCAAAAGCAGATCAAAGTGGTGGGACTCGCGTCG | Hypo | TRUE |
| ZAK | cg03608974 | 2 | CGCAAAGAAATAGAGGCTGTTTTGTGCCCCGCAAGAGTTAATTCTCTAGT | Hypo | TRUE |
| ZNF513 | cg11177693 | 2 | TGTACACTTTCAATCAACACTTTTTCAGACTAAAGGCCAAAACCTAATCG | Hypo | TRUE |
| CD96 | cg11119596 | 3 | GATCACAAAGTCAATTGATGTTTTCAAGCAAACTCCAGCCACCCACTTCG | Hyper | FALSE |
| ZBED2 | cg24323726 | 3 | CGCAGGAAAGATCAGAGAGAAGTCCAGAGCCTTGCCTGCTTGTAAGTACC | Hyper | FALSE |
| NFKBIZ | cg15006396 | 3 | GAGGTTACATGATAAGCAGCAGCTAAGCAGCCTTTTTCTCTAAGAACTCG | Hyper | TRUE |
| A4GNT | cg17687282 | 3 | CGTGAGATCTGTGTTCTCCTTGGTTAGAGCTAACATTTTTGGTGAGGAAA | Hypo | FALSE |
| A4GNT | cg18931888 | 3 | CGCCCCTGAAATGAGCTCTTAGCAATCTTCTTTGGAGCCATCCTCTGCTG | Hypo | FALSE |
| AADACL2 | cg25159668 | 3 | CGGACCAAGAAGGTGGTGCTGAGGCAGCACTAATATGAATTAGCGTTACA | Hypo | FALSE |
| ACPP | c915958424 | 3 | CGGGGAAAGCTGTTGATCAAGGTCACAGAGCATGTTAGCAGACATTTCTA | Hypo | FALSE |
| ADIPOQ | cg03573747 | 3 | CGGGAGAGCCTGGGTGATCCCAGCCAGAGGCTATGCATGCATCCCCCACC | Hypo | FALSE |
| ADIPOQ | cg04627663 | 3 | CACACCACAGTCTTGCTCACTGTGCATGATTAAGTCTGAGACTGTGTACG | Hypo | FALSE |
| ARIH2 | cg06641503 | 3 | TTTACTCATGCTGTCGTGGCTCATTTATGTCACATTACTCATAAATGTCG | Hypo | FALSE |
| ARL14 | cg16334519 | 3 | TCTCTGTAGAGACTTGGATTTTTCGCAGCCTCAGTTCTGCTTGAAGAACG | Hypo | FALSE |
| BPESC1 | cg20630151 | 3 | AGGAACACGTTGCTGTGTGCTCGTGGCACGTGGCCTGTTGGGTCCTTTCG | Hypo | FALSE |
| BTD | cg18204685 | 3 | CGGTGGGAGTGTAAAGCAGGAATATTTAGCCTCAGCTGGACTGAGAGTAT | Hypo | FALSE |
| BTD | cg24239808 | 3 | CGGGCTTGAAAGGTCAAGAATCCACTTCTGTGATATCACATACTCTCAGT | Hypo | FALSE |
| C3orf14 | cg09473585 | 3 | GACCTCTGTCTGTGTCGGTCCAGTGTCTTTAGCCAAGGTGAGCTTGCTCG | Hypo | FALSE |
| C3orf22 | cg24389347 | 3 | CGCCAGGCAGACTGAAGCTGGCCATGGTCCCAGCTGCCACATTACCACAG | Hypo | FALSE |
| C3orf32 | cg22959932 | 3 | GGACACGCTGTAGAACAGCTCACACTGGCTGGCACTGCTAAGCAGGTGCG | Hypo | FALSE |
| C3orf35 | cg18328190 | 3 | CTTTATGTTCCTGCATCACTCACGTGGTGTGAATCTGAACTTCACACACG | Hypo | FALSE |
| C3orf57 | cg04691961 | 3 | CGGGGACTACCAAGGCCATGTTGGTGAGGCCAATTCTATTTACACTGGTA | Hypo | FALSE |
| C3orf63 | cg22332306 | 3 | CGTGAAGAAATGTAGAATGAATTATGCAGCTTACTGGGGAAAGTGAGAGA | Hypo | FALSE |
| CAMP | cg04523589 | 3 | CGGTCCTCGGATGCTAACCTCTACCGCCTCCTGGACCTGGACCCCAGGCC | Hypo | FALSE |
| CCDC13 | cg07339138 | 3 | CGTGACTGGTGTAAGTCTAGCCCCAAGAGATACTCATGGTATAATAACTA | Hypo | FALSE |
| CCDC54 | cg27585441 | 3 | TGTGATTTCTTTACCCCTTTCTCCCTCCAGAATCTCTAGACAATGTATCG | Hypo | FALSE |
| CCR3 | cg04111761 | 3 | CGTTTGATATGTGTGTAGGACTGTGCTGTATGCTTCATGATAAAGAAAAC | Hypo | FALSE |
| CCR3 | cg11126313 | 3 | CGCAAACTTATCATTGTGTGGATGGGAGACAGAAAGGGAAAATTAGAAAA | Hypo | FALSE |
| CCR4 | cg21366834 | 3 | CGGAGCTTCATTGGCAGTGGTCTTGGCTGAGGTCTTGATCTTCACTTTGG | Hypo | FALSE |
| CCR8 | cg23519969 | 3 | CGCCCAGAAGTCAGGGCTTTGTGTGAGATCACACCTGCGTATAACTACTG | Hypo | FALSE |
| CD80 | cg21572897 | 3 | GCTTGAGTGTCCTCTTTGGAGACCACCCTAGAGCTAGAGTTCCAGCCACG | Hypo | FALSE |
| CNTN4 | cg10503138 | 3 | CGCAGGAGTAGGTAAGATTGCTAAGGATCAAAAACAAGTTTCATGAGAAT | Hypo | FALSE |
| CNTN6 | cg05209917 | 3 | CGCACAGCATGCCTGGCTGAGAGCTTGAAACAGAGTTCTGCAGAAAAACT | Hypo | FALSE |
| CNTN6 | cg07664856 | 3 | CGAGAGCTTTGCACATGTGCCTCAAGAACTGATTGTCTGGCTCCGACAGG | Hypo | FALSE |
| CP | cg17439694 | 3 | ATAATCCCAAGTCGTTTCAATAATTCCAATGTAATAATGCTTTTCTTTCG | Hypo | FALSE |
| CPB1 | cg26361780 | 3 | TTATGTTAATGTGATTTTCATCTTCAACGTTAACACGGAACACCTTCTCG | Hypo | FALSE |
| FAM79B | cg19682367 | 3 | CGTCCTCGACACGGTGGAAGCAGGTAAAAGGACTGTTTATTCATTGTGAC | Hypo | FALSE |
| FAM79B | cg22875391 | 3 | CGGCTTAGGGGACAGAAGCAATTGGTTCATAGAGAAATAACCCATCTCTG | Hypo | FALSE |
| FLJ23049 | cg24197445 | 3 | TCTTCATCGAATGACCCTTCACACAACAGACTCTTTCTTGGTTTTGTACG | Hypo | FALSE |
| FNDC3B | cg02976574 | 3 | TGGCTACCTCTCCGTTCAGCAATGGTGGCAGTTCCAGAGGGATTTGGTCG | Hypo | FALSE |
| FNDC3B | cg04848046 | 3 | AAAATCACCTGTAACACAACAAGTCACATAACAATCTAAGTGCTCCATCG | Hypo | FALSE |
| FNDC6 | cg06392589 | 3 | CTCAGCCATCTTTCTTCAGAATGCATATGTTGGAGCTGAGGTCTGAGTCG | Hypo | FALSE |
| GADL1 | cg15946807 | 3 | AGTATAGGAGTCAAATTGCCACGCAGGCTCCATGACAATCTTGGCTGACG | Hypo | FALSE |
| GADL1 | cg18047970 | 3 | ACTACCCAAATCCCTTGTCAATGAAGGATGTGTTGCTCCGGGCTGGAACG | Hypo | FALSE |
| GPR15 | cg08375941 | 3 | CTTTTCATTCACTCTTTACACAATGAAAGACTAGTTTTCTTCCTAGTTCG | Hypo | FALSE |
| GPR15 | cg19859270 | 3 | CGACTGGCCACACAATGGCCAGGTAGCGGTCAACACTCATGCAAGTGAGC | Hypo | FALSE |
| GUCA1C | cg19561186 | 3 | GCTTTGTTCTACCACTTATTAACTATATTGAAACATTACTTACATTCTCG | Hypo | FALSE |
| HCLS1 | cg11256445 | 3 | CGTCGACCAATTGAATGCCAGAAGAGAATAACTCATGAGGGAAAAGGCAA | Hypo | FALSE |
| HRH1 | cg07043494 | 3 | CGGGTTGGGAGTGGCCTCCGTGCTTTTGGGTAAGTACTCCCAAGGCTACG | Hypo | FALSE |
| HTR1F | cg12775613 | 3 | TCTGTCTGGGCTGGCACTGATGACAACAACTATCAACTCCCTTGTGATCG | Hypo | FALSE |
| HYAL2 | cg27091787 | 3 | CGGAAGCTCTCAGTGGAAAAAAACGGACTCAGCTACTGGAAGTCCCCCCG | Hypo | FALSE |
| HYPB | cg24776019 | 3 | GATAAATTAGTTCTAGAGCCTCTCTCAGACCTAGAGTGAGATCTGCTCCG | Hypo | FALSE |
| IMPG2 | cg01095395 | 3 | AGTCTATGTTTGAGAATGAACAACCACTTCAAAACCATTATAAATTAGCG | Hypo | FALSE |
| IQCF2 | cg10691387 | 3 | GGTTCATTAGCCCTGATTTCTCTGCTTCCCAAGGTCTGGCATGAGTAACG | Hypo | FALSE |
| IQCF2 | cg14940420 | 3 | CCATTCCTGGTCCACCTAATAGATCTGGCCATGTCTCTTACACAAAATCG | Hypo | FALSE |
| KCNAB1 | cg15423862 | 3 | CGGAAGAAACAGCCACTGCCAAACTTCAGTATTACAAAGTTGTTGGGAGT | Hypo | FALSE |
| KCTD6 | cg09224952 | 3 | TCTGTTTTTCTCCTCTTGAAGTTTCCCTGAAACCTGGGCTCTTGAAGACG | Hypo | FALSE |
| LPP | cg06547766 | 3 | CGTGTCCCATCACCATGCAAGTGAGCCAGCCCACAGGCTGTAAGCCCCAG | Hypo | FALSE |
| LRTM1 | cg06470471 | 3 | CGGGAATTGATCAGGGCTCACCTTTCATGACTGAGTCTCCTTGGGCGTCC | Hypo | FALSE |
| LRTM1 | cg11532513 | 3 | GCTACAGCTGTTCACCAAGGTTTGACAAACATTCTTTACGCGGCTCATCG | Hypo | FALSE |
| LSM3 | cg08611205 | 3 | CGGGGTATCTGGGAAGGACCACCTTAGTTTGCTCAAGGAATGTCTAACTT | Hypo | FALSE |
| MASP1 | cg21831174 | 3 | CGTTCCTTTGGCACGTTCTGGGGAACAGTGGCTTGACTCTCACTGTACTT | Hypo | FALSE |
| MOBP | cg16729794 | 3 | TTCTGCATGCATTGAAGTAGGCTCAAACCCTCAGGGACCTGGTATAGACG | Hypo | FALSE |
| NEK10 | cg23143093 | 3 | CGTGATATCAGTGCTTATGAAGAATTGGTATCCAAGCTGAATTTATTAGT | Hypo | FALSE |
| NR1I2 | cg02863947 | 3 | GCTCAGGTAGGCCACCTTGCCAGAAGTCCTTAGGTTATGGGTAACATACG | Hypo | FALSE |
| OSTalpha | cg12894629 | 3 | ACACAGCATCTTGTACTGTGGTACGGTGGTACCTCTAGGTTCCTGGCACG | Hypo | FALSE |
| OSTN | cg03192737 | 3 | TCACGATCTTCTCCTCACAGAGGAGTCGGAGCAAGCCAGTTATCTAAACG | Hypo | FALSE |
| P2RY13 | cg24474182 | 3 | CGGCAGTCATTAGTTCAGCCTACAAATGAGCATGTGAAGCAAATGTTCTG | Hypo | FALSE |
| PIK3CB | cg16050349 | 3 | AAGGAAATCCACAGGTATGGAGCCATCAGATGCTATCTGTGAATCCACCG | Hypo | FALSE |
| PLD1 | cg15329866 | 3 | CGAGCCACGGGTAAATACCTCTGCACTGCAGAAAATTGCTGCTGACATGA | Hypo | FALSE |
| PLSCR1 | cg20586531 | 3 | ACTATAGCCCTCATGTTGTACATTAGGTCTTCCCATTTGTTCATCCTACG | Hypo | FALSE |
| PLSCR2 | cg03075662 | 3 | CAAATTCACCTCCCAGGTAGCCAATGACATGTAGTTTCCAGAGACTAACG | Hypo | FALSE |
| PLSCR2 | cg15847988 | 3 | CGCATACCAGGATATAAAGCTTGTAATTCTCCCATGGTGTTGGAATGGCA | Hypo | FALSE |
| PODXL2 | cg05781767 | 3 | CGAGGGATGTGCCTGTTTTATTTACCACTACAGTGCTTGGCATATTAAGG | Hypo | FALSE |
| POP2 | cg16739580 | 3 | TTTCTACCAGTTGCTTCCCATTAGCCTTGTCTACCTCTGTCTGGGGGACG | Hypo | FALSE |
| POU1F1 | cg10874403 | 3 | CGGTTCAGATTGATAAAGCAATACTCCTGGGAAAAGACTATTAACATGTA | Hypo | FALSE |
| ROBO1 | cg20145360 | 3 | GAATAGTAAAACTATTGTTAAAAGATTAAGTCTTTCCACTTCCCAACTCG | Hypo | FALSE |
| SAMD7 | cg04039225 | 3 | ACCATACAAAGACTTTCTGGCCTTCAACTGCAGAAGCTTCTCTGGCTGCG | Hypo | FALSE |
| SAMD7 | cg05721199 | 3 | CATCAAATGTTTCAGCTCTGTGGAAAATAACTTAGGTTTTTTCCTACTCG | Hypo | FALSE |
| SH3BP5 | cg21283680 | 3 | CGTCTGAAGCTCAGGGGACAGGCCAAGACTGCAGATATAAATTTAAGAGT | Hypo | FALSE |
| SLC12A8 | cg14391622 | 3 | ACAGGAGCCTACCCTGTGCGGCTCTGAGGAGTGGCTGTGAGCACTGCACG | Hypo | FALSE |
| SLC15A2 | cg18636558 | 3 | CGAATGTCCAGGGAAACTTGGCAAGCATTCTTGTCTGAAGAACTGTGTGT | Hypo | FALSE |
| SLC22A13 | cg25411725 | 3 | CGGGCTGGCTGGTTGCTATAAGCCATCTTAACATTTGGCTAAGCTCACTC | Hypo | FALSE |
| SLC22A14 | cg08934427 | 3 | GTCAAGGTTGGAATCCATATTGCTTCAAGCCAGAGGCCAGTTCCTAGTCG | Hypo | FALSE |
| SLC22A14 | cg16558203 | 3 | CGTCAAGGTTGGAATCCATATTGCTTCAAGCCAGAGGCCAGTTCCTAGTC | Hypo | FALSE |
| SLC4A7 | cg06798189 | 3 | CGGTCTTCAGGAATTTTTAAGAATGTAGAGAATCCCAAGTCCAGTAGTTA | Hypo | FALSE |
| STAB1 | cg15407570 | 3 | GCCTGGCAGGCTTCAGCTTCGTCAGGGGGCAGGTAAGTGTGAGCCAGTCG | Hypo | FALSE |
| SUCNR1 | cg05702774 | 3 | CGGGAGGGACCAGAGCTTAAGCCTATGTACTTGGATTCTAAAAGCACCGA | Hypo | FALSE |
| TMCC1 | cg03704024 | 3 | ATAATGAAACAGCTCATTTCCTACATTCTTCCTGAATGTTATTAGACACG | Hypo | FALSE |
| TMCC1 | cg15489422 | 3 | CGCTCGGTGAACAGTTGCCTTTGGTCACAAGATTTAGAAGACACAGTGTC | Hypo | FALSE |
| TRIM42 | cg13998904 | 3 | TATGTCACAATCCCTGTCTCTCTACCATGCTAGGTAGATAGCAGGATGCG | Hypo | FALSE |
| TTLL3 | cg07614786 | 3 | GCCTGAGTTTAGAACTTGCTCCTGTTTCAGGCTGGTCACGGTGGCTGACG | Hypo | FALSE |
| UNQ846 | cg02912041 | 3 | GATAGTTACCTGGAATAGCGGCAAACACAAGATCCCTATCGTTGAGATCG | Hypo | FALSE |
| UPK1B | cg22842233 | 3 | GAAACTAAAACTGGACATGGCCCTACACAGGTAAGCACATATCAGCATCG | Hypo | FALSE |
| URB | cg21307628 | 3 | CGAGCATGGAACTGAGAAAGTCCTGTATAGAGGTTAACTATAGAGTTGCC | Hypo | FALSE |
| UTS2D | cg11158430 | 3 | CGGGAAAAATGAGTGAAAACATGTTTGATGTGTGACTAAATAATAACCAA | Hypo | FALSE |
| ZDHHC3 | cg05161795 | 3 | CGGCAGGTCACGATTTTTAAATGGACATGTCCTTAACTCACGTTGTGGGA | Hypo | FALSE |
| ZDHHC3 | cg25766774 | 3 | GATGTAGCCATCGGATTGAAGCGGCCAGCTATCATTGAAGTCCCACAACG | Hypo | FALSE |
| APOD | cg05624196 | 3 | TTTTATAAGCTTCTTCAGGTCTCTGATGTTTACTTTTCATGCATGCCACG | Hypo | TRUE |
| ARL13B | cg07204803 | 3 | CGCCCGGCCCCAAATGGTTATCTTTGAGAGCTCCTGTGAGATCTCATTTT | Hypo | TRUE |
| AXUD1 | cg02254461 | 3 | CGACATGCCCCGGCAACCAAGTCCTGGCCTGGGAGCCCACCCTCAGCCCC | Hypo | TRUE |
| CLDN18 | cg10784090 | 3 | CGGACCATGTAATGGAGGCGGTTACTCACCAGTGCCACCTGGGCTTGCCC | Hypo | TRUE |
| COX17 | cg26808606 | 3 | AAAGCAGCTATGAGCGGAGACAGCCAAATCTATGCCAGCCTCGGCAAACG | Hypo | TRUE |
| CPNE4 | cg16673198 | 3 | TTTACTCATGCATTACTTACTAAAAATAATTTCCAGGCTCCTGCCATACG | Hypo | TRUE |
| EPHA3 | cg18055394 | 3 | TTGCACTCACATTGCCATATGATACTCCTATCAAGGCTGTGATTTCTTCG | Hypo | TRUE |
| FAIM | cg02712878 | 3 | CGGGCAAAAACAGCCCTGTGCCTGCTCTGCAGCTATGGGGAAGGAATATC | Hypo | TRUE |
| FHIT | cg04835638 | 3 | CGCCCGGCCCAGCCAAGAATTCTTAAGAAAATATCCTAGTGAGAGCCTTT | Hypo | TRUE |
| FHIT | cg15931943 | 3 | CGCGTGGAAACCCAGACCCGCGCCCCAGAAACAGTATTCCACTTGGGCTT | Hypo | TRUE |
| FSTL1 | cg22469841 | 3 | TCCCGCTTACGGCCCGAACTACTTTTCCTGCTTTAAAGATTTAAGTTTCG | Hypo | TRUE |
| GOLGA4 | cg20227213 | 3 | CAGGGCCAAAGCCCAGGTGAGAGTCAGGGTAGTGTTCAGACTAGCCCACG | Hypo | TRUE |
| GPR175 | cg13728650 | 3 | CGCCTGTCGGCCCTTGTGCCTGGCTTCACGCTATATCACTTCTGAGAGTC | Hypo | TRUE |
| GPR27 | cg22631938 | 3 | CGCACCTGAGTATCAGCGGTTTTAGGATTACGATGACTATTACTATCGTA | Hypo | TRUE |
| HTR3C | cg18271969 | 3 | ACAACAACAACAAAACCACAAAGTGAGGCCGGTGCAGATATTGTCTCTCG | Hypo | TRUE |
| IGSF11 | cg14458615 | 3 | GCACTGTGGGTGGGGTTGGGCTGGGTCGTCTAGGCGACCCTCCAGGAACG | Hypo | TRUE |
| ILDR1 | cg04059863 | 3 | GGCGAAACCCTGTCTAATAAAAATACAAAACAGCCGTGCGTGGTGGCACG | Hypo | TRUE |
| ILDR1 | cg08463485 | 3 | AGGTGCAGAGCAGCAGCCAAGGTGCGGGCAGTTTGGGCCATGCCATGCCG | Hypo | TRUE |
| KALRN | cg12144803 | 3 | GACATGGACTTGACTGTGGATTTTCATTCTCAAGACCACTGCAAACCTCG | Hypo | TRUE |
| LEPREL1 | cg18626709 | 3 | AGGAGCGTGTGAGCTGTGGGCGTCCCTTTAAGAGCGGCTGGCCAGGCACG | Hypo | TRUE |
| LIPH | cg01390445 | 3 | CGCCAGAAAGGGAATTAAATTACCTTGGAGCTATGAAGCACAAGTTTAGT | Hypo | TRUE |
| LOC348840 | cg02141570 | 3 | GTTACCAGGCAGTTGTTGCCTGCACACAGAGGGCGACTGCAGCTTGGGCG | Hypo | TRUE |
| LRRC33 | cg00293409 | 3 | CGGGGCTGGGCTACCTCCTTGCTGTGGGGCATCAGATTATTTTAGCACCA | Hypo | TRUE |
| MFSD1 | cg25050026 | 3 | CGTGACACATGGCTGGACACACCAGAAATTGTCCGATCAAGTTTGTGGGT | Hypo | TRUE |
| NSUN3 | cg04032566 | 3 | GAAGCCAGGCCAAGAATGCCGCGAAATTCCCTTCTTCAAATTTTTTTACG | Hypo | TRUE |
| NSUN3 | cg23126947 | 3 | TTCTTGGCCTGGCTTCCTGGCGTAGCCAGCAAGTTCGGAGGTGTTAACCG | Hypo | TRUE |
| PFKFB4 | cg19348001 | 3 | CCGTTTTGGAACAAGTGGGCCCAGTTCTTCAGGCCAGGATCGAGAATGCG | Hypo | TRUE |
| PLCD1 | cg15120942 | 3 | CAGGTATTGCTCTCTGAAGACCTTCTAATCGTGTCCGTGCACCCATTTCG | Hypo | TRUE |
| RBP1 | cg12497564 | 3 | ATGTTGGTCAACGAGAATTTCGAGGAGTACCTGCGCGCCCTCGGTAAGCG | Hypo | TRUE |
| SFMBT1 | cg19373170 | 3 | GCCTCCTTTTCAGCGTCCAAAATCGGACTTTAGGAACAGAAATCGAAACG | Hypo | TRUE |
| SLC15A2 | cg10523671 | 3 | GAACACAACACCTCGAGCACAGATTGAAAAACTGATTCCATGGTCAGGCG | Hypo | TRUE |
| SPATA16 | cg01216369 | 3 | CGCCAGGACTTGAAACGTCCCGTGCCACGAGGCCCATCGCGCCCACAAGT | Hypo | TRUE |
| SPATA16 | cg06577725 | 3 | GTTGGCAGATGCTGTGGCTGGGAGGAGTCCAGAGCTTCGCCCTGTCCCCG | Hypo | TRUE |
| SSR3 | cg24517609 | 3 | CGGCTGAAATCCTGCAGGAGCAGGTCCTCCTCAGACTGCTGTTTGGAGCT | Hypo | TRUE |
| TAGLN3 | cg20126106 | 3 | TTTGTAGGTGAAACCCCATTGGCTTCATTGGCTCCTTGATTTAAACCACG | Hypo | TRUE |
| TBC1D5 | cg01765641 | 3 | AAGTCAAGTTCCGTAAAGCACTTACAACAGTGTCCGGCACTCAGTAAGCG | Hypo | TRUE |
| TMEM42 | cg26889990 | 3 | CGGCGCCGCTTTTGGGGCGTATTCAACTGTCTGTGCGCCGGCGCGTTCGG | Hypo | TRUE |
| TMEM44 | cg27033479 | 3 | GTCACACTGCGAGTCAATGGCGAAGGGCTGACAATAGCACCCAGGGCTCG | Hypo | TRUE |
| VHL | cg24092914 | 3 | AAGAGAACCACTTGACCCCAGGTGGCAGATGTTGCAATGAGCCGCAATCG | Hypo | TRUE |
| VHL | cg25539131 | 3 | GTACAACTGAATTGGGTATCCCAATTCCTATTTTACACTCACTGGAAACG | Hypo | TRUE |
| VIPR1 | cg03160740 | 3 | GGAGGCGAGTCGAGATGCTTGATGTCCCCTATTCCTCTTACACAGACACG | Hypo | TRUE |
| VIPR1 | cg10970409 | 3 | CAGAGATCGGGTTGTTTGATCAATTTTCAACAACCCCAATTCATCCTTCG | Hypo | TRUE |
| XYLB | cg12340144 | 3 | CTATAATCTGCTTCCAGGTCACTGGTTGTGCATGTGCGCAGGGCTACCCG | Hypo | TRUE |
| BRDG1 | cg12879425 | 4 | GGCTTCTTAGCCATCATACCCCTCTCTTTGGTGTGTGGTTTGGTTTCTCG | Hyper | FALSE |
| FLJ13614 | cg02782630 | 4 | CGATGCCACAGTGGATATGCCACGGTTTTGGTTTTCAAGCTGCATTTTAG | Hyper | TRUE |
| RPL34 | cg16525761 | 4 | CGCAGAAATCTATTGGAAATCGCTGTGGAAACAAACGCAAATGAAAAGCC | Hyper | TRUE |
| ADAM29 | cg16411152 | 4 | TAAAATAAAAGCTCTCCTGATGGCCTGTTCCTGCACATTTCCTGAGGACG | Hypo | FALSE |
| ADH1A | cg02039053 | 4 | CGGTAAAGCGATAATTTATTCCAAGCTAATCATGATTAATTTGTAAAGCC | Hypo | FALSE |
| ADH1A | cg15677344 | 4 | CGCACTTCCCAGCCAGGCTGATATGTAGACTTGGCTGCCTGTGTATCTTT | Hypo | FALSE |
| ADH1B | cg01528948 | 4 | CGTGTGGAATTGGAATTGGATGTTACACAAGCAAACAAAATAAATATCTG | Hypo | FALSE |
| ADH6 | cg06518271 | 4 | CGGTGGAGAAAATCAGCATGTGTACTACAGGCCAAGTAGGTGCAGTCTTA | Hypo | FALSE |
| ADH7 | cg06425515 | 4 | TGGGCAATTGCTCCAGGAAGCCAAATGTTTCCACAAGGACACTTCAATCG | Hypo | FALSE |
| AFM | cg01675895 | 4 | CGTAGAATGAGTAAGTTCAAATGCATCACATGGACTACAGCTAATAATAC | Hypo | FALSE |
| AFP | cg20630386 | 4 | TTTCTGCCCCAAAGAGCTCTGTGTCCTTGAACATAAAATACAAATAACCG | Hypo | FALSE |
| ALB | cg13077930 | 4 | AGTGTGCTTTTACCTATAGATAATGAAAAATTTACACACAAGTACTCACG | Hypo | FALSE |
| AMBN | cg13523386 | 4 | CGCAATAAAAGGGTGTGGACTAATTGCAGGAGCAGAGATTCCCGCCCCAA | Hypo | FALSE |
| APIN | cg04570669 | 4 | CGAAGCAAATGCTAAATTCCCGATGGCCATGAGAAATATGGGGCAGGATA | Hypo | FALSE |
| ART3 | cg22252999 | 4 | TATAATCTTAGAATTGCTGCCTACCCAGTTCCTTCTTATTCTTGTTCCCG | Hypo | FALSE |
| ASB5 | cg11698653 | 4 | ATCGGCCGTTTGCTCAACAATTATCCAATGTCTACTTTACAATACTTTCG | Hypo | FALSE |
| ASB5 | cg12182525 | 4 | TCTGCGGCGGTCTTTAGTTGGATCCAAGTCTCAAATGTGCCTGGCTCTCG | Hypo | FALSE |
| C1QTNF7 | cg24829483 | 4 | AAGACAGTTGCAAAACTTCGTACAACAGCATGAGCTCCAAGCTTCAAACG | Hypo | FALSE |
| C4orf17 | cg27563778 | 4 | GCACTTAAGCTAGAAGTTTTTAGTTGGTAGAGACAGACCAATCTCGAACG | Hypo | FALSE |
| C4orf6 | cg11237738 | 4 | CGGAAGGTGCTCAGCCTTTTAGGACAGAAACTGTTGGGACAGAAGAATAC | Hypo | FALSE |
| C4orf7 | cg10585462 | 4 | CGCTGTTATGAGAAATGGCAAGTGACTGGCCCTGGAATATTGTAGCTGTT | Hypo | FALSE |
| C4orf7 | cg25600236 | 4 | CGCATATTTAAGGTAATTCTTGAATGTTTTGTGGGCCCTAGTTTCTGTTC | Hypo | FALSE |
| CASP6 | cg17714799 | 4 | TTTCAACATTGGCTCGCTTTGTGTCTCTGTGTCACATTTTGGTACTCTCG | Hypo | FALSE |
| CFI | cg12243271 | 4 | GCTACGAAGACAGTGAGACTGATCTCTTCCTTCAACAGCCTCTTAGTACG | Hypo | FALSE |
| CHRNA9 | cg23621817 | 4 | CGGCAGATGGAAAATATGCTCAGAAGTTGTTTAATGACCTTTTTGAAGAT | Hypo | FALSE |
| CLOCK | cg04485603 | 4 | CGGTTGAGTTCCCAGAGGGGTTGATGAGATCTGATCTATTTATTGACACA | Hypo | FALSE |
| CLOCK | cg05960024 | 4 | CGGTGGAAGCATAGGACAAGGAATTATAAAAATACTTGGGTAATGATCTG | Hypo | FALSE |
| COX7B2 | cg25463409 | 4 | CGGCTTCAGATAAAGCAATGAACAGAAGAGACAGCGATCTGTGTCCTCAT | Hypo | FALSE |
| CSN1S1 | cg09096383 | 4 | CGCAGTACCTTAAGCCCAAGTCTGGAGAGAAGCAAGTTGTGTTGATGACC | Hypo | FALSE |
| CSN3 | cg13459560 | 4 | CGGGAGAAAATGTGCTGCAGCCCAAACGCAAATGATTCCCCACTATATAC | Hypo | FALSE |
| CSN3 | cg13546796 | 4 | CGTATTCCTACAGACAAATGTTGAGAGTTAACTCCACAGGAAGTTGGGCT | Hypo | FALSE |
| CXCL11 | cg08046471 | 4 | CACACCTCTGGGATCATGTCCCACACAAATTTAGTGAGTTTGGTCAGGCG | Hypo | FALSE |
| CXCL13 | cg17001652 | 4 | CCAGCAATGTTCAATACTTACTCTTGATAAATTATTTTCTTTCTTCAACG | Hypo | FALSE |
| CXCL5 | cg04559909 | 4 | TCATGGCCTGTGCCAGAGCGGGCTAGGGATGCCGGCTTTTCTGAGGCACG | Hypo | FALSE |
| DMP1 | cg18397653 | 4 | TGTGGCATAAACAACAGGCACAAAAATAGGAACTGTTTTTACCCAAAGCG | Hypo | FALSE |
| DMP1 | cg22416721 | 4 | CGGCAGGATGGCCACTGAACAAGAATTTAGAGAATATCAGCTGCTGGACC | Hypo | FALSE |
| ELF2 | cg05088386 | 4 | TGAGATAGTAAATACTTAATAAAACAAATCACTTCCAAAGCCATATGTCG | Hypo | FALSE |
| EMCN | cg12532667 | 4 | CGGGGCTTGTACCCAGGACTATGGCAGTGTTATCACCACGTTTTAATCAG | Hypo | FALSE |
| EMCN | cg27019278 | 4 | CGGGTACAGCAGCCTGAAAGCATGTTCGATGAAATCACAAAGTACTGGAA | Hypo | FALSE |
| F11 | cg24529858 | 4 | CGGATGGGAAGCAAAGTACAGACAGCTCCTAAGAGCCTGGCTCTTGCCCA | Hypo | FALSE |
| FABP2 | cg26073856 | 4 | TACCTCCAACATAGTCTGCACTTTGAACTTAGAAAAACAATCTTCAGACG | Hypo | FALSE |
| FGA | cg12827188 | 4 | TGGTTAATCATTGGCTTTGTCCTGTGTAGACAGTCAACCCTCCCTCTACG | Hypo | FALSE |
| FGB | cg18876189 | 4 | GGGTCCCACACCATTCTCAAGACTCTGTTTCAAAGCATTGTTTCAATACG | Hypo | FALSE |
| FLJ20184 | cg25370441 | 4 | CGGATCAGGGTTTGGCAAGTATGTTTTCAGTAAATAATTGCTGAATGTTC | Hypo | FALSE |
| FLJ32028 | cg12968903 | 4 | CGCCAGATGGAGGTGGATGCCACACCCACACCTTAAGGTTATGTTCTGCT | Hypo | FALSE |
| GC | cg09816180 | 4 | TATTTTCCACTGCTGTTCCTCACTAAAGTTTACTTAATATGTTAGTAACG | Hypo | FALSE |
| GK2 | cg14078518 | 4 | GCTGTGGGGCCGTTGGTGGGAGCGGTGGTCCAGGGCACCAACTCCACTCG | Hypo | FALSE |
| GNRHR | cg27219973 | 4 | TTTACACTTTTGCTTTCACATACCCTTTGAACTTTCTCACATTGTCTTCG | Hypo | FALSE |
| GUCY1A3 | cg02210887 | 4 | CAGACGAGGACAACAGCAACAACAAAGTCTTTATACAAGCCTGCAACACG | Hypo | FALSE |
| GYPB | cg16636571 | 4 | CTCTCTTCCCTGTATGCTACAGAGTGCTCAGTAGATCCTTGATACTTGCG | Hypo | FALSE |
| GYPE | cg16998872 | 4 | CGCCTGTTAATAAAGATACATGGATATCTTGGGGCTATGAAAGTGGTAAG | Hypo | FALSE |
| HDCMA18P | cg21270015 | 4 | CGCACAGTGTATGTGGTAAGCTTAAGAACCCGGGTCCCCAGTCAGAAACT | Hypo | FALSE |
| HSD17B13 | cg24999727 | 4 | CGACAGAGCATATTGGTTCTGTGGGATATTAATAAGGTAATGTATACATC | Hypo | FALSE |
| HTN1 | cg06545504 | 4 | GAATACCATCTACTACTTTTCAACAAATATATGTCCAAGATGGAACAACG | Hypo | FALSE |
| HTN1 | cg21621204 | 4 | GATGACTTCCAGATCTCAATTCCTATGAATTAACACCAGCAATCATCACG | Hypo | FALSE |
| HTN3 | cg25040282 | 4 | TCACTCAGGGCTAGACTAACACTGGGATTAGCATGTGATGGGTCCATTCG | Hypo | FALSE |
| IL2 | cg09526693 | 4 | TAGCATCAGTATCCTTGAATGCAAACCTTTTTCTGAGTATTTAACAATCG | Hypo | FALSE |
| INPP4B | cg06318853 | 4 | TTAGCAATTAACTCTGCTTTCAACATTGACAATCAGATTTCTCAAAAACG | Hypo | FALSE |
| INPP4B | cg10978346 | 4 | GCATCTTGTCAAGACATTACCATGTTTTGGCAAGGTGAATATTACTATCG | Hypo | FALSE |
| KLB | cg21880903 | 4 | CGGGGGATTGCAAAGATCTGTCATCCTGTCAGCACTTATTCTGCTACGAG | Hypo | FALSE |
| KLB | cg27558666 | 4 | CGAAAGGCCAGGCACAGTGATTCATGGCTATAATCCCACCACTTTGGGAG | Hypo | FALSE |
| LDB2 | cg08899626 | 4 | ACGTCCATGCAGAGCACATGGGCTGTGTTCTTCCCAGTACAAAGTAGACG | Hypo | FALSE |
| LOC91431 | cg07790638 | 4 | CGGCAGGATTTTAGCAGTCAAGATTCGGTTTCCAGAAAGAAAGTACTTTC | Hypo | FALSE |
| LRP2BP | cg06521761 | 4 | CGTCCTGTCTGGCTATGGGTTTATACATCAAGATGGGTCAAGTCACCCAG | Hypo | FALSE |
| MAB21L2 | cg20334738 | 4 | TCTCTTTACCCTGTTTCTTTATCAAGTGCAGTGGTGGCTGCTACCGTTCG | Hypo | FALSE |
| MEPE | cg05679613 | 4 | CGCTGAGTGAGCCAGTGCTGATTGGCCATTGGGAACTCTAACAAACTTTA | Hypo | FALSE |
| METAP1 | cg07829809 | 4 | TAAGGTCAGAGATTGTTCCACTGACCTGTGTTGCAAATTACCTATCTTCG | Hypo | FALSE |
| METAP1 | cg17499294 | 4 | AGTATAATACAGTCAGTCCTCCATATCTCCTGGTTCTGCATCTGTTGACG | Hypo | FALSE |
| MTTP | cg16650125 | 4 | CGGTTTGAGAAAAGGGTTTTGAGAGTGACCAGGATAGATTTAAGAATTCA | Hypo | FALSE |
| MUC7 | cg03970609 | 4 | TGTTCCTGTTGGGAGGACCTGGGCCATGGTTGTTTGTTTCTCCGTAAGCG | Hypo | FALSE |
| MYOZ2 | cg14736911 | 4 | CGTCAGGATGGAGCCACATTCATGCTGTGCTATATTAATGCTACGAAGGA | Hypo | FALSE |
| NDST4 | cg27063986 | 4 | CACATGAATACATTCCAACAGAAGCTAATTCAGCGATGGGCTGCATTCCG | Hypo | FALSE |
| NYD-SP26 | cg22182945 | 4 | GGACTCTATAGTCTTTTCATTCAATATTCCTGCAATTAGATAACCAATCG | Hypo | FALSE |
| OTUD4 | cg09088577 | 4 | CGCTGTGCTTAGTTAGAAGAAGAGGTAGGAATGAGTAAAGATATCGAAAT | Hypo | FALSE |
| OTUD4 | cg25424525 | 4 | GACAACCAATAGATTATCAGTCTTTCTCCATTTCCCTTTCTATAATTTCG | Hypo | FALSE |
| PALLD | cg17925436 | 4 | AAATCTTACGTATTATCTGTTTTTGGCAAAACCGTAACATTCTCATTACG | Hypo | FALSE |
| PDHA2 | cg17725968 | 4 | CGGCGATTAGGATGCCCTGTAGTTTGCCCAAGTCCTCCAGAAAAGGAAAT | Hypo | FALSE |
| PPBPL2 | cg03163246 | 4 | CGCCAAAGACAGCAGATGTTCTTTGGGACCGTATGGATAAAATAAGAGCC | Hypo | FALSE |
| PROL1 | cg02741177 | 4 | CGGGAACATACAGAAGGGAACAATAGACACCAGGGCCTACTTGATGGTGT | Hypo | FALSE |
| PROL1 | cg06585690 | 4 | CGTGCATGCAGGTGGAAGCCATTATCCTAAGCAAACGAATTCAAGGAGAG | Hypo | FALSE |
| PTTG2 | cg16370389 | 4 | CGGCAATAATCCAGAATGGCTACTCTGATCTACGTTGATAAGGAAATTGG | Hypo | FALSE |
| RRH | cg19428735 | 4 | CGGATGGTGGAGTTGATCATATTATATCCATGCTATGAAATACATAGCTA | Hypo | FALSE |
| RUFY3 | cg06059810 | 4 | TCAGTTCAGTTCATTAGTCAGCCATTTTGGTCAACACCCTGCTTACTGCG | Hypo | FALSE |
| SCRG1 | cg01324261 | 4 | ACAAATGAACCTTTGTCTGCCTTGTCTCTGGCCTGGGATCGACAGACTCG | Hypo | FALSE |
| SCRG1 | cg05348123 | 4 | ACTGCCTACTAAACATTCTCAACTGTATTTAGGGTTCCTTAAACTCAACG | Hypo | FALSE |
| SDAD1 | cg11631275 | 4 | CGGGATCATTTAGATAGTAACTGGCAGAACAGGGCTACAATCTGAATTTG | Hypo | FALSE |
| SHRM | cg14898892 | 4 | AAATGCCTATGTCTCACTCCCTGAAATTCTCCTTTAATTGGTACGAGGCG | Hypo | FALSE |
| SLC10A6 | cg25177139 | 4 | TGCTCATGTTCTCTTTGGGATGTTCCGTGGAGATCCGGAAGCTGTGGTCG | Hypo | FALSE |
| SMR3A | cg11799561 | 4 | TTCCTGACAGTCAACTCTGCACATAGGTTGAGTGTGTTGTCTGAACAACG | Hypo | FALSE |
| SMR3B | cg08113203 | 4 | CGGCAAATAAAGGTGAAAAGGGACAAGAAATCTTAGCTCTTATATATTGT | Hypo | FALSE |
| SOD3 | cg10307548 | 4 | CGCCTACCAACAGAATGCAGAGGTGCAAGACTGAGCTACTGGTGCCTGAG | Hypo | FALSE |
| SORBS2 | cg26583078 | 4 | GCTCCTGTTAAATCATATCCATTTTATTACGTCTCTCCTTGTGGATTACG | Hypo | FALSE |
| SPARCL1 | cg05350879 | 4 | CGCATGGTAAGTTTTACTGTGTTCCCATTTGAGGGGTAGTGTCATACAGT | Hypo | FALSE |
| SPOCK3 | cg06021171 | 4 | CGGGATGCTTGGCATGGTATGTATGGACAGTAATCTTAACCTTATACTCC | Hypo | FALSE |
| STATH | cg00436282 | 4 | CCAGGAAACAACTGTACCCACTGCATGTTAATCCCACTGTTAGTCTAGCG | Hypo | FALSE |
| TDO2 | cg08121954 | 4 | GACCTCCTTTGCTGGCTCTATTCACACCAGTTTGTGATTTGTCTTCTTCG | Hypo | FALSE |
| TLR6 | cg13006591 | 4 | CGTGCCCAAGGCTGGACGCATGTTCAGAGGAGACCTGAGAAAATCCTAAA | Hypo | FALSE |
| TLR6 | cg25769980 | 4 | AGACCTACCGCTGAAAACCAAAGTCTTAGATATGTCTCAGAACTACATCG | Hypo | FALSE |
| TMPRSS11B | cg06399881 | 4 | CGCAGCTTTTGACTTATGTGCTACATCCAGTGTTGGAGCTTGGTTTTTAT | Hypo | FALSE |
| TMPRSS11B | cg19510180 | 4 | CGGCCCAGTTTGGTCAGCTAAGAGGCACACCCAAGAAACAGCTTTGAAGT | Hypo | FALSE |
| TMPRSS11D | cg03536003 | 4 | CTCAACTGCTTTGAGATTCCCACTCAAATGAATGACTCTCATGTATTACG | Hypo | FALSE |
| TMPRSS11F | cg02936740 | 4 | CGGAGTGGAGAAGACCTGAGTTATGAACCAGGGCACCTGTCTCAGCCATT | Hypo | FALSE |
| TMPRSS11F | cg20695587 | 4 | TCAGTTTTGTGCCAACTGGCTCCACACAGTGAAGTAATTGTCAATATCCG | Hypo | FALSE |
| TMSL3 | cg11826486 | 4 | CTTTGTGATTACATCCTCCCACTAGGTATCTAATGAACTGAAGTAGACCG | Hypo | FALSE |
| TNIP3 | cg20950277 | 4 | CGGCAATCATTCTAGATGTGCCCTGTACAAAATGTGCCATGGAAGCTGTT | Hypo | FALSE |
| TRPC3 | cg15798530 | 4 | ACTTTGTGAGTAAAGCAACTGGGCACTAATTGTACATCCAGATCAATGCG | Hypo | FALSE |
| UGT2A1 | cg19399100 | 4 | CGGCAGAGACACACTTTGTATGATAACATTGAAGAGGAAATAAAGAAGAA | Hypo | FALSE |
| UGT2B11 | cg13436996 | 4 | CGGAGACTGTACACAAACCGTATGTTAAGTAGCGCAGCCAGCAGCTCACC | Hypo | FALSE |
| UGT2B28 | cg23183296 | 4 | GGTGACTGTACTGGCATCTTCAGCTTCCATTCTTTTTGATCCCAATGACG | Hypo | FALSE |
| UGT2B4 | cg03498559 | 4 | CGGAGGCTGTAGACAAAGGGTATTTTAAGTAACTCGGCCAGCAGCTCACC | Hypo | FALSE |
| UGT2B7 | cg04558553 | 4 | GCTCAGTGCCCTGCAATTATTAAACTCCTTCTTTGCTGCCAAATCTGACG | Hypo | FALSE |
| UGT8 | cg25892041 | 4 | TCATCGTGCCGCCAATTATGTTTGAAAGCCATATGTACATTTTCAAGACG | Hypo | FALSE |
| UNQ689 | cg17536071 | 4 | AAATGCTTCTTCACCTCCTTCTTCTTCCCAAATGATTTCTCAGATGTACG | Hypo | FALSE |
| UNQ689 | cg19666391 | 4 | GAGGTCTGTTAATCAATTTCTGAGACCATTTCAATGATGAGCCTGTGTCG | Hypo | FALSE |
| AFF1 | cg16090392 | 4 | CGGGCCACAGTTAGAAAGGAAAAGAAATTGCCTCTGGGCTCACTTGAAGT | Hypo | TRUE |
| ANP32C | cg23679141 | 4 | CGGCCGCACGTTTTAGGACTTTGAAGACTCAACCAGCTCCGCTCGGTTCT | Hypo | TRUE |
| ASAHL | cg10682057 | 4 | GTCAGGGACCTCCAGGCCCGATGGAGAGTCGGGGCGGGCTAGTGGATGCG | Hypo | TRUE |
| BST1 | cg06000781 | 4 | TTTTGGTATCCAGGAGGTTCCTGGAACCAATTCTCCATGGATACCTACCG | Hypo | TRUE |
| CXCL2 | cg16890267 | 4 | CGCTGCCAGTGCTTGCAGACCCTGCAGGGAATTCACCTCAAGAACATCCA | Hypo | TRUE |
| DKFZp686L1814 | cg16854524 | 4 | CGAGGTGAAAATGGCGGATCTTTCGAAATACAATCCCGGCCCCTGACATA | Hypo | TRUE |
| EREG | cg19308222 | 4 | CTTAACTTGAAGTCTGTCAGTGATTCAAGCGCCCTCCTTGCATTGAAACG | Hypo | TRUE |
| FLJ21511 | cg04005707 | 4 | TCGGTTCGGCAAGTGGGTCAGTTGGCTGGGGCTCACTTGGCAACGGGACG | Hypo | TRUE |
| FLJ30834 | cg14654731 | 4 | CGGGCAGGAGCAAACTCGAGTACCAGTATGCCCTAAGTACCCTCTCGCTA | Hypo | TRUE |
| GAB1 | cg01601573 | 4 | GAGACTTCAAAATGTCTCAGAGATAGGACCCAACCAAATCCTTGGCCTCG | Hypo | TRUE |
| GPR125 | cg23337382 | 4 | CGGAGGAAAGTTCGAGTCCAAACTCCACCCGCGGTGGCCACTCTCCTGCT | Hypo | TRUE |
| GPR78 | cg10189695 | 4 | CGCGCTTCTGTTCCGGGCCAGGTCAGTCCCTGCCCTGGTCACACCTCCAG | Hypo | TRUE |
| GRIA2 | cg25148589 | 4 | CGGCAGCTCCGCTGAAAACTGCATTCAGCCAGTCCTCCGGACTTCTGGAG | Hypo | TRUE |
| HHIP | cg14580567 | 4 | CACAGCCTCTCATGTTTCGTTCCCTCTTTTCTTCTTCTTTTTAACTAGCG | Hypo | TRUE |
| IDUA | cg21459867 | 4 | ATTCCTGGCCCTAAGGGTCATTTTATTAGTCACTGAACGCACGGGCAGCG | Hypo | TRUE |
| KDR | cg17286640 | 4 | AAACTGAGGCTCAGAGACTGGCCCAAGATTACCCAGCGAGTCTGTGGTCG | Hypo | TRUE |
| LETM1 | cg04794887 | 4 | TTTCTACTCGTGGGTGCAGGACTTAGTCCCAGAAAAGTTCCGGACACACG | Hypo | TRUE |
| LRPAP1 | cg25201363 | 4 | CAACCCATGACACTCTAGGAAATTCACAGAGCCAAAGTTAGCATAGACCG | Hypo | TRUE |
| MAB21L2 | cg26218269 | 4 | TTTCCTTCTTCTCCTCTAGCTTGCTTTTACAGATTCCACTTTCTGAGTCG | Hypo | TRUE |
| MRFAP1L1 | cg10203523 | 4 | GATGCACACAAATAAGCGGCCTACAAAATGGAGTCGCAGCCGTCAACTCG | Hypo | TRUE |
| NAP1L5 | cg12759554 | 4 | TCCAGAGCCTGAAATTCCTTATCAAATTTGGCTTCTATCTTATCGCATCG | Hypo | TRUE |
| PDHA2 | cg27108154 | 4 | CGGGATGCCACCAGCACTCTGCGAGCTGATTTCTGGGCAACTCGCCTCAA | Hypo | TRUE |
| PGM2 | cg18081881 | 4 | CGCGCCAGGCACATGTCAGATGCTGGGATACCAGGAAGTGCACCCAGATA | Hypo | TRUE |
| PIGY | cg24892074 | 4 | CTGCGGTGAGGCCTGGTCTCCGGCTGCCAGACCATGCTGAGTGGAGCACG | Hypo | TRUE |
| SET7 | cg25903375 | 4 | GGGGATCGGGGTGGCCAAAACTGGGCTAGGGGATTGCTCCGCGGAGTCCG | Hypo | TRUE |
| SH3TC1 | cg02635407 | 4 | CGTGTGCCTGTCCATGTGTGCACACACTTGTGCTTGTGAGTCTCTGTGTG | Hypo | TRUE |
| SLC34A2 | cg21200703 | 4 | CGGCCCAAAGCCAGCCAAGTTCCTTGAAGTCAGCACCGAGAGGTATTTGC | Hypo | TRUE |
| SMARCAD1 | cg26226968 | 4 | AACCTTCCTGTGTGTTCTTAATCCTATCAGCTTCCTCTCAGCTGGGATCG | Hypo | TRUE |
| SRD5A2L | cg14838256 | 4 | TCTTCCAGGACCTGATCCGCTATGGGAAAACCAAGTGTGGGGAGCCGTCG | Hypo | TRUE |
| TACR3 | cg05389335 | 4 | CGCATTTCATTCATTCGCTGCAAGCAGCTGGAGCTTGGCAAGCTGACCCG | Hypo | TRUE |
| TETRAN | cg05209463 | 4 | CGGCTATTTTTTGTGCAATCCCCGAAGCCTGCGTTTCCTGCTGCCTGGGT | Hypo | TRUE |
| TKTL2 | cg16413535 | 4 | CTCCCTGTCCACGCCCAGCTGAATGGATTTTTAGTATTTACTTTGTCACG | Hypo | TRUE |
| TLR10 | cg23855121 | 4 | CGCCTGTAGTCCCAGACATTTGCGGGACTGAGAAGCCCAGCCTCTTGCGG | Hypo | TRUE |
| TRIM60 | cg07485777 | 4 | GAAACCCAGTCTCCACCAAAAAATACAACAATCAGCTGGGCGTGGTGGCG | Hypo | TRUE |
| UBE2D3 | cg16746737 | 4 | CGGCTCCCAGTCCCTGAAAGCATTACCGGGTTCGCTAGGCTCACAGGTAA | Hypo | TRUE |
| UGDH | cg22158956 | 4 | CGCGTCTGCCAGGCTTTAGGGCTGCGCGGACACTGGGTGGGTGGTGGGCC | Hypo | TRUE |
| UGDH | cg27406727 | 4 | TCGGCCCACCACCCACCCAGTGTCCGCGCAGCCCTAAAGCCTGGCAGACG | Hypo | TRUE |
| ZNF509 | cg17259741 | 4 | GCAGGAAGGCGGTTCCGGCAAGCCAAGGGGGCGTTGTCGTGATGATTCCG | Hypo | TRUE |
| ADAMTS6 | cg14700821 | 5 | CGACCCAGGACACATGCGCACCCGACGCAGCCCAGGCACATCTGCAGACT | Hyper | FALSE |
| GRIA1 | cg08578734 | 5 | AAGGAATATGCAGCACATTTTTGCCTTCTTCTGCACCGGTTTCCTAGGCG | Hyper | FALSE |
| HAVCR2 | cg19110684 | 5 | TGCTTTTAAGGTGTCCAGATAAAGGTCACACTCCCAGAGCTGAGGCTACG | Hyper | FALSE |
| NR3C1 | cg08818984 | 5 | GACCTTAGAAGGTCAGAAATCTTTCAAGCCCTGCAGGACCGTAAAATGCG | Hyper | FALSE |
| 39878 | cg20126158 | 5 | CGTGCACCACAACTGCCCGGCTGCCAAACAGAAATGCTGATGCCTGGGCC | Hyper | TRUE |
| LOC91137 | cg07611177 | 5 | GTGCACTTCAACTTTTAAAATGCTTGCTCTGGTGGTCCACAGTACTTTCG | Hyper | TRUE |
| RIOK2 | cg14081015 | 5 | CGCGCTGCGTCTTAGTATAGGTCCTTGTTAATAGTTAGAAGTGCTGTTCT | Hyper | TRUE |
| RIOK2 | cg12676081 | 5 | CGTCCCGGGTCCCAGAGTGTGCCTGCTCAGATCCCAGAAAACTTGCAGGA | Hyper | TRUE |
| SDCCAG10 | cg16434546 | 5 | TCCTAGCTCTTCCTGTTGTATGTAGCTGCTCCGTGGCCATAGATTGGTCG | Hyper | TRUE |
| AGXT2 | cg09745307 | 5 | CGTGGTCCCCCATTCTGAAGCAGTGGGAAACCTAGAAGAGATGTACTCTT | Hypo | FALSE |
| ANKRD32 | cg16625901 | 5 | TAAGAAATGTAACAAGGCATACAAACCTTCTAAGCGTGCTTTACCCTACG | Hypo | FALSE |
| C5orf13 | cg03775246 | 5 | CGTTAAAGTCCCTGTGTATGTATGTGTTTATATGTATGTTTCCTTGTAGA | Hypo | FALSE |
| C5orf21 | cg03952109 | 5 | CGTTTTGGAAGGAATCTGCGTTAGACATTGTTATGGAAATTTGAATCCTA | Hypo | FALSE |
| C5orf21 | cg18370979 | 5 | CGGAGATGTTATTAAGTGATGAAGCCGTGATTTGTTTACAGCAATTAAAA | Hypo | FALSE |
| C6 | cg11976616 | 5 | GCCCAGAGGCTCAAGAAATGAGCCTTTCTATCTTTCTACCTTTACTATCG | Hypo | FALSE |
| C7 | cg24382521 | 5 | CGGAAGCTTTGTCTCTGGAAACCACCATTAATTTATGAGGGGAGGATAGG | Hypo | FALSE |
| C9 | cg14606768 | 5 | GATGAGACCCTGCATCCATGCTTTTAAAAGCTTTGCGGATCATTCTAACG | Hypo | FALSE |
| CAST | cg12095491 | 5 | CGTGATATAATTACATAAAGCACTAGCAGCACGCCTGGTGTGGTTAATGC | Hypo | FALSE |
| CATSPER3 | cg08452348 | 5 | CGCCACTCGAGAGTCATTTCTAGTTCACCAGTTGACACTACATCGGTGGG | Hypo | FALSE |
| CATSPER3 | cg20300655 | 5 | AATGCAACAGAATGCCCAAGAGTGACCTCATAAAGCAAGGATTCCCTTCG | Hypo | FALSE |
| CD180 | cg17751569 | 5 | TCTGCTTTTTAGCATCTTTTCTGAAATCTCCAGATGAACAACATTCTTCG | Hypo | FALSE |
| CDH10 | cg01058368 | 5 | TTTCCAAATCCCTTCTCTTGTTGCTTATTGTCACAGGAGTGCATACCTCG | Hypo | FALSE |
| CDH12 | cg15175266 | 5 | CGTGAAGGGAGGCACGGAAAAATGTAATATTTACACACTGTATGCTGTGT | Hypo | FALSE |
| CDH18 | cg03504701 | 5 | CGGGTATAAAATACAAATTTGTATGCAATATTAGATTGCACTTAAAGTGA | Hypo | FALSE |
| CDH18 | cg27043873 | 5 | AGGAAAAATCCAAAGTTCTTAAACAGATCTACAGGATCTACACATGATCG | Hypo | FALSE |
| CDH9 | cg19475870 | 5 | AAATAACACTTACCTTGCTTAACAATGGAACTGAGTTTAGCCCTACTCCG | Hypo | FALSE |
| CENTD3 | cg11136562 | 5 | AGTTGTATCTGTGTCTCTGTCTGCCTCTGAGCCTGGGTTTCTGTCTTCCG | Hypo | FALSE |
| CPEB4 | cg03032025 | 5 | CGGGTTTGGAGTGCTAGTGCAAAGCAATACTGGGAATAAATCTGCTTTTC | Hypo | FALSE |
| CRHBP | cg16545105 | 5 | TGCTGGGCCACGCTGAAAATTTGTGGCTGAGAGCTGGACCCTCGTCATCG | Hypo | FALSE |
| DDX4 | cg15875314 | 5 | CGTTTTGGGAGATATTTTAAATTCTGAAAATTGATTTTGTGCAAGGAGGG | Hypo | FALSE |
| F12 | cg06625767 | 5 | CGGCCCTCAAGGGGTGACCAAGGAAGTTGCTCCACTTGGCTTTCCACAAA | Hypo | FALSE |
| FLJ21657 | cg06597095 | 5 | GGCCATTCAGGTATGAGAAGAACCTAGGCTGGGCACAGACTACACAGACG | Hypo | FALSE |
| FYB | cg27606341 | 5 | AGTGGATCTTCCTGGGCCAGGGTCTGGGCCCTACTCACTTCTAGCTGTCG | Hypo | FALSE |
| GABRA6 | cg07592353 | 5 | CGGCCGGGATTTGGAGGTAAGAAGCTGCATCTTTGCTACACAAACACCTG | Hypo | FALSE |
| GCNT4 | cg11743470 | 5 | ATTTTTGGCTCTGTGGGCCATATTGTCTCAGTCACAACTACTCAATTCCG | Hypo | FALSE |
| GCNT4 | cg19297823 | 5 | CGGGCGGAATTGAGTAGTTGTGACTGAGACAATATGGCCCACAGAGCCAA | Hypo | FALSE |
| IL5 | cg26081812 | 5 | CGCTCAAGACAGGCCTGAAGTCAGGCTTCTAGGCTGCAACATAGAGCCAC | Hypo | FALSE |
| JMY | cg17758148 | 5 | CGGAACCCTAAAACACAGAAGCAAGAGGGAATGAAAAGCATTGACTGCTT | Hypo | FALSE |
| KIF2 | cg03338064 | 5 | GCCCGAGGTGGGTGGATCACTCGAGGCCAGGATTTCGATACCAGCCTGCG | Hypo | FALSE |
| LEAP-2 | cg12576844 | 5 | AAAGGCCTCTGCAATGTTGTCACACTCATGAGGATGAATGGTCCTTTCCG | Hypo | FALSE |
| LECT2 | cg21783004 | 5 | TTTGTAATGTCTTCTCAACCCACTATTATGTTTCCCTCATTAAAGAACCG | Hypo | FALSE |
| LHFPL2 | cg06759890 | 5 | CGGGAGCCCTGTCCTAAAAGTGCAGCAGCAACCAGGACAGTGCCCCCTGG | Hypo | FALSE |
| LRAP | cg11769360 | 5 | TGTTAAAAACATTCAACATGCAATGAATTTACACACCTGCCTTCTGCTCG | Hypo | FALSE |
| LTC4S | cg11394785 | 5 | CGAGGTAGCTCTACTGGCTGCTGTCACCCTCCTGGGAGTCCTGCTGCAAG | Hypo | FALSE |
| LTC4S | cg16361890 | 5 | TCTGCGGAAGCCCTTCCCAGTGCCTTTGGCTTCAGAATGGAGTCCCAGCG | Hypo | FALSE |
| MAPK9 | cg21169285 | 5 | ACTTACAGCCACATTGTCTTACATACCAATAAGTTCAGAACTCTCTTACG | Hypo | FALSE |
| MYOT | cg04956382 | 5 | CCTTCCCTTCAATAGTGGGTTAAACCCAGCTGGCACCCTCTGGAACTACG | Hypo | FALSE |
| PCDHGC5 | cg17108383 | 5 | CGCATCAGAGTGGTGGCATAGATCTTTTGGTCTGGGTCTTAGGACTCATA | Hypo | FALSE |
| PDE4D | cg05992340 | 5 | CGTAGGAGACAAGAAAAATATTAATGACAGAAGATCTGCGAACATGATGC | Hypo | FALSE |
| PDE4D | cg13112511 | 5 | CGGTAGCACTGCGTTAAAGTGACCATACATGAATATGTGCCTAAGAAAGA | Hypo | FALSE |
| PJA2 | cg17225169 | 5 | CATGTTGGCCAGGTTGTTCTCGAATTCCTGAGCTCAAACTGATTTGCTCG | Hypo | FALSE |
| PMCHL1 | cg12530080 | 5 | ATTCGGTAATATAAAATCCTTGCTGGCCAGCCTGGCTTTAGAATACTTCG | Hypo | FALSE |
| PMCHL2 | cg16794882 | 5 | CGCTTATGGATACCATAGTTTAGTAAGGAAGCAGAGAGTTGGCAAAAATA | Hypo | FALSE |
| PPP2R2B | cg17342759 | 5 | CGGGTTATCTGATGGAAGTAGTATAGAGTCATCATTAAAAGTAGAGACTT | Hypo | FALSE |
| PRLR | cg17397493 | 5 | GGGCTGCATGTTGTTCTGACTTTTCTTCTTCTTGAAACCACACACAACCG | Hypo | FALSE |
| RAD1 | cg06466479 | 5 | CGCCATCATATGGCTGTTGTTGTGCTTATGTTGAGAGGTGCTTTGGGGTT | Hypo | FALSE |
| SFRS12 | cg14787704 | 5 | CGGTTTTTATTGACAGAGCTCTGATAGTTGTTCCTTGTGCAGAAGGTTGG | Hypo | FALSE |
| SPATA9 | cg07948472 | 5 | GTAAAGGAACTCTAGGGGATCTTATTCCCAATTGTTCCCACACCCATACG | Hypo | FALSE |
| SPINK1 | cg16360372 | 5 | CGCAAAGGTTCTGAGGCTGACGCTGGTTTGACATGTTTGAGAAACATCCA | Hypo | FALSE |
| SPINK5L2 | cg26851800 | 5 | CGAGCAAGTACAGATCCACTCCACTTATTGAGAAGTTCATGTTGTCTAGG | Hypo | FALSE |
| SPINK7 | cg27488807 | 5 | CGGTGCCACACCCTGGGCTGTGTTACAGTCCTTGTTACTGAACTGCCACT | Hypo | FALSE |
| SRD5A1 | cg16935609 | 5 | ACTTAGTTTTTTAGATCAGTTTGAAACTTCCTTATTTTTCAATAGCCACG | Hypo | FALSE |
| TAS2R1 | cg09532664 | 5 | CGAGACATTGCCAAATGTTCAAGAGTGGCAGAACCACTATGACGGGACAA | Hypo | FALSE |
| ADRB2 | cg19110523 | 5 | GTGGTGGGGACTCGTCCTGCACACTCAGCTTGTCGGGTGCTAGGGGCTCG | Hypo | TRUE |
| APXL2 | cg21433933 | 5 | GTTTCACGATGTTGGCCAGGATGCTCTTGATCTCTTTACCTAGTGATCCG | Hypo | TRUE |
| COX7C | cg20938689 | 5 | CGGACCACAGAGGTTGTGAACCTCCGGATGCTCTGGCCCAACATACCGCT | Hypo | TRUE |
| DHFR | cg07526021 | 5 | GGAGGTGGATTTCAGGCTTCCCGTAGACTGGAAGAATCGGCTCAAAACCG | Hypo | TRUE |
| ERBB2IP | cg07172256 | 5 | GAGCGTACCCATGTTTCTTCTAACAAAGGCACGATCTTGAGGCCATTTCG | Hypo | TRUE |
| FAM71B | cg14376424 | 5 | AAGTACGGCCAGTGGCGAGTTTCAGGCGCAGCTGCTGTTTCTCATGATCG | Hypo | TRUE |
| FBN2 | cg27223047 | 5 | CGGGACCAAATTAGGGGCTGGGAGTTTCCAGATTGAAATGCGCCCTCCAC | Hypo | TRUE |
| FIS | cg04011402 | 5 | CGGTGAGTATTACAGTTCTTAAAGGCAGTGTGTCCAGAGTTTGTTCCTTC | Hypo | TRUE |
| GLRA1 | cg00059225 | 5 | GCAGGGAGCCAACAGACACGCTGGAGTTTAACAAACAGCAATACTCTTCG | Hypo | TRUE |
| GOLPH3 | cg03522216 | 5 | CGCCCCCTGACCCGCGGTCCTGCAGTCCTGCTCCCGTGACGTGCCCTCCC | Hypo | TRUE |
| H2AFY | cg01550148 | 5 | TTGCACATGGAAGCGGTTAGCTACTTCGCTTCAGCAAAAGTTCACTTTCG | Hypo | TRUE |
| HIGD2A | cg07510052 | 5 | AGGCTTCGATGGTTCAAAGGGGACCTCCGGAATCACAGGGCCGGGAGTCG | Hypo | TRUE |
| HRH2 | cg14345676 | 5 | CGCTCTTCTGTCGGCACGTCATCTGCATAGCTGCATTCGCACTGCAAAGG | Hypo | TRUE |
| KCNIP1 | cg08422599 | 5 | TGGGTCTCGGAGGGCCGAGTACCAATCATGAATGAACAGAGCCCGGACCG | Hypo | TRUE |
| MAN2A1 | cg04020816 | 5 | CGGATTGATGAGTTTCCTCAGAGCTAGCGTCCGCTCGCCAGACTCTCCCG | Hypo | TRUE |
| MEGF10 | cg26465611 | 5 | CGCTGCGATTCTCAAGATCTCTGGACCTGGGTAAGAGTTGGGCAAACTCA | Hypo | TRUE |
| MGAT1 | cg21898046 | 5 | GTTACTGACTGACTGCTCACTAACTTGTTTCTACATGAAACCACGAATCG | Hypo | TRUE |
| PCDHAC1 | cg12629325 | 5 | GTCCGGAGCATGGTCCTGGGTCACCGTTGGTGTAGCGTGTTGGTGGAACG | Hypo | TRUE |
| PCDHB13 | cg24435562 | 5 | TAATGGAGCTGCAGCTGCGGTTCTGGTTTGTGCCTTCTTATCCTGCAGCG | Hypo | TRUE |
| PGGT1B | cg08987989 | 5 | CTACAGAGCCAGAATTGTCTCAAAGCGTACTTGATGCTTTTGACCTTGCG | Hypo | TRUE |
| PRKAA1 | cg10786880 | 5 | AGAAACACGACGGGCGGGTGAAGATCGGCCACTACATTCTGGGTGACACG | Hypo | TRUE |
| RHOBTB3 | cg11017269 | 5 | AGCGGGCGGGGGATAAGCTGCCGCTACTCAGGGAGTGCCCGGGAACATCG | Hypo | TRUE |
| ROPN1L | cg22411068 | 5 | TCTAGGGTGTTGTCGGAGTGGCAGTTGGTCCGAATTTCTCCCGAAGCCCG | Hypo | TRUE |
| SLC25A2 | cg26783353 | 5 | CGCCGCAGTTCAGCTGGCGGCAAAAGAAATGCTGTCCTAATCAGTCAGCC | Hypo | TRUE |
| SLC27A6 | cg07103493 | 5 | ATGATGACTGAGAAGCGCAGCGATTTACAGTCTCTACGCACCAGAAACCG | Hypo | TRUE |
| SLC6A3 | cg26205131 | 5 | GAAGGACGCTTTCTAACGGGCCACATTTTGCTGTGTAGACCCAAAACTCG | Hypo | TRUE |
| SMAD5 | cg14181459 | 5 | GGTGGTGGTGGGAGCTATCTGATTCCCATTCCCAGGCCTGGCCATCGACG | Hypo | TRUE |
| SNCAIP | cg04747322 | 5 | GCTGGAACCCTGGAATGGTCTGGGGACCAATGAGATGGCAGCGGTTAACG | Hypo | TRUE |
| TBCA | cg23152667 | 5 | TAGTTTCCCCAAAGGCCCAGGCTGTGGAGACCGGGATAGTGTAACTTGCG | Hypo | TRUE |
| ZFR | cg13954292 | 5 | CGTTCTAGGAGCGGGTATATGTCAGCCAACAGCCGGTAGCCAAAACACAG | Hypo | TRUE |
| ZNF300 | cg19014419 | 5 | CAGAGGCTTTGTTCAGGAAGCAACATGGCTGCTCCCTGGAGCTGTTTCCG | Hypo | TRUE |
| ZNF454 | cg23037403 | 5 | AGCAGCCCTGAGACTTGTGGGAATTCGGCCCAAGGGTTCCCAGGGCAACG | Hypo | TRUE |
| BAI3 | cg09747829 | 6 | CTGATAATCTGGGAACAGCTGTCATCACATTATTTCTCTCCTCTTAAACG | Hyper | FALSE |
| BTN3A2 | cg14345882 | 6 | CGCTGCCAGTGGAGTACATATTCTCTGAAGCTAGACACTCCATAGGCTGT | Hyper | FALSE |
| SESN1 | cg00922727 | 6 | CGGGCTTTCAAATACCGAGTCTTCGGATGGGTTGAATAAGCTACTTGCTC | Hyper | FALSE |
| TRIM40 | cg09196959 | 6 | CGGGCCCCAAATTAAAAGGGCAAGGTGTCATTGTCATGGCCAAAAGCCAG | Hyper | FALSE |
| GLO1 | cg26824091 | 6 | GACAGGCATCTTTGAACCTATTTCTGGGAGTTCTGAAACTACTGTTCTCG | Hyper | TRUE |
| HIST1H2BN | cg18715868 | 6 | CGTCCAATTTCTACCGGGCACCAAGAGCCTGGAACTGTTTGGCACCATCC | Hyper | TRUE |
| PRIM2A | cg16001460 | 6 | CGTGGAACCTGCCAGTAGGGGCTTGCCGCCCAATACGAAATTCAAAATAT | Hyper | TRUE |
| SUPT3H | cg05112986 | 6 | AGGCGTGTGGATGTGGAACCCTTTCTGGGACGGCGAAACCAGCTCTTACG | Hyper | TRUE |
| TTK | cg02966329 | 6 | CGGCTGTTCCTCAGTGCGCCGGTGCACCGGTAAGACAGAACTTACCTACA | Hyper | TRUE |
| AKAP7 | cg13703941 | 6 | CGGACAGCATTTGTGTCTGTCAATAAAGGCATGGGTTATAATGGCACTGG | Hypo | FALSE |
| ARG1 | cg02862362 | 6 | CGGGTTGGCAACTCTAAAAGGATTTTAATGGATTTATGAAACCCCCAGAT | Hypo | FALSE |
| BTNL2 | cg09748960 | 6 | CGCTGTGCCTAAGTGAGGCTGTGACACACCCGGCACACTCCATGGCTTCC | Hypo | FALSE |
| C6orf111 | cg08096038 | 6 | CGGTAATTTCAGGTGCACATTGCCATGTGTAACCCCATAGGGGTTATGCC | Hypo | FALSE |
| C6orf111 | cg12216205 | 6 | CGGCAGATACTAATCCCTCAAATGAAGAACACTGTGAGTTATGGGAGGTG | Hypo | FALSE |
| C6orf118 | cg05799317 | 6 | ACTGGCACCTACTCTGTGCTGGACCTCCAGGTGCAGTTGGGTGGGTTACG | Hypo | FALSE |
| C6orf142 | cg13281868 | 6 | CGGTAAGACATGAGATTTAGCACACACAGATTTATAATGAAATTGACAGG | Hypo | FALSE |
| C6orf182 | cg01747191 | 6 | CCAACATTTATTCACTATACTCCAAACAAATTCACTAGGATCTATCATCG | Hypo | FALSE |
| C6orf182 | cg08550724 | 6 | TCCATTTTCCAAAGTTTTGTTGTTGTCACCTCTACTTATCTTTCTCTTCG | Hypo | FALSE |
| C6orf188 | cg22419732 | 6 | AACTACAGTTTTTGGTTTTCTATTTCCGAGTTACTTCGCTTGGAATAACG | Hypo | FALSE |
| C6orf204 | cg05564266 | 6 | CCACAGTGCTGGCCCAGAATTTTTTATACGAACTAGTTCGTAACTAAACG | Hypo | FALSE |
| C6orf204 | cg15945754 | 6 | TGGGAGGCGGGCTCTGCAGTAGGCCCATCACTCAGAGGTAAGTCGGAACG | Hypo | FALSE |
| C6orf55 | cg10035272 | 6 | CTCACAACTTTTCATTTATTTGTTTCCTATTACTTCTTGATTCTCAACCG | Hypo | FALSE |
| C6orf78 | cg03003256 | 6 | AATAGGCAAGAACTGCCTTATGTAATCACTCACCCATTTGGTCTATTCCG | Hypo | FALSE |
| CGA | cg07981495 | 6 | AGAACTCATAAGACGAAGCTAAAATCCCTCTTCGGATCCACAGTCAACCG | Hypo | FALSE |
| CLDN20 | cg17306637 | 6 | CGTCCTAGACACCCTGGCCTGGAAACTAGGACATCTGCCTCGGGCCTGTT | Hypo | FALSE |
| CLDN20 | cg25106358 | 6 | CGGGCCTCGAGGTTACAACTTTCCCAGGTAAGGAGAATCCCAGGTAGAGG | Hypo | FALSE |
| CLIC1 | cg01578324 | 6 | CGCCAGCACTCCCTGAGCTGCCCAGACTGGTGTCTCAGTAGGTCCTGTGC | Hypo | FALSE |
| COL10A1 | cg07472159 | 6 | AATTTAGATGATGGTCTAAATCCAGTACCCCCTTCAAGGAATTTTATCCG | Hypo | FALSE |
| CRISP1 | cg04201526 | 6 | CGGGAGTTGCTAGACATTTAATGGATAATGGCGATTAAAGATTTATTTTA | Hypo | FALSE |
| DDO | cg26155617 | 6 | CAGCTGAGGCACTAGATTCTTATAGGAGCACAAACCTACTGTAAACTGCG | Hypo | FALSE |
| EGFL11 | cg07465609 | 6 | CGGCAATTGGTGGAAGAATGGCATCCACAACCCTCATCATATGTGGTAAA | Hypo | FALSE |
| ENPP3 | cg20988616 | 6 | CGGAAAGTCTGAAATTTCTGTGACAAGGCTTTTTGTTCGGGGTTATTTTT | Hypo | FALSE |
| EPB41L2 | cg11386709 | 6 | TGACATAAAGAACAACAGGCGGGGCCTGCGGAGATAGCCGATCACATTCG | Hypo | FALSE |
| FHL5 | cg23978322 | 6 | CGGGGAAGGCTGAGTCCACACTGCAAGTCCAGAGAGCAGGGAACTACCTT | Hypo | FALSE |
| FLJ33708 | cg17774418 | 6 | ATCTGCAATGGAAATGATCACTAGGCAATTTCAGCCTTGCAAATCTAACG | Hypo | FALSE |
| GABRR2 | cg06445611 | 6 | GGGCAAGGCTGGCCAGGCTAGTTGTCCCGATTTACTATTTGATACTGACG | Hypo | FALSE |
| GABRR2 | cg13903548 | 6 | CGTCTCCAACTATTTATATCTGCCTCAAATCAAAATGCTTTGGCTGAACG | Hypo | FALSE |
| GCM1 | cg20967220 | 6 | TTACTGCTGGTTCAAGTCCCAGCAGGCTCTGGTCATTTTCTGAGCAGACG | Hypo | FALSE |
| GCM1 | cg26023389 | 6 | CGACACAGTGCTGTCTGCTTCTCCGTAAGAAGTTAGAAGGTAAGAAAGCC | Hypo | FALSE |
| GLULD1 | cg03352153 | 6 | CGGAGAATTGGAAAAGCTAAAGAAAGATATTTCAGTTTTATAATGAAGGT | Hypo | FALSE |
| GPR115 | cg23613030 | 6 | CGGTAGGTTTGGTATTGTTCTCAGCGATGAATACCAGGTTGTAACATCTT | Hypo | FALSE |
| GPR31 | cg12588299 | 6 | CGCTTGCTGGGATCCTTCTGCATGGGGCTTGATTTTACACACTGGTCAGA | Hypo | FALSE |
| GSTA2 | cg03517000 | 6 | CGCAAAGAGGATAGCATATGCAAATAGGGTTCCCGGATTTGTCAGATAAA | Hypo | FALSE |
| GSTA3 | cg02075593 | 6 | GCAATTTTGAGACTTTAAACCCTGCTCACCCTTTGGTCCCAGATACTTCG | Hypo | FALSE |
| HCRTR2 | cg17063201 | 6 | GGCGTCCTTCAAGAATTTGTAGCTCTATTTCACATGACACTTAACTATCG | Hypo | FALSE |
| HIST1H1B | cg03821311 | 6 | CCACAGTCAGAGTGACTTCTTCTGCATTGCAGCACCAGTAATACAAATCG | Hypo | FALSE |
| HIST1H2BK | cg02704907 | 6 | TACAAATATGGGATTCAGGAAATTCTGCATCCCATATTCTCCTTCCATCG | Hypo | FALSE |
| HLA-DQA2 | cg22282941 | 6 | ACACAGACCTCCAGGCTATAGTCTCTGGATATAATATAAACAGAACAACG | Hypo | FALSE |
| HYMAI | cg07018708 | 6 | CGGATCTTGAAATGAGGAGACCACCTTCAGTTATTTCAGTGAGTCCTAAG | Hypo | FALSE |
| IBRDC1 | cg20034100 | 6 | TCTTCTCATGTTTGTGTCCTCCTCTGTATACTAAATAAAGTACACAGTCG | Hypo | FALSE |
| IBRDC1 | cg24298280 | 6 | TATCCTTACAAAAGAGGCTTCAGAGAGCTTGTGTTGCCCCTTCTGTCACG | Hypo | FALSE |
| IL17 | cg27168844 | 6 | CGGTCCAGAAATACTATCTGGTCCAAATCAGCAAGAGCATCGCACGTTAG | Hypo | FALSE |
| IL22RA2 | cg26112901 | 6 | CGGGGATGCAGAAATGAACAAGACTACAGAGCCAGCCCTCAGGGAACCAA | Hypo | FALSE |
| IMPG1 | cg09617773 | 6 | TCCAGCAGCCTTGGCCTCTCAAAGTGGTGGAATTATAGGTGTGAGCCACG | Hypo | FALSE |
| KATNA1 | cg15926557 | 6 | GTACAGATACTTGTTCATTTGGTCAAGAACTCCCTGATAATAGACCATCG | Hypo | FALSE |
| KIAA0240 | cg14378057 | 6 | CGGCTGAATTCATTCAGATGCTGAATGATCTGGGAGATTACAAACCCTGT | Hypo | FALSE |
| KIAA0240 | cg15679095 | 6 | TTGTTTCAGCCCAAGCATAGTCATTTCACTGGCTAAGCTTGACACTGTCG | Hypo | FALSE |
| KIAA0274 | cg01500097 | 6 | CTATTTTTCCCAGTTAAAAGATCCAAGTCCAAAATGCCAGAACGGACACG | Hypo | FALSE |
| LTV1 | cg02885771 | 6 | CGGCATAAAGACACAATCCAGGGTAAGCCATTCATTGAGAGGTCACCAGA | Hypo | FALSE |
| LY86 | cg20162076 | 6 | TATTCTGCTGCAGGACAGCAAGGTTTCTCAGTCTTGATTCCTCAACCCCG | Hypo | FALSE |
| MAK | cg03349251 | 6 | TTCTAAATCCTTTGTTCTTGACTGGGCACTGGTTCATGCCTGTAATCCCG | Hypo | FALSE |
| MAK | cg10965489 | 6 | CGTGCCGTCCCCCAACTGTCTCATGGTTGTGTATCGGTTCATCTTGGAAA | Hypo | FALSE |
| MAS1L | cg01078434 | 6 | CGCCACAGAGCTGAGATACCAGGTTTGGGTTCTGTGCCTCCTGGTCACCA | Hypo | FALSE |
| MEP1A | cg16019620 | 6 | CGGTATTTATGACAAGGTGTGTGCTAAAATCAGCTCACTTGCAGCAATGG | Hypo | FALSE |
| MEP1A | cg20980592 | 6 | CGGTACATATGGAAGGGTCAAAGTTTCTAATACGACCGTCAGGGTAAAGT | Hypo | FALSE |
| MYCT1 | cg02830467 | 6 | GTCCTTTCCCCCAATTTACTATATAAATTTAATTTTCAAGCATTGGAACG | Hypo | FALSE |
| NOX3 | cg21765730 | 6 | TCATGACCTGGGTAAATACAAGGCAAGTCTCTGTCTAATGATTCCTTTCG | Hypo | FALSE |
| OPN5 | cg20906802 | 6 | CGAGGGATCTGAAAAGCAAACCAGTAGAGATCTCAGCAGACCTGAATAAG | Hypo | FALSE |
| OR12D2 | cg04737405 | 6 | CAAAAGACAAAATAATCTATGGAACACTAATCGCAATCAGAATCCTTCCG | Hypo | FALSE |
| OR12D2 | cg21414251 | 6 | TCTCCTCTTGGGAGTGACAGACATTCAAGAACTGCAGCCTTTTCTCTTCG | Hypo | FALSE |
| OR2A4 | cg11884699 | 6 | CGACCAAGGAAAAGAAGAATTTATTTGAAGGATATGAGATAGCTCACTGA | Hypo | FALSE |
| OR2B2 | cg12351042 | 6 | CGGCCAGGAGAAGACATTCTGTGGAACCCAAGGCCAGGAAAATGAAAAGC | Hypo | FALSE |
| OR2B6 | cg03340878 | 6 | TCTTACACTGTGACCATCTTTGGCAATCTGACCATTATTCTAGTGTCACG | Hypo | FALSE |
| OR2H1 | cg02117021 | 6 | CACCAAAGACCAAATTTTAACCCAGGTGGGCTGGCTGAAGAAGCTATGCG | Hypo | FALSE |
| OR5V1 | cg14258236 | 6 | ACTGCTATCCACTGGGGTCTTCATTGGTTGGACTCCTTTCCTTTGTATCG | Hypo | FALSE |
| OR5V1 | cg24076830 | 6 | TGGATGAGAGCACCAAGCCTCAGCAAGATAAACGTCTGGAAGATGTCACG | Hypo | FALSE |
| PGM3 | cg25383093 | 6 | TTTCCTGGGTCAATTAATTCCCAATTAGCCCAGAGATGAGGAGCAGTCCG | Hypo | FALSE |
| PHACTR2 | cg10784341 | 6 | CCTTGCTGGCACACTGAGCATACTTCATGCACTGTCTGCAGGAGACACCG | Hypo | FALSE |
| PHF3 | cg12368241 | 6 | ATTTATATAATTTAAGCCCCAATAATAAACAGGGTCTATTAACATCCTCG | Hypo | FALSE |
| PHF3 | cg18887228 | 6 | CAGGCAAACAGAACTGGTTACTTGCAGATCCTAGCATAGGATCCTTATCG | Hypo | FALSE |
| PLN | cg26205432 | 6 | ATACTCTATACTGTGATGATCACAGCTGCCAAGGTAAGAAACAGATTTCG | Hypo | FALSE |
| RAET1E | cg19979896 | 6 | TGACCTCAGTTGTTCCAGGGTAAAGAATTTGGGCAGTGCCCACACCCACG | Hypo | FALSE |
| RHAG | cg19862344 | 6 | CGGCAATCAGTCAAGCAAAGCTGGAATGTAAAAGAGATGAAGAGAAAAGG | Hypo | FALSE |
| ROS1 | cg21166999 | 6 | CACCACAGAAATCCATAGGCAGCCAAGAGTTGCAAAATTGACAAGCTTCG | Hypo | FALSE |
| RPS6KA2 | cg13217373 | 6 | CGGCATTGTGTGTGGTGTAAATACATAAATGATAATGAGTACAAGAAACA | Hypo | FALSE |
| RTN4IP1 | cg24914244 | 6 | CGCTGCCAGCTGGGAAACAAACAAAACGACAACTTCTAGGGTGGAATAAA | Hypo | FALSE |
| SAMD3 | cg11249120 | 6 | CGGATTATTGCTGGAGAGGCTTTTGGTCCATCTCTTCCAGAAGAGAAGAT | Hypo | FALSE |
| SCML4 | cg02937102 | 6 | CGGATGAGGTCTCACTGTTACAACATGGCCATAATGCATGCTGTCGTGTG | Hypo | FALSE |
| SFTPG | cg09408780 | 6 | CAAGGCATCTGGGGAGTTGTTTGGGGACACACACACCACACACATATACG | Hypo | FALSE |
| SLC17A1 | cg22101098 | 6 | TAAAGTGCTACCTTTTTTGGGAGGCAACCGGTTATCCATTTGCATACACG | Hypo | FALSE |
| SLC17A2 | cg05948654 | 6 | GCCACTGGTACCAATGGACACTGTGGACAATGGTCATTTCTCCAAGGACG | Hypo | FALSE |
| TAAR1 | cg15582891 | 6 | CGAGTGTGGTCAGAATTATGAGCACCATTAAACTGTACAGGGAAGCACGG | Hypo | FALSE |
| TAAR2 | cg09217923 | 6 | TGATCTCAACCACACATGGATGGGACCTCTGGTTCAAGCAGAAGAATGCG | Hypo | FALSE |
| TAAR6 | cg23887102 | 6 | AAAGATCACCTCCTGTTATCTTTATCTCTGTTATCTGTCCTGCATTACCG | Hypo | FALSE |
| TAAR8 | cg07558006 | 6 | CGGTGAACTTGGTAGCATAGACCAGGGGATCAGTAACCACAATGTACCTG | Hypo | FALSE |
| TBC1D22B | cg02187357 | 6 | CGCCAGAGAAAGGCAAGTAAAATAATTAAAAGAATAGAGGGGCTTTTTTT | Hypo | FALSE |
| TBC1D7 | cg09258965 | 6 | CGGATGCCAAGCTTTGAAGGAAACTTAGGACTATCAACAGTGCAGAAGTC | Hypo | FALSE |
| TBP | cg24710073 | 6 | CGGCAGGATTTAAAGCCATTATAAGTATGATTAGAGATTTATCCAGGACC | Hypo | FALSE |
| TFB1M | cg16035531 | 6 | TAACTGTCCCTGTTATTCTTATTCTCTTGTGCTTCGATCTACAGCCAACG | Hypo | FALSE |
| TINAG | cg12397274 | 6 | CGACACAATGAAGACAAAAGTGTGAGTTGAATAAAATAAACAGCAAGGTC | Hypo | FALSE |
| TRDN | cg14462830 | 6 | CGGGAGGTCTGAAAACGAAAAGTATCAAGTTCAAGCTAAAAGATTAAACT | Hypo | FALSE |
| TRDN | cg19478478 | 6 | CGACCACCATGACTGAGATCACTGCTGAAGGTATTGCTACCATTTTCCGA | Hypo | FALSE |
| TRIM15 | cg27091343 | 6 | TGTGGCTGGTGGCTCCTGTATTGGACAAACTAGTTCCTGGGCTGCACTCG | Hypo | FALSE |
| UNQ9356 | cg18582689 | 6 | CGGCAGTTCACCTGGAAAAAAAGGCAGATGCGTTTCTTCTGACAACTTTC | Hypo | FALSE |
| VNN3 | cg22825487 | 6 | CGCTGAGGATTGGGGTACAATGATTGCACCACCCAGCATAGTATACAACA | Hypo | FALSE |
| ZNF323 | cg21750589 | 6 | TCCTCAGTATGGTATTATCTAGAAACAACAGCACCAGCCATCAGGTTTCG | Hypo | FALSE |
| BRP44L | cg14947494 | 6 | ACTATGTCCGAAGCAAGGATTTCCGGGACTACCTCATGAGGTGACGAGCG | Hypo | TRUE |
| C6orf145 | cg24549507 | 6 | TCAAACAAGTGCTATTAATTCTCTTCCAACTAGGAACGGCCTCAGTAACG | Hypo | TRUE |
| C6orf146 | cg15637528 | 6 | CGGCTCCCTTGAGACACGCGCCTTCAAGCACTCTGGCCCCTAAAGCTCCT | Hypo | TRUE |
| C6orf66 | cg11787828 | 6 | GGGGTGTCTGGGAGCGACAGAGGGCTTCATCTTGCTGATTTCCCGTTCCG | Hypo | TRUE |
| CCNC | cg06667091 | 6 | TGCTCTGTAAGTTTGCACTTTATCACTCCAAAATAACTCCATTAAGATCG | Hypo | TRUE |
| COQ3 | cg24831427 | 6 | CGCCCGGCCTGCAGCCGACTTTCATGATTGTATTGTTGAGTGTTATGTAT | Hypo | TRUE |
| DNAH8 | cg15933546 | 6 | CAGATGATCATGAAGCGGATCTGAATAGAGTTCGACAGAGGCTTGCACCG | Hypo | TRUE |
| DNAH8 | cg24760768 | 6 | ATAGAGTTCGACAGAGGCTTGCACCGCGACCGGTTCAGTCAGTGATTTCG | Hypo | TRUE |
| FKBP5 | cg08636224 | 6 | CGAGGCTCTTCATAAATGTTTGAATGCAGTATAGTGCAAAGAGAGCAGGT | Hypo | TRUE |
| FOXC1 | cg04504095 | 6 | CGCGCTACTCCGTGTCCAGCCCCAACTCCCTGGGAGTGGTGCCCTACCTC | Hypo | TRUE |
| FOXQ1 | cg19899882 | 6 | CGGCCCTGGGGCAAGGACAACTACTGGATGCTCAACCCCAACAGCGAGTA | Hypo | TRUE |
| GFOD1 | cg23640903 | 6 | GGGGGAGTCTCCTTTCTTCCTAGCTCTCCGTTGGGAATGAAATAATCCCG | Hypo | TRUE |
| GPR126 | cg11176095 | 6 | TTTTCTGCCACTTTCTTTACTTAACTTTTCTGTCTTCTCTGACTAGTTCG | Hypo | TRUE |
| HIST1H1T | cg19515446 | 6 | GCACTGGCAGAAGCTGCAGGCACGGTTTCAGACATAACAACAGAGAAACG | Hypo | TRUE |
| HIST1H2AA | cg02854090 | 6 | TCTGATTGGCTGATGGCCGTCTACCCAATCAGAAAGTCGTACTAGAATCG | Hypo | TRUE |
| ID4 | cg00468146 | 6 | TCCACTTTGCTGACTTTCTTGTTGGGCGGGATGGTGGGCACCAGCCTCCG | Hypo | TRUE |
| IL22RA2 | cg09855435 | 6 | CGCCACTGCGCTCCAGTCTGGGCAGCGATAAAGCGAGAGTCCATCTCAAA | Hypo | TRUE |
| LRRC1 | cg15286372 | 6 | CCAGGCGCTACTGGATTCGGTGTAGTTTTGAGGTGTTTGCACCACCCTCG | Hypo | TRUE |
| ME1 | cg06836736 | 6 | CGGCCGGAGCCCTTGGCTCCATAGGGCCTCTGCCCACCATGGGCTTATGA | Hypo | TRUE |
| MLLT4 | cg13325666 | 6 | AGGTCCAGCCGGTTGGCGTTCCAGTGGTGGATGATGTCGGCCAGCTTCCG | Hypo | TRUE |
| MOXD1 | cg07570142 | 6 | CTCGGAGGGCAAGTACTGGCTGGGCTGGAGCCAGCGGGGCAGCCAGATCG | Hypo | TRUE |
| NEU1 | cg14976276 | 6 | AGCTAGACTCCACAGAGTCGGGAGTCAGCTGACCCGGACCCTTTAAAGCG | Hypo | TRUE |
| NR2E1 | cg19697981 | 6 | ATGCTTAAATTTCCACTGTTGGACGAATTCTGAGCGCCCAGGGAGCAGCG | Hypo | TRUE |
| NRM | cg16979445 | 6 | CGGTATCAATGAAAGTCACAGTTTTTATTGAGAAAGTCCTCTCGCCGGGC | Hypo | TRUE |
| NT5DC1 | cg25179963 | 6 | GCAGGTTGTAGCGACACAGAGTGTGGTCCAGGTCGAATCCGACCACGTCG | Hypo | TRUE |
| NUP153 | cg08620270 | 6 | CGGACCCCCGCCTCTGTGTGTGTCACGGTCTCTATGGAGATCTCCCGCAG | Hypo | TRUE |
| PPIL6 | cg21273098 | 6 | TGCTGGTGAGTGCGTCTGCGGAGTGCGGTCTGGGGGCCACCTTCCGTTCG | Hypo | TRUE |
| RAB32 | cg04113075 | 6 | GGATGGGATGGGCAGTAGGAGTTGGAGCAGGTCCTGCACGCCAGAGCTCG | Hypo | TRUE |
| SMPDL3A | cg02275989 | 6 | CTGAGATGCAGGATGTAAACAAAAGCCAGGCTGGCGAAATCCGGCCGACG | Hypo | TRUE |
| TAAR6 | cg12813797 | 6 | CGTTATGAGCAGCAATTCATCCCTGCTGGTGGCTGTGCAGCTGTGCTACG | Hypo | TRUE |
| TRAM2 | cg12963312 | 6 | CGCCCGCTGCCATGGCTTTCCGCAGGAGGACGAAAAGTTACCCGCTCTTC | Hypo | TRUE |
| VIL2 | cg20291674 | 6 | GCAGTCACAACCGTCAAGCCTTTGAGAAACTCTTTCAAAAACTGCAACCG | Hypo | TRUE |
| WTAP | cg24909975 | 6 | TCTAAGTTCTCAAAACTTACAGGTGAGCTTCTGCTAAGAGTAAACGCCCG | Hypo | TRUE |
| YIPF3 | cg19506903 | 6 | GCGATGTCCAGAAGTGTCTTGGGGATTCCCCCTCTGGGCCTGGAAGTCCG | Hypo | TRUE |
| TFEC | cg15339605 | 7 | CGATCTAGCCGTGAGTAATGAATACTTTGGGCTGGTTGGAATCCAGTTAG | Hyper | FALSE |
| CLDN12 | cg18967846 | 7 | CGAAACAAAACTAAAAGTAGTTTTGAGTTGGATACCTAAGTACCCAGGTG | Hyper | TRUE |
| DNAJB9 | cg20807701 | 7 | CGTGAAGTGGGGAAAAGACTGAAAACCACAGAAGCCCGCGCAAACTTTAC | Hyper | TRUE |
| GTF2IRD1 | cg14120784 | 7 | CTGCCATGCCCAGTCTAGCCAAGGTCTAGTTCAGGGATCAGGGCACCACG | Hyper | TRUE |
| PEG10 | cg23096644 | 7 | CGGCAGCATCTCTGGCCTCCAGCCGGGGTTAACCCTGACCTGAACGCCCT | Hyper | TRUE |
| PEG10 | cg07236943 | 7 | CGTTGCAAGGGAAGCAAGGTCTCTGTGTAAACCTCGTAATCGCCACCAAA | Hyper | TRUE |
| PTHB1 | cg09080746 | 7 | CGTCCCGGGCAAAGAGAGAGCCCCACCAGGCAGCACCACCAGCTCCACAG | Hyper | TRUE |
| AASS | cg06667406 | 7 | CGGGTTGTATTTTACCTCAGATTTCTCAGGAGACCAGAACTGATCTGCCA | Hypo | FALSE |
| ABCB4 | cg04737046 | 7 | CGATACAGATGGTATTTAAAGCTGTGTGACTGACTGACATGACAGAAGTG | Hypo | FALSE |
| ABCB5 | cg22066521 | 7 | CCATAGCAGTTATTGCATTGGAGCAGCAGTCCCTCACTTTGAAACCTTCG | Hypo | FALSE |
| AGR2 | cg21201572 | 7 | CGGTCCAAGCTTCTGAGTGTGCCAGCACAGCTGAGTCTCTATTTATGCAC | Hypo | FALSE |
| AGR2 | cg24426405 | 7 | CGATGGGCAGAGTGCCAAATCCAGGTAGACTTTGAATGAAGACATTTGAT | Hypo | FALSE |
| APS | cg05253159 | 7 | ATCCCAGCAGTGGAGTTCAGCCCACTACTCTGAACCAGGTTAGTCCACCG | Hypo | FALSE |
| ASB4 | cg09375488 | 7 | CGGGGGCTTTCGTTCATATTGACACTATATATTACTGAATGGATCAGTTA | Hypo | FALSE |
| ASB4 | cg11554605 | 7 | CCTTTGGATCAAAATAGCCTTCAATTTTCCGAAGTCATTGGACTTTAGCG | Hypo | FALSE |
| ASB4 | cg25692621 | 7 | CGGATCAGCATAACTTTGGGATAAAATTAGCCGACAGTTTGTGGACTCTC | Hypo | FALSE |
| BCMP11 | cg21041127 | 7 | AAGTAGCCATAGACACTAGTAAGCAAATGCACATGGCTGCATGCCATCCG | Hypo | FALSE |
| C1GALT1 | cg13109289 | 7 | CGGGTTAATGATGTCACACAGACAAACAGCTAAAGGACAGAAACTTGGAG | Hypo | FALSE |
| C7orf33 | cg25043279 | 7 | CACTCCATGATACTCCTGACAACAAATAGCATTTTAACCAGTAATTTACG | Hypo | FALSE |
| C7orf33 | cg26866014 | 7 | CGGAAAGTCAGCTGGAGCTTGTCCTCCATGTAATTCAGATCACGTTGCCT | Hypo | FALSE |
| C7orf9 | cg27356438 | 7 | CGCTGTATGCTTGCTAAGTACCATACTCACCAGTACAATTGTCATGACAG | Hypo | FALSE |
| CD36 | cg18508525 | 7 | CGTGAAAAGCATAAATGCAAGAAATGAGAAATCTCCGTGGCTGGAGTGGT | Hypo | FALSE |
| CLCN1 | cg17922226 | 7 | CGTGGTGATGTGTTCAAAATATGAAAATCTTTGAAAGTCTGGGCTCACTT | Hypo | FALSE |
| CPA2 | cg22213042 | 7 | CGTGAGTTCTCAGAAGGCCAGCAGATCACCCTCAGCTGCCATCCCTACAA | Hypo | FALSE |
| CPA4 | cg00845900 | 7 | CGGCAAAGAAAACAGAGAGGATCAGTGGGATTACTAAGAGAAGACATCAA | Hypo | FALSE |
| CROT | cg15350036 | 7 | ATTTAAAAACTTTATCTTGTAAGCAAACTTTAACATCATCCAGAGCATCG | Hypo | FALSE |
| CYP3A43 | cg13364756 | 7 | CTTTGTCTTACTTTACCTACCTGAATAAGCACATAGTTTACCTTGGCACG | Hypo | FALSE |
| CYP3A7 | cg06459378 | 7 | CGGCAGGACTTTTGAAAGCTACAGAGGAAGAAGCACAAATTGATGCTATT | Hypo | FALSE |
| DPP6 | cg06434470 | 7 | CGAGTGTTGATATATCTGCAACAGACAAAAAGGAAAAAAGGTAGGCATTG | Hypo | FALSE |
| DUS4L | cg19770955 | 7 | AAAATAAAGCCCTTCTCACCTGTTCTTAATTTTTTCTCTAGTGGCCATCG | Hypo | FALSE |
| Ells1 | cg01541443 | 7 | CGCCTACTCACAGGCCGATCTGGGTAAAGAATGTCTTGTTCCAAGTTAAT | Hypo | FALSE |
| ERV3 | cg27542948 | 7 | CGATGGAACCAAGGTGCCAGTGAGATGACAACAGCCCTGCTCTGGTCACT | Hypo | FALSE |
| ERVWE1 | cg21736205 | 7 | TCGACCTTCCCTGAGGACTGTGGCCTTCAGGCGCAGTGTAAGTGATATCG | Hypo | FALSE |
| FLJ39575 | cg11161873 | 7 | CGCCTGCTACAGGATATTTATATATGGAAGCATACCATGGCAGGAGTGCT | Hypo | FALSE |
| FLJ40288 | cg24469977 | 7 | CGCTACTAGTGGGCAAGATCTCCATGCATTAAGGTCTCCATGTGGTCTGC | Hypo | FALSE |
| FLJ44060 | cg08489623 | 7 | TATCTGGATGCCATTGCTAATCAATTCACTCATTATCTTATTCTTAAACG | Hypo | FALSE |
| FOXP2 | cg05232889 | 7 | TCCCACCCCTCTCTAAACTCTTACAGATATTCTCTTAGCAAAAAGTAACG | Hypo | FALSE |
| GHRHR | cg05058973 | 7 | CATGTCTGGTGTTCTAGCACGCAGCCCAGCAGCTTCTGTGAGTGGAGACG | Hypo | FALSE |
| GPR141 | cg24995381 | 7 | TGGCACTGTCAGCAGAAAAACGCTGTGGACCACCACCAAGTTAATGACCG | Hypo | FALSE |
| GPR22 | cg24648061 | 7 | CGGATATGATAGTGGTTGGTACATATTGGTGTTGATGTCATCAATGTCAT | Hypo | FALSE |
| GUSB | cg18219226 | 7 | CGGCCATAGCCTTGACCCTGGGCTTCTGGAGCCCTGACCTTAACCCAGGG | Hypo | FALSE |
| HIPK2 | cg25274750 | 7 | CGCCTCTCCTGAGAGCCACAGGCCCTTCAGAGGAGGAGTCAGTAATGGCA | Hypo | FALSE |
| H-plk | cg00245878 | 7 | TATGATTAACTGCCTTTGTTCTGCTTCTGTAAGACTGCTTTCTCACCTCG | Hypo | FALSE |
| HYAL4 | cg05341115 | 7 | TGAGCCACCGTGCCTTGCTATTTATGCCATCTATTTCACTGAAGATTCCG | Hypo | FALSE |
| IFRD1 | cg20891917 | 7 | CGAGAGCGGGATCTGTTATAAAGAAAGTGATTTATTCCAAAGCTTAGCTT | Hypo | FALSE |
| INHBA | cg11079619 | 7 | CGGCTGGTGGAAGAGTGGGGACCAGAAAGGTAATGCTTTTTAACTCTTAC | Hypo | FALSE |
| INHBA | cg16415646 | 7 | ATGTCTCAATGAGTGTGTCCAACTTTCAACTTTTACTACTCGCACACACG | Hypo | FALSE |
| KEL | cg02774963 | 7 | TTGCTTCTATAACTTCCCAATAAATGCTTGCCTCTGACATTTTGTCATCG | Hypo | FALSE |
| LOC136263 | cg05343453 | 7 | GCACAGAAATCAAGGTCACAATACAAGGGGGCCGTCTGCAAGGAGACCCG | Hypo | FALSE |
| LOC136263 | cg06981910 | 7 | AGAACACCACTGACCAAATGACAGCATTATGTATTAGGGCTGCCATAACG | Hypo | FALSE |
| LOC253012 | cg11608424 | 7 | CGAGGATTCAGTTTTGGGAGCGTTCATTTTGAGATGCCCATTAGACATCT | Hypo | FALSE |
| LOC346673 | cg11649846 | 7 | CGCAGCCCTTGACCTAGGGTCGCTCAGGGCTTTAAGGAAATTGTCACCAC | Hypo | FALSE |
| LOC54103 | cg26594488 | 7 | CGTGTTGGTAATGTTAAATGTTTTGGGTATACTGATATACTCTGCAATAA | Hypo | FALSE |
| MGAM | cg01476044 | 7 | TTTTAAAACAACTTCCTTCCATCACAATCATCAGATTGTGCTACTAAACG | Hypo | FALSE |
| NEUROD6 | cg11554507 | 7 | CGGTTTCACTGGCAATCTGTAGAAATAGCTGTGTTAGTGTTCAGTTTCGC | Hypo | FALSE |
| NEUROD6 | cg26312920 | 7 | ACATTGATGCCAACTGCCAGAGCTGGTACCCATGCCATCTGCTAGTGACG | Hypo | FALSE |
| OPN1SW | cg21230435 | 7 | ATATCCAGATTATTTGAGCCCAATCTCTTATCCTCTGAAGAACACAATCG | Hypo | FALSE |
| PARP12 | cg24435704 | 7 | CGAGAAAAGATGGCTGTACAGAAATGTCTAAATAATCAAGTTGAATGATC | Hypo | FALSE |
| PCOLCE | cg02797569 | 7 | GGGTCCTCAAGACAGAGGCAGCAGCTGAATTTTGCAGAGCAGCAGCAGCG | Hypo | FALSE |
| PILRA | cg06762858 | 7 | AGGGGCAGCAGCAGGGGCCGACCCATGGCCTTGTTCTTCTCCAGGGGACG | Hypo | FALSE |
| PIP | cg15542496 | 7 | CGCATGAGACAAGTGTAAGAAAGTGGCCATGTCAATAAGAAAATAAGCCA | Hypo | FALSE |
| PLXNA4B | cg06084117 | 7 | CGGCAGCCTCGGCAAGATCTGCTGTTCAACTCAGTCCTTCAACAAAGGCA | Hypo | FALSE |
| POT1 | cg10569616 | 7 | TATTAAACTATACCAATAAATTATTAACACCTTCTTTCCAGTTTCACTCG | Hypo | FALSE |
| POT1 | cg21792432 | 7 | AAACATCTTCAACATCTACAGCTACAATATAGCCACAGATGACAATAACG | Hypo | FALSE |
| POU6F2 | cg04748010 | 7 | CGGAAGATCTGTGGCTAAGTCAGAGTCAGAACCTAGTTGTTTAGTGTTCT | Hypo | FALSE |
| POU6F2 | cg26180557 | 7 | CGCCCGGCCCAACTGTATTATTAACTAGAATGGGGACTTAAAAATGTGAT | Hypo | FALSE |
| PPP1R3A | cg00967316 | 7 | TTCTGTGTGGAAAATGTCCGTCCCTAAGTCAAAAGTGGTTGAAGCACTCG | Hypo | FALSE |
| SLC26A3 | cg04996020 | 7 | AGTACACGTGAGCATCTGCTGTGCAATCTCTGCAAACCAATGAAATTACG | Hypo | FALSE |
| SRI | cg02399455 | 7 | CGCAAAGTTTACACAGAACCAGAGATAAATAGAGAAGCCAGACTTGTGGA | Hypo | FALSE |
| STYXL1 | cg06772202 | 7 | AAAATAAATACAAATGCTCCTGGATTGATGGCTACTTCCCATACCCATCG | Hypo | FALSE |
| TAS2R38 | cg03017475 | 7 | GCAGAACATGCAGGCTTGTTACATAGGCATACACCTGCCATGGTGGTTCG | Hypo | FALSE |
| TAS2R4 | cg06244634 | 7 | TCTGGTTTGGATTCTAAGTTTTTGGAGCCTGCTGTGACTCTTCCCTCTCG | Hypo | FALSE |
| TAS2R5 | cg17560179 | 7 | CGGTGTACTAGGCACAGGGGACGGCGCCATTATAATACACAGTCCCTGCC | Hypo | FALSE |
| TAS2R60 | cg15905634 | 7 | CGGGGAGTAGTATGGCAAGACCCCTTTAACTGAGACAGAGAGAAAACTGA | Hypo | FALSE |
| TSGA13 | cg11058932 | 7 | CGGGTCTTGTCTGCCTCTTAAGCTGTGAGTCCCTTAAAAGTGGAAATGTA | Hypo | FALSE |
| XRCC2 | cg23126915 | 7 | ATTTCTTTTTACCTCAGATTCATGTTTTCTACCTTGGCCTCTTCTCTACG | Hypo | FALSE |
| ARL4 | cg13140740 | 7 | CGCCCAGTCCTCTGCCATCGCCCACGCCTCCCTGGTGCCAGGGAACAGGT | Hypo | TRUE |
| C7orf20 | cg04220579 | 7 | AGCATTTTACACATTGAACTGTATAGCTCAATGGCTGCTGTTACACCGCG | Hypo | TRUE |
| CASP2 | cg09243021 | 7 | GGCTGTGATGTAGGTTTCGGTCGCTGGAAGCTGCTAAACCATAGCTGACG | Hypo | TRUE |
| CHN2 | cg11185569 | 7 | CGGCCCCCAGCCCATGGCAAAGTCCTGGGGACGCGCAGAAAGCACCAGCC | Hypo | TRUE |
| CPA5 | cg11063110 | 7 | AATCGCCAGTGACAGTTAAGTGGCCTATTGTTGACGTCCTCTGCTGAACG | Hypo | TRUE |
| CYP51A1 | cg24896109 | 7 | CGGGGCCGGAAGATAACTTACCTGAAGAGGCGATCAATCCCTGAGAATCG | Hypo | TRUE |
| DBF4 | cg04525773 | 7 | GAAATGTCCTTTACTGTGGATCCTCATGGCTCCGGAGTTCATGGCAGTCG | Hypo | TRUE |
| DDX56 | cg14450506 | 7 | TGCTTCCCTCTTCTACACTGAAAGACTTATGGGCCAGGAGCAGTGGCTCG | Hypo | TRUE |
| FASTK | cg26975609 | 7 | GGACAAGTGGCTTCGTCTCTCTAAGTCTCCTCACCCGTGAAATGAAAACG | Hypo | TRUE |
| FLJ32110 | cg27319898 | 7 | CGGGCCAGCGATATATTTATTTAAGGACAACTTCCAGGGTCCACCAGGGA | Hypo | TRUE |
| GNG11 | cg22983529 | 7 | TGAGGGTTAAGTTTGAGACTGGGTCCAAGCAGCTTCCCGCTGCTCAATCG | Hypo | TRUE |
| GPNMB | cg22932819 | 7 | TTCCTATACTGCATCAGGCACCCAGCTCACGTTTAGAGTTCACAGTTACG | Hypo | TRUE |
| HECW1 | cg17628717 | 7 | CGAGGAAGATGCTCTATGCCATGTTTCATATCTGCCCAGCAGGGCAGCTC | Hypo | TRUE |
| HECW1 | cg21070087 | 7 | TGCTGACCATGAGCGTGGAGCGGCTGTCCGAGGTGACCAGGTCAGTGTCG | Hypo | TRUE |
| HLXB9 | cg20899053 | 7 | CGGCTGAGTTTCCGGCGGCGACTTTGATTATTGGCAAATAACCACCATAA | Hypo | TRUE |
| HOXA9 | cg01354473 | 7 | CAACGCTGTACCCGCTGCGGTGTACCACCACCATCACCACCACCCCTACG | Hypo | TRUE |
| IMMP2L | cg02391387 | 7 | CGCCGGTTTCTCAACCTAGTTAGCCAGTGGCACCAAGAAGAGGACTAGGC | Hypo | TRUE |
| LOC90693 | cg25635316 | 7 | GGACGAGGTTTGTTCCCAGCTTGTGGAGATTTTACTCCGCTCGTCCCTCG | Hypo | TRUE |
| METTL2B | cg05590567 | 7 | AGGAGTTTCTCTCCCCTTGGAGAGTGCCTCGGGTAGGGCAGCTTGACTCG | Hypo | TRUE |
| MGC22793 | cg15547534 | 7 | AAAACTCTGCTATGGCTGAGTTACCCAGAGGAATCTTAGTCCTGCTAGCG | Hypo | TRUE |
| NPTX2 | cg00548268 | 7 | TCAGGTCTTGCTGAATAAGGTCACCGCCCAGGGGGCAGTCGATGAACACG | Hypo | TRUE |
| PDE1C | cg00546491 | 7 | ACACCACACTCAAAAACTCTTGATGTTTTCTTGCTAAAGGGGCTCTCTCG | Hypo | TRUE |
| PDGFA | cg02683985 | 7 | TATTTGCGGACATCAGCCCCAAGAAGAACTCCGGAGGGAGTCTGGGGCCG | Hypo | TRUE |
| PEG10 | cg01488147 | 7 | CGCCCCATAGCATCGGGCCCAGTTGTCCACGAAACTCACGACCTGATAGT | Hypo | TRUE |
| PEG10 | cg22647507 | 7 | CTCGGTTGGATCTACCTGGTGGTGGCTTGCAATGTGAGGCAACACCAGCG | Hypo | TRUE |
| POR | cg20748065 | 7 | AGAAGTATCTCTTTTCAGCATGACGGACATGATTCTGTTTTCGCTCATCG | Hypo | TRUE |
| PRPS1L1 | cg00911873 | 7 | CGGAAGTGAAGCACAGACTCTAATGGCTTCCGGTTGTTACTCAACCGTTA | Hypo | TRUE |
| SGCE | cg03682823 | 7 | ACTCAGCAAACCCACAGTTTCCACAAACTGTTGCTGGACGCTGATTCGCG | Hypo | TRUE |
| SGCE | cg18139769 | 7 | ATACTCAGCAAACCCACAGTTTCCACAAACTGTTGCTGGACGCTGATTCG | Hypo | TRUE |
| TWIST1 | cg26312150 | 7 | GTCTGAATCTTGCTCAGCTTGTCCGAGGGCAGCGTGGGGATGATCTTCCG | Hypo | TRUE |
| TXNDC3 | cg12099032 | 7 | ACAGTCTTGTTTGTGGCTTTTCCTTTGTTGTACGCTAGCGTGCACTATCG | Hypo | TRUE |
| WIPI2 | cg20592700 | 7 | GGCCTTACGTGTTGTCCTGGTTGAAGTTGGCGAAGAGCAGCTGGCCGGCG | Hypo | TRUE |
| ZYX | cg03100196 | 7 | GGTGTGTGAGCCGGAACCTCCAGCATTCTTGGGGATACGAACTTCCAACG | Hypo | TRUE |
| LY6H | cg04583874 | 8 | TTTACCTCCGAGTGTGGGAGTATTTGGCGACAGAAGCCCCTGGGGCTGCG | Hyper | TRUE |
| MTMR9 | cg20951726 | 8 | CGGGTTTCAGCTTGGTAAATCCTGATTCTAGGCCACAGAGGGCTCATCTT | Hyper | TRUE |
| PKIA | cg04689061 | 8 | CTGGTTGGCCCCACTTCTCCAGTCTTTTAGGAGATTCCCGTTCTATTACG | Hyper | TRUE |
| ADAM7 | cg05847038 | 8 | CGTTGATGATTTTTCTGAGAGCTTCGACTAGATTACAGCTAATCATGAGA | Hypo | FALSE |
| ADAM7 | cg15610233 | 8 | CGTTCAGTTTGTGGAAATATTAGAGACATATAGATGCGGGTGAGAAATAG | Hypo | FALSE |
| ADAMDEC1 | cg13059335 | 8 | CTTGGGTCCTGCTGCCTGTACTTTGGCTCATTGTTCAAACTCAAGGTACG | Hypo | FALSE |
| ADAMDEC1 | cg14143055 | 8 | CGGGTCATAAAGGATATAAGAAGGATGCCTATCTCTGGACCAGAAAAAGA | Hypo | FALSE |
| ANXA13 | cg00283535 | 8 | CGTCATGTAAGTACTCATTGCCTTTGGGAATTGGTTTTAATTTTGGTTAG | Hypo | FALSE |
| ANXA13 | cg02800334 | 8 | CGGTAGACTGATGAAATAAGGTTTGGTTCATATCCATAACAGTTGACTAC | Hypo | FALSE |
| C8orf17 | cg23430634 | 8 | CGGGGCTATCAACTTGAGCTGGTCCAGTCTGCAGATCTACATCCTGCCCG | Hypo | FALSE |
| C8orf34 | cg10371914 | 8 | TGGTAAAAATCCTTTGATCTTTTTACTTCTAACTCTGTGTTCCATCAACG | Hypo | FALSE |
| C8orf45 | cg12255284 | 8 | CGGCCCTCATCTATCTTGACAGAAGTGGAGGCCTCCAAAAGTTTATAGAT | Hypo | FALSE |
| C8orf46 | cg17449882 | 8 | CGTGCTGCCTTACTACGGTTTATCCTCAGGTCTCTGGGGTCTGATGGACT | Hypo | FALSE |
| C8orf72 | cg26369642 | 8 | CGGAGCCCCTCACCTTGAATGGGCCTCAGTTTCTGGTTCTGTAGATGGGG | Hypo | FALSE |
| CA1 | cg25142416 | 8 | CGGATAAAACACTTCAATGCTCAGCTAGATGAAAGGCAGAAGTCTTTGTT | Hypo | FALSE |
| CDH17 | cg12038710 | 8 | CGGAGAAGGGAAATTTGTTGCTGGCATGACAAGTTTTGCTTATGGAGCAC | Hypo | FALSE |
| CNGB3 | cg06757810 | 8 | CTAAAAAATCTCATCCAACAGCATAGAACATCAACTTTGTCTGGGCTCCG | Hypo | FALSE |
| COLEC10 | cg27041096 | 8 | CGCTGAGTTTCAGAAAGGTTGTGAACCAGAGAGGTCTTCAGTTAGCAACA | Hypo | FALSE |
| CYP7A1 | cg12010995 | 8 | CGGTGATCAAGTTCAGAGGAAAGAGAACTGGGAAAAACATTTCTGCTGCT | Hypo | FALSE |
| DEFA5 | cg15481539 | 8 | CGGCATTTCAGAAACTGATTCAGGTGCTTTAGGGAGCCTTGTTAGGACCT | Hypo | FALSE |
| DEFA6 | cg07974303 | 8 | CGGGATCCAGCTCTGGCCTCAAGGTCTAGACCTCCAGAGAGTGGCCAGCC | Hypo | FALSE |
| DEFB105A | cg14120879 | 8 | TTTTGTCAAGTTAGCTCTGAGTCCCCTTTCCTGTAAGATATCACCTCACG | Hypo | FALSE |
| DEFB106A | cg05810550 | 8 | CGCTGCTTTACCTGTTGCCATGACTGGCATGAGTGCATAGGTGTCTCTAA | Hypo | FALSE |
| DEFB106A | cg08753553 | 8 | ACTGTGATGAGAGCTTCACATAAAATGCATCTAGTCTTCCAGTGCCAGCG | Hypo | FALSE |
| DKK4 | cg01762581 | 8 | CTGAGCTGCCAGCTTAGTGGAAGCTCTGCTCTGGGTGGAGAGCAGCCTCG | Hypo | FALSE |
| FABP4 | cg10062803 | 8 | CGCTCATCTACTCTGGACTGTTGCATAGATACACAGACTGTGGTGATGTA | Hypo | FALSE |
| FGL1 | cg01871995 | 8 | CGAGGTCACACAGCTAACAAGAGGTATAGCTGGGCTCAAAGGCAATCCTG | Hypo | FALSE |
| FKSG2 | cg08331840 | 8 | CGGTAGTTCAGCAGAGCAACCATGCCAGGTGGATTTAGGTTTTCACCAAT | Hypo | FALSE |
| FLJ46365 | cg25538571 | 8 | CGCCGCTTTTAACCACAGAGATGACTCAGCACTGGAAGGTTAGCTGTGCT | Hypo | FALSE |
| HNF4G | cg24512303 | 8 | GGATTAGCACTCACAGATTGAAAGCAAAACACATCAAAACACTCATCACG | Hypo | FALSE |
| INDO | cg08465774 | 8 | CGGAGAGTGGTGAGAAAGGAAACTATAGAAAGTGTATCAGCTTTACATAA | Hypo | FALSE |
| KIAA0196 | cg19437319 | 8 | CTGAGGCCAGTTAATCATCCCCAGTGTCCAGGCACAGAGTAGTCGGTCCG | Hypo | FALSE |
| KIAA0196 | cg27089714 | 8 | AGTCATTCTCTACTCTTTTAATGATCCTGGCTTCACATCAGAATCATCCG | Hypo | FALSE |
| LONRF1 | cg22836132 | 8 | CGGGTGATTTGACCCCATGAGGCACACCTAATTTTGCAAGACTTTTGAAC | Hypo | FALSE |
| LONRF1 | cg23719367 | 8 | CGGAGGGCCAACTGTGCTGGCAAAAATCATTTACTTGTCACAGTGTTGGA | Hypo | FALSE |
| MLZE | cg24243265 | 8 | TTTTTTCTTCCCTTACCTGTCTGAATACACACATAGTTTGTGATGGCACG | Hypo | FALSE |
| MSR1 | cg01668126 | 8 | CGTGAAAGAGGAGATCATGAGAATTAATGTATGTTTTAGAAGGCATAGAT | Hypo | FALSE |
| NAT1 | cg04149472 | 8 | ACATTCCTTTTACTTCCTAAGGAGGTAGACTCTGTCTTCACACTGTGCCG | Hypo | FALSE |
| NCALD | cg01484156 | 8 | CGGGAAATAACATTATAACTGAAACAAAAGTTGGGATTTTGCTTGTAAGT | Hypo | FALSE |
| No Gene | cg08631437 | 8 | TAAATTTGTTTGTGCGACATGATCGCTCGGTTTGCTAGCCTTCAGCCCCG | Hypo | FALSE |
| present | | | | | |
| PCMTD1 | cg03835158 | 8 | GTAAGCATTGTCTCTGTAGCCTTCCAAATAGTAATCTCCACGATCAATCG | Hypo | FALSE |
| PLAT | cg12091331 | 8 | CCTGGCTTCGGGCCAGGCTGATTATTCACAGCCGTGATGTCATTGAATCG | Hypo | FALSE |
| PMP2 | cg21649520 | 8 | CGGGCAGCTGGCCATTGAAGAGCCATTCATTGCTTAGTCCCGACACTGCC | Hypo | FALSE |
| SLC26A7 | cg10851775 | 8 | CTTTGTGTCTGTGCAAAAATACCTTTCTTTTTAAATCCAACGAAGAGACG | Hypo | FALSE |
| SLC30A8 | cg07459489 | 8 | GTTTTGACCTTCGGAGCACACGTGGGTGAGCTGCAAATAGCTACCATTCG | Hypo | FALSE |
| SLC7A2 | cg02786378 | 8 | ATGATTTTCATGAGCCTAATGATACATGTGAGATCTTTCTTAGCCCCACG | Hypo | FALSE |
| TATDN1 | cg26490372 | 8 | CGGATTAGTGGGGAAAATGGACATGTAAACAAATCGATGATGAAGGAAGT | Hypo | FALSE |
| TMEM74 | cg12991341 | 8 | ACAATCTCTTACCCCTTATGGTCATATTTCTTCTGATTTTGTGAGACACG | Hypo | FALSE |
| ARHGEF10 | cg14681767 | 8 | CGCCCCCGACCCCCTGCGCAGATGTTTCAGGGAAGGGGCTGAGACCCCCT | Hypo | TRUE |
| ASPH | cg04333463 | 8 | TCCCACCGCGCGCCGCCTCCATCCCCCGCGACGCTCCTCCTTTAGGCGCG | Hypo | TRUE |
| C8orf4 | cg03727165 | 8 | GATGGGCTGACTCGTAGCGACGTGGACATGATGACGGCTTGGTGGCTTCG | Hypo | TRUE |
| C8orf78 | cg05412531 | 8 | ATGGTTCTATAAATGGCGGTTTCCCCAGCTCGCTCTTGCCTGCTGCTACG | Hypo | TRUE |
| CYP7B1 | cg17347634 | 8 | CCTTATTCTTTCTGAGTACAGCCTGTAGTACTTGAACCACTTCTCTTTCG | Hypo | TRUE |
| DOCK5 | cg01638025 | 8 | CGGGCGCGCAATAAATATTTGTTGAATGAATGAGCAGTTGACTTCTGCCT | Hypo | TRUE |
| FLJ23356 | cg25861458 | 8 | TGCATGAGCCTGGCTCCAGGCTGAAGCAATAGTCGGTCAACACAAAATCG | Hypo | TRUE |
| GPAA1 | cg20669525 | 8 | CGCCGGACCCGAGCCCTAAGCCTGGGCCTGATACCCTCAGTGCTTCCAGA | Hypo | TRUE |
| HTRA4 | cg12535715 | 8 | CGCCGCCTCCGCCGGCCCCCAAACTTTAAGGGGCAGAGCCTGGCATACCT | Hypo | TRUE |
| LY6K | cg08569678 | 8 | CAGGCAGGGGCCTTACTAGTAAGCACGTTTTGGGAAGTCCTCAGGGCACG | Hypo | TRUE |
| LYPLA1 | cg10644878 | 8 | GGCACGATGGCGGGCAGCGGGGTTGACATGTTATTGCCGCACATACACCG | Hypo | TRUE |
| MAF1 | cg08825571 | 8 | GGCTATTCGAGCTCTCGATCTCGGAGACTGGAGCGGGCCATTCAGAGGCG | Hypo | TRUE |
| MCM4 | cg16104446 | 8 | CGATTGCCATTTGCCTCTGTTTGGTTTGGTTCAGTGGTGAGTCATAATGC | Hypo | TRUE |
| NCOA2 | cg05868799 | 8 | CGGGATAAAGCAAATGCTGCACACAGAGTGTGAAACTTAACCTGGTTGAG | Hypo | TRUE |
| PROSC | cg19149125 | 8 | CGGCCAGTGCTGTCTCATCAGGGGACACAGGCAGCATGATTATTACTATT | Hypo | TRUE |
| SLC20A2 | cg02641676 | 8 | TGGTCAATTTTAGAATCACCTAGACGTGACATCAGGAACCCAAAATCACG | Hypo | TRUE |
| SOX17 | cg02919422 | 8 | CAGTGTCACTAGGCCGGCTGGGGGCCCTGGGTACGCTGTAGACCAGACCG | Hypo | TRUE |
| SOX17 | cg21226224 | 8 | CGCTCGGTATGTTCATCTAAACGACCTTGGGCAAGTACGTCGATTCCAAG | Hypo | TRUE |
| TACC1 | cg09990086 | 8 | AAATGGAGAACATCAGCTATTTCCCATTGCCTTCAAACCTAAAGATGTCG | Hypo | TRUE |
| TG | cg23427666 | 8 | AATATATCCTTGTCACTCATGAGGCACCAAGTCTCAGGCAGCGAAAGTCG | Hypo | TRUE |
| THRAP6 | cg02422627 | 8 | TTGGGAGGCTGTGGGGCCTCAGCGTTGGAACCAGCTTGAGAGACCCCCCG | Hypo | TRUE |
| TMEM65 | cg11172196 | 8 | GTGTGTCTCTGTCAGTCTGATCTTCCAGAGGATGAGTCAGCCACGCACCG | Hypo | TRUE |
| TPD52 | cg18459342 | 8 | CGCCATCCCGGTTCCCAAGCAGGCTCCACGCAGCCTCCATGGCCGAGTCC | Hypo | TRUE |
| TRPA1 | cg06493386 | 8 | AAAGTAGCGCGGGCCTGAGAACTCCTTCCAGAAGTTCTCCAGGGCTTCCG | Hypo | TRUE |
| WDR21C | cg17703554 | 8 | AGGGCACCTCAGAGCATTCGGGATTTGGGCCAAGGCGACGAAGAATCTCG | Hypo | TRUE |
| WHSC1L1 | cg11360768 | 8 | GATTTGGCGGCGGCGGCGCCCCGAGAGTCGGGGTGGGGGGGCTTTGTGCG | Hypo | TRUE |
| TNFSF8 | cg27631256 | 9 | CGCCCCCAGAGAAGAGTTTCTCCACCAGGCAGCAGGTGAAGGTTTTTTTC | Hyper | TRUE |
| 40148 | cg04761824 | 9 | CCCAAAGAGGCAGTCCTCAATAATGCCATCTTTGTTGCAGCAGAACATCG | Hypo | FALSE |
| 40148 | cg26981881 | 9 | CGAGCTGGCGTTCAAATGAATCCTTGAATTGTGGAAACAGAATGTTAAAT | Hypo | FALSE |
| ANXA1 | cg01894895 | 9 | CGGGGGAAAAAGACAACAAAACAAAAGTAAAAACAGGTTCAGAAAAATTA | Hypo | FALSE |
| ASPN | cg26478992 | 9 | CGATGGTCAGACTCTTGATGACAGTAGAGAACAGGTCTTCTAACCCACTG | Hypo | FALSE |
| BAAT | cg00755709 | 9 | ATTTACCACAGCAGGATTTTTTCCCCATCCTAATAAGCCTGAGGGTACCG | Hypo | FALSE |
| BNC2 | cg14613546 | 9 | CGACATGTTATCAAGGGTGTATTTCATCAGGCAGGAAAACGTTATAGAAT | Hypo | FALSE |
| C5 | cg01843018 | 9 | CGCCATGTGGAGGATGCTGTCGTCATTCTCTAAGTATTGGAGAATAGATA | Hypo | FALSE |
| C5 | cg02552945 | 9 | CGAGCAGCTAAGGCTTAGAGAGACTGAAATTAAGTGACTTCAAATTGGTG | Hypo | FALSE |
| C9orf102 | cg08637669 | 9 | CTTAAGAATTACTGGAGTTTACTGTCATCTAGCAGATGCTTCCAATCACG | Hypo | FALSE |
| C9orf26 | cg05418129 | 9 | ATGATTATTCAAATATCTTCATCTGTTATTCTCTTCTTCATCAGTAGTCG | Hypo | FALSE |
| C9orf26 | cg18236721 | 9 | CGCAAGTAATGAATTGTTCTAGGATGTTATGATGGCTACAACAGCACTAG | Hypo | FALSE |
| C9orf68 | cg09519758 | 9 | CTATTAGATGTAGTGAATGTCCCCTACTCATTCAGAACTCTTGCTCTGCG | Hypo | FALSE |
| CCL19 | cg08418332 | 9 | CCGAAATATACAGACCTAAGCATTTGCCTGAACTCACCATGTCCCTTACG | Hypo | FALSE |
| CD72 | cg12971694 | 9 | CGGCTTAGCAATTGGCCCTGTGACTTCCAGTCACAAAAGAGGAAGGTGTT | Hypo | FALSE |
| CER1 | cg07926025 | 9 | CGGCAGGAGGCCATTAGCACTACATAATTCAAGCAAACAATAAATGTGTT | Hypo | FALSE |
| CIZ1 | cg05826823 | 9 | CGCAGGGGCCATCCCTGACCACAGCAGATTTCATCGAGTACTTGCTTGTT | Hypo | FALSE |
| CTNNAL1 | cg05485060 | 9 | CGCCGTGAAGGAATTCCAGACTTAAGCAACAGACTGAGAAGCATGAAAAA | Hypo | FALSE |
| CYLC2 | cg07136161 | 9 | CGCAGTGTTAACCTTTAGTAAAAAGTGGGGCAGCTCTATCCAAATGTGAC | Hypo | FALSE |
| DENND4C | cg11074362 | 9 | TGCTTCTTAAGTTTCTCCAAAGTTTGGAGCTCTTAGGAGCCATAAAAACG | Hypo | FALSE |
| DENND4C | cg19584733 | 9 | ATATAGACCTGTTCATGTTGCATATGTCACAAGCTGTACACCTACCTACG | Hypo | FALSE |
| ECM2 | cg24105685 | 9 | CGCAACCCTGCTGTTTATGAGGGACCTTGAGTAAGTTACTTAATGTTTCT | Hypo | FALSE |
| EGFL7 | cg08529852 | 9 | CGCGAAGCCCCTCACAGCGGGCCCAGCCAAGCTGAACTTTGCTGCCAACC | Hypo | FALSE |
| ENG | cg05050341 | 9 | GTCAGACGTGAAGTGTGTGGCCCTGGGCAGCTCCTCTGAGCCCAGAGACG | Hypo | FALSE |
| FLJ20444 | cg06220208 | 9 | CGGCTTTCAAGTGCCAGAGCCAGGACTCAGATCTACACAGGTCTGGCTCC | Hypo | FALSE |
| FUT7 | cg02679745 | 9 | ACCAAGCCTGACCTGCATTGAGATCTCCAGGACGTCTGGGTCTGGCCACG | Hypo | FALSE |
| GNG10 | cg22174355 | 9 | AAAGAACAAGCTTTTCAAATAGTTTAGGAGCTAACTGGCTAACTGGTACG | Hypo | FALSE |
| GPR21 | cg04655481 | 9 | CGGCAGCATGAAGTGACAGATCACTCCTGAGCTCAAGATGAACTCCACCT | Hypo | FALSE |
| GPR21 | cg04784315 | 9 | ATTACTAAACCTTTAACCTATAATACTCTGGTTACACCCTGGAGACTACG | Hypo | FALSE |
| HIATL1 | cg12044689 | 9 | CGAGCGAAGTACAGCTTATGGATGGGTAAGATAATAGACTATATATATTT | Hypo | FALSE |
| HIATL1 | cg22232859 | 9 | AAATATAACAGAAAACGTGACCGAGAAGACTCCAGACACAGAAATCATCG | Hypo | FALSE |
| IFNA1 | cg16823701 | 9 | CGGTGGGTTCAATTAGGAAAAAGATATCTAAAAAGTCTCTGGGAACAAGA | Hypo | FALSE |
| IFNA10 | cg01549015 | 9 | ACATCAGAATGGTCATCTGTAAAGGACTAGTGCCTGCACAGGTATACACG | Hypo | FALSE |
| IFNA13 | cg01713938 | 9 | CGGTGGGTTCAATTAGGAAAAAAAATCTAAAAAGTCTCTGGGAACAAGAT | Hypo | FALSE |
| IFNA13 | cg01906717 | 9 | CGGCTCTAAACTCATGTAAAGAGTTCAAGAAGGAAAGCAAAAACAGAAAT | Hypo | FALSE |
| IFNA14 | cg00474004 | 9 | CGGGATTCCCAATGGCATTGCCCTTTGCTTTAATGATGGCCCTGGTGGTG | Hypo | FALSE |
| IFNA14 | cg21023114 | 9 | CCTTAGAAATTCCTCCAATCACAGCACCCATTTGACATAGGTTTGTAACG | Hypo | FALSE |
| IFNA16 | cg06479216 | 9 | CGAGAACCCTTAGGAGAAGTATCACATAGACATATGTGACTTAGAATATA | Hypo | FALSE |
| IFNA17 | cg01074640 | 9 | CGGCCATCAGTAAAGAAAAGGACAGGGCCATTGGGATGTTGCAAATGTTG | Hypo | FALSE |
| IFNA21 | cg07373172 | 9 | CGCAGGCTTCCAGGTCATTCAGCTGCTGGTTAAGTTCAGTGGAAAATTTT | Hypo | FALSE |
| IFNA21 | cg19982860 | 9 | CGGCCATCAGTAAAGAAAAGGACAGGGCCATTGGGATGTTGCCAATATTG | Hypo | FALSE |
| IFNA4 | cg23029519 | 9 | CAGAGATGGCTTGAGCCTTCTGGAACTGGTGGCCATCAAACTCCTCCTCG | Hypo | FALSE |
| IFNA5 | cg27351998 | 9 | CGGCAGAACTCAAGAAGTGTGAAATGGTGTACTAGTCAATGAGAATCATT | Hypo | FALSE |
| IFNA6 | cg26766480 | 9 | CCTGTGCAACTGAACACGATGTTGCTTAACACACTTGAAAATACTTGACG | Hypo | FALSE |
| IFNW1 | cg07236769 | 9 | CGCAGTTTTGTTTGCTGTTTTATTCACAACAGAGGATGATGATGATTAGC | Hypo | FALSE |
| IKBKAP | cg11953824 | 9 | GACCAACCTGTCCTAGTTCACCCATGACTGAGGGGTTTCCCAGAATGTCG | Hypo | FALSE |
| IKBKAP | cg25018881 | 9 | CGTGTACTCATTTTGAAGTGAGTGTAAAGTAAGATGGAGCAAGGAGTTAA | Hypo | FALSE |
| KIAA0367 | cg11880010 | 9 | CGACAACAGGAAATTTGATATTAATGTCAAACTGCCCAGCTGCGGGGAGT | Hypo | FALSE |
| LOC349236 | cg01120307 | 9 | GGGATGCTGTTCCAAGGCCCAGAACCATTCTGTAAGAAACCAGCACAGCG | Hypo | FALSE |
| MGC41945 | cg23552468 | 9 | CGGTACACTCACCAGCAGTTTTGCCATGAAGAGTACACCGAACAAAGGAG | Hypo | FALSE |
| MPDZ | cg03905144 | 9 | CGTGGGATCACTATGATGACTTTTGTTCCTGGTACTGTGCTGGTAATGAA | Hypo | FALSE |
| MPDZ | cg22117143 | 9 | CGTGGATGTTAGCAATGCAGATCTGTATCCAGTATTTCAAAGAATCTAGT | Hypo | FALSE |
| OGN | cg13580728 | 9 | CGCCAATTCTGTGCCAGGACTTCAGACACGTAAGCTCAGATAAGCAAACT | Hypo | FALSE |
| POLE3 | cg01481976 | 9 | TGAGAATTAATGCTGCTTTTTTTTCCCGTCAAGCATGCAGTCCCAAGTCG | Hypo | FALSE |
| POLE3 | cg16367027 | 9 | TAGCGCTGAGCAGCCCTGATGGTTTCAGCCAGGTCTGTTCTATCCAAGCG | Hypo | FALSE |
| PRSS3 | cg05413282 | 9 | CGGCATGCCTGGAAACGTTAAAAATCACCTGGGAAGCTTAAAAGCCCAGT | Hypo | FALSE |
| PTPN3 | cg17824393 | 9 | CGAGAGGATGGGATCTGACAGGTATCTGCACTCACAAGTAACTGACAATT | Hypo | FALSE |
| PTPN3 | cg26646980 | 9 | CGCACCTCGGAGTTACCCAAAGAGAAAACTCGATCAGAAGTCATTTGCAG | Hypo | FALSE |
| PTPRD | cg09440243 | 9 | CGTTGAGAAAGATACAAGTCCATGAAAGTGTTGTAGTGTTTCGGGAGTTT | Hypo | FALSE |
| SLC28A3 | cg18999668 | 9 | ACACTGATACAGTACCTGGGTATCGCTGCTGGTTGTTCAGGTCCCAAGCG | Hypo | FALSE |
| TMOD1 | cg25494064 | 9 | CGGCCTGGGTACATTTTATGAATTGCCAGGATAATCATTACTATGGTGGA | Hypo | FALSE |
| TNFSF15 | cg11809085 | 9 | CGGTCATTGAAAAAAGTTAGAAAATACAGATAAGGAGAGGAAGAAAGTCA | Hypo | FALSE |
| TOR2A | cg22105022 | 9 | CGCCTTTGAGGTTTGATGATGGTTTTACTGTCATTATGTCTCCAGCATGT | Hypo | FALSE |
| TRPM6 | cg22161874 | 9 | TCACAGGTAGTAAAAGCAGTGCGTTAGCTTAAATCTCTGATCTCCTCACG | Hypo | FALSE |
| TTF1 | cg12271587 | 9 | GAGCACAGAGTGAATCCACACAGTGAACCCACAGGGTGACAGACAGGTCG | Hypo | FALSE |
| TYRP1 | cg25989745 | 9 | TGGATTGCTGCCTGATAATTAATCCCAAATCTGCTCACCCAAACTAGGCG | Hypo | FALSE |
| ZNF169 | cg15264273 | 9 | CGAGTCAATTTCATAAAGAGATTTTTAAGAAGCGAGAAGTAGGGGTAGAT | Hypo | FALSE |
| ZNF322B | cg12599000 | 9 | CGAGAAACCTTATAAATGTAGCAAATGTGAGAAGAGCTTTTGGCATCACT | Hypo | FALSE |
| ATP6V1G1 | cg17742155 | 9 | CGGCCTAAGGCACCTCGAAGGCCCCTTGGGTCAGCTGACACAGCCGCCCA | Hypo | TRUE |
| C9orf121 | cg00755043 | 9 | CGCCGACAATGAGACACTCAGACACCAGAGACCCCAGATACCTGGGCGAC | Hypo | TRUE |
| C9orf41 | cg18168989 | 9 | CGCCCGGCCCCAGAATAAGTTATTTCCCAAGAGCCACCCTTAGATGCTGG | Hypo | TRUE |
| C9orf45 | cg07763768 | 9 | CGTGCCCAAGAAGGGAGACATGGTCTTGGCAGCATCACCAGTCAACATCA | Hypo | TRUE |
| CAMSAP1 | cg20414506 | 9 | CGTGACCCCCAGGTCTTTAATGTGCCCCGCGCCCAACACTCTGCTAGGAG | Hypo | TRUE |
| CCIN | cg15248035 | 9 | CAGGACTGGCCCAGTAGTGGAAGTTGTCCCGAATGCCAGAGTAAGCTACG | Hypo | TRUE |
| CDC14B | cg20811389 | 9 | TTCAGCGCGCTCGGGGAATCCTCAGGGGCTGATTCAGAGGTTGTGACTCG | Hypo | TRUE |
| CDKN2B | cg08390209 | 9 | GCCTAAGTTGTGGGTTCACCATAACTCCTCAGCAGACATTGGAGTGAACG | Hypo | TRUE |
| CKS2 | cg05465755 | 9 | CGCGCCAGCAGGATGGCCCACAAGCAGATCTACTACTCGGACAAGTACTT | Hypo | TRUE |
| COL5A1 | cg26024843 | 9 | TGCCGAGGTCCCCATGACCTCCTAAAGTGGTGCGGTCCCTGCTGAGTGCG | Hypo | TRUE |
| DMRT1 | cg25905812 | 9 | CAGGCAGTCCCGGGAATGTTCTGAAAAGTATCCGAAAGTTCTGAGTCGCG | Hypo | TRUE |
| GADD45G | cg20070077 | 9 | AGAGTCATAGTGCGATCAACCAGCAGCTAGTTATCCACAAGCGGAGAGCG | Hypo | TRUE |
| GNE | cg24556026 | 9 | GATGTCCCTAGGCCTCGGGACTGGCTGGGAGTTCCCTGTAGTGGAGGCCG | Hypo | TRUE |
| OR2K2 | cg09931793 | 9 | CGGGTTGCCTGACCGCTCTGCTGGAAACCAGTTTTGCCCTGCAGATACCC | Hypo | TRUE |
| PBX3 | cg04794505 | 9 | CGGTGTGCCCGCACCCCGACTCCTGCTCCATGCTTTTGGCAGTCATGGGA | Hypo | TRUE |
| RAD23B | cg14919562 | 9 | CGGCGGCACCATGCAGGTCACCCTGAAGACCCTCCAGCAGCAGACCTTCA | Hypo | TRUE |
| RLN1 | cg00055233 | 9 | CCACCTGCTAGAATTCTGTTTACTACTGAACCAATTTTCCAGAGCAGTCG | Hypo | TRUE |
| RUSC2 | cg16480145 | 9 | CGGCGGTTCTCAACGCTGGCTTCCCAGTAGAACCTAGTGTGGAAACTAAC | Hypo | TRUE |
| SLC35D2 | cg22324153 | 9 | CCTTGGGACTTGGGTGTCCTCTGGGTGCTTTGTGGTAGGTGCATTCCTCG | Hypo | TRUE |
| SPTAN1 | cg03243895 | 9 | GGGCGTGGGTGCGTCGGGCCGAGGGGTGCTGAAGGACCGAGGAGCCTCCG | Hypo | TRUE |
| TGFBR1 | cg15526708 | 9 | CGTAGAGTTTATTTGGGTTTTTAGTGACACCTCAGGATTATTATACAGCA | Hypo | TRUE |
| TRIM14 | cg01618660 | 9 | AACCAAGTATTATTATTTTAAAACGATCTGGCCGGGCGCGGTGGATCACG | Hypo | TRUE |
| ZNF297B | cg10805447 | 9 | AAGGCACAGGCTGAATCTGTTGCGGCAGCTGAGGCTACAACAGGCCTGCG | Hypo | TRUE |
| ZNF322B | cg00429618 | 9 | AGGGTTTGCGTTGCCGGCCTTGTGGGCCCTTGAAGCGCTCTGTTAAAGCG | Hypo | TRUE |
| IFIT2 | cg06476606 | 10 | AAAGAGTCCTGCCAATTTCACTTTCTAGTTTCACTTTCCCTTTTGTAACG | Hyper | FALSE |
| PCDH15 | cg03808835 | 10 | CGTGGAGAATGATGGTATGCTTTCTGAGTTAACATGTTGAACTGTTTTGC | Hyper | FALSE |
| PRF1 | cg02374486 | 10 | TGATGAACAGGCCAGCAGGGCCATCTCCTTGCTTCTGATGCACAGCATCG | Hyper | FALSE |
| RPP30 | cg05163348 | 10 | CGGTATCTACTTAGTGCTGCTCATGAATCAGAGAATTCTGCTAATGGGTG | Hyper | FALSE |
| MASTL | cg21244397 | 10 | CGGCTTTGGCTTTAAGTGCCTGTTGTACTAAGACCGATGTAATCACCTCG | Hyper | TRUE |
| MLLT10 | cg11443787 | 10 | CGATGATCCGGAAAATGCAGTTGTATTACACCAAAAGGAAGAAGGAACTC | Hyper | TRUE |
| MPHOSPH1 | cg20571908 | 10 | ATTCGGTTACGGTTTAAATCTCGCCTCCACTGCTAATTAGCTGAGTGACG | Hyper | TRUE |
| NSUN6 | cg05018361 | 10 | CGCTACGCCACGCCCCCGGAGGTTCCTAACCCTGCGTGAGGCTCTTTCAC | Hyper | TRUE |
| ABCC2 | cg17044311 | 10 | CTTATCATTATCATTTCAACATCAACATGTCTCAGCAAGACTCAGTCACG | Hypo | FALSE |
| ACF | cg03817621 | 10 | TCAGAGATCCCCACCCGGAAAAGGTTTCCTTGATTATGGCGAATTCAACG | Hypo | FALSE |
| ACSL5 | cg11152574 | 10 | CGCACTATGCCTCTGTGAAATGGGAAGGATACCACCTGCTTTATAGGATG | Hypo | FALSE |
| ACTA2 | cg10894512 | 10 | CACCACCCAGTGTGGAGCAGCCCAGCCAAGCACTGTCAGGGTAAGTGGCG | Hypo | FALSE |
| ADD3 | cg25341032 | 10 | ATCCTAAGGGCACCTATCAGAATATAGTCCTCACTATATTTTGCTAGTCG | Hypo | FALSE |
| AKR1C4 | cg09272256 | 10 | CGGGCATGAAGTGACCATCATTTAGCTCTACACGCTGATATTTGGGATCC | Hypo | FALSE |
| ANKRD1 | cg14558138 | 10 | CGTGTAGTTATCAAAATGTCTTAGGGAAGAAGTGTTATTGAAAGAATGTA | Hypo | FALSE |
| ANKRD22 | cg00098162 | 10 | TTGTGTAATGTGCCTAAGAATAACTTGGGGGCCACACATGGTGGCTCACG | Hypo | FALSE |
| ARL3 | cg10872209 | 10 | CGCTGGAGACACAGCAGTGGACAAAATCAGCCCGTATGGAAATTACATCC | Hypo | FALSE |
| BLNK | cg16779976 | 10 | CGGGGACGGTTATTTTATTAAGCTTGTCCATTCTGTTTGGTAATTGTAAG | Hypo | FALSE |
| C10orf12 | cg14647515 | 10 | CGCCAGGATTTAGAGGCAAATGAACAAGATGCAAGGCCAAAGCAAGAGAA | Hypo | FALSE |
| C10orf26 | cg15227982 | 10 | ACATCCTCCTCAGTATTCCAGTGCAGCTGTCTGAAGTTTTTTCTGCTGCG | Hypo | FALSE |
| CTNNA3 | cg00132141 | 10 | CGATCTCAGATGTGACACATGGCCTTGATGCCATCATCTCTAGGGTTCTG | Hypo | FALSE |
| CUBN | cg10707565 | 10 | GGAGATTGATGCTTCTTTTTTGTCTCTGCAGCTCAAGTTCTCCAGCTTCG | Hypo | FALSE |
| CYP17A1 | cg24934431 | 10 | CGCTAGTCCTGCTGATGAGCAAAGAAGGTGTTGATGGCATTTTGATCAAC | Hypo | FALSE |
| CYP2C8 | cg15201291 | 10 | TGAACCCCAATGGGTATCAGAAGATCTCTGCTCAAATCCCGGTTTTACCG | Hypo | FALSE |
| CYP2C9 | cg26822241 | 10 | TCATAGCTGGCAGAACTGGGATTTGAGCTGAGGTCTTCTGATGCCCATCG | Hypo | FALSE |
| DMBT1 | cg27015047 | 10 | GAATCTTAATGATCTTGTCTGCGCTCAATTACTTGACCTGATTTTGCTCG | Hypo | FALSE |
| DNMBP | cg05863612 | 10 | CGCTAGGGCAGAAGTCAAAAATGGCTCGAACCACTGAGCCAGCCTCCATG | Hypo | FALSE |
| EXOC6 | cg09944526 | 10 | CGAGTGAATAAATATAGCTGGCACTAGGCAGGAACTTTCCGAACTGTGTC | Hypo | FALSE |
| EXOC6 | cg19780563 | 10 | CTCAGCCAGGACATTCTCATAGGTTTGATCTGTTTCTTCTTCCAACATCG | Hypo | FALSE |
| FLJ14437 | cg18901940 | 10 | CGCCCTTGGAAATAGAGAGTAGCCGTCCATAGAGAGTGAGGAGTTAACCT | Hypo | FALSE |
| IDI2 | cg11406340 | 10 | GTAAAACCTTCTCATCATCCTTTTCTACTTTTTAAAAAAATGCATTCACG | Hypo | FALSE |
| IL2RA | cg26105232 | 10 | CGTTCCTAGAGAGGAAGTTATACCTGCTGTGGAATTTAAGAGAATCTTGT | Hypo | FALSE |
| ITIH2 | cg06224510 | 10 | CGAAGCCTGATACTTCAGAAAGAAAGAAGCAGATGAAAAAGCACGTGAGT | Hypo | FALSE |
| KIAA1128 | cg13442811 | 10 | CGTGTTCCTACTCAAGGAATGTTTGATAAAAATGGGATAAAGGGAGGTTT | Hypo | FALSE |
| LARP5 | cg10789261 | 10 | GGTTAGCATTACACTTCTCCCAGTGGAGCCCATGACTTCTGATCAGGACG | Hypo | FALSE |
| LIPF | cg11231018 | 10 | TTTTAAAATACAGTTGATCCTTTACAACCATCATGAGCATCTGTTGCTCG | Hypo | FALSE |
| MAPK8 | cg19612574 | 10 | CGTACTTTTAATGCCTCAGGCAGGATAGAATAGTATTGTTTTGTTTTGTA | Hypo | FALSE |
| MMP21 | cg07504718 | 10 | CGGCTGTGACCCAGTCAGTCTGCACTCTCAGGAGGACATCTGCTCAGATA | Hypo | FALSE |
| MSMB | cg17030820 | 10 | CGTGCTAGCAATCCACCAGCATAGGGCGAAGGCTCAGCAAAGAGAAGTTC | Hypo | FALSE |
| OIT3 | cg05998983 | 10 | ATCCTCTTCCTCTGATAAAGCCCCTACCAGTGCTGATAAAGTCTTTCTCG | Hypo | FALSE |
| PCBD1 | cg04916980 | 10 | TTCACATTTTTCTATTAACTTTTATTCTTGTGCTCCACTTTTATTCCCCG | Hypo | FALSE |
| PGBD3 | cg01982597 | 10 | TCAGTTCCACAGTTGCATTTGCCCTTTTTCAAGTGCTCAAGAGCTACACG | Hypo | FALSE |
| PLCE1 | cg09480837 | 10 | CGGGAGAAGCAAGGGGAAGAAAGACATCTATTTGTCAAAGAGCAAAGGCA | Hypo | FALSE |
| PLCE1 | cg23439277 | 10 | CGGCTGCAGATGAAAGTAGTGAAAAGGTCTCAGACATCAATATTTCAAAA | Hypo | FALSE |
| PNLIP | cg11812202 | 10 | GGCCTTTCTTTGCATGCCATTTTTCCACGGTTTCAAAAAGATAAGCTTCG | Hypo | FALSE |
| PNLIPRP2 | cg11310496 | 10 | CGCGGCATGATGTTTCCCTGTTACCACTTTGGGAACACAATCTCTTGGCA | Hypo | FALSE |
| PPP2R2D | cg21750602 | 10 | ACTGAAAATTACTGACCTCTTGTTCACGCTGAAAAATAACAACTCTGCCG | Hypo | FALSE |
| PPP2R2D | cg26381263 | 10 | TTAATTTTTTGGTATTGTGACTCCTCCCCAAAACCGCATCCGGTAAATCG | Hypo | FALSE |
| PRAP1 | cg10742801 | 10 | GGGGCCCAGCTGTGCTGCGCTCCAGGGGGCCTGGTTCAGGGGAGTGTGCG | Hypo | FALSE |
| SHOC2 | cg09830278 | 10 | ATTCCTTCAGTGGTGTATAGGCTGGATTCTCTCACCACTCTTTACCTTCG | Hypo | FALSE |
| SLC16A9 | cg24443367 | 10 | CGTGAGATTGTGAGTGAAGTTGATTTTTTAGGATGTGTACCTATGTGACA | Hypo | FALSE |
| SNCG | cg05046097 | 10 | TAGGGGTCAGGGCCACATAGGCCTGTTAGGTGAGAGCAGCCAACCTCCCG | Hypo | FALSE |
| TACC2 | cg21302727 | 10 | CGGCCACTCCCAAGTGCTGGCAGACCACTGCATAAGTGGACAGCCTGCTC | Hypo | FALSE |
| TLX1 | cg16715722 | 10 | CGCATCTGTTTATTTAAAACCAAAGGGGTATGTTGAGGCATGGGCACCCT | Hypo | FALSE |
| TMEM12 | cg23817637 | 10 | GTTGTTGTCTGCTAGACTCAGCAACGCTTTGGGAATACAGATCCTCCACG | Hypo | FALSE |
| TUBAL3 | cg07803864 | 10 | CGCAGATTTGGATAAGCTCTCAGTAGTTCATCTGCAGCTGTGTACAAACT | Hypo | FALSE |
| USP54 | cg21194776 | 10 | TCTTCTCAACCTGGACTTCCCAATTTTGGCTCTCATAATCACTGCTTTCG | Hypo | FALSE |
| VTI1A | cg17872476 | 10 | TTCTCAAACTATTCACTAAGCGTTGGATGGTGACAGTCCCCTGACAAGCG | Hypo | FALSE |
| VTI1A | cg21242004 | 10 | CGTGTATCCAGTTTGCATGCCATTCAAACTTGTACCATATTTTGGATAAG | Hypo | FALSE |
| WNT8B | cg26109803 | 10 | TGGACGTTTGGCAGCTCCATTTCACCTCCCCTTAACTCTGTTTGGGATCG | Hypo | FALSE |
| ZNF22 | cg00899659 | 10 | CGGACGACCCAGAATTGGAATGGTTCTTTGTGGCTCCAAAGTCTGATTTC | Hypo | FALSE |
| ZNF438 | cg01656216 | 10 | TCTTCAAATCCCAAACTCTTGATTACTGTTTTCCTGTCAAAAAGGCTGCG | Hypo | FALSE |
| ZRANB1 | cg17607024 | 10 | CGAGGTTTGATCTAAGAAGGATGAGATTAACGGGAAGCCACTAATAGAAA | Hypo | FALSE |
| ACBD5 | cg04466253 | 10 | TCTTCTGCTAGACATGCTCTTCCTCTCGGTGAGTTGTTTTGCTGTCGTCG | Hypo | TRUE |
| BTAF1 | cg04350610 | 10 | TAAGACTAGACACCCTCTCCACATCAGCACAAAGCGCTTTTATTTAGGCG | Hypo | TRUE |
| C10orf47 | cg03411288 | 10 | CGGGGACCCTCTGCGCCCAAGGCTGGGAAACCCGCCTCCACCCCTGAGCC | Hypo | TRUE |
| COMTD1 | cg02749825 | 10 | GCAGTGACAGGTCACGTGAGCTGGAGCTCCTGGGACAGGTCTCGGACTCG | Hypo | TRUE |
| CPXM2 | cg09619146 | 10 | GGACCCTGATTATTACGGGCAGGAGATCTGGAGCCGGGAGCCCTACTACG | Hypo | TRUE |
| CYP26C1 | cg26404725 | 10 | AGTCCTGAGGCATTTGGAACCCTTGAATGGGACGCACAAAGCCCAAAACG | Hypo | TRUE |
| DYDC1 | cg17703212 | 10 | CGGAAAAGGGTGGAAGACCTTCCAGAGTCCCTGGAAGACCGTCACTGCAA | Hypo | TRUE |
| ELOVL3 | cg00431050 | 10 | TCATCACAGGCCTGGGTTTCCCAGGATCTCAGGGAGCCTGGAAACTGACG | Hypo | TRUE |
| FLJ46831 | cg13929328 | 10 | GGGAAGTTACCAGCCACGTACTGGTAGATCTGGCTGAGCGTCAGCTTCCG | Hypo | TRUE |
| MGMT | cg02381948 | 10 | CGACAGAACAGAAACAAGTTGTGAAAAAGTGATTTGGGACTAACATTGCT | Hypo | TRUE |
| MGMT | cg10333959 | 10 | CGGGCAGGAGCGTTCTAGGCAAATGATGAAAATGGTATTTTACACATATT | Hypo | TRUE |
| MGMT | cg14129786 | 10 | CGGGAATGCATTAGAAGAGAAGAGATTTCACAGTCCCCAAATCCCGTGAA | Hypo | TRUE |
| MGMT | cg20537325 | 10 | CCCCTAAAGTTGCTGCACTGTGCACTCACAGATGGCACCAACTAATGTCG | Hypo | TRUE |
| MGMT | cg20778669 | 10 | CGGTGAACACTCAACATCACGGGCCCCCCTTCAATGAAGGGTAGCCTCAC | Hypo | TRUE |
| MYOZ1 | cg18180783 | 10 | CGGGATAGACATCGATGTCTCCCTGAGAAGCACATATAGGCTCTCTGAGG | Hypo | TRUE |
| NEUROG3 | cg06043042 | 10 | GTGAGACCGCAGGGATTTCCTGAGCAGCAAGTCGTGTGCCCCTTGGCACG | Hypo | TRUE |
| PDLIM1 | cg06542614 | 10 | TCACCTACTGAGCAGACTCAGTTACTTCATCTGTAAAATGGGACTAAACG | Hypo | TRUE |
| PHYHIPL | cg25946758 | 10 | GAGTCCGGGCCCTTATTTTTCCAATTCTTGGTAAACAACAAACATGCTCG | Hypo | TRUE |
| PTEN | cg01228636 | 10 | CGGGGAGAGAGTCCCCAAACTGGTGCCACTCCTCGCCTGCTACCCTAAGA | Hypo | TRUE |
| SLC18A2 | cg00512279 | 10 | CGCCGTCGGGGACCCAATCTGGAGACCCAACCTAGAACCCCCAGGACGCT | Hypo | TRUE |
| THEDC1 | cg27465849 | 10 | CGTGGGTAGGAAACAGACCAGAGGGCAAATCCAAGTAGTCTGGTTCCAGA | Hypo | TRUE |
| TRIM8 | cg14603406 | 10 | GCAGATAGGGCAGATGAGCTCCTCCTCGAAGCAGTTCTTCCAATTCTCCG | Hypo | TRUE |
| UNC5B | cg18858343 | 10 | CTAGGGGACCCTTGCGCCTCACTCTGTCCTGAAGTTGAGGTGGTCTTTCG | Hypo | TRUE |
| WDR37 | cg27274028 | 10 | CTGATTCTGTTTTTCCTTCCCAGCCAATGGTGATCAAAAGCTTCAGGACG | Hypo | TRUE |
| Bles03 | cg10467098 | 11 | TGACTTCTTGAAGGACCTGGTGGCATCTGTTCCCGACATGCAGGGGGACG | Hyper | FALSE |
| CASP4 | cg08469834 | 11 | CGGAGGTCATATGTTTTCCAGATGTCTTTGAGCCAGAAAGAAGTTAATTC | Hyper | FALSE |
| MS4A1 | cg06806711 | 11 | CGCTGATAGACATCAGGTGACAGGAAATCAGTAGCTTCTGCTACCTTGGG | Hyper | FALSE |
| MTMR2 | cg02807450 | 11 | CGGGAATTTGAAAGGGCAGGGAAAAATCGGTGAAAGTTTGTCTTCTACTT | Hyper | FALSE |
| DCDC1 | cg25572812 | 11 | CGCTCCAGAAGAGAGACCCTACCAGGAGCCCCAGAAATCAGGCAACCTCT | Hyper | TRUE |
| PPP2R1B | cg22582569 | 11 | CGGTTGAATACAACACCTGTGGTTTCAAAGAAAAGTTCCCACAGAGCGGA | Hyper | TRUE |
| SLC17A6 | cg04270835 | 11 | CGGATGCTATGGAAACCATTGGGAAGATGTCATCATCTCCAGAGTTTGCA | Hyper | TRUE |
| SWAP70 | cg15044073 | 11 | CGGAGTCACTGTCTGAGAAGGCCAGAGAAGACCCCGAAAAGTCCCCAGAC | Hyper | TRUE |
| ACRV1 | cg07153965 | 11 | CGGGAACAAGGGCCAAAATGCCTCATTATGGGAACATCTTCCCAGGCAGC | Hypo | FALSE |
| AD031 | cg06378107 | 11 | CGCAGTGATGTGAGGTCATGCTAACAGCTGTGAGTTACAAATGTATCATA | Hypo | FALSE |
| ALDH3B1 | cg07730301 | 11 | CGGGCCTAGCCACCGGCAGCTGCACTCAGAGGCCACTGTGTCCTGGCTGA | Hypo | FALSE |
| AMICA1 | cg23818978 | 11 | CGGGGAAACATTCAAGTCATTCAGGCCCAAGGAATAATCTATAGAAGTCA | Hypo | FALSE |
| ASCL3 | cg18920846 | 11 | CGGGCCACTCTGGAGAATAGTCTCTTACCTGAGTTTTGTCGTCAGGATGC | Hypo | FALSE |
| BCDO2 | cg02119229 | 11 | CCAAATCCTCTCACACTGGCAGTTTTGAGTACTACTAAACAGTGAACACG | Hypo | FALSE |
| BSCL2 | cg07237830 | 11 | GAGCCTCTGTTGACTCTGGATCTTCCACTGAGTCACTTGTGGCTAAAACG | Hypo | FALSE |
| C11orf55 | cg00795268 | 11 | CGCCATTTGGAAAATGTTGAAACTGAAGTAGAGATGAGAGATCTTACGTC | Hypo | FALSE |
| CASP1 | cg00051623 | 11 | CGGACGACATTGCTCTAGGTGCCAGAGGTTCAGTCAAAACATATCATGGT | Hypo | FALSE |
| CASP5 | cg14758526 | 11 | TCCAATCCACTCTGAAGGATACCTTTGAACATAGCTTCAAAATTCTTACG | Hypo | FALSE |
| CNTF | cg26229648 | 11 | TGTTATCTGTTTTCCCTTCATCTTTTTTGATCCAGCAACTTACCATCACG | Hypo | FALSE |
| CWF19L2 | cg09918512 | 11 | TCAGGTAGCATCCATGTATCCTCACCCCGAAGTCGCTTAAGTTCTTTACG | Hypo | FALSE |
| DLG2 | cg16986720 | 11 | CGGTGATTTGTAGTATTTGCCAAACAGGGTGCTGCACCAGAATAGCCTGG | Hypo | FALSE |
| FGF4 | cg14578030 | 11 | GCACTTGGGGGTCATCAAGTGGCTTTGGCAGGACCGGAACCTCAGCTCCG | Hypo | FALSE |
| FLJ21103 | cg07374928 | 11 | CGCATATGTATAGGGAACAAAAGTGTTCCAAGAAGAAATAATGAACAAAT | Hypo | FALSE |
| FLJ21749 | cg01432087 | 11 | CGGGTCAGGCCTTAAAGGGAATTCAAGAATTTCTAGACTCTTTGGCAAAC | Hypo | FALSE |
| FLJ38159 | cg24939733 | 11 | CGGGTGCAGATATGCAGGCTTTTAGGGTCCTGGCTCTCAGAATACCACTA | Hypo | FALSE |
| FLJ46154 | cg02255732 | 11 | CGTGGGTTAAAATCCTGGATTCATCACTTACTGACTGGGAGACTTTGCAC | Hypo | FALSE |
| FOLR2 | cg11295113 | 11 | CGGCTGTGTCTGAGTTGGCCTCTCTCTAAGTAGGCAATAGATCCAGGCCC | Hypo | FALSE |
| FOLR3 | cg25634666 | 11 | CGCTGTAGGTCCAGGCTCTGACACCAGCTTGCTCTGTGACCTTGTAGGGA | Hypo | FALSE |
| GDPD4 | cg13002506 | 11 | CTTATTAGTCAACGATGGTATTTTCATGTACCTCACCCGTGCCTTTAACG | Hypo | FALSE |
| GLYAT | cg15423764 | 11 | GCAAAAGAATCTGGTGTCAGTTCTAGTGGAATTCAGCCCTGCCTCTCACG | Hypo | FALSE |
| GRM5 | cg14379865 | 11 | TGCTGGCTAATTTCTTGATTTGCGACTCAACGTAGGACATCGCTTGTTCG | Hypo | FALSE |
| GRM5 | cg17173856 | 11 | GCTAGGCTGTCCCTTATGGGAATCAATACAAGATATCAACGAAATAAACG | Hypo | FALSE |
| HBB | cg06233985 | 11 | CAGGATTCAGGATGACTGACAGGGCCCTTAGGGAACACTGAGACCCTACG | Hypo | FALSE |
| HIPK3 | cg05501357 | 11 | CACTGCAGGTGCTACAAAGGTCATAGCAGCTCAGGCACAGCAAGCTCACG | Hypo | FALSE |
| HSPCAL3 | cg18740800 | 11 | CGGAAAAAATGGTTGTAGGTGTGACTATTATCACTAGATAAACTTTATGG | Hypo | FALSE |
| HTR3B | cg06531741 | 11 | CGGCATCAATTCCAAAACATTTGCATGGTGCTGGTATTGCCTTTGGTCCC | Hypo | FALSE |
| HYLS1 | cg17259265 | 11 | CAAACTTTTCAACTATAGTCCTCCCTTGTCTGACTAATTACATCCTGTCG | Hypo | FALSE |
| JOSD3 | cg21296602 | 11 | TGTTCCTTCCCTTTAATAGCACTTTTCCCCTTCTTTTTGAACAAGGGACG | Hypo | FALSE |
| JOSD3 | cg26570233 | 11 | GCTGCTGAATACGGCAGTGAGGGACATGCCATACCAGTCCTGGAGCTTCG | Hypo | FALSE |
| JRKL | cg03024246 | 11 | CACAGCCTTTTCCTGCAAGCCTTTAGATCTTAAATACTCTCGAACTTGCG | Hypo | FALSE |
| JRKL | cg10985320 | 11 | CGAGAGTATTTAAGATCTAAAGGCTTGCAGGAAAAGGCTGTGCTCTTGTT | Hypo | FALSE |
| KBTBD4 | cg25689955 | 11 | CGCAAGTTTATACCAGGTTCTCAAGCTAAGAACTTCAGGGCTTGAAGATC | Hypo | FALSE |
| KCNJ1 | cg05193832 | 11 | ATGTGGATTATTAGCTGTGTGCTGCATCTTGCCTTCCCTGGGTCACTCCG | Hypo | FALSE |
| KCNJ1 | cg14481339 | 11 | TAGCCTTGGTAGCTCAACACCTTTGGTATCTCACTCACTTAACTGCCACG | Hypo | FALSE |
| KIAA0652 | cg11178136 | 11 | CGGTCCAATGTCCGGTGACCACGGCCATATAGCAAGAGGTCACAGTCAAG | Hypo | FALSE |
| LMO2 | cg11822932 | 11 | GGGTCCTGCAGGGCTTGCTAAGGAATCCCCTGATGGCCTAGGATTCCACG | Hypo | FALSE |
| LOC220070 | cg19815589 | 11 | CGGCTTGTCTCCTGCTGAGACCAAGAGCCCCAAGACGGGCACTTCAGCAA | Hypo | FALSE |
| LPXN | cg23641267 | 11 | CTGAGAATCCAAGCATGAATCCACTTCTGCCCTACTTTTAAGGATTTACG | Hypo | FALSE |
| LRRC32 | cg20899321 | 11 | CGGATGAGAAAACAGTTTCCGGAAAGTGAAGTGACTTACCCCCAGAGTTA | Hypo | FALSE |
| MGC15912 | cg09657311 | 11 | GAGACTCCTTTACCTATCCCTATCTGTTAGGGTTTTCAGATGTCCTCTCG | Hypo | FALSE |
| MMP1 | cg02212280 | 11 | TAAACCAACTTTTCTTACCAGGAATGCTACAGATAGCACTGGTGACACCG | Hypo | FALSE |
| MMP12 | cg03179866 | 11 | TGTGAGGATAGATTCTACTCAACACCCCTTCAAATCACACCATAAGTTCG | Hypo | FALSE |
| MMP13 | cg13041032 | 11 | CATCAGGAACCCCGCATCTTGGCTTTTTCATGACATCTAAGGTGTTATCG | Hypo | FALSE |
| MMP20 | cg26757793 | 11 | CGGAGGGTCCAGACCTGTTTGACTCTATAAAAGGAGCTCAAGGTCGAAGT | Hypo | FALSE |
| MMP26 | cg12493906 | 11 | CGCCACTCACAGATTCAAAGAAAGGGCAAACTGGCAGAGTGAGTCATTGG | Hypo | FALSE |
| MMP3 | cg16466334 | 11 | GTCAAGCTGCGGGTGATCCAAACAAACACTGTCACTCTTTAAAAGCTGCG | Hypo | FALSE |
| MMP3 | cg18113270 | 11 | CGCAAGCCCAGGTGTGGAGTTCCTGATGTTGGTCACTTCAGAACCTTTCC | Hypo | FALSE |
| MMP7 | cg25511807 | 11 | GCAGAAAACACCAAATCAACCATAGGTCCAAGAACAATTGTCTCTGGACG | Hypo | FALSE |
| MMP8 | cg01092036 | 11 | ACAGCAGTATTTTCCCAGCCTTTAAAGAATTCAGCTTGTTTTCATGTCCG | Hypo | FALSE |
| MMP8 | cg03469158 | 11 | CGGCAAAGAAAATGCCTGTATGGAAGCACCAGACATATAGTAACTTGATT | Hypo | FALSE |
| MPPED2 | cg06790862 | 11 | ACATCAACCAGAGCAGATTCCAGCCTCCACATGTACATATGTAAGTATCG | Hypo | FALSE |
| MPPED2 | cg23577242 | 11 | GGGTTACCTAAGGGTTACCCAAGGAGTGTACTACGGCTTCTTCTCTACCG | Hypo | FALSE |
| MS4A2 | cg22197708 | 11 | CGCTGCAGCAGATGGTCTTGGAAATACAACAGGCTGCATTCTAACTGCTG | Hypo | FALSE |
| MS4A3 | cg17173423 | 11 | TTGCGGGCTGACTGACCAGTGTGCTAATCACATCTGCATTTGGGGCCTCG | Hypo | FALSE |
| MS4A5 | cg06066303 | 11 | CGGTGATAATTTGAAAGGAGATGATTTAGTTGGTACTTCAGTCTAGACCA | Hypo | FALSE |
| MS4A6A | cg03055440 | 11 | CGGCAAGGGAATAGTGAGATGAGAAAAGTCTTCCAGCATTACCTACCTGT | Hypo | FALSE |
| MS4A6A | cg04353769 | 11 | CGGTGATGGTTCAGGTTGTGTTTCTGGGTTCATTCTGGAAGCTCCCCCAA | Hypo | FALSE |
| MUC15 | cg03087937 | 11 | TACCTCCTAAGCCTGAAGGTAAGTGTGCGTTGGGTCACTTAGGTCTCTCG | Hypo | FALSE |
| MUC15 | cg16215361 | 11 | CGCCAAGGGCCGTTCAGCTCAATATGCCTGAGGTTCATACTTGGTTTCTG | Hypo | FALSE |
| NALP10 | cg20311730 | 11 | CCCTGCGTTTCATCTGCTTGTCTTTCTTGGAGCTTTGCACATGTATCTCG | Hypo | FALSE |
| NDUFV1 | cg06235429 | 11 | CGGGGCACTGTGGAAAGGAAGAAAGGCCTAGATTCCAGTCCAGCTCCACC | Hypo | FALSE |
| OR51E2 | cg25322008 | 11 | TTTGCCTCATACAGTCCTTTTATATCTGTTCCATTATGCAATTACTTACG | Hypo | FALSE |
| OR5I1 | cg25890048 | 11 | CGGTTGATTGTCTTGTCATACCTTGGAGGCAACATGAGTTCCCTGGTTCA | Hypo | FALSE |
| OR5P2 | cg13410437 | 11 | CGCATTCGACTGTTGCAAAGAAAGCCGCTGAACCAAGCTGGATGGCACAT | Hypo | FALSE |
| OR6A2 | cg05393484 | 11 | CGGCAATGCTCTAGACCATGGGCTAAGAGTTGTGGTATATAAAGGTTCAC | Hypo | FALSE |
| P2RY6 | cg15903837 | 11 | CGCTTCAGGGGTACTTGGATTCTGGAGTCAGACCACCTGGCTTCAAATCT | Hypo | FALSE |
| PC | cg16046376 | 11 | CGCCAAGATGAAGCAAGCTTTTCATTCGGTAAGTAAGAGGAAATGGTTTA | Hypo | FALSE |
| PGR | cg01987509 | 11 | AGTATGACTCTAAAATCTCAATACCCACTAGCAGTTATTCCACATTTCCG | Hypo | FALSE |
| PIK3C2A | cg11201229 | 11 | CGGAACCAACAAGAGCAAAAGATGTGGACAAAGAAGAAGCATTACAGATG | Hypo | FALSE |
| PTH | cg24816298 | 11 | CGGGATGACTTTATAGCTGTGTTTAATTATTTATAGGGTTACCATAAGGA | Hypo | FALSE |
| RAG2 | cg27310234 | 11 | CGGGAAAAGATTAAATGAGATAATGTATGCAAAGTGTTCAGCCAAGGAAG | Hypo | FALSE |
| RICS | cg20892287 | 11 | CGGAATGCAGAGCTGTTGTATCCTGATGAATCTACTGCTAAATATAGTCA | Hypo | FALSE |
| SDHD | cg04455759 | 11 | CGCCTAGACTCTCGCACTGAAAATTGTCTCTCCAGCTGTGTAGACCGCTT | Hypo | FALSE |
| SLC22A18 | cg19906550 | 11 | TTGCTTCTCTGAAGCGGTGAATGCCCTGGGGCTGGGGACGCACAGGCTCG | Hypo | FALSE |
| SLC22A6 | cg12428447 | 11 | GAAACAACAGAAGTCAGAGGCCGCTCTTGGAGTGGGACCTAAGACCAACG | Hypo | FALSE |
| SLC22A9 | cg23683201 | 11 | CGGTCATTCCAGGAAGCATAATTTTGGCGACTCAAAGGTGAGGTGCTTTT | Hypo | FALSE |
| SLC5A12 | cg20092728 | 11 | CGTGGAGAGGCAGAAAAGCTTCACAGAGTAGAGAAAACTCATACTAGATC | Hypo | FALSE |
| SLN | cg17971003 | 11 | CGCCTAAAGTAGTCCGTGGAAGCTGGCAATCACTGTGATGTCACTGATGA | Hypo | FALSE |
| SPI1 | cg06147863 | 11 | CGGCAGGCCCTTCGATAAAATCAGGAACTTGTGCTGGCCCTGCAATGTCA | Hypo | FALSE |
| SRPR | cg13952892 | 11 | CGGTGTGAGTAGTAGCATGAAATGTAGTGTGGACAGGTAAGCTAAGGCCA | Hypo | FALSE |
| ST5 | cg00186954 | 11 | CCAAAATGGCTTCATTCTCCAGTAGGGAATCCTAGAGCTAACCTGTGACG | Hypo | FALSE |
| TCN1 | cg20018806 | 11 | CTATCACTCTAGAGTAATTTTAGCTCAAAGTTTACTCACCACAAATCTCG | Hypo | FALSE |
| TEAD1 | cg19447966 | 11 | GGTTTATTTTCTTGAAAAGGCTCCAGGCTTCGGCTTGGAAAATCCCACCG | Hypo | FALSE |
| TEAD1 | cg19662708 | 11 | CGGTTAAGTTCTTTAGTGGTGATTTTGGTTCAGTCACCAGCTTTGCTTGG | Hypo | FALSE |
| TECTA | cg15737168 | 11 | GTGTTCATCTCAGACTTGTACTCATGTGCCACTTGAACTAGACAAACTCG | Hypo | FALSE |
| THYN1 | cg09360083 | 11 | CGCTAGGCCAGGGCAGCACCTCTTGAATGAGTTTTAGGACATTCAGAAGA | Hypo | FALSE |
| TNKS1BP1 | cg12603560 | 11 | CGCTTGGCTTCAGCTTGGAATTTGATGAGGTAAAGCCAGGGCCTAGTCCT | Hypo | FALSE |
| TPH1 | cg16935075 | 11 | CGGGCTAAAAAAGAAGTTGCACAATGCAGACAATATTTGATAACTAAGGG | Hypo | FALSE |
| TRIM49 | cg02284188 | 11 | TTGACTTTAAACCAAAGCTTTGATTCATGACCACTGGGATCCAGCCAGCG | Hypo | FALSE |
| TRIM49 | cg22767466 | 11 | CAGGCTTACTTGGGTACACTTCCTAGTTACAGGATTAGGACCTTTGCTCG | Hypo | FALSE |
| TSPAN18 | cg09390792 | 11 | GAGAAGTTTCTTCCTCGTGTGAAAATGCATTCCTGGGATGCTCCATGCCG | Hypo | FALSE |
| TYR | cg03417466 | 11 | CGTGAGATATCCCCACAATGAAGCAAATCGCCCAGTTATCAAAGTGAGCT | Hypo | FALSE |
| AHNAK | cg19764555 | 11 | ACAGCGATTTCCCACAGCCACTTCTAACTACATCGAGATTTTATTAAACG | Hypo | TRUE |
| AMPD3 | cg08035082 | 11 | CGAGTAAGTCACCAAGCTCGGAGAGGAAACTTCATTAGTGAGCACCCACT | Hypo | TRUE |
| ASRGL1 | cg12640109 | 11 | AGCGTTGCTTTTCAATCTGCAATTACAAAATCGTGGCATGCCACTTCACG | Hypo | TRUE |
| C11orf47 | cg25368651 | 11 | CGACACCCTCTGGATTGCTAGTCTCCCGAGTCAACCGTACTGCACGTGCA | Hypo | TRUE |
| CCND1 | cg06539449 | 11 | CGGGAGCCATGAATGAAAACCTTCTCATTGAGGCAAATCAGAACCGCACA | Hypo | TRUE |
| CCND1 | cg09637363 | 11 | CGGCCAGGTTCCACTTGAGCTTGTTCACCAGGAGCAGCTCCATTTGCTGC | Hypo | TRUE |
| CLPB | cg05812599 | 11 | ATTCCTATCTCAGGTGCAGTAGTTACCCTAAACATCTTTTTGAAAGGCCG | Hypo | TRUE |
| CTSD | cg04984200 | 11 | CTCGTCAGGTGAAGCCTCAGGGGCCGGGGCTCAGGGACGGGCAGGGGTCG | Hypo | TRUE |
| DSCAML1 | cg19703610 | 11 | GGTAACTTTCCTCCTGCTCCTGGACTCTTTACACAAAGGTGAGACCTGCG | Hypo | TRUE |
| DUSP8 | cg23121547 | 11 | AGGTGACGTCAGCGGAGCCCGGGCTCGGGGTGAAGCTGAGGCGGCTGCCG | Hypo | TRUE |
| EFEMP2 | cg02586730 | 11 | AGCATCCTGGGGCTGCGAGATGGTGGACACGGGTCAGGGGCCTCTGCCCG | Hypo | TRUE |
| EIF3S5 | cg12510755 | 11 | AAGAGCAGGACCAGGCAGAGCGGGCGCTGGGGTCTGCGCTGGAGCTTGCG | Hypo | TRUE |
| FEN1 | cg22704775 | 11 | CCCTCTACACCCGAAATCGCAGGACTACAAGTCCCTCAATGCCACTTGCG | Hypo | TRUE |
| FEZ1 | cg19433435 | 11 | GCCTCCTCATTTTTGGCTTGAGGTCCGAACCCAGTTGGAGCTGGGAGACG | Hypo | TRUE |
| FLJ25530 | cg06142324 | 11 | GAGCTCCCACGGCATTCAGTACATTAGATGGCGGGCACTGGGCCATTTCG | Hypo | TRUE |
| FOLH1 | cg06980460 | 11 | CGCCCGGCTTTAAAAAATGGTTTTGTAATGTAAGTGGAGGATAATACCCT | Hypo | TRUE |
| GSTP1 | cg22224704 | 11 | CGCAGGAGGCTTTGAGTGAGCCCTCCTGCCACGTCTCCACGGTCACCACC | Hypo | TRUE |
| H2AFX | cg07697569 | 11 | GGAGGGCGCAGAGGTGTGTCCTGGGGGCTTATAAAGGCGGCCTCGCGGCG | Hypo | TRUE |
| HPS5 | cg13777411 | 11 | AGGAGCTCTAGGCCAAATGGTTGGGCCAGCCAGGATCCCAGGACCCTTCG | Hypo | TRUE |
| HSPC152 | cg11296937 | 11 | AGAGTTTGTGCGGCGACATGAAACTGCTTACCCACAATCTGCTGAGCTCG | Hypo | TRUE |
| IRF7 | cg00645579 | 11 | CATTAGCGCTTGAGCCCAGGTGTGCAGATGAGGCGGTGGGTCTGGCCACG | Hypo | TRUE |
| KCNC1 | cg27409364 | 11 | GTCGGCTGGGCAGTGCAGCTTGCCCGTGCGGTAGTAGTTCAGGATGTGCG | Hypo | TRUE |
| KCNE3 | cg02595219 | 11 | CGCCTGCTTCCTGGACCAGAGACCGAAAGCCTCTCGCTCCGCTGGGCCTC | Hypo | TRUE |
| KCNQ1 | cg04719766 | 11 | CGCTTCTGTGACTGGCACTGTGTGTTATCCGGTGTCCTCAAGGTGCCTCT | Hypo | TRUE |
| KCNQ1 | cg16465939 | 11 | CGCCCAGCTTTGCAGTGCCAGAAAGCTGTTATCTCAGCACTGCTAAGGAA | Hypo | TRUE |
| LDHAL6A | cg07915343 | 11 | GGCCATGAGCTGGGCTGCAAGAGTCCTGGGGAGCAGCCAGAGAGCGGGCG | Hypo | TRUE |
| NAV2 | cg08550026 | 11 | GAGGTGCGGCAAGAGCCCCCGAAAGGTCTCTCTTGGGGTGACAGTCACCG | Hypo | TRUE |
| NUCB2 | cg00324733 | 11 | CGCCTGGTGCTTGCGTCCAGCGCACAAACCTGTCCTCCAGCCCCCGGCCC | Hypo | TRUE |
| OVOL1 | cg13496736 | 11 | TGCCCCCTCCCTCCCGGCTCCGCTCGCTCCGAAACTCCTGTTTGCAAACG | Hypo | TRUE |
| P2RY2 | cg10287137 | 11 | GGGGTAGGGTGGCGCGGTGGCTGGGCGCAAAGGTCCCGCAGTGGGCCACG | Hypo | TRUE |
| PDE3B | cg27143049 | 11 | GGTTGCGAACCAGGGGGCGCCCCGAACGCGGGGGTTGGGGTCTGGGAGCG | Hypo | TRUE |
| RCN1 | cg06755819 | 11 | CGGCCCCCTGAGGACAACCAGAGCTTCCAGTACGACCACGAGGCCTTCCT | Hypo | TRUE |
| RNH1 | cg15796682 | 11 | TGGAATCTAAGGCACTAGAGGGCTTGACGGCCACGTGAGGACGAACCACG | Hypo | TRUE |
| RPS13 | cg05592434 | 11 | CGACGTGAAGGAGCAGATTTACAAACTGGCCAAGAAGGGCCTTACTCCTT | Hypo | TRUE |
| SCN3B | cg13765785 | 11 | GCTGGCCTAGCAGCCAGGCTGTGGAAGGGTCCAGGTTGATTCACCTCTCG | Hypo | TRUE |
| SLC37A4 | cg17791936 | 11 | CGCCCAGCCCACAATTTGGAATTTTAACTTGTGGTTAGATTGTTGGGGAC | Hypo | TRUE |
| SNF1LK2 | cg10797910 | 11 | CCGGGTGGGGTTCTACGACATCGAGGGCACGCTGGGCAAGGGCAACTTCG | Hypo | TRUE |
| SPON1 | cg02994974 | 11 | GGATACGGCTGCAGTAGCCCTCTGACTTGGGCACTTTGTCCAGGGTCTCG | Hypo | TRUE |
| STIP1 | cg19357918 | 11 | TGAAGGGCAGCGATTTAAACCAATCAGCGCAAAGAGTTGGCAACCCTCCG | Hypo | TRUE |
| URP2 | cg14654385 | 11 | CGCCCGGCCTGGGTGATGGTTTTAATGCACGGCTCTTACCTGAGAACTTA | Hypo | TRUE |
| VWCE | cg11072113 | 11 | AAAGTGGCTAGGGCCCCAGGCCAGGGAGCGGTTGGACCCACAGATCAACG | Hypo | TRUE |
| WT1 | cg25563456 | 11 | CGCAGGCACTGGCCCCCGACATCCTCCAAAGCCAGGCAGAGCTAGGAGCC | Hypo | TRUE |
| ABCD2 | cg15876417 | 12 | TTTCATATTCATTTTATGTTGATCCTCTTGTCCCTCCTCCCTCATTTTCG | Hyper | FALSE |
| CD69 | cg05590294 | 12 | CGTAGCAGAGAACAGCTCTTTGCATCCGGAGAGTGGACAAGAAAGTAAGT | Hyper | FALSE |
| CLEC2B | cg17475456 | 12 | ACAAAAACTATTATCTCTCTCTCAAAGACAAATGCGTGCAAAGTCACACG | Hyper | FALSE |
| DGKA | cg13634319 | 12 | TGCTCAAAGTAATGCCACCCTATGTATTACCTGTGTTTCTCACTCTATCG | Hyper | FALSE |
| GPR92 | cg15464148 | 12 | CATTTCTACAGGGGGGTGCTCCCCTTGTGCTCCCTGTGCAGTTCAATTCG | Hyper | FALSE |
| LRMP | cg03521113 | 12 | CATGACCTTAGCCTTTCTCCTTAAGGGTTGTCAATCATAGTATAAACACG | Hyper | FALSE |
| MGC26856 | cg07684809 | 12 | CGCGTCTGGATTGTAATACAGATTGCAATATGCAAGCCACACAAGTTAGG | Hyper | FALSE |
| RPH3A | cg12681402 | 12 | CGCTAAGTCCCAATGACTTGGTTTAAAAGCTCAGCGGAGGTGCCTGAAAG | Hyper | FALSE |
| FAM19A2 | cg06438300 | 12 | CGAGACAGTAAAAGATGAGGAGGCAACTGGTATAAAAGCTGGACTATGTC | Hyper | TRUE |
| NEDD1 | cg14031452 | 12 | CGTCGGCCTGGGTTTAGGGACAGCGGCTACAGGAACCAATTCAACTACAC | Hyper | TRUE |
| PTK9 | cg18730023 | 12 | CGGTGGAAGGCACGCCCCCTTCAACCAGGCCGCCTCGAAAGCCAATTTCC | Hyper | TRUE |
| A2M | cg12058490 | 12 | CGCCTCAGTCTCTGGAAAACCGTGAGTTCCACACAGAGAGCGTGAAGCAT | Hypo | FALSE |
| ABCC9 | cg20025970 | 12 | CGATGGTGTACTACAAAATTCCTGCTTTGTGGATGCCCTCAACCTGGTCC | Hypo | FALSE |
| ART4 | cg04228042 | 12 | CGCCACCCTGGGTGTCTATAGGCTCATCTGGCCCTGCTGATAGGCCCTGC | Hypo | FALSE |
| ART4 | cg20967028 | 12 | AACTCCGACTTCTTTGCAAAACTGAAATCTCTGTGAAATAGCCAGATGCG | Hypo | FALSE |
| ATP2B1 | cg10501629 | 12 | CGGGCTCTCATGGAGCTCAGGTCCACAGATGCATTACGAAAAATACAGGA | Hypo | FALSE |
| ATP2B1 | cg24171152 | 12 | CAGTCCCACTGCTGCTCATGACTGTCTGGCTCCATTTTACAGATTTAACG | Hypo | FALSE |
| AVIL | cg06317209 | 12 | CGTGGCCTTGGACATGGGTAGGTGCTTAATTACCCAAGATGCTCCTTGAA | Hypo | FALSE |
| C12orf25 | cg02564061 | 12 | CGGGTGGTTGCTTTCAGCTCACCCTGTATATGCCAAGTTTAGGAGAGAGA | Hypo | FALSE |
| C12orf26 | cg02845923 | 12 | CGGAAGGAAAAGAAGGCTCAAACGTCACTGGAATCTCAATTCACAGATCG | Hypo | FALSE |
| C12orf50 | cg13976438 | 12 | CTATCAGTAGTATTCCTTTAAAACTGACCTCCTGTTGACAGTATATTACG | Hypo | FALSE |
| C12orf51 | cg24408511 | 12 | CGATCAGTGGTGTAACCCTGGGAATCAAGCCTTCCATTATGTCTGCCAGA | Hypo | FALSE |
| C12orf54 | cg12133004 | 12 | AAATTAAAATTAAAATCCCACAACATTATCCCTCCATTTTACCATTATCG | Hypo | FALSE |
| C12orf54 | cg21674595 | 12 | CGGGGTATACAAACTAGGGACATTAATTTATTCCAGGATTGACTTTGCCT | Hypo | FALSE |
| C12orf59 | cg26718420 | 12 | CGCTGGAGTACTCTGGTGAAGGATCAAGAATATTACCAGTTTTCTGATGA | Hypo | FALSE |
| CCDC77 | cg19471399 | 12 | CGGATATGGGTGACAACTTAAAGTTAAATTTCACTGTTTCAAAGCCATTT | Hypo | FALSE |
| CLEC12A | cg11905488 | 12 | GCATTCCCTACCTCTCTTAGGCAAACCTATAGCTATGTAACATGGCAACG | Hypo | FALSE |
| CLEC1A | cg07959477 | 12 | CGGTGTAGCACTGTGGTTCCTTCAGAGTCTGCAGAATAATAATAACTTGG | Hypo | FALSE |
| CLEC2A | cg24820250 | 12 | GTACATGAAAAGCTTTCTAGTCCTCTCCTACTGATCTCCATCGGTTAGCG | Hypo | FALSE |
| CLEC2A | cg27190239 | 12 | CGGTTGTTGTGGTGTTTACATGATTGACTTTACGATCCTTTTGTTATGGA | Hypo | FALSE |
| DCN | cg04088433 | 12 | CGGGAATTTGCCACAGGAGCCCTCAAAGCTGAGATGTAATTACACTAAAT | Hypo | FALSE |
| DKFZP779L1558 | cg17489451 | 12 | CGGGCTTGTTTCAATATCTTATATTTTTCAGGTGCCACTTGAAGAATGGA | Hypo | FALSE |
| DSPG3 | cg13798376 | 12 | TGCCTGAATCCAAGTTTCTAGGCTTGTCCTCTTTAGAAGCAAGGTCCACG | Hypo | FALSE |
| EMP1 | cg05885720 | 12 | CGCATATTTTGAATTGAAATAAGTTGTCAGGGTGCAGCAGAGAATAACAG | Hypo | FALSE |
| FAM71C | cg04282622 | 12 | ACTTTAAACATTTCACTGAACATAATTCCATATCCACAAACACATACACG | Hypo | FALSE |
| FLJ22655 | cg19229991 | 12 | AAGTTAGAGCACATTATTGCTCAGTTCCAGAACATCCACCAAGCCATGCG | Hypo | FALSE |
| FLJ36004 | cg15758700 | 12 | ACAATGTGGCAGATAATCCTACTTAGTAAATAGTGTTCCCACATGACACG | Hypo | FALSE |
| FLJ44112 | cg18777554 | 12 | CGCCCGGCCGAAAACAGGGTTCTTGATCAGGGTGTGCTCTGGAAACTGTA | Hypo | FALSE |
| FLJ46363 | cg20088913 | 12 | CGTGTTGTTTTTAGAGGGTAGCAAATTGGCTTATAAATTAAAAAGCGTTC | Hypo | FALSE |
| FLJ90579 | cg09111484 | 12 | CGCCAGTTTGTGAACGAGAAGCTGAAGTTGTCATGGGCATCATTGATAAA | Hypo | FALSE |
| GLTP | cg06236061 | 12 | TCAGACATACAGAGCTTGGCACCAATTCCTCCCTCAGTTTGGGCTCTACG | Hypo | FALSE |
| GPD1 | cg24210717 | 12 | CGGCACCATGGCTAGCAAGAAAGTCTGCATTGTAGGCTCCGGGAACTGGT | Hypo | FALSE |
| GPR109B | cg15447486 | 12 | CGGTGAATTAATTCTGCAACGTTGAGTACTCAGTTGGCATACAAGCACCC | Hypo | FALSE |
| GPR84 | cg21969640 | 12 | CGATAGCCCAGCACAGACTCATGGTAGCAGGAGAAGTTGGCGTCAGAGCT | Hypo | FALSE |
| GRIP1 | cg09414535 | 12 | CGCTAAGCACTGAACAGTGCATTCTGTTTAAGGCAAAAGGCGATGTATCC | Hypo | FALSE |
| GSG1 | cg08399444 | 12 | CTTGGAGTGCAGATGGCATCCTTCGGTTCTTCCAGACAAGCTGCAAGACG | Hypo | FALSE |
| GUCY2C | cg13131015 | 12 | TCCTGCCATAACGTAGCTGCTAATTACTGGCAAGCAGGCTGTGTTCCACG | Hypo | FALSE |
| GYS2 | cg04184278 | 12 | GGAATTCTTCCTCCTCTTTCTCGTCTTTCTGGGCAGGTATTGTGAGGACG | Hypo | FALSE |
| HAL | cg21682902 | 12 | CGATGAAAGTGCTGCTTAGTCAAAATAGCATCTGCATATCTTTGATGCCG | Hypo | FALSE |
| HDAC7A | cg08045757 | 12 | CGGCCCCCAGTGGAGCCCCCACCAGAGCCCACATTGCTGGCCCTGCAGCG | Hypo | FALSE |
| IAPP | cg15583072 | 12 | CGTAGCAAATACACAGTGTCCTTGTGCAGTTAATGGTGTGTCATACACAG | Hypo | FALSE |
| IL22 | cg26333641 | 12 | CGAGAAAGAGCAGGATTGAGATGTATACCTCCTTAGCCAGCATGAAGGTG | Hypo | FALSE |
| IL26 | cg08338368 | 12 | CTTGGAAGAATCCAAGCCTTATTTCCCCAGGAGCAAGATCACTGGTAACG | Hypo | FALSE |
| INHBC | cg03399971 | 12 | CGCCCAACACTGAACCGCCCTGTGTCCAGAGCTGCTTTGAGGACTGCACT | Hypo | FALSE |
| KERA | cg10094277 | 12 | GTAAAATATATGCACTAGTAGATCCAAATTTAACCCCTCCAACAACCACG | Hypo | FALSE |
| KLRA1 | cg10145725 | 12 | GATGATGTGGCCGACTTCAGGGACTACATGTCCCTGTATCAGCAATTTCG | Hypo | FALSE |
| KLRB1 | cg13995453 | 12 | ATTAAGTCCCAGTGCATTTTCATCCATAATATTCCTTTCAGAATACAACG | Hypo | FALSE |
| KRT1 | cg17405586 | 12 | TCTTGTATGGCTGCAGGCAAGCCAAACCCTTGACAGGCACTGCATCTCCG | Hypo | FALSE |
| KRT2A | cg16405957 | 12 | CGGCTCAAGCAGGAGAAGCTGGAAGTTGATCTCCGGCTTCCACCAGACAC | Hypo | FALSE |
| KRT4 | cg12610744 | 12 | CGGGGTCTGGTGGTGTGCACTCTGCTGCTCCATTTGCTGTCCAGTTGTTT | Hypo | FALSE |
| KRT6C | cg16112157 | 12 | CGGCATGTGGGCAGGTGATCACACAGTACACAGAACAAATGTTGCTCCTA | Hypo | FALSE |
| LUM | cg10401088 | 12 | CGAAAGCAGTGTCAAGACAGTAAGGTAAGTGCTGTTTTAACTATTGCACT | Hypo | FALSE |
| LUM | cg10634424 | 12 | ATGTTAATTTCATTTCTTTCTATTGGACCCTGAAAATATGCTCTGAAACG | Hypo | FALSE |
| LYZ | cg16097772 | 12 | TCAACATGAAGGCTCTCATTGTTCTGGGGCTTGTCCTCCTTTCTGTTACG | Hypo | FALSE |
| M160 | cg13986618 | 12 | AATCCTATTTAGGAGTTATAAGTCCCAAATACAGCAAAAACCTCCCTTCG | Hypo | FALSE |
| MGAT4C | cg18344063 | 12 | CGGGCAATAGATCAGAGGATATTGCCAGTTTTCTAATGGATTATTGTTAT | Hypo | FALSE |
| MGC13168 | cg07618900 | 12 | CTTTCTTCCTTGATCCCAGGGTGGAGTCAAATGAATCTAACAGACAAACG | Hypo | FALSE |
| MGP | cg13302154 | 12 | CGGTGTTGATTAAGGAAACAGAACTCATGGTGCACCGGATATCTCCATCC | Hypo | FALSE |
| MGST1 | cg11203041 | 12 | GGGTTACATTCTGTCATTGTCAGCCTTTTAAGGAGGCCTTGCCACCAGCG | Hypo | FALSE |
| MLL2 | cg13007988 | 12 | CGGGGAGACCTGTTGGTGCCAAGAAAGAGATCTATATGCCTACTAAGTCT | Hypo | FALSE |
| MLSTD1 | cg05697976 | 12 | CGTTTCTCAAACTCTGTCATGCTGAGGGCTGCAGTGACAACATTTTAGGA | Hypo | FALSE |
| MLSTD1 | cg21522988 | 12 | CCAGTCTCTCACCCTAAGATTCATTCAGTTTGTCACTCCTGTGAATAACG | Hypo | FALSE |
| NCRMS | cg03415518 | 12 | CGCTCTGTTCAGAAGGAGAAGCGCCTTTGGCAGCTAGAGTCCACATAGCT | Hypo | FALSE |
| NECAP1 | cg23205183 | 12 | CGGAAAATGGCATTAAGTTGGAATAGTGAATTGTTCAGGAAAGCTATAAA | Hypo | FALSE |
| NFE2 | cg09303642 | 12 | TGGCAAGGTCTTCCTGATCTCTACGGTCAGACATTGTGTCTATGTGCACG | Hypo | FALSE |
| NR1H4 | cg15381313 | 12 | CGCAAAGCCCCAGAATGAGGAATGTGACAAAACCAAGGAGCCCTGCAGCT | Hypo | FALSE |
| NUP37 | cg08085165 | 12 | CGAGCAGTGGTAACACTCTCAGGTTTAATCACCAAAGTAAGATTGCTTTG | Hypo | FALSE |
| OLR1 | cg07829804 | 12 | CGTAGCAGCAGAGAGCACTTTGAATGCAGAAAGAGCTAGTTTCAGTACTT | Hypo | FALSE |
| P11 | cg15727320 | 12 | CGCCTGCACCCTCAGACAAGGACAACCCAAAAGTGCTCTGCGGCTTTAGG | Hypo | FALSE |
| PDE6H | cg12572827 | 12 | CGGGCAGTGACATTGGGAAACACACAGTATGTCTCCCTAACTGGTATTGT | Hypo | FALSE |
| PHB2 | cg15778232 | 12 | ACTTCTAAACCAATGCGATTTCTTCTGGGCCTATTCAATTAGTTCTAACG | Hypo | FALSE |
| PLCZ1 | cg15736336 | 12 | CGCTAAGTGTCATGTTTGGTTGCAACAGAAGCAAAGCTTCTGAAATGAGG | Hypo | FALSE |
| PMCH | cg03535648 | 12 | ACATGGAACAATGGAAATTCTCATACCCTGCTTATCGAGGGCACAAATCG | Hypo | FALSE |
| PRB2 | cg27345534 | 12 | CGTGGGGAGGAATGCATATCAGAATATTGTAGAAAAAATACTCCTTGTGG | Hypo | FALSE |
| PRH1 | cg24653967 | 12 | CGGAACTGTGTCCAAGCAGTCGGCACAGTGTCAGGATTGAACTTTAGACA | Hypo | FALSE |
| PRH2 | cg14502651 | 12 | CGGAACTGTGTCCAAGCAATCAGCACAGTGTCAGGATTGAACTTTAGACA | Hypo | FALSE |
| PRH2 | cg23527067 | 12 | CGGGCATTTGTAAGATTGTATCTAAGTGGCTATGTCTGGTGGCTCCTGTT | Hypo | FALSE |
| PRR4 | cg12089169 | 12 | ATCTCTTTCATTGATTCTGCATCCCCTGTACAGCAAGGACACCATCATCG | Hypo | FALSE |
| PZP | cg01714932 | 12 | CGGTTCTGTAGAGTTTGAGTCACTGGCAGAAAGCAGGATAAGAAGTAGCA | Hypo | FALSE |
| R3HDM2 | cg00364814 | 12 | CGTGTGTTTATATGAATATGTTGTTAACAGTGAGATTTCTGATATGGTAT | Hypo | FALSE |
| RIMBP2 | cg24272907 | 12 | TCTCCCTGCCTATTTTTGGACTCTGAATCTAGAAGGTTCCAGAAGTTCCG | Hypo | FALSE |
| SBEM | cg17981339 | 12 | CGTGGTATATTTGGATAATGCAACGGAAAGGAAATGGTCAGTCTGAAGGA | Hypo | FALSE |
| SBEM | cg27160701 | 12 | CGGGCAGAGACCAGAAAGATGGAAACTCCCAAGAGTACCAGGACTGCTAA | Hypo | FALSE |
| SBNO1 | cg04398275 | 12 | AGTTCAGCAGGTAAGAGTTTTCCAAAGCCTCTCTTTCTTAGTGATTTCCG | Hypo | FALSE |
| SDR-O | cg02658214 | 12 | CGTCTTCATCACAGGCTGTGACTCTGGCTTCGGGAACCTGCTGGCCAAAC | Hypo | FALSE |
| SFRS2IP | cg12658552 | 12 | GAACACTTTACGTCCACTCTCTAGCAATTTTCAAAAATACAATATAGTCG | Hypo | FALSE |
| SLC16A7 | cg11871280 | 12 | TCCTTCTCCACCCTCTTGTATTTTGCTTGTTCTAATAATGGCTTTCCTCG | Hypo | FALSE |
| SLC41A2 | cg23855818 | 12 | GCCTTGCCAGCTATGGCAGCAATTGTCAGGTTTTCTTCCTGGTCAGGTCG | Hypo | FALSE |
| SLC41A2 | cg27149093 | 12 | TACTCCTTAGATCTCAAGCTTCGGGAACCACAGCAGATGAATCAGAACCG | Hypo | FALSE |
| SLCO1B1 | cg00995065 | 12 | CGTGGTATGTATGGAGACTGGAGATACCACCTGGAATAAGAGAGTCCCAA | Hypo | FALSE |
| SPIC | cg01917648 | 12 | CTCAAAAGCATCTTCAAATGCTTGACCCAGCTTGTCTTGTTCAACACACG | Hypo | FALSE |
| TAS2R10 | cg19120125 | 12 | CTATCTTAGATTACCTGCTGCAGAATGAGGCATATATTGGCTGCTCGACG | Hypo | FALSE |
| TAS2R13 | cg08658594 | 12 | TTCTTCTTCCTTCTCCTTTTTCTGCTCCTTCTTTCATTGTTGGCTCAACG | Hypo | FALSE |
| TAS2R48 | cg21874193 | 12 | CGAACCATTTCAGCATGTGGCTTGCTGCTAGCCTCAGCATATTTTGTTTG | Hypo | FALSE |
| TAS2R48 | cg25677688 | 12 | ACTGCCTTATCTACCCTAAATCAGCCAAACTAGCGGCAAGATGCAGTACG | Hypo | FALSE |
| TAS2R49 | cg12424907 | 12 | CGGAAAGGAACAAGAAAGCCTAATGTGGAGGTCATCTCAAATTTCGATGT | Hypo | FALSE |
| TAS2R49 | cg12791554 | 12 | TGAGTAACTCATGGAATCATATGGCTCCTGCCTGATCCAGCCTTAAATCG | Hypo | FALSE |
| TAS2R7 | cg06496654 | 12 | CCAATTCCCTTTCATGGTCCTGCATTGTCTTTCTGAGGCTAAGGTGTACG | Hypo | FALSE |
| TAS2R8 | cg08507270 | 12 | GGAAATGACTTCTAAAATTGCCATCACCAGCTAGAGTACTCATGAACACG | Hypo | FALSE |
| TAS2R9 | cg03363283 | 12 | TGTATTCTTATCACTCAGTTCAGACTGAAGAGTCTTGTATATCTATCACG | Hypo | FALSE |
| TAS2R9 | cg20090497 | 12 | TTGAATTATTGGCAAATGTCCAGACAACATTCACAATGCTTACTAGCACG | Hypo | FALSE |
| TSPAN8 | cg12965512 | 12 | AAATTACAGTGTCCACCTTAAAAACAAACCAAGCTATCAGAATGACTACG | Hypo | FALSE |
| TSPAN8 | cg15684563 | 12 | CGGCAGCTCTGGAATTCTTTTGAAATAAATTTAGATGTTTTGGAGGGCAG | Hypo | FALSE |
| WBP11 | cg22833175 | 12 | TTCTTTTTTATGTACTACCTGGTTTATCAGCTTTAACCTACAATATCTCG | Hypo | FALSE |
| ANP32D | cg13003163 | 12 | TGACTGTTGTCCAGGAAAAGTTCTTTCACATCGGAGGGCGTCCTGTTCCG | Hypo | TRUE |
| C12orf23 | cg06496078 | 12 | ATGCTAAGAAGTCAGGCGGAGGCTTTCCAGGGGTGCGCAAGCTCCAATCG | Hypo | TRUE |
| C12orf40 | cg22941086 | 12 | CGCTGAGGCAAGGCAGGCCTAAATAAATGAAAGCCTAAATTTTTGACAGG | Hypo | TRUE |
| CCND2 | cg08069899 | 12 | CGGGACCCCGAGTAGAAAGGCAACCCCCCCCAAAAGGCCAGAGCAAATTC | Hypo | TRUE |
| CD9 | cg08519905 | 12 | AGCTCGGCATCTGGAGCAGTTCAAGGCAGCAGCGAGCAAGTCCAAAGACG | Hypo | TRUE |
| CDKN1B | cg04875709 | 12 | AAGCGGAGAGGGTGGCAAAGCCCGTCCGAGTCTGGGCGGGTGCAAGCCCG | Hypo | TRUE |
| CHFR | cg20535781 | 12 | GCAGGAGGATCTCGAGCCCAGGAGTTCGAGATTAGCCTGAGACCTCATCG | Hypo | TRUE |
| CHFR | cg21432513 | 12 | CTGTAGATGGGGACCTTGACCTGAACGGGCAGTTGTTGGTCGCACAACCG | Hypo | TRUE |
| CLEC4D | cg09546307 | 12 | AGTTGAGGAGTGGCCTACAAATCCAAAGACACAGCTATAAAGACCAGACG | Hypo | TRUE |
| CLEC9A | cg17469479 | 12 | AGTTTACCGGGCCGCGAGGGTGCAGGCTGCGCAGATGGTGTGGTCCTGCG | Hypo | TRUE |
| CLEC9A | cg20098659 | 12 | TGCTTTTCTGCTAGACTGGCAACATGTTTTGATTCTTCTCAAATAACTCG | Hypo | TRUE |
| DNCL1 | cg02951021 | 12 | GAGCCGCAATGTCCTTCTCTATGTTGTATTTCTCCAGCGCCTGAGTAGCG | Hypo | TRUE |
| DPPA3 | cg08284151 | 12 | CGTAGCAGAAACTGATGACAGAGCCTCAAATTGCTACCAGGTAGCCCGGA | Hypo | TRUE |
| FLJ37587 | cg01703884 | 12 | AGAGGGTCCTCAGATCATCTCTTGAGGGATGCTATTCTAGGAAGGCTACG | Hypo | TRUE |
| GLT1D1 | cg16717225 | 12 | AACGTGGTCACTGCTGGTCCTAGTCCTCTTGGGAGGGACTGTGGTCACCG | Hypo | TRUE |
| KITLG | cg18422443 | 12 | CGGTAAATGCCCCAGAAGTTTGGCAGATTAGGCCAACCTTGTCCGCTCGC | Hypo | TRUE |
| KRT7 | cg09522147 | 12 | CGCCAGGAGGAGAGCGAGCAGATCAAGACCCTCAACAACAAGTTTGCCTC | Hypo | TRUE |
| MARS | cg24779015 | 12 | CGCCCGGCCTATGTACATTTTTGTTGTTGTTGTTGATAGGATGGATATGT | Hypo | TRUE |
| METTL1 | cg04819539 | 12 | CGCCTTGGCTTTGGACATGGTCTTCTGTCAAGATGCACATATGGGGGTAC | Hypo | TRUE |
| METTL1 | cg23106559 | 12 | TCTCCATAAAATCACAAAGAGTAACACAAGGCTGGGTGTCGTGGCTCACG | Hypo | TRUE |
| MFSD5 | cg27467734 | 12 | CGCAGTGGGGTGCCAGTGACCTGGAGGAGTGGGCCTCTGAGATGCACACG | Hypo | TRUE |
| NCOR2 | cg22820108 | 12 | AGTACGAGCTTTTTCTCCCAGCCTTGGCAGTAAGTAATAATTCCTCATCG | Hypo | TRUE |
| NTF3 | cg02554564 | 12 | CGGGTTGTATTTACATTGGATGTCTGCTTTATCCTGCGGTCTCTGCTTGT | Hypo | TRUE |
| OBFC2B | cg14816013 | 12 | GGAAACTTCCGGGAATGTCCGCACTCCCGCGTTCCACGGGGCAGCATCCG | Hypo | TRUE |
| PITPNM2 | cg08176694 | 12 | CGGGAAGGCTTGGACTCCAAGATGATTATAAAGGAATATCGGATTCCTCT | Hypo | TRUE |
| PUS1 | cg09218130 | 12 | GGATTAGGGTGTTGAGGGCGGGGCACCAGGCCCTCCTGCATCCAGCACCG | Hypo | TRUE |
| RERG | cg19205533 | 12 | AGCTAGGAGAGCCCTGTCAAGATAGGCTGCTGGTGTTCACATCTCCCTCG | Hypo | TRUE |
| RFC5 | cg18627459 | 12 | CGCCTGCACAGTGACCAGCCGCGACCTGACCCTGAGACCCTGGCACTTAC | Hypo | TRUE |
| RHOF | cg02539714 | 12 | GAGGGTCCCTGCCGAAGGCGGAGCCTGCTAATCAGGGGCACCTGGAGTCG | Hypo | TRUE |
| RNF41 | cg15870225 | 12 | CGGTGGGGCGGGGCGGGGAAGAGTAGTATGGCCAGGTGCAGCGGCTCACG | Hypo | TRUE |
| SLC2A13 | cg04575343 | 12 | GGTGGTGTCAGGGGCCATGCTGCTGCTCAAGCGGCAGCTCAGTCTGGACG | Hypo | TRUE |
| SMARCC2 | cg03184964 | 12 | CGGGGAAACCCCATTGGATTTCGAGTCCAACGCCTTAACCACTCGGCCAC | Hypo | TRUE |
| SOCS2 | cg11738543 | 12 | CGGCTGCAGCCCAGGATCTTGGCGGCCAAGTTCAGGGACTGACACTGCCG | Hypo | TRUE |
| SOCS2 | cg23412850 | 12 | CGCGGCACGCTGTCTCTAGGCATCTGAAAAAAGAAAAAAGAAAAAAAGTA | Hypo | TRUE |
| SSPN | cg19574623 | 12 | GGTGAGTCGGCTCCAAATGTTTTCCATATTTGTTCAGCCTCCATAATTCG | Hypo | TRUE |
| TMEM19 | cg04969878 | 12 | CGCCCGGCCTGATTTCATGTTTTATGTGAAATTAACTTGTTTGCCTGGGT | Hypo | TRUE |
| ULK1 | cg18081313 | 12 | CGCTGCTTGGCCTAAGTGATGAGTTAGCTGTCATTATAGTTAGGAACGAC | Hypo | TRUE |
| USP15 | cg02776251 | 12 | CTAGCGAAAGAACCAGCTCGCGGCTCCCGCCCACTTCTCCACTATCCTCG | Hypo | TRUE |
| YAF2 | cg14932684 | 12 | TTACCTGGTGGGGCTCTTCTTGTCTCCCATGGCTTGGCTATCACCGCACG | Hypo | TRUE |
| ELF1 | cg11793332 | 13 | CGTTGTGAAATTACTCATTGGGTAGCAGTTTCTATGTATGTGCTTTGCTG | Hyper | FALSE |
| DACH1 | cg19756611 | 13 | ACTTCTCTTCTACTACTACCGTTAGATTGCATGTCTCACATTCCATTTCG | Hyper | TRUE |
| KLF5 | cg09667226 | 13 | TTCTGGGTTTCAGCTTTTGAGTTTCAGGTCCTTGCACAACACCTAAGACG | Hyper | TRUE |
| STARD13 | cg26049501 | 13 | CGCTGAAAGCAAAATACACGTATTTGACGTGCCTCAGAGCTGACGAAGCA | Hyper | TRUE |
| CAB39L | cg17777592 | 13 | CGCTTGGTAATAGGAGGCAACCTCTATTAAATGGACGATAAAGGCTACTT | Hypo | FALSE |
| CG018 | cg11008571 | 13 | CGGCTCTGGGGCCAGAAGCCTAGGTTTTAATCCAGTTGTACCACTCGTTG | Hypo | FALSE |
| CLN5 | cg04290964 | 13 | TGACTGGATTAAACTGCAAATATCTCATGAAGCTGCTGCCTGCATCACCG | Hypo | FALSE |
| CPB2 | cg14662172 | 13 | CCTTGCAGTCCTTGTACCCATTGTTCTCTTCTGTGAGCAGCATGTCTTCG | Hypo | FALSE |
| CSNK1A1L | cg25306170 | 13 | TAGGATTATACTCAGTTCCTATCCCATCTCCTCATAAAACAAAATAATCG | Hypo | FALSE |
| CYSLTR2 | cg16886259 | 13 | ACGTTTTCATGCTAAATCTGGCCATTTCAGATCTCCTGTTCATAAGCACG | Hypo | FALSE |
| CYSLTR2 | cg18236297 | 13 | CGGGCGTGAGCCACCAAACCCAGCCTAGTCATTCTTTTAAGATAGGTCTG | Hypo | FALSE |
| DCAMKL1 | cg17470143 | 13 | AGTACGCAGCCTGAATTTTGATCCAGTTAATCTGACTTTCAATCCTGTCG | Hypo | FALSE |
| FLJ30046 | cg19782598 | 13 | TGCTGCTTACTTGTGATGTGCTGCCGCCCGCATCTGTGGGTGAGAACACG | Hypo | FALSE |
| FLJ40919 | cg07409200 | 13 | CGCTACTCAATCAGGAGAACAGTAACAGATCTGTGTTTGACAGAGGGCAT | Hypo | FALSE |
| FLJ40919 | cg26682500 | 13 | ATACCAACCAAGATATACTCCTGTAATATTCTCTGTGATTGACACCTACG | Hypo | FALSE |
| GJA3 | cg12428416 | 13 | CGAGCAGGCACTACACAAGTGCAAGCGTCCATGAGGAACCACAGGTTAAA | Hypo | FALSE |
| GPR18 | cg03404502 | 13 | CGGGAGAAACTGGACCTGGCTTTACCTTGAGTTCTTAAGCAAGTAACTGG | Hypo | FALSE |
| KCNRG | cg27533013 | 13 | AAATCTAATTAATTAGTACCTTCAATACCTTTAGTTGTCTCCCACACACG | Hypo | FALSE |
| KCTD4 | cg04439215 | 13 | CGGAAAAGAGAATTTGCATTTAACTGTATCAGGGAAGGGATTTGTTGTGA | Hypo | FALSE |
| KCTD4 | cg21457147 | 13 | TTGTGTTTCCCTTCATACTCCTTTTCTTTTTCTCTTCTGTTTATTTTACG | Hypo | FALSE |
| LGR8 | cg21431536 | 13 | TCTCTTCAGCCTCAGATTGATTACAATGTTCTTTCTACTTCATTTCATCG | Hypo | FALSE |
| LMO7 | cg22227965 | 13 | CGGCCAGATATTTGGTAGGTGACTAAACTATACTGCAGTGTGTTGAGAAG | Hypo | FALSE |
| LNX2 | cg10100220 | 13 | CCCATTTTGAATCAATTCTGTATCCTCATGTGTTAGACTTCCACTTCACG | Hypo | FALSE |
| LOC122258 | cg21624282 | 13 | CGGTTCTCGGCCGGAGCTCAGTTTCTTGCCAACAGCACAGCAGGAGGACA | Hypo | FALSE |
| MBNL2 | cg02838877 | 13 | GTATTTATCAAATGGCATCTAAGATGGTTAAAGCACACCTAATCCTCTCG | Hypo | FALSE |
| NEK3 | cg19524009 | 13 | CCTCATAGGATTACTGTGAACAACATCTGGTTACCCTTTACTTGTAAGCG | Hypo | FALSE |
| PAN3 | cg08923109 | 13 | CGGGAGTATGTAGAGGGTAGTTAGAGACTAATTTCACTTGTGTATTTTGT | Hypo | FALSE |
| PIG38 | cg11635563 | 13 | CGGAGACCTTCTCCAAGGGCATTCAATTGCAGTGGCCAGAAATGGAAAGG | Hypo | FALSE |
| POSTN | cg23032612 | 13 | GAGTTTGTTTTTAATCAACAGCCTTTACCCCCTTGTGATTGTCAGACTCG | Hypo | FALSE |
| RB1 | cg13221796 | 13 | CGTTGCAGATGAGGAAACAGGCTCAGAGGAGTTAATTTGTCCAATACCAG | Hypo | FALSE |
| RCBTB2 | cg25165199 | 13 | ACATCCTCATTATTTCAGCATTTGTACTACAGGGGGCTACAAGACTTCCG | Hypo | FALSE |
| RNF113B | cg23934633 | 13 | CTCATCCTAAAACACAGGCGCTTGAAATGCGTATTTAAAAGCAACACACG | Hypo | FALSE |
| SACS | cg01498098 | 13 | CGTCAGGTAGATTTCTGTACCAGGGTGCTGCAGTGAGATATATGCAACCA | Hypo | FALSE |
| SACS | cg25206802 | 13 | AAACCTCTAAAATCAGGAGTCCAATGGGCATGCATTCAAGCCTCTAATCG | Hypo | FALSE |
| SCEL | cg21063899 | 13 | ACCTCTACCTGACTGTATTAGTGAACAGTTCAGAGGTTTCTTGCTCAGCG | Hypo | FALSE |
| STOML3 | cg03712843 | 13 | AGCTCCATTGGTCTCCTATCAGTGCCTCCAAAGCTTGATATGTCTTCTCG | Hypo | FALSE |
| STOML3 | cg05380910 | 13 | CTTTTTTGGCAACATAAGGTACAGAGCACAGGTTAGGTCATACACACACG | Hypo | FALSE |
| TDRD3 | cg24949049 | 13 | TTTTACAATACATCTTTTACTTTTCCTATCTCTTTTCAGTTTTTTTTACG | Hypo | FALSE |
| TMTC4 | cg05950276 | 13 | ATCCCATTGCTGGCCTGAGGTGATAGACCTTTCTGGACAAATGGCTTTCG | Hypo | FALSE |
| TNFSF13B | cg09646392 | 13 | TTCACTGCTTTGCCCCAGCATTGAAATATTGATTCATCTTTCAACAAACG | Hypo | FALSE |
| TPTE2 | cg19950767 | 13 | CGTGCCCAAGACCTGGAGAACTGATAATAAATTGTGGTTTATCCTTGCAA | Hypo | FALSE |
| UTP14C | cg05482722 | 13 | ATCTTCTGAAAGCACCTTCTAGTATCTGTTGACCGTTGACATTAACATCG | Hypo | FALSE |
| UTP14C | cg24167928 | 13 | CGACAACCTCCAATGAGGACAAGTTTAAGCGAAGGAGGTGACTCAACCAT | Hypo | FALSE |
| B3GTL | cg14714578 | 13 | CTGGGTAAGTAGCGGGCGGCCAGGCGCGCAAGGGCGAGGCGTGGGGTTCG | Hypo | TRUE |
| BRCA2 | cg27253386 | 13 | CTCCAGAGGTGCAGTTCTTTTTTGGCCGGAGTAAGCTGACAAAAACCGCG | Hypo | TRUE |
| DGKH | cg00109274 | 13 | AGGTAGACACTTTGCGGATCAGTTTCTGGGGTCCCTCTTGCTCCGCTTCG | Hypo | TRUE |
| DLEU1 | cg05701114 | 13 | CCTGTCTCTCCCGCTAGATTGATGAGATCAGGCATCACTCGAAAATGGCG | Hypo | TRUE |
| DNAJC15 | cg00131557 | 13 | CTTCAACTGCTGGTTAATTTTTGCTCTAAAAACTTGATGGAGGCCAGGCG | Hypo | TRUE |
| FAM10A4 | cg19307060 | 13 | AGAAACCTGGCTTGAAAAGTTGATAGCATAGGCAGCCGCCCCCTTCTGCG | Hypo | TRUE |
| FLJ26443 | cg26815414 | 13 | CGCACTTCTGTTGTGTATACTATGCAGTGTGTGACACTTTGTTACGGCAG | Hypo | TRUE |
| KLHL1 | cg20349377 | 13 | ACTGATAACAGCTTTCATTCCGAGGCTACACACCAAATGCACTGATTTCG | Hypo | TRUE |
| LATS2 | cg12900467 | 13 | AATGCCAACAATGTAGCGAATGTCCCACTTGGGTCTGCGCTTTGGAACCG | Hypo | TRUE |
| LMO7 | cg22783258 | 13 | CGCCCGGCCCCAAAAATATTTTCTTAATAAAGTTAGTGAGAAAAGTGGCA | Hypo | TRUE |
| MLNR | cg07935568 | 13 | CCGTACAGTGCTCAGTCCTGTAACCAAAGCTGTCTAGGGTGCAGACATCG | Hypo | TRUE |
| NUFIP1 | cg18843688 | 13 | CGGCCAGCCTTGGAATTTCCATGCTTCCACATCGTGGTATTGGAGACAGT | Hypo | TRUE |
| PABPC3 | cg00094319 | 13 | TGGCTTGCCCTTTATAACATCAAAATTCATGGTGTCCAGAGCATGCTCCG | Hypo | TRUE |
| RB1 | cg03085377 | 13 | CCTTGGTGGCCACTGGCTTCCTCTAGCTGGGTGTTTTCCTGTGGGTCTCG | Hypo | TRUE |
| RB1 | cg10552385 | 13 | GCGGTGGCGGCCGTTTTTCGGGGGGTTTTGGGCGGCATGACGCCTTTCCG | Hypo | TRUE |
| RB1 | cg27182551 | 13 | CGAGGACCTGGACACGGCCATCAAGGACTTAAGGTCCAAGCGAAAGCTCA | Hypo | TRUE |
| RCBTB2 | cg16000832 | 13 | GAGCTTAGGATGAGAGCGGCCTCCGAGCAGATGATCACCCTGGAACGACG | Hypo | TRUE |
| RNF17 | cg17806989 | 13 | CACTGTTTGGCTATCTGCAGGGGCTGGCCTCCAATGATTGGTCGCTGCCG | Hypo | TRUE |
| STK24 | cg10057295 | 13 | CGGAGGCTGAACCCCACCATCTCTGGGATCCGCAGCAAATCAGAAGCCCC | Hypo | TRUE |
| TMTC4 | cg07980015 | 13 | CGTTGCCCCCACGTTATAGGTGAGTTCCTTGAGACCGTGAAAGTCACTTG | Hypo | TRUE |
| UGCGL2 | cg25169784 | 13 | CGCAGTTCTCAAGTGTTACTACAGGTTGGAATCACCTGGGAGAGCTTTTA | Hypo | TRUE |
| C14orf39 | cg27398547 | 14 | CTGAGCGAGTCCAGCCCAGGGCTCCGGGGACCGTTTGTAGTTAGGATCCG | Hyper | TRUE |
| SCFD1 | cg24478145 | 14 | CGGCAAGGTGATTTTGCAATTACTACAAGGAAAGAGGAGAAATGCTAATT | Hyper | TRUE |
| AKAP6 | cg24812523 | 14 | CTACATATTTTAATTCCTATATGACTCTTACAGGCCTTTGTCTTAACCCG | Hypo | FALSE |
| BAZ1A | cg00169548 | 14 | TTACAAAGTGTCATCATGCTTGTAGGACCCCAGCATTCTTGAAACTAACG | Hypo | FALSE |
| BDKRB1 | cg10238171 | 14 | ATCAAAGTCAGGTGAAACATGTCAGGGCTGAATGCAGCCACCAGAGTTCG | Hypo | FALSE |
| C14orf103 | cg12466095 | 14 | GAGGAGACTTTGCAGTATTTTTCCACTGTTGATCCCAACTATCGTTCTCG | Hypo | FALSE |
| C14orf105 | cg15661409 | 14 | CGGCTAAAGCGTCATTTGATTTTTCTGTCGATGACTTGAGTTGCCTTTGA | Hypo | FALSE |
| C14orf108 | cg09329225 | 14 | CTTTTTCTTATCCGTTTTCATTTCTTTCACACAAGGAGATGCTTTATACG | Hypo | FALSE |
| C14orf155 | cg20103550 | 14 | CGCTTACTGAATAAGGTGGGATCCAACAAGAGTGTAGTATGGAATGCAAT | Hypo | FALSE |
| C14orf29 | cg17352004 | 14 | CGTAGCAGCATGTAGCAGAACCTCATCATTGTACCAAGGAGTTCACACCT | Hypo | FALSE |
| C14orf54 | cg18075299 | 14 | AGCTCTGTTTCTAAGCAGTTTCCCTCTAAAAATGCTATATTCTTTTAACG | Hypo | FALSE |
| CDH24 | cg03770548 | 14 | CTGAGCAGCTGCTTGTCCTGCAGGTGTGGATCCATGGGGTAGCCTCAACG | Hypo | FALSE |
| COQ6 | cg10784821 | 14 | TATACACAGAGTTGTGCAACTACCATCACAATTTTAGAACACCTTCATCG | Hypo | FALSE |
| CTAGE5 | cg13277939 | 14 | CAAAAACTGGCCCAAGTTCACAGCAAGTGATTTTTCAGGACCAAAATGCG | Hypo | FALSE |
| CTSG | cg24355048 | 14 | CGTGGGACTGGTGTTTAAAAATCTAGACATGAGCTGATGGTACTGTTATT | Hypo | FALSE |
| CTSG | cg24777950 | 14 | CGGCTGGAGAAAGAAAAGGAAGAACAAGGCTCTGACAATCACAATTACTT | Hypo | FALSE |
| EXDL2 | cg05300132 | 14 | CGCCGCCGAAGGAGTAAAACGAGTCCTGTGACCCAACAGCCACAGCAGAA | Hypo | FALSE |
| EXDL2 | cg07366967 | 14 | TTGATTTACATTAACCTGCCTGGCGCTGTGGACACTTCAGTTTGCATCCG | Hypo | FALSE |
| HSPA2 | cg10846410 | 14 | CGGCGTGAAAATGGACTAATGTAGCTGTTAATAGTCAAGTTCTCAAAATC | Hypo | FALSE |
| HSPA2 | cg13135121 | 14 | CGGCCTCTGATGCACTCGAACTTCCAGCCCTTGGAGCAGACATAGGGTTT | Hypo | FALSE |
| IFI27 | cg20161089 | 14 | GCTTCCCTATGGAAAGCTTCTGACCTGGAGCAAATCACTGAGCCAGATCG | Hypo | FALSE |
| JDP2 | cg22143352 | 14 | CGCCAGCTCTGGTCCTTGGTGGCTGGCAGGGGTTAACACTACCACACCTA | Hypo | FALSE |
| KCNH5 | cg06501084 | 14 | AATGACCTTAGCCTATAACGGAAAGTGATCAGCTTCCCCCAAAGCAGCCG | Hypo | FALSE |
| KIAA0317 | cg26666286 | 14 | CGCCCGGCTTTCTGAGACTCTTAAACTCAGTGAAGATCAGTCTTTATTTA | Hypo | FALSE |
| L2HGDH | cg15996947 | 14 | CAAATGCTTCACTGTGCTAAACACCTGCTGACCTTATCTCGTGTAATCCG | Hypo | FALSE |
| L2HGDH | cg20189937 | 14 | ATCACGTAGCAAATGCTTCACTGTGCTAAACACCTGCTGACCTTATCTCG | Hypo | FALSE |
| LTB4R | cg25775449 | 14 | CGGGCTAGGAATAGCTAGCAGCATCTTAGAAGGAGCCCAGACTTGGCAAA | Hypo | FALSE |
| MIA2 | cg24603941 | 14 | CGGGAATCCCAAGTGAAGTTTAAGCCAATTGTTCAGGTTGTAGAGATGTC | Hypo | FALSE |
| MYH7 | cg05744229 | 14 | CGCCCATGTTTAGACCTGCACATGTGTGCCCAGTGACTGGACCTGGTACT | Hypo | FALSE |
| PPM1A | cg17884373 | 14 | CGGGTATAATCCATAGAAAATAACTTGGTGAGTTGGTCTGGTGCAAAAAG | Hypo | FALSE |
| PPM1A | cg23504707 | 14 | GGGCACACCCTCTCCCTGAATGAAATTCATTTAGGGGCACTGTCTGCTCG | Hypo | FALSE |
| RNASE3 | cg15910079 | 14 | GGTCCACTTGTGCAATCATCCTTTTTATTTGATGACTTGGCTGAGCAACG | Hypo | FALSE |
| SERPINA1 | cg24621042 | 14 | AAGAGGTACAGTCACACTGCCCAGAGGATTACTAGAAATGACAGGCCTCG | Hypo | FALSE |
| SERPINA5 | cg25889160 | 14 | CGGCAGGATCACTACTGGGTATCCAGAGGCAAGTCCCACTACTACTAGGT | Hypo | FALSE |
| SIPA1L1 | cg11077161 | 14 | CATAGTACTTACTATATTCTTGTGCCATGGCTACCGAAATTTAGACAACG | Hypo | FALSE |
| SOCS4 | cg08292050 | 14 | CGCCATCTGAAGACGGAGCAGGCATTAAGCAGTATAAAGAGATGAGTGGT | Hypo | FALSE |
| SPATA7 | cg27539233 | 14 | AGGTGCAAGCACTCTTAGCTTCCCCAGCTGGTATCTTAATAGGTCACACG | Hypo | FALSE |
| SPG3A | cg06832950 | 14 | TACCAGATCCATGATCTCTGCTAATTCCTCATGGTAAGCAACTCCTCACG | Hypo | FALSE |
| STON2 | cg02657438 | 14 | CGGCAAGAGAGGCTGATCTGTCTACATTCTGAGTACTGCCCTTGGCAAGA | Hypo | FALSE |
| WDR20 | cg18412984 | 14 | CGACAGAACATACCCTGGTGTTTTAAGATTAGGGAAAGTCGGATAACATC | Hypo | FALSE |
| ACTN1 | cg25126812 | 14 | CGGGCGCTTGGACCTAATCTCCACGCACACTGAACTAGGCGGACACACTA | Hypo | TRUE |
| AP4S1 | cg01546046 | 14 | CGCCATACTAAAAGCCAAAATGGCTGCCCCGAGGAGGCCCGCACCGCGTA | Hypo | TRUE |
| C14orf126 | cg15247031 | 14 | ATCGGCTGGGCGAATTTGCAGCCGGGCGTGCAGGCACTGCTGTAGGAGCG | Hypo | TRUE |
| C14orf147 | cg13846682 | 14 | GTGACCAGCAGGTACTGGTAGTAGAACCAGGACATCTGCTTCCAGGCCCG | Hypo | TRUE |
| C14orf149 | cg23709121 | 14 | CGGCGAAATGCCAGGTCTTTGTTGTTTGGTCCGAAATGTCTCTTCAGTCC | Hypo | TRUE |
| CKB | cg22392276 | 14 | CGATGATGGGGTCGAAGAGATCCTTGAACACTTCGTAGGACTCCTCGTCG | Hypo | TRUE |
| CPNE6 | cg22082462 | 14 | CGCCGGGGGCTGTAACTGTCGTGGTGTCACAGTGAGTTTATGTACTGGCG | Hypo | TRUE |
| CRIP2 | cg17818900 | 14 | AGTACACGGTCTTGTCGCACTTGGGGCATTTGGAGGCCATGGTCGGTGCG | Hypo | TRUE |
| CYP46A1 | cg01117627 | 14 | CGCCCGGCCCGACCCTGGCCTGGCCTGCCCTGCCCCGGAGCCATGAGCCC | Hypo | TRUE |
| DAAM1 | cg19168631 | 14 | GTGGTCCCAATCTATTAGCGGAGCCGGGACAGCTTTGCTGTCGGGACTCG | Hypo | TRUE |
| DLK1 | cg06504820 | 14 | CGCATCTGTCTTTGTCCACAGTGGCATGCATGGGCAGCCTCACCAATGTG | Hypo | TRUE |
| DLK1 | cg09971646 | 14 | CGGGCTGAGGTTGCAACAACACTGCTTAGAGATTCTGACACTTTAACAGG | Hypo | TRUE |
| ERO1L | cg08554114 | 14 | CGGATAGACTAGTCCCAACTCTGAATGTTAAAAGACCAGGACTGGGTATC | Hypo | TRUE |
| GCH1 | cg01838317 | 14 | TCCAGGAGCTGGGATCTCAGTGAGAAAGACGCGGTCTGGGCGCCCAGTCG | Hypo | TRUE |
| KIAA1333 | cg07906495 | 14 | CGGGCCGGGAAAAGTGGCACTGAGGCTCTGGAACTTCTGCCCAGCTCTCC | Hypo | TRUE |
| KNS2 | cg23090046 | 14 | CGGAGCCTCGCCCATTGAATCAGCATGCCCTCCCGGCTGGCTGCTGAGTC | Hypo | TRUE |
| LGMN | cg02628202 | 14 | GCTCCAAGAGCTGGTATGATCTTTCGGTAGATGCTTCTGGAATCACCGCG | Hypo | TRUE |
| MEG3 | cg15373285 | 14 | CTGGGGTCCACACTGCACTAAACCTGTGTATTTGGATTCGGAAAACCTCG | Hypo | TRUE |
| MEG3 | cg16567044 | 14 | CGTCCACAGCTAATGACTAGGGAGGTGAACATTGACCGTCAGGTCACTAG | Hypo | TRUE |
| PSME2 | cg05874478 | 14 | GACCAGAGATCTAGCGACTGAAGCAGCATGGCCAAGCCGTGTGGGGTGCG | Hypo | TRUE |
| RCOR1 | cg08707819 | 14 | CGCCGCCGCCTCAGCCGCCGCCGCCCCCAATAATGGCCAGAATAAAAGTT | Hypo | TRUE |
| RHOJ | cg18771300 | 14 | CGTGCCCACTGTGTTTGACCACTATGCAGGTAAGAAAAAGTGGGAAACTC | Hypo | TRUE |
| RTN1 | cg25097436 | 14 | CGGGCGACTGGGAATATTCGCGGGCTGGTAGAAAACAACAATTTTATTTT | Hypo | TRUE |
| SUPT16H | cg25820971 | 14 | GAGAGTGCGGGATTCCTGGGCCGAGAGCGGGTGGCTGAGCCGGGACCTCG | Hypo | TRUE |
| XRCC3 | cg13042487 | 14 | AGTATTAAAATAACTGTTCAGACCTCTCCCACTTCGATGCGAAGCCAGCG | Hypo | TRUE |
| CHRNA7 | cg04785227 | 15 | CGGGATTCTTTTAAGACTCCAAGAACTAGGGAAAGGCTCACCAAAAGGTG | Hyper | TRUE |
| ANPEP | cg13042288 | 15 | ATTAACCAGGGCTCCAACAGGCGAAGGTCACTGGACTGGGCAGGGGCACG | Hypo | FALSE |
| C15orf24 | cg21484964 | 15 | ACATAACCAGACTGACTTTCACAAAGTACATATAGCTTCAGACCAAATCG | Hypo | FALSE |
| CAPN3 | cg23414431 | 15 | ATCACACTTCCACCTCGCTGAAACACTGGAATCTGTAACAGAGCAGCACG | Hypo | FALSE |
| CHD2 | cg06572974 | 15 | CGAGCACCATTTGTTATTGACTGATGTGAGGTGGTTGGTCTTTGTTAAAT | Hypo | FALSE |
| CHRM5 | cg22927134 | 15 | CGACCACAAACTGGCTCTTTTAGATGCTTTGTGGTGCTAACACTGGATTG | Hypo | FALSE |
| CLK3 | cg08025786 | 15 | CGCTCTGCCACAAGGCACCTGACTGAAGCTGATCTGCTGATCTCGATGGA | Hypo | FALSE |
| CYP19A1 | cg15329467 | 15 | GAACTTATCCTATCAGGACGGAAGGTCCTGTGCTCGGGATCTTCCAGACG | Hypo | FALSE |
| FBXL22 | cg13288195 | 15 | GGGAACGGAAGTGCAGCAGGGACCAGAGTGCGGGGTCCTCAAACACGTCG | Hypo | FALSE |
| FGF7 | cg27525902 | 15 | CGCTGTTTGCTATTTGACTTCTGTTTGCAATGAGAGATTAAGAATAGGGA | Hypo | FALSE |
| FLJ35695 | cg21039679 | 15 | CGGAACTGTCAAGACCAGAATGAGCAAAGATAGTGATGCACCCCCAGAGC | Hypo | FALSE |
| GABRA5 | cg08099701 | 15 | CGCTTGCCCTCTGAAATTTGGCAGCTGTAAGTTATTTTCACAAGTAAGAG | Hypo | FALSE |
| GABRG3 | cg27592112 | 15 | CAAATGTGACTGGTTGAGTCTTAGCCCCTCCAGAGGTCAAGCTGATATCG | Hypo | FALSE |
| GATM | cg22340747 | 15 | GACCATTAACTACTTGGATAACCTTGAGCAAGTCACTTAATCTCTCCACG | Hypo | FALSE |
| GCNT3 | cg06817269 | 15 | CGCCTTGTGAAGAGATCATCCCTAAGCAGGAGAGAAGCTACTAAAGGTGA | Hypo | FALSE |
| GCNT3 | cg23877385 | 15 | AGTTTGTACCTGTGTCACCAACTATTCATAAAAGCCTGTCAGTGCTCACG | Hypo | FALSE |
| GNB5 | cg19366178 | 15 | AGAAATCTACGTTTCCCAAGTTTTATGGGAACTGGCTATTCCTTGTCCCG | Hypo | FALSE |
| GOLGA8A | cg01714513 | 15 | CGCAGAGGCTTTCAGCACAGCCCAGGGTGCCCGGGACTGAAAACTCCTTC | Hypo | FALSE |
| HBII-13 | cg07478122 | 15 | AGGATCTAGAACCAACTTCCTTGTATTGCACTGGAAAAACCTACAACACG | Hypo | FALSE |
| HBII-436 | cg11166999 | 15 | CGATACCATTTTTTGACCACTTAGTTGATGCCTCTGAAAGGAAGAGAGAA | Hypo | FALSE |
| HBII-438B | cg09839960 | 15 | ACATCTGGAATGAGTCCCTCAGCATCCTCAGACAATTATTCTCATCATCG | Hypo | FALSE |
| HBII-438B | cg18499731 | 15 | GCAGGCCTAACTGGTGAACTCCTCAATTATCTCACAATAGCACTATCACG | Hypo | FALSE |
| LDHAL6B | cg18809535 | 15 | TGGAATCCTTTCAAAATAGGCCTCCAGCGCCATAGACCAGAAAGCAGGCG | Hypo | FALSE |
| LIPC | cg01733599 | 15 | GTCGGGGTAGGTGGCTTCCACGTGGCTGCCTAAGCCTCCCTGTGACAGCG | Hypo | FALSE |
| LTK | cg07930578 | 15 | TATCATCTATTGACCTTCAGTGCTACTAAAAACACTCGGATCTTCTAACG | Hypo | FALSE |
| MEF2A | cg00183782 | 15 | AACCGAATTTTACAAATTTCCTCAACTGGGTCTAAATTAAGCCCCCCTCG | Hypo | FALSE |
| MKRN3 | cg16131766 | 15 | CGCTTTTCACCAGCAAGGCATTAGCAGAGAGCACTTCTGATCCGAGGCTA | Hypo | FALSE |
| MKRN3 | cg20769842 | 15 | CGGATCAGAAGTGCTCTCTGCTAATGCCTTGCTGGTGAAAAGCGTATCCA | Hypo | FALSE |
| MYEF2 | cg20603888 | 15 | AATTAAGCAAATATAAGTCTCTTGCCATTTCAATGCCTAGGCACCCTTCG | Hypo | FALSE |
| No Gene | cg19195724 | 15 | ATACTAAAGTGCATACTGACTCATAAGACAGGATGCTAATGCCCTCTTCG | Hypo | FALSE |
| present | | | | | |
| NUSAP1 | cg19468534 | 15 | CTACAATCCTTTTAGATATTAGAACTTTTTGATACAGGGTCTTGCTCTCG | Hypo | FALSE |
| NUT | cg18768283 | 15 | CGGAAGTGTCCCCTGTTCAAGAGAATCAAGTTGCTAATTGCCATCCTTTC | Hypo | FALSE |
| PLCB2 | cg02240622 | 15 | GAATTCCCTTAGCTCCAGCCTCCACTGGGCAGTTTATTATCTTAATTCCG | Hypo | FALSE |
| PLIN | cg01035422 | 15 | CGGCTGACCGCCACCTCAGTCTCACAGAGCCCAGGCTGCAGAGTGTCTCC | Hypo | FALSE |
| PLIN | cg01348757 | 15 | GGCTGTCTGGGTGCTCTTGATTAGTGATAGAATCCTAGTCAACACTGTCG | Hypo | FALSE |
| PWCR1 | cg10832166 | 15 | CGATCCAAGCACATTTGACAAGGGGCAAGACATTTGACACCACAGGCTGG | Hypo | FALSE |
| SLC12A1 | cg20226593 | 15 | GCCTAACTTTCTGGCTGAAAGCTAAGTGTCCCATATATTCCTGGGTGACG | Hypo | FALSE |
| SLC28A2 | cg01789267 | 15 | TGAGGGTCCAAGTAGGAACCTTTATAGCCCAGATCCTGGGGCCCTGGGCG | Hypo | FALSE |
| TGM5 | cg27496506 | 15 | CGGGGCTGGACTGCTGCACTGCCACCTGATTACCGAGCAGATCACAACTG | Hypo | FALSE |
| TMCO5 | cg23254045 | 15 | TTCATTCTTTCCCTCCAGTGCTTAGAACAGAGCCTAGAAGATACACATCG | Hypo | FALSE |
| ANXA2 | cg09533293 | 15 | TCTAGAAAGTGCCCCCCATCTGCTCTAAGTTACTGTACTCGAAACAAACG | Hypo | TRUE |
| ATP10A | cg08831522 | 15 | CTTCCCTAGAAAACAGATTTTGATTAACAAAACTCACGAGACATTGGTCG | Hypo | TRUE |
| ATP10A | cg11015241 | 15 | CGGGCTATGCCACATCGAGACCGCCAACCTGGATGGAGAGACCAACCTGA | Hypo | TRUE |
| ATP10A | cg17260954 | 15 | TTGCAGCGAAGACGCACAAAGTCTCCCACGTGGATTTCTTTCCAGAATCG | Hypo | TRUE |
| ATP10A | cg19326876 | 15 | GGCTGGGTGCTTAGAAGGCAGCTCCACTCAGGGTGGAGGGCCCGGCTGCG | Hypo | TRUE |
| BCL2A1 | cg24924631 | 15 | CGGGGTAAACCGGAGTAACGACAATTTGGAATGGAGACTACAAAACAGCC | Hypo | TRUE |
| CGNL1 | cg05750321 | 15 | CGGCACGCCTCTCGCTAGCTGTGAGAACTTGGGCAAAATGTTATCAGTTC | Hypo | TRUE |
| CYFIP1 | cg22432269 | 15 | CCTGGGAGTTTCCTTGGCCGAGTGAGTCACTCGGGCTGGCCGGGAATGCG | Hypo | TRUE |
| IGF1R | cg14568338 | 15 | TTTTTTCCGCTCAGCGGAGTTAATGCTGGTAAACAAGAGCCCCAGCCTCG | Hypo | TRUE |
| KLF13 | cg12056618 | 15 | CGGGAAATCTTCGCACCTCAAGGCGCACCTGAGAACTCACACAGGTCAGT | Hypo | TRUE |
| KLF13 | cg19182048 | 15 | CCGGGGGCCAAGGCTGTCACCACATAAAAGCTCCGGCAGAGAAGTGCTCG | Hypo | TRUE |
| KLHL25 | cg24345138 | 15 | CGGCAGAGAAAGGTCGCACTCAAAGGCACACCCACCTGTCCACCTGGGTG | Hypo | TRUE |
| NR2F2 | cg04943986 | 15 | CACTGAGCTCTCTATATAGTGAACTTTGACACGACTGCTGCAACTTAGCG | Hypo | TRUE |
| PSMA4 | cg13782957 | 15 | CGGGCCCCAAGGGGCCAAAGGCTCACCAGATGGAAGACCCTGAAGACCTG | Hypo | TRUE |
| PYGO1 | cg23412777 | 15 | GTTAACATGAAGCCAATGTACAGCCTCAACAGCTGCATACCAGACAATCG | Hypo | TRUE |
| SNRPA1 | cg22730560 | 15 | CGCCGCCTGCTCGATCAGCTCCGCCGTCAGCTTGACCATCCTGCAGCCTC | Hypo | TRUE |
| SPINT1 | cg26531804 | 15 | TGACAGTGAGGCAGACATCCCGGATCCCTGTTATCACAGGTGCAGCCACG | Hypo | TRUE |
| TJP1 | cg13836627 | 15 | AGTGGAGTGTTTTGCAGTCTCAAAGCCTTATCGCTGGCGTGCGCATACCG | Hypo | TRUE |
| TM6SF1 | cg14696396 | 15 | CGGCCACCGGGGTCTTCGTGCTGTCCCTCTCGGCCATCCCGGTCACCTAT | Hypo | TRUE |
| VPS33B | cg20788083 | 15 | AATAATAATAACATAGAAATACAATACCTGGCCCAACGTTGTGGCTCACG | Hypo | TRUE |
| ACSM1 | cg16940935 | 16 | CGCTGCCGGTCTTTATCAGAATTTGGAGCCCCAAGATGGAATGACTATGA | Hypo | FALSE |
| ATF7IP2 | cg00461841 | 16 | ACATTCCAGCTTAAATAAATAAGCCAACTAACCTGGTAGGGTGGCTCACG | Hypo | FALSE |
| BRD7 | cg16834187 | 16 | CGGACACCAGAGAGGCTTGTTACAGGGAAATAATAGACACACACTTTTAG | Hypo | FALSE |
| C16orf47 | cg10683939 | 16 | TTAGACTTGATGGATAGGTTCAGGGCTACATCTCGGCAGCCAACTCACCG | Hypo | FALSE |
| C16orf50 | cg01813965 | 16 | TGGGTTCTTCTCCCCAGCTCTGCCTCTGATGGTGTTCTGGGACTGACACG | Hypo | FALSE |
| CBLN1 | cg15869642 | 16 | CGGTGAACTCAAGGTTACATGTTTAAGAAAAGCATCGGGTTAATTCCATT | Hypo | FALSE |
| CDH5 | cg22319147 | 16 | CGCTCAGCCCTGGACGGACAGGCAGTCCAACGGAACAGAAACATCCCTCA | Hypo | FALSE |
| CES7 | cg23092086 | 16 | GCCGGGCTGCTTGTCTGAGCTGGCAGTGCTTGTGCCTTCAGAGCCACTCG | Hypo | FALSE |
| CHST5 | cg13496066 | 16 | CGGGCATGAAAGGAAAGAAGACAGAGGTCTGTAGAGGAAAAAAGACAAAA | Hypo | FALSE |
| CIAPIN1 | cg27589921 | 16 | CGCTTGAATTCAGTCTGTATCTGTGGTGGCATGATTGCCACTGAGTTGGC | Hypo | FALSE |
| DDX28 | cg06042828 | 16 | CCATTTTCCAGATCTGTTCAAGAAGTATCTGTTGGGCATGGTGGCTCACG | Hypo | FALSE |
| FLJ20718 | cg09230646 | 16 | CGAAGACTAAATGTGTTCATATGTTTAAGGTGCTAAGAACAGAGACTGGC | Hypo | FALSE |
| FLJ32871 | cg18609562 | 16 | TCCACTAAATGTGTAACCAACACAATTAAGATCTAGAACATACTGTCTCG | Hypo | FALSE |
| GPR97 | cg08368934 | 16 | TTTCACAGCTCTGATGATCAGAAATGATGTAATGGCCACAGGCGGCTCCG | Hypo | FALSE |
| HP | cg06172871 | 16 | CAAACCTGCCAAAGTATTTCCTGAAATCAGCAACTGGGCAGGACAGGGCG | Hypo | FALSE |
| HPR | cg20672044 | 16 | CGTAGCTGTGAGCATAGGATGGGGCATACAGCAGGCACTTAACAAATACT | Hypo | FALSE |
| HSPC065 | cg17170504 | 16 | CGGCAATAATACCAACTGTACCAGATTGTTTTGAGGATTTAAGGAGATGA | Hypo | FALSE |
| IFT140 | cg06730286 | 16 | TCAAGTTGCCGATGGTCTTCCGATGGTGGCTTTGGGATGCTTCCTTTTCG | Hypo | FALSE |
| KATNB1 | cg01656750 | 16 | CGCAACTTCCAGGCTGTCTTGGTGACCACAGGGGTGGCCATCCTTCAGCT | Hypo | FALSE |
| LOC81691 | cg03582451 | 16 | CTTTTAATTCACAATATGAATTATTGTGTCCTCCCTGATTCCTGGATGCG | Hypo | FALSE |
| LOC81691 | cg15298545 | 16 | CGGTGCCTGGCCTAGTGATCCTTTTAATTCACAATATGAATTATTGTGTC | Hypo | FALSE |
| MGC33367 | cg07804582 | 16 | TTCCTTTCTTTGAAAGCACTCATCTTCACTTGTCATTATGAATTCATACG | Hypo | FALSE |
| NOD27 | cg04799664 | 16 | CGGGACTGTCCACAGGGGATGAACAAGACCATTCCAGAGAGCCAGGGTGC | Hypo | FALSE |
| NUP93 | cg05587736 | 16 | CAGCCAGGCTGTTGTGCAGTGGTGTGATCTTGACTCAACGGCAACTTCCG | Hypo | FALSE |
| OR2C1 | cg24264578 | 16 | ACCCCGTCCATCACTGGTTGTCTTCAGTCACTTGATGAATTCATTTAGCG | Hypo | FALSE |
| PMM2 | cg00011459 | 16 | CGCACAGCTCGGAGAAGGGCAGCCTGAAAGGGAGACAGTAGACCATTTCT | Hypo | FALSE |
| SLC5A2 | cg01171858 | 16 | AGCCTTCAGCCTTGATATGACCTGATTCAGCTAAACAAAGCTGGGGAGCG | Hypo | FALSE |
| SRCAP | cg03766965 | 16 | CGGCTGAATTCCTGAGCACTAAGTGGGCTGAGTGTGTTATGCTTATGTTT | Hypo | FALSE |
| TNFRSF17 | cg18485955 | 16 | CGGTGATGACTTCTGGATGCTTGGACTGTGGATTTTTAAAATGGTTTTAT | Hypo | FALSE |
| TSC2 | cg02198582 | 16 | CGCACATGGGCTAGGTCGTTATCTTTTATGTGTGTTTGTGTCTTTGTCAC | Hypo | FALSE |
| UBN1 | cg23460697 | 16 | CGGGTGTCACTGCATGGCTTCTGTTAACATTGAAAAGAAGGGCCAGGTCA | Hypo | FALSE |
| XYLT1 | cg09485593 | 16 | CAAGCATCCGTGAATACAAAGCTTGTGTCAGACACTGGGCCAGGTGCACG | Hypo | FALSE |
| 40057 | cg19289461 | 16 | CGCTGTTTCAAAAAAAGAAAAAGAAAAAAGTGGACCAGAAGCCATGATGG | Hypo | TRUE |
| APRT | cg10139614 | 16 | AAGCCTGTACCGTATTTCATGGACTCCTAGGCGCCATCGATTTTAAGACG | Hypo | TRUE |
| AQP8 | cg05186188 | 16 | CGCTCGGCTCCCTGGCCTTGTCATTGCCAAATTCAGGCTCACACATGGCT | Hypo | TRUE |
| BCL7C | cg22377963 | 16 | ACTCAGTCATCCATTCATTCAACAGTCTTGTTAACTGAGTGCCAATTACG | Hypo | TRUE |
| C16orf48 | cg26335299 | 16 | AGCGGTGGTGTCCAGGGCCCGGTCGGAAGTCAGCAAGTCCAGCTTCAGCG | Hypo | TRUE |
| C16orf52 | cg10052190 | 16 | TAAACTGACCATCATCTCAGGATGTCTCTTTCTGGCCGCCGATATCTTCG | Hypo | TRUE |
| CHST5 | cg17564818 | 16 | CGGCTGCTTCTGCTGCAGCCTCAGGTCTCCGTTCACGTATAACTGGGATC | Hypo | TRUE |
| CMTM2 | cg01683883 | 16 | CGAGAGGAAGCAGGTGTTCTCGATAAAAGCAGCAGCCCTAATTTTATGGT | Hypo | TRUE |
| CNTNAP4 | cg25383242 | 16 | CGGGCTTTCCCGTGCTATTCTCGTGATAGTGAGTAAGTGTCATGAGATCT | Hypo | TRUE |
| DUS2L | cg06140118 | 16 | CGAGCGCGCGCAACAGGAGGCGCCAGCGGTGCGAAAGCTCTCGTCTAAGG | Hypo | TRUE |
| DUS2L | cg24654547 | 16 | ACGGTGCTCCAGCTCCACACACCGTACTGAGCCTCGCCAGCCACCGTACG | Hypo | TRUE |
| FUS | cg17022635 | 16 | CGTCATAATCCCCGAACCCCAGAAAGGCCGAAAGGCAAGGCAACCCTGAA | Hypo | TRUE |
| GLIS2 | cg01934797 | 16 | ACTTCTGAGCTCTGCGATCTGAGGCGATGCCTGTAAAAGACGCAGTTTCG | Hypo | TRUE |
| HBQ1 | cg17714030 | 16 | CGCCCGGCCATGTACATTATTATAGCACTGAATTTCGGCATGGATTTGGC | Hypo | TRUE |
| IRX3 | cg17745122 | 16 | CGCCCCGTAGAAATGTCAATCAGAGCCCGGAGCCCCGGGAATCTCCGCCA | Hypo | TRUE |
| JMJD5 | cg24705286 | 16 | CGCGGGTTTTATACTCTGCTATATGTGTGTCCGCTGCTTTTAGGCAACCA | Hypo | TRUE |
| KARS | cg24966460 | 16 | ATCGCTTGAGCTCAGGAGTTCAGACCAGCTTAGGTAACAGAGACCCATCG | Hypo | TRUE |
| KCTD13 | cg08256260 | 16 | CTCGTGAAGCTCTCTGACAGCAGAGACCCAATCACGAGGTGGAGACTTCG | Hypo | TRUE |
| NOMO1 | cg23830611 | 16 | GGAGCTTCTCCCTGTAGGCATGCACCTTGCGTTGCGCCTGCCAGATGTCG | Hypo | TRUE |
| NUDT21 | cg25974870 | 16 | CGGGAAGCGGTTATCTGCAATCCCCTCAGCGGCTACTGCCCGCCATTAAC | Hypo | TRUE |
| NUP93 | cg10586756 | 16 | CTTCCCCATGTGGAACGGAACTTACAGGAGATCCAGCAGGCGGGAGAGCG | Hypo | TRUE |
| PDIA2 | cg03390211 | 16 | CGGGCGCAGATGCCGCATCTGAGGAAGGTGCGAGGCGGGTGGGTGTCCCG | Hypo | TRUE |
| PKMYT1 | cg00319761 | 16 | GGGAGGAGCCTCGAGGCCGGTTTGGAATTTTTGGCGCGAGCAGCTCCGCG | Hypo | TRUE |
| RBBP6 | cg16050957 | 16 | CGCGGAAACTGAAAGAGCAGGGACAACGGGAAGAACCATCTGCTTCAAAA | Hypo | TRUE |
| SLC12A4 | cg06071083 | 16 | GGCGACTATGACAACCTCGAGGGGCTCAGTTGGGTGGACTACGGGGAGCG | Hypo | TRUE |
| SNTB2 | cg00424946 | 16 | TGGACGCGGGCCACCAAAGCGGGGCTGGTGGAGCTGCTCCTGAGGGAGCG | Hypo | TRUE |
| TERF2IP | cg08585897 | 16 | CGCTCACGCAGCACTTCTGGCAGTCCCTGAAGGACCACTACCTCAAGTCT | Hypo | TRUE |
| TMC5 | cg09514038 | 16 | ATAAAACTACAGATATAAAATATAAGTTCAGCCAGGTGCTGTGTCTCACG | Hypo | TRUE |
| VKORC1 | cg22062239 | 16 | CCTGGAGATAATGGGCAGCACCTGGGGGAGCCCTGGCTGGGTGCGGCTCG | Hypo | TRUE |
| WDR24 | cg15070798 | 16 | AAATAAATAAACCAATCACACAAGCACAGCACCGCAGCGCAATGGCAACG | Hypo | TRUE |
| ZNF19 | cg07506795 | 16 | GCCGGTGTTTCCTGGTTGCTTACTGGTCTTTCTGAGTTCTGGTTCACTCG | Hypo | TRUE |
| ABI3 | cg25839227 | 17 | CGGGTCAATCCAGAGACCCAAAGCCTCCGTCCTCACACAGATGCTGGCGA | Hyper | FALSE |
| EVI2A | cg23352695 | 17 | CGGGGATTGGTTCTACAAAGCCTCCTGTCATGCCAGTGGCCAACTAGAGA | Hyper | FALSE |
| PTRH2 | cg08793459 | 17 | CGAGGTGAAAAGAAACGTTCCTACTGGCGAGAAAATGAATAATGATATTG | Hyper | TRUE |
| TP53 | cg22175811 | 17 | TGAGAAGTGCTAAACCAGGGGTTTGCCCGCCAGGCCGAGGAGGACCGTCG | Hyper | TRUE |
| ABCA6 | cg22081096 | 17 | CGTTACCTAGACAAACAGAGAACTGGTTTTGACAGTGTTTCTAGAGTGCT | Hypo | FALSE |
| ABCA8 | cg21660392 | 17 | CGATGGAAGATATAAGGGATTGGAGTCAGACTGGAGTTTGCATGCTACCT | Hypo | FALSE |
| ABCA9 | cg06213598 | 17 | AGGAGTTCAGCCTACTTCCACAGACTGCTTGCTGAGCAACTTCTGGATCG | Hypo | FALSE |
| ADORA2B | cg07677850 | 17 | CGTCCCAATGATCAGCAGTGCTGCTGGTTCTGCTTCCAGAGACTTGCTTC | Hypo | FALSE |
| APOH | cg19058765 | 17 | CTCCAGTTAGGACCTTAGAGCTATCCTTGAATTCTCTATCTTCTCTTACG | Hypo | FALSE |
| ARSG | cg00374717 | 17 | TACAGGATGAGTTCTCGCATCTGCAGAACACCTGGATGTTCTAGAAGCCG | Hypo | FALSE |
| ARSG | cg15308737 | 17 | CGACCAGTCATTTTACTGAGCTGCGGTGAGGAAACACTGACCATAGAAGA | Hypo | FALSE |
| ASGR1 | cg09245073 | 17 | CGGGGCTTCAGAGAGAGCCATGTGAATTTGAATTATGCTCACTTGGAAAT | Hypo | FALSE |
| ASGR2 | cg26661623 | 17 | CGTGGCTGACTGTCTACACTTGCGCTAACAATAGCTCGGGAAAGAAAACA | Hypo | FALSE |
| ASPA | cg07732644 | 17 | CGCCAGGTTGTTTGATAGAGGGTACAATAAGAGTAATTTATTACAATTGC | Hypo | FALSE |
| C17orf73 | cg03016571 | 17 | AAGGCTGGGACACAGGTGATGCTGTGGCCAGCAGTGCCCTGTGGCCTCCG | Hypo | FALSE |
| CCL13 | cg24615251 | 17 | TTGGAGATTTCACAATGTTTCTTTGCCTCTCTGCTCCTCTGGCTGTTCCG | Hypo | FALSE |
| CCL23 | cg24325790 | 17 | CGGGATGTCGTATGAGCTGTGTTTACCAGCAGAGATCACAGCTCTACAAG | Hypo | FALSE |
| CCL5 | cg12455187 | 17 | CCCACTTCAGTGCTCTGTCCATTAAGTACTGCCCAACATTAAAGGGTTCG | Hypo | FALSE |
| CCL7 | cg02936263 | 17 | ATGTAAGGGATATTCCCCTTTTCCCTTTGGAGTGGTATCCCTAGGACACG | Hypo | FALSE |
| CCL7 | cg08124722 | 17 | CGGGCTGTTTCCAGATACCGGGAGACCCAGAATCTGGTCTGTGGAAGCCC | Hypo | FALSE |
| CD300LF | cg15374234 | 17 | CGGGGACCTGTCTGAAGAGAAGATGCCCCTGCTGACACTCTACCTGCTCC | Hypo | FALSE |
| CDK3 | cg14056306 | 17 | TTCTGACCAGCCTTTGCCGGGGCCCTGACTGTGGAGTTTGGTGGATGACG | Hypo | FALSE |
| DKFZp667M2411 | cg06488505 | 17 | CGGGTAGGTGTATTTGAAAATTGGTACATGCATACTGAACAATATTTTAG | Hypo | FALSE |
| DYNLL2 | cg07056057 | 17 | CGAGCCTTTATTGGGAACCAAGCATTTTGGCCATACAGTAGGGATTAAGA | Hypo | FALSE |
| EFCAB3 | cg07292816 | 17 | CGCAGGAGTTAGGAGTGTCTTTAGTCTATCATGGCTAAGTACAGATATCT | Hypo | FALSE |
| FBXW10 | cg10762615 | 17 | CGGTAAAGCCATGTTTCCAAGGAGGTCTGTACAAAAAGCCAGACTTCTGC | Hypo | FALSE |
| FLJ46247 | cg12864903 | 17 | AAGACCTGCCTTAAAGAGTTCCCAGTTTAGTCCGGGCGCAGGGGCTCACG | Hypo | FALSE |
| GP1BA | cg25526759 | 17 | CGCTGCCAGTGCTGGGGACCCTGGATCTATCCCACAATCAGCTGCAAAGC | Hypo | FALSE |
| GRB7 | cg17740645 | 17 | CGACAGCCTGCCAGGCAACCCCCAGCCGCACCAGGGCCCCAGGCTGTGCC | Hypo | FALSE |
| GSDML | cg12360886 | 17 | AGGTACTGATTGTCCTGGAACCTTTGGCTCTTCCTTGACCTCATGTCACG | Hypo | FALSE |
| HIGD1B | cg02164386 | 17 | GAGTCTCAGCTGCTTACATCCAGGTCCAGGATTATGTCTGCTAACAGACG | Hypo | FALSE |
| HSA277841 | cg02655623 | 17 | AGAAAAGCATTCTACCTTTAATACTTACAAGCATTATAGCACTAGTTCCG | Hypo | FALSE |
| HSA277841 | cg15307449 | 17 | CGCAGAATATTATAGTTTGAAGGGAACTTTGAGATTACTTGATCTAACTT | Hypo | FALSE |
| KA35 | cg09088193 | 17 | TCTTCCTGGATTTTAGATTCCAGTTCAGCATTCTCTCGTTCTAGCATTCG | Hypo | FALSE |
| KA35 | cg22506453 | 17 | CGAGAGAATGCTGAACTGGAATCTAAAATCCAGGAAGAAAGTAACAAAGA | Hypo | FALSE |
| KRT10 | cg22805632 | 17 | CGAACAGACATGGTGATGCTGTTTAGCCCAGGGAGTGCCTGCTACCAAGG | Hypo | FALSE |
| KRT10 | cg24249775 | 17 | ACCATGCAGAATCTGAATGACCGCCTGGCTTCCTACTTGGACAAAGTTCG | Hypo | FALSE |
| KRT20 | cg00091693 | 17 | TGACATGTCACTAGGATTGGCACCACAGTCCACCTTGCCTTACTTCCACG | Hypo | FALSE |
| KRT25D | cg20484002 | 17 | AATCCTTTCCTTTCATCTAGACCCTAGGCATATACTGTCATTATCTGGCG | Hypo | FALSE |
| KRTAP1-1 | cg24414383 | 17 | CATATAACCATTTTCAACTTCATACCTACAGTCATGGTTACCATATGACG | Hypo | FALSE |
| KRTAP4-2 | cg20331177 | 17 | CGGTGTTCTCGTTCTCACACCAGTGGTCATCTGTTTCACACTGAAATCTG | Hypo | FALSE |
| KRTAP4-4 | cg15312323 | 17 | CGGAGGGACCTGAACCTTTTAGTATAGCTGATCTCTGTAGCCAATTTCCC | Hypo | FALSE |
| KRTHA8 | cg18848394 | 17 | GTCATCCTCATTTTCATGAGCTTCTCAGATACCTTGTTTGAAACATCACG | Hypo | FALSE |
| LPO | cg12032049 | 17 | GGGAGCAACTGTCAGAAATTTATCAACCCCAAAACAGACTTCTTGGTTCG | Hypo | FALSE |
| LSMD1 | cg21068030 | 17 | ACAGCAGTTCATGTATCTTAGTGATGGTGGTCCTTCGAAGCTCTTACACG | Hypo | FALSE |
| LYZL6 | cg06548519 | 17 | AAAGCAGGCAGTGTGAATCTAGGGCCCTTGCTATTCAACACACACACACG | Hypo | FALSE |
| MBTD1 | cg02880679 | 17 | CGCCCAGCCAGAAGATTTTTAATAGAAGTAAATAGAAAGTGAAGCAATAA | Hypo | FALSE |
| MBTD1 | cg25670376 | 17 | CGCCTGGCCAGGAGTTTCTTAACTGTTCTATACATGACACATGCTCCTGA | Hypo | FALSE |
| MKS1 | cg09572685 | 17 | CGGTACTGATAATCCAAAGGACTCTGACAGGCTGTTTCATTTTGGTACAG | Hypo | FALSE |
| MKS1 | cg10728503 | 17 | GTTTGGCTCAAGCATTTGATTCACTCTGTTGTCTTTGGAGGTGGACACCG | Hypo | FALSE |
| MRC2 | cg14764661 | 17 | CTGCACCGGGAACACTGACACAGGGGTCACGAAAATGCTAAAACAAGACG | Hypo | FALSE |
| MYH4 | cg23400451 | 17 | GGGCATATGTGATGGCCCATCCATCTTTTCAATCCACAGGGAGAATATCG | Hypo | FALSE |
| MYH8 | cg11680741 | 17 | AAGGCACACATGTACTATATATGCATCTATAATATGATCCCACTTATACG | Hypo | FALSE |
| MYOCD | cg04882759 | 17 | TAACACACAACATCAGGTTCATCTTCTCAGCGATTATAACCGATACTACG | Hypo | FALSE |
| NLGN2 | cg03169180 | 17 | CGCTAAAAGCCCTGCCTGTTGGCCAATCAAAGCCTAGCCTTAGTGACCAG | Hypo | FALSE |
| OMG | cg13759778 | 17 | TCTCATGCATAAGGTATCCCATCCTATAGCAAATCAGATATATAGGTACG | Hypo | FALSE |
| OR1A2 | cg27429194 | 17 | TGACAGGTTATGATGCAGCAAGAAAGCCCTTGCCAGAAGCCAGGGCCACG | Hypo | FALSE |
| OR1E1 | cg16506346 | 17 | CGCCCAGCCTACACCTGAGTTTTAAATGGCAATTAAAGCCATTGGAGTAG | Hypo | FALSE |
| OR1G1 | cg06882926 | 17 | CGCTCAGGTTTCTGGCCAGACCCGCTGTGTAGATAACAGTGATAATGATT | Hypo | FALSE |
| OR3A1 | cg26232558 | 17 | CCAATGGAACAGTCATTGCTGAGTTCATCCTGCTGGGCTTGCTGGAGGCG | Hypo | FALSE |
| PSMC5 | cg07117700 | 17 | CGGTAAAAAGGAAAAACTTGCCTTTAGAGGATTTCAGGGATGTAGATGTT | Hypo | FALSE |
| PSMC5 | cg10840864 | 17 | CGTGCTCAAAGCACGGTAAAAAGGAAAAACTTGCCTTTAGAGGATTTCAG | Hypo | FALSE |
| TIAF1 | cg25743584 | 17 | AAGTTGGAACTCTAGGATCTGGAGGCAGGGCTGCAGCTCCAGGGACCACG | Hypo | FALSE |
| UNC45B | cg25013053 | 17 | TAAGACCTGCAATGAGAGTTCAGGCCTTTGGCACAAACTAAGCAGCTTCG | Hypo | FALSE |
| VTN | cg04706338 | 17 | CGGCCCTTGCATGACTCTATGAGGAAGGAGTGTCAGTCGGTGCCACCAAG | Hypo | FALSE |
| VTN | cg21846903 | 17 | TTCTAGCTCAGTGCCTGGCAAGCTGGGCTCTGGTCTCCCTGAAGTCTCCG | Hypo | FALSE |
| AXIN2 | cg14846293 | 17 | ATTTCCCGGCTCTCGGGCTGTTACTGAGTTGCCAGGACCTTATCAAAGCG | Hypo | TRUE |
| C17orf44 | cg25827139 | 17 | CGCCCGGCCATACATGGCAAGTTTCTACATGGTGTTTCAGACTTAGCTGA | Hypo | TRUE |
| CD300LG | cg24862483 | 17 | GAACTGTGAGCTCCTCTTCAGTCACACGGGTCTTTAACTTTCTCTAGTCG | Hypo | TRUE |
| CENTA2 | cg22485810 | 17 | GCTACGAGACTGTGGACAACCTATTCAACCTCTGTGGGTCTCAGTTTCCG | Hypo | TRUE |
| DDX48 | cg06577463 | 17 | CGGCTGCTCAAAGAGGAAGACATGACTAAAGTGGAATTCGAGACCAGCGA | Hypo | TRUE |
| ERBB2 | cg22778981 | 17 | GTGTGAGAACGGCTGCAGGCAACCCAGGCGTCCCGGCGCTAGGAGGGACG | Hypo | TRUE |
| FAM100B | cg07126839 | 17 | GTCGGTGAACATGGACGAGCTGCGGCACCAGGTCATGATCAACCAGTTCG | Hypo | TRUE |
| FLJ44861 | cg26717786 | 17 | AGGGTTAATTTCCATGCAAACCGGGAGCCGTGGGGCCCAGGGGCATCACG | Hypo | TRUE |
| FN3KRP | cg23509064 | 17 | ATGCCAGGGTGTGGTGAGGCGCAGCAGCTGGCCTGGGGGCAGCACCTTCG | Hypo | TRUE |
| GAS7 | cg22471346 | 17 | AAGGGGCGAGGGCCGGGGCTGTAGGAGCCGGGGCTGCGGTCCTCGGTGCG | Hypo | TRUE |
| GIP | cg04019407 | 17 | GTTGCCCTCAGTTAGAAGGGATACTTGTAGGCCAGGCGCGATGAATCACG | Hypo | TRUE |
| HAP1 | cg10154926 | 17 | GGTGGGGGCTGCCGAGAAGCAACTAGTGGCAAGCGGGACTCAGAGCCGCG | Hypo | TRUE |
| HGS | cg00906183 | 17 | TTCTCATTGGTTCTTAGGGCTCATTGTTCCAAGGGCGCGTCCAATTAGCG | Hypo | TRUE |
| HOXB6 | cg18878432 | 17 | CGGGGTTATTTCAGGGGACCTGAAAAACCTGGGCTGAATTTTTATTTTAT | Hypo | TRUE |
| NTN1 | cg19564877 | 17 | GGCAAACTTTTCTTTCTCTTTTGCCCCCTCCAGAGGTAAAGTCCCGAACG | Hypo | TRUE |
| P2RX1 | cg01526089 | 17 | GAAGGTGGGCGTTATCTTCCGACTGATCCAGCTGGTGGTCCTGGTCTACG | Hypo | TRUE |
| PCYT2 | cg21770145 | 17 | GTGAGAACGGAACTCGGGTTATTTCAGCCCCGGCCTGCAGAGTGGAAGCG | Hypo | TRUE |
| PLD2 | cg16685860 | 17 | CGCTCAGATTTCGGGATTTCTACCCCCGGCTGGGATCGCGTAACTTCCTC | Hypo | TRUE |
| RAB34 | cg21237418 | 17 | CGCCCCGACCCAGGCTGGAGCCTATCCAGATAGGGACTCCCCAGGCTGCT | Hypo | TRUE |
| RABEP1 | cg09394600 | 17 | CGCCCGGCCTAAAAAGCTATTTTGAAATCAGAGAGGAGCATCAGGAATTA | Hypo | TRUE |
| RPL23 | cg18516268 | 17 | CGCCCTGGACAGAACCTGCTGTAAAGTAGGAGCTCAATAAGTATGTGAAT | Hypo | TRUE |
| SFRS2 | cg19125323 | 17 | ACGAAGCGGGGCGCGGTGGGCCAATCAGAAGGTTTCATTTCCGGGTGGCG | Hypo | TRUE |
| SLC13A5 | cg16652063 | 17 | GATCACGAAGGACTTGAACTTGGAGACATAGCTCAGCGCCGAGGCCATCG | Hypo | TRUE |
| SLC16A11 | cg15639045 | 17 | TGTGGTGATCTCTGTTTACCGAGAGAGCCCGTCCAAGTTGGGCTCCATCG | Hypo | TRUE |
| SLC16A5 | cg27619475 | 17 | CGCCACGGGATATCCGTGTGTCTGAAATTTGCACAACCCGGATGCCCTCT | Hypo | TRUE |
| SMCR7 | cg26771272 | 17 | CGCCTGCTGTATGCTGCGAGCTACACGTGCATTCTTTGTTAATTTGCTCA | Hypo | TRUE |
| SOCS3 | cg15502888 | 17 | CGGCCGGCCTTCTTGTAATGTTTAGTGACTACTCGCAGCAGAGAAAGGCT | Hypo | TRUE |
| SOX9 | cg06391468 | 17 | TTCTCCTGCTCGTCGGTCATCTTCATGAAGGGGTCCAGGAGATTCATACG | Hypo | TRUE |
| TBC1D16 | cg19663942 | 17 | CGTTGTGGGAGGACCTGGATCACGGAGGGGCACCTGGGGACTTTTCCCCG | Hypo | TRUE |
| TBX2 | cg13274713 | 17 | TGAGATAGTCACAGTTTTCCAGAGATCACGACAAGATCTAACCAGTCGCG | Hypo | TRUE |
| NOL4 | cg18114671 | 18 | CGGGTGTTAAGGGACTAGAAAGAGAAAGTTCTTACCTGTCATGTTTTTAA | Hyper | TRUE |
| PIK3C3 | cg24362401 | 18 | CGGGAACTTAGGTACAGGAAAAACAACATAAATGAACCAGCTGAGCCCCA | Hyper | TRUE |
| AQP4 | cg22295573 | 18 | ATTCCTCTTTCTAATGAGAGCTCTTCACCCATTCCCATGTCTCAAGTACG | Hypo | FALSE |
| C18orf14 | cg03686067 | 18 | CTGAGGTGGCAAACTCTGTTTCTTTTTCAGTGTACTCAATTCTTTCATCG | Hypo | FALSE |
| C18orf14 | cg15081561 | 18 | CGGGAGCTTGAAGAAGTCAAGGCCAGAGCTGCTCAGATGGAAAAGACCAT | Hypo | FALSE |
| C18orf20 | cg01722450 | 18 | CGCACACATGGTTGCGTGATAAATCACCCTGGCTGCCATCGATGGTTTCC | Hypo | FALSE |
| C18orf20 | cg10054857 | 18 | CGCCTTAGAGCAGGGAGCCTTTATCTGAAGTCATTGAACTTCTGGGGAAA | Hypo | FALSE |
| CCDC68 | cg12432709 | 18 | TTAACACTACTCCAGACTTGATGTAGCTGTCACTAGCTTTTTGGCTAACG | Hypo | FALSE |
| DSG1 | cg22386311 | 18 | CGGCAGTACAGGAGGTTTATAAATGACATATTAAGTGAAGAAGTGGCTAT | Hypo | FALSE |
| DSG4 | cg13445249 | 18 | CGGGGTGAGAATCTGGCTGAATTAAATTTATATGCCCTCAGAGACATAAT | Hypo | FALSE |
| FAM38B | cg21165219 | 18 | AGGATGAGTATGCACGGCCTTGGGATTTGTCCTCAACTCTGCTCCCATCG | Hypo | FALSE |
| GALNT1 | cg10130071 | 18 | TCTGAGGTCTCTCAGGCTGCTTCATCATGCTCCAAGATGAATTCCTTACG | Hypo | FALSE |
| KCTD1 | cg26755793 | 18 | TCTGTGTGTGAGCAAATGCATAGGCACCATGATGCATCTGCACATACACG | Hypo | FALSE |
| KIAA1468 | cg22568695 | 18 | CGCATGCAGCAGAGTTGATTTGCAAGCAAACTGGTGAATGTTTTCCATAG | Hypo | FALSE |
| KIAA1632 | cg01106788 | 18 | TCAACCTGCATTCTAAACTGGGGTGCAGAATATTTTTGCCCCATAATACG | Hypo | FALSE |
| KIAA1632 | cg10732834 | 18 | TGCCACTCTTGTACAATGACTCTTTTGTTGTGACATTGTCCCTGTATTCG | Hypo | FALSE |
| MC4R | cg02037013 | 18 | CGCAGCAGTTACAGACTGCACAGCAATGCCAGTGAGTCCCTTGGAAAAGG | Hypo | FALSE |
| MEP1B | cg01941619 | 18 | TTTTTAAATTATCTTCTATATACTGTTTCCTTACCAAGCCAGAAATCACG | Hypo | FALSE |
| METTL4 | cg06454226 | 18 | CGTGAATGTAGGTCATAAGCATGAAGCGCAGTTCAGTTTCCAGCGGTGGT | Hypo | FALSE |
| MYOM1 | cg12067287 | 18 | CGGGCTTTGGAATCAAATGTCTCTGAATGAAGTTGCGTTTCTGTCATCTA | Hypo | FALSE |
| RIT2 | cg22039287 | 18 | CTGCTTATAGTCTTGCATTTTATCACTCTTCTATTGCAGTTTTCATTCCG | Hypo | FALSE |
| SERPINB12 | cg03468463 | 18 | CGTGTCCACTAGGGTGCTACACAGGGTCCTAAACTCTGGGTCCACACTCA | Hypo | FALSE |
| SERPINB13 | cg18121684 | 18 | CGCAAGGTGGAAAACCACTGCTGAAGCAGATGTGGAGAACTATAAATTAA | Hypo | FALSE |
| SERPINB2 | cg13943564 | 18 | TATTTTCAATTCAACAACTAAACAAGAAAACACCACTTAAATTTTACTCG | Hypo | FALSE |
| SERPINB2 | cg24691255 | 18 | CGGGAGAAGAGCACTAAGGACAAAGGGGCACTTAACACGTGTAAAAGGGC | Hypo | FALSE |
| SERPINB3 | cg10533434 | 18 | CGGGCTAACACTCACCTTTATGAATACGAAAATTTATGACAAAGGACAGG | Hypo | FALSE |
| SERPINB7 | cg01568736 | 18 | CGGCCAGAAACTGAAATGTGTTTTTGCCCCTGTGTGGCATGTTCTGATGG | Hypo | FALSE |
| STARD6 | cg18934187 | 18 | TATTACTGCTGTGAATGAGTTCCGGAAGCTGCAGTCTCACTGGTCCTTCG | Hypo | FALSE |
| TCEB3C | cg08008233 | 18 | CCGATTCTCAGGGCATAATGATTTTCTTTCTGCAGAAGAAACACACCCCG | Hypo | FALSE |
| TGIF | cg13224710 | 18 | AGCTTCTGAGCCTGGTGACACTTGCTGGGGACCAAGACCATCCTACTCCG | Hypo | FALSE |
| ZFP161 | cg04319097 | 18 | AGTTATAGTTACCATGAACAACTCAGGCTATTATCTTAATGCCTTGAACG | Hypo | FALSE |
| ZFP161 | cg05528918 | 18 | GCCTTGAACGCCAAAATCTTCAGATCAGAGTAACTCTGATCAGGAGCACG | Hypo | FALSE |
| ZNF532 | cg17675150 | 18 | CGGGGCTGGGAAAACAGCATACCTCATCTGGAATGGAAATCTATCGTCTC | Hypo | FALSE |
| BCL2 | cg08223235 | 18 | CGAGTTCTGTCATTGTGTTCCTCAAACTGTGGTTTGTTCCAGAAAGGAAG | Hypo | TRUE |
| BCL2 | cg12459502 | 18 | CGTGGTTTTGAGGCGCACTCCTGGCCACATCACAGCTATGTTCTCTTGCC | Hypo | TRUE |
| BCL2 | cg23756272 | 18 | GATGGGATGGTGCATATGTCTTGCTTCTTCCTTAAAATGGGCCTCTCTCG | Hypo | TRUE |
| C18orf24 | cg01313966 | 18 | AAGCCCAGGATGGTGAGACGGGACTCTGTAAGCAAAATTCAAACCGCCCG | Hypo | TRUE |
| CCDC11 | cg03143333 | 18 | TAGTATTACTTGCTATTCTATCAACCCTGTAAGATATTTGCGGCCACGCG | Hypo | TRUE |
| DCC | cg02624705 | 18 | ACCAGCGGCTAAGCGCGGGGATGCGGGTACGCGCTCATCACAGGACAGCG | Hypo | TRUE |
| DSG3 | cg08555924 | 18 | CTAGACTACACAGTCCTTTCTGCTTAAAATACTCTGTGATTGGCCTGGCG | Hypo | TRUE |
| GNAL | cg14371329 | 18 | CGCCGGGCCTGGATTACATTTTTAAATCAAGAAGTTGGAGATCCGGCATT | Hypo | TRUE |
| KIAA0427 | cg18530324 | 18 | CATATGCATCTCAATAACCGACGGTGGCATTTAGTGCAGCATTAATCACG | Hypo | TRUE |
| ONECUT2 | cg02250594 | 18 | TCAGCGTGGTGTAGGTGTTGCTCATGCCCATGCCAGGCGGAGACGAGTCG | Hypo | TRUE |
| PMAIP1 | cg22549408 | 18 | CGGGTGCAGAAACTGAGGTTTGTAGAAAATTGCCCAAGTTCACTTAGGCA | Hypo | TRUE |
| SDCCAG33 | cg01297972 | 18 | CGCATTTCATGGAGGTATGTGGAAAAGCAGCAAAGCCAGGAATCACAATC | Hypo | TRUE |
| SERPINB5 | cg06682185 | 18 | TTTGCCCTCAAAATCATCATAACCCTAATTCTTTTCCAGCAAGGAAGACG | Hypo | TRUE |
| SERPINB5 | cg20837735 | 18 | CGGTGGCTCACCTGGGCAGCACCGCCACGCCCACTGCCAGCCCAGCTCCA | Hypo | TRUE |
| TNFSF5IP1 | cg02201963 | 18 | ACTGTTTTCAAACAGTGGCGGACAAACAGGGCTTGGGGCTGGCCCGCACG | Hypo | TRUE |
| CD37 | cg10037005 | 19 | GCCCAGAGGTGGGTTCCAGTAGATCAGGGGTCCCTTTAGATCCCCCAGCG | Hyper | FALSE |
| ZBTB32 | cg08539991 | 19 | CGGCAGAGCACACAGCTGCAGAAGTAAAAAGGATTGAAACATTTGGATCC | Hyper | FALSE |
| C19orf12 | cg07288394 | 19 | TCACACAAGTAAGCAGCAGAGCTGGGACTAGAGTCCCGGGCCCTGGCTCG | Hyper | TRUE |
| ZNF222 | cg09757277 | 19 | CGGACATTAAGTGACACTCCACACCACACTGAAAGGGGCTGCACACGTAG | Hyper | TRUE |
| ZNF223 | cg16534499 | 19 | CGCCTACCTGAGCTGAAGTATCAGGAATCCCGCAAGGTGTCTGGACTGCA | Hyper | TRUE |
| ARHGEF18 | cg27377450 | 19 | GCTCACACTTTATCCGAAACAGCAGTGGGGCTTGGGTGCGGTGGCTCACG | Hypo | FALSE |
| BIRC8 | cg09377486 | 19 | CGGGCACATTGAGGTTATTTCCGTATCTTGGTTATTCTGTATAATGCTCC | Hypo | FALSE |
| BRUNOL5 | cg06734812 | 19 | CGACAGCACAGGAGAAATGGTAAAAGTATCTTCCAGTTCTATAGGGTGCT | Hypo | FALSE |
| C19orf18 | cg27623214 | 19 | ACCTGGTAAGCCTGTTATGTTTCCAGTGGGATGGAGTCCATCTGCATACG | Hypo | FALSE |
| C19orf35 | cg01129847 | 19 | CGGGGGAGACAGTGTCCAGGGACCCAGGGATCCACACTCAGGCCTCATCC | Hypo | FALSE |
| C3 | cg17612991 | 19 | TGACTCCCAGCCTACAGAGAGATTCCTAGGAAGTGTTCGACTGATAAACG | Hypo | FALSE |
| CASP14 | cg03752087 | 19 | CGGGATCTCAGTATTAGCTTCAGAAACTCTGAGACCTCTGCAAGTGAGGA | Hypo | FALSE |
| CCL25 | cg21743830 | 19 | ACACAGTACCTTGGGTGTGGACAGCGGGGGCCCAGGCTCCCAGGAAGCCG | Hypo | FALSE |
| CD22 | cg03574571 | 19 | CGGAACAGCAGTTATGGGCCAGGCATACCTCCCAGAGCTGGGAACACAGT | Hypo | FALSE |
| CEACAM1 | cg19776453 | 19 | TGGTGGACAGTTCTCTCCAATCTTGACAGAAGTCCTCTGGACAACTCACG | Hypo | FALSE |
| CEACAM3 | cg23181133 | 19 | CGGGTCACAACAAGACAATCACATTGAACTGGGATTGATAAGAGGGAGGA | Hypo | FALSE |
| CEACAM5 | cg21505334 | 19 | GACACTTTAAATAAAAACATAACCAGGGCATGAAACACTGTCCTCATCCG | Hypo | FALSE |
| CEACAM7 | cg19623751 | 19 | CGCTCTCATGCGGCAGAAGACAGACAGGCAAAGAGATCTAGAATGTGAAG | Hypo | FALSE |
| ELSPBP1 | cg08981777 | 19 | TTGTTCAGCTGAAACCTCTCCAGCTCCTCATAGCTGAATTTCTGGGAACG | Hypo | FALSE |
| EMP3 | cg07605143 | 19 | CTCAAGGTCACTGAACCAGGAAATGATGGCGCTGGGATTCTTAGCTTCCG | Hypo | FALSE |
| FFAR3 | cg21624359 | 19 | GCCTTTTCATGGGCACATAATCCATAGCAGACACTGCTTCTAGGGCAACG | Hypo | FALSE |
| FLJ38288 | cg02682905 | 19 | GGAGGAATGGAGTCTCCTTAGTGAGGCTCAGAGATGCCTTTATCATGACG | Hypo | FALSE |
| IER2 | cg17753124 | 19 | GTGGGTCAGGAAGGCTTACCTCTCTGTTATTCCTCTCCAAAAATGCTACG | Hypo | FALSE |
| KIAA0355 | cg21665774 | 19 | AGGGCCAGCCCAGTCTGGAAGCATCTCTTATTAATGTTACAAGGAAACCG | Hypo | FALSE |
| KIR3DL3 | cg23404467 | 19 | CGCCCCAGCTCAGTTCAGCAGCACACAGGATGTTGTGAGGGGCTCATGCA | Hypo | FALSE |
| LAIR2 | cg00269932 | 19 | CGCCAAGCGACGCAGAGGCAGAGACCAAGTACTGCATGATGTCACTTACA | Hypo | FALSE |
| LGALS4 | cg06394229 | 19 | CGCCCTCCTGCAAAGAGGAAGTGCTCATGAACTTCGGCCCTGCCAGGGCC | Hypo | FALSE |
| LGALS4 | cg16731016 | 19 | CGGGCTACCAGCCCACCTACAACCCGGTGAGATGCCAGCTCAGGCCCCAC | Hypo | FALSE |
| LIPE | cg14679230 | 19 | CGGAGGCCTAAATTGGGATGCTTGCCTTATGAGAAGAAACATTTTAACGG | Hypo | FALSE |
| LRG1 | cg08837884 | 19 | CGCATTTAATAGGAAATGAGGAAGAATGGAAACAATAGCATGGATGTCAG | Hypo | FALSE |
| LRG1 | cg24926276 | 19 | CGGAGATACAGGACATTCCAGCTAACCCATAGAAGTCACAGGGAGCAGAT | Hypo | FALSE |
| MBD3 | cg03569412 | 19 | TTGACATTGGGTCCACCCGATCTGGGATGCTTTCCCATCTGAAGATCTCG | Hypo | FALSE |
| MBD3L1 | cg18885299 | 19 | GAAACCTCGTCTCTACAAAAACCACAAACAGCCAGGCATGGTGATGCACG | Hypo | FALSE |
| MRPL54 | cg00968931 | 19 | CGGGTTAAGGATTTAGCAGTAGTAGAGCTGGAAAAGAATATATAAAATAT | Hypo | FALSE |
| NALP8 | cg22190114 | 19 | ATGTCTCTGCAGGTCTCGTGTTTCTCTCTTCCAATCGGTTGTCTTTATCG | Hypo | FALSE |
| OR7A17 | cg04645174 | 19 | GCCTGCGAAGGCATCTCAGTATGTGTAATGCATCCCCTCTTTTTTTCCCG | Hypo | FALSE |
| OR7A5 | cg02124291 | 19 | TAAGCCACCGTGCCCAGCCAGAAGTTCTTATTCTAACTGCAGAATGTACG | Hypo | FALSE |
| OR7C1 | cg24992780 | 19 | TTACTTTGCAATTGGACTTTCCAGTTGATCTGCGCCATCTTGTCTGCTCG | Hypo | FALSE |
| OR7C2 | cg19784470 | 19 | AAAACTAAACCAGAATGCTGGCTCCATACCCAGAGTATCAGATTCAGTCG | Hypo | FALSE |
| PRTN3 | cg09134726 | 19 | CGTGCCCATCCATCCAGCCTCCAGGCCCCGGTGGATTGTGGGGAAATATC | Hypo | FALSE |
| RLN3 | cg00722300 | 19 | CGCCCAGTGCAGTATGTGCTACGAGGCCAGGCACACTACTGTAAGCATTT | Hypo | FALSE |
| TEX101 | cg20017147 | 19 | AAGGCCATAGGAGCCCTCTCTTTGAAAGGCAGGCATCCGGGCAGAAAGCG | Hypo | FALSE |
| TFPT | cg04632683 | 19 | CGCCCCACTCTAGACTACAGGAGGTTGCTTTGTGATAACGTGTCCCGCAC | Hypo | FALSE |
| TSPAN16 | cg00988256 | 19 | AGCTAGATTTCTGCATCACAGAGCCTCTGGATCCATTCATTCATTCTCCG | Hypo | FALSE |
| TUBB4 | cg06697251 | 19 | GCAGGTCACTGTCCCCATGGTATGTGCCTGTGGGGTCGATGCCATGTTCG | Hypo | FALSE |
| ZNF329 | cg22628694 | 19 | TGTCATCTTTATTATTTATAGATTATTCTATTACTCTCCGAACCTCTCCG | Hypo | FALSE |
| ZNF439 | cg11337780 | 19 | CGGATGCATACCACAATGCCCAGCTAATTTTTTGCTGTTGTTGATATGTG | Hypo | FALSE |
| ZNF45 | cg00185103 | 19 | CGTAGCTTAATCTGAGCCCTGGAGGGTGACTGAGCTCTATTAGCCAGAGA | Hypo | FALSE |
| ZNF45 | cg00410831 | 19 | TCAAGTCACTGGCAAATCCAATGTCTAATGAGGCCACTCTTACTGGTTCG | Hypo | FALSE |
| ZNF536 | cg26116551 | 19 | AGGCCTCTCTTGTGTGATTTTGCTGCTCACACGTGGCCTGCTGGGAGCCG | Hypo | FALSE |
| ZNF545 | cg15383087 | 19 | TTGAGCTACAAGGACAGACTCGAGTAGTTACACAGACCAGATGGCCCACG | Hypo | FALSE |
| ASF1B | cg14203758 | 19 | CGGGAGTGGACCTGGTCAGCCCTACCCCACTGACCCCACCGGACCCAGGC | Hypo | TRUE |
| BRD4 | cg08044694 | 19 | CGAGCGCTGTTCTCACCAGCTGCCTGAGCCAGTCAGATGGAAAAGTAATC | Hypo | TRUE |
| CAPS | cg16125615 | 19 | CGTGGGCCCTGTTTGAGGACCCACTGTTCGCCCCGACCCAAGGATCATCA | Hypo | TRUE |
| CAPS | cg16992787 | 19 | CGCCTGGTCCAGCACCAGCCCGAGTTTGGCCAGACCCTGCCGGAACTCAT | Hypo | TRUE |
| CD22 | cg15743985 | 19 | TGTGCCTTTTTCAGCGGGCTGCAGTTCTCCTGCTTGGCTTGAGTCATTCG | Hypo | TRUE |
| COX7A1 | cg24335895 | 19 | CGTGAGGGCTAAGGCAGGATCTTTCTCAGAGATTTGTTGAGACATTAAAT | Hypo | TRUE |
| DDA1 | cg21061811 | 19 | TTGCCCAGACTGGACTGTAGTGGCTTAATCTCGGCTGACTGACACCTCCG | Hypo | TRUE |
| ELA2 | cg07239938 | 19 | CGGGGCCTCTGGATCCCCCACCAGGAACCCACGGGATCCCCCACCGGGAA | Hypo | TRUE |
| FBXO17 | cg08820801 | 19 | CGGCCAGAAGACAGAAAATCCAGCAACGGTAAAAAGCGGCCTGGCCTTCC | Hypo | TRUE |
| FLJ21742 | cg23158022 | 19 | AGTGATTCTCTTGCTTCAGGCTTCTGAGGAGCTGCGATTACAAGCGTGCG | Hypo | TRUE |
| FLJ37549 | cg10710439 | 19 | CGTGCATTTGTGGAACTGCATGTCAATCAGGCCAGTTCCCTGCAGAGGGA | Hypo | TRUE |
| GRLF1 | cg23328124 | 19 | GCTGTCTGGTCCATTGGAAACACTAATCTGATCTCAGAAGTGGCTGATCG | Hypo | TRUE |
| HIF3A | cg02879662 | 19 | CGCCCCGGGGCGCGCAGTTGGAGGCACATCCCCACCGCACTCTCCACCCT | Hypo | TRUE |
| HSPB6 | cg24673765 | 19 | AGGAGCAGGATGGAGATCCCTGTGCCTGTGCAGCCGTCTTGGCTGCGCCG | Hypo | TRUE |
| HSU79303 | cg12582959 | 19 | TCCGCGCTGGCTAGTTCCTGAGAGAGCGTTAAAAGTAGATTCTCCTTTCG | Hypo | TRUE |
| JAK3 | cg18145683 | 19 | AGGTATTTCTCCCTTAAGACTCAGGGAGACGCTGGGCGCAGTGGCTCACG | Hypo | TRUE |
| KLK14 | cg05242523 | 19 | CGCGCAGTGTGATCTGTAGTCTCATTAATAGTTTGGTTTCTGTGTTGATT | Hypo | TRUE |
| LENG9 | cg13079099 | 19 | CGGCTGGTCCCAGCAAAAGGCGCTGAAGGGCTCCTCGCGCACACCCAGAA | Hypo | TRUE |
| LOC148137 | cg15660498 | 19 | CGGAGGCCCAGCCCCACTAATAGATATTCTGATTCTGTTGGTCTGGAATG | Hypo | TRUE |
| LRP3 | cg07351267 | 19 | GGCTTAGGGACCTCATAGGGGTGGCACAAGGCTAAGGCCTGTCTTCTTCG | Hypo | TRUE |
| MAST1 | cg20966551 | 19 | CGATGAAGGTCAGCGTGGACCTGCCGTTGCTGCCCACAAGCATTATCAAC | Hypo | TRUE |
| NIFIE14 | cg00739120 | 19 | CGCTCAATGACAATTTCGTGAAGCTCATTTCATGGTAAGGGGGAAGGAGC | Hypo | TRUE |
| NUMBL | cg13285447 | 19 | CGCCCATTGGCCAGTCCCGAGCTGAGCATGCCTATGAACATCGCCGAGTC | Hypo | TRUE |
| PLAC2 | cg16483916 | 19 | GCTGGTGGGCCAGGGCGTGAGCTCCTGGAAGCGCGCCTTCTACTACAACG | Hypo | TRUE |
| RAB3A | cg00320243 | 19 | CGGCCGGGTGTGCTCAGGCTCCGAGCACCTGCATAACCTTCATTTGACTG | Hypo | TRUE |
| RFX2 | cg07944287 | 19 | ATAGAGACTGTAGCCGTGGAGACTGTTACTTACCAACGGGGACCAACACG | Hypo | TRUE |
| RFX2 | cg18109231 | 19 | GGGGTAAACGGAGTCCCTTGGGTCCCCTAAAACTGGACTTTCCCAAAACG | Hypo | TRUE |
| SUV420H2 | cg14112945 | 19 | CGGGTGAGGGGCGGCGCGGGGCCCGATCTCTGAGCCCCTTCACGGCCCCA | Hypo | TRUE |
| UNQ3033 | cg01718139 | 19 | GCACACCTGCGGTGGGTGGGTCTGGGCTGTGGGTTCTGTGAGTTCTGCCG | Hypo | TRUE |
| ZIM2 | cg01656470 | 19 | CGGGGACTGAGCCAGTCCCACTGGCAAAACAGCCTGGCGACCAGCACACA | Hypo | TRUE |
| ZNF414 | cg15530356 | 19 | ATGGGGGTCTCGCTTTTTCGACCAGGCAGGAGTGCAGTGGTGCCATCACG | Hypo | TRUE |
| ZNF442 | cg08847636 | 19 | AAACTGTTTCTGCTGCAGGCCTTGGAGTCTCGGTGCAGTGACTCGGACCG | Hypo | TRUE |
| ZNF447 | cg18888520 | 19 | CGGGTAAATAATAGACCCCTGACAGCCAGAGACCCGGAGAAACAAAGACG | Hypo | TRUE |
| BPIL3 | cg18223379 | 20 | CGGGATGCTCCAGGATGTGCAACCAAGAGCAGTGACTACCTACCACCTAC | Hypo | FALSE |
| C20orf135 | cg09868035 | 20 | GCAGTGACCTTCTGGGGCGGGTCCTGCCTGGCTGGGGTTCCTCTTTCTCG | Hypo | FALSE |
| C20orf173 | cg08308510 | 20 | TAGGTCAGCCCCTGTCCTCATGAATCTTACATCCAGTGGAGGTCATTTCG | Hypo | FALSE |
| C20orf175 | cg27214774 | 20 | GGGTGGTCCAGGCAAGTTGTGTGACCATCCTGGGCTTAGTCTTGACATCG | Hypo | FALSE |
| C20orf186 | cg21519900 | 20 | CGGGATGACTTCTCCAGGCTGATCTAGCCCTGGCATCCTGGCCAGCTCAT | Hypo | FALSE |
| C20orf79 | cg20998885 | 20 | CGGGTTCATTTTGCCCAAAACCAGCTCCATAAAGACAGACTCCGGGATTG | Hypo | FALSE |
| C20orf86 | cg09898548 | 20 | CGGCGTTCAAATTGGACTCCCAATCAAGGCAAACCTTGTCCACAGCAGGA | Hypo | FALSE |
| CDH26 | cg20895028 | 20 | CGCTGGCTGAGCTGTTGTTCCTGAGGTCAGACCCCAGCCAGTCTTTTGTG | Hypo | FALSE |
| CDH26 | cg24607535 | 20 | GGCTGAGCTGTTGTTCCTGAGGTCAGACCCCAGCCAGTCTTTTGTGTACG | Hypo | FALSE |
| CDS2 | cg25984124 | 20 | CGCAGTGTTATATGTGTTTTACATCACTTACAGGGCAGTGAATAGAAAGA | Hypo | FALSE |
| CST8 | cg23033024 | 20 | GAAGCTGGGCTTGCAGTGTCTTGACCACCAGGAAGACATACTTGTCCTCG | Hypo | FALSE |
| CTSZ | cg01623438 | 20 | TTCCACTTGGCGCAGGCATCAGGAGTTATCCAATGTGACTTCCAAAGACG | Hypo | FALSE |
| DEFB127 | cg24116886 | 20 | CGCAGCCGGACCAAGATCGAAATGTACTCACCTCCAAGAATGAATGTGGC | Hypo | FALSE |
| DEFB129 | cg00769470 | 20 | CGTTGGAGTAGGATAAGAGTTAGATATTTGATTCACTGATTGTCAGCCCA | Hypo | FALSE |
| HAO1 | cg25157408 | 20 | CGGGGGAGCATTTTCACAGGTTATTGCTATCCCAGATGGAGTTCGTTGTT | Hypo | FALSE |
| MRPS26 | cg26060255 | 20 | TGCACTGTAAATGTTTGATTTGCAAAACAGTAGCAAACCATTTCCCCACG | Hypo | FALSE |
| NFS1 | cg12552392 | 20 | TATTTTACACTGCATCTGCTGCCTCCCACAAACTGAAGGCAGTTAATACG | Hypo | FALSE |
| OTOR | cg16537367 | 20 | CGGAGAATTCACTTGGCTGAGTTTTGTTGCAGCTTTAATATCTTGGCTGT | Hypo | FALSE |
| OTOR | cg21845297 | 20 | CGGCTTTAACAATAGTGGACCATTTTGGATATTATCTGTGTATAGAAAGA | Hypo | FALSE |
| PLCB4 | cg24736099 | 20 | CGGGCACCTATAGACCCACCTACTTCAGAGGCTAAGGCAAGAGAATCCCT | Hypo | FALSE |
| PRND | cg09906458 | 20 | CTGGGCGGACCTGGCTGCCAAGAGGGTGTGCTGGGGGACTGTGCAGCTCG | Hypo | FALSE |
| PROCR | cg25461934 | 20 | CGCGTCACCCTTAGTAAGAGAAAGTGTTATGTCATGAAATATTTGCTCAG | Hypo | FALSE |
| PSMF1 | cg26414731 | 20 | GAAGAACTGAACCAAGGGGCAGCGCCTAGATGGGCACTGAGGCGAAATCG | Hypo | FALSE |
| RIN2 | cg17016000 | 20 | CGGAAGAGGACAACATGTAAACAGCTTCACGATCATCCACAAAAGGGGAG | Hypo | FALSE |
| SEMG2 | cg02311163 | 20 | CGGGTCCAGTCATGATCATTGATGTCTACATGATATGTGTGTTGAATAGA | Hypo | FALSE |
| SLC13A3 | cg01521624 | 20 | TCTTTATCAGCAGTGTGAGAACGGACTAATACACTAGTACTCACTATGCG | Hypo | FALSE |
| SLPI | cg23889010 | 20 | GGTGTGGGTGTGTCCCCTTCTGTAGGCTCTGATCCCTCAGCTTAGTTTCG | Hypo | FALSE |
| SPAG4L | cg08642068 | 20 | CGGTCTAGTGCAGGAGACTGGTATGAAAGAAGGAAACAAGTATTTCGCCA | Hypo | FALSE |
| SRC | cg22437284 | 20 | CGCATGTAAGGATGAAATGAGGTGATGCCCGCTCAGCACATGTGAAATCT | Hypo | FALSE |
| SYCP2 | cg22214414 | 20 | CGGATAAAAACAACAACAAAGAAAACAATTTGGCAGATGGGGGAGGCAAA | Hypo | FALSE |
| TGM3 | cg21611708 | 20 | AGGACAAGCTTTGCCTTGTTTGTGTTTGCGTTTCTTTTACACATCCGTCG | Hypo | FALSE |
| TM9SF4 | cg27643859 | 20 | GCTTTTCTCCCTGATGTGTGAAACAAGCGCCTTCTATGTGCCTGGGGTCG | Hypo | FALSE |
| WFDC3 | cg01517033 | 20 | CGGGCTCATCAGAGTCTGTTGATGAGAACACAGTTGTCTGACTCCAGAGC | Hypo | FALSE |
| WFDC6 | cg12547930 | 20 | TTGTCACAGCTACAGCATTGGATTAAAAGTCACACCCTGAAGCATTAACG | Hypo | FALSE |
| ZNF336 | cg26170257 | 20 | GAATCCAAATCCTCCCCATTTAACCTACTGCATGAGATGCATGAGCTTCG | Hypo | FALSE |
| BTBD4 | cg21291985 | 20 | GTATTAGTTTCCTGGGGCTGCTGTGAAAGTACCACCTGCTGGGCAGCTCG | Hypo | TRUE |
| C20orf108 | cg06590533 | 20 | TGGACACCGCCCGGGATCAGGGTCGGGGTGGGGTGCTTACCTGGTGGCCG | Hypo | TRUE |
| C20orf116 | cg08661003 | 20 | GGTAATCGCTATCCTGAAGTTGGTGTGCATCAGTCCCAAGCCTCTTTTCG | Hypo | TRUE |
| C20orf30 | cg23291865 | 20 | CGCCCAAGGTTGCATGGCATGGCCCGCTTAAGTGCCACTCAGCCGGCCCC | Hypo | TRUE |
| C20orf6 | cg23222573 | 20 | ACTACTTGCACGTTCCCTCGAGAAGATCTTTGGAGTAGACACAAAAGCCG | Hypo | TRUE |
| C20orf7 | cg15910230 | 20 | CGCGCCACCATGCCGGGCTCATTTTTGTATTTCTTGTGGGGATTCACCAT | Hypo | TRUE |
| CTSZ | cg23265096 | 20 | CGGCCCCCCACCCCGAAGCCAGGAACCCCGGCAAATGAGTCCAGCCGGAC | Hypo | TRUE |
| E2F1 | cg14618681 | 20 | GTGTGGGCCGGGGCGCCTGCGGTGTGGCGAAGAGCAGCAGGTCAGGGTCG | Hypo | TRUE |
| GNAS | cg14597908 | 20 | CGCGGAGCTTTAGAAAGTTCTTAAGTGGTCAGGAAGGTAGGTGCTTCCCT | Hypo | TRUE |
| GNAS | cg20582984 | 20 | GGGAATCTGCTCTGATGACCCAGCACAAAAACGGCAGCAATCTGGTAACG | Hypo | TRUE |
| KIAA0889 | cg14898639 | 20 | CGGACCAGGGTGGTAGACCAGAGTGTGCCCTCAGTGTTATTTCCACTAAT | Hypo | TRUE |
| KIAA1434 | cg26942392 | 20 | CGCTCAAACCGGTTTCAGCTGCTCCAGACCAAACTGCCAGGCCACCCCGC | Hypo | TRUE |
| L3MBTL | cg01071811 | 20 | CGGGGTCCAGTCCCAGGGTGCCCCACTCTAAGCCACGCCCCCAGGCTCCC | Hypo | TRUE |
| MAP1LC3A | cg14880655 | 20 | CGCAAACCTGTGTACATTTCTAGAGAGCAGGTTCATGTTTGCAGGGGGCT | Hypo | TRUE |
| MYT1 | cg16772207 | 20 | CATTAGCAGCGGTGGCACGGGCTGGCGGAGGAGGCTCCTTTGTAAATACG | Hypo | TRUE |
| PLCG1 | cg23761264 | 20 | GCAGCCTCGAGGTGGGCACCGTCATGACTTTGTTCTACTCCAAGAAGTCG | Hypo | TRUE |
| PTPNS1 | cg18952560 | 20 | TTTGCGCAAACTTGTTTTTCTAAGGTCAGCGCTGCGAGCTGGCTACATCG | Hypo | TRUE |
| RALY | cg24428760 | 20 | CGGCCTGCCGGAAGAAGTGAGTGAACGGAAAGGCACAAAGCACACACCCT | Hypo | TRUE |
| SCAND1 | cg01470283 | 20 | TCAGGGGCAGGCGGTGAGGCCTCTGGCAGCGAGGAGCCCACACAGTTACG | Hypo | TRUE |
| SLC13A3 | cg18468842 | 20 | CGTGGCAGCAGGAAGTGCCGAACAAGAGGGAAAAGCCCCTTATAAAACCA | Hypo | TRUE |
| SLC23A2 | cg12821724 | 20 | CGGGCAGCCCCTGTTGGTTTGGTGGAACAAGTAAAGTCATTGAGTACTAA | Hypo | TRUE |
| SLC35C2 | cg04506546 | 20 | CGCCCTCCTGCAAGGCACCTGCCGGACGCCGGCTCATCTGGTATTTCCTG | Hypo | TRUE |
| TFAP2C | cg02536286 | 20 | AGTTATGATAATTTCCTTCTCATTAAGGCGCTCGGGTCCCCCGGCTATCG | Hypo | TRUE |
| C21orf91 | cg01284306 | 21 | CGAAGAGGAGCAGTTTGTAAACATTGATTTGAATGATGACAACATTTGCA | Hyper | FALSE |
| ABCC13 | cg23322112 | 21 | GTATCTGCCTCAAAGCAACTTGTTGCATACTCTTTACTTCTATATACACG | Hypo | FALSE |
| ABCG1 | cg08663969 | 21 | TCAGGTGGGCCTGTGGCAGGGCTGCCCATGGCCCCTGGTGAGCATGTGCG | Hypo | FALSE |
| C21orf42 | cg25864727 | 21 | CGATGTAGTAGCTAGGTGGCTACATGTTGGGCAAAATGGGATAAGACAAT | Hypo | FALSE |
| C21orf7 | cg22074666 | 21 | CGGCAGCCTTAGGGGCTTATGGCAGAAATGCCAAAACAGCATGAAAATAG | Hypo | FALSE |
| C21orf86 | cg04595021 | 21 | CGCCACAGCAATGCTGTTAAATAGTCCAGACAGAGGCGGTATTGCCCGAA | Hypo | FALSE |
| CLDN17 | cg13792279 | 21 | CGGGCATCTTCGTTCTGATTCCGGTGAGCTGGACAGCCAATATAATCATC | Hypo | FALSE |
| CLDN8 | cg04052038 | 21 | CACTGTCATGCCTCAGTGGAGAGTGTCGGCCTTCATTGAAAACAACATCG | Hypo | FALSE |
| DOPEY2 | cg00673191 | 21 | AGCCATTTGGGGATACAAATCATTCCCAACCCAGAGCTACAGAAGACACG | Hypo | FALSE |
| JAM2 | cg11344614 | 21 | GGAACAGCCCCTTATCATGGACCTTGGACAAGCCATTTAGTGTCTCTCCG | Hypo | FALSE |
| KCNE1 | cg03801286 | 21 | AAACGTCAGAGTACTTTCTGGAAATAAGCCTTCCTCTCCAGGGAACAACG | Hypo | FALSE |
| KCNE1 | cg09964921 | 21 | CGCCAGCTGCCTGACAATTTGTGGGATTAAAGCTCTAAGCTGCTTACTGG | Hypo | FALSE |
| KCNJ15 | cg18248112 | 21 | CGCCGTGTACCTCTTACCTGCAAAGACTGAAGAGTGCAGACTCCTGGCTG | Hypo | FALSE |
| KRTAP10-8 | cg17778867 | 21 | CGCCTGCTGCACCAGGACGTATGTGATTGCTGCATCCACCATGTCTGTCT | Hypo | FALSE |
| KRTAP13-1 | cg02764897 | 21 | CGGCTGAACGTATATAAATGGTCCTGTCCAGATGTGGCATGCAAACTCAG | Hypo | FALSE |
| KRTAP15-1 | cg15606663 | 21 | GCTAGAGTATGTCAGTGTCCAGTATAGAAGGTAACATTCACACACACACG | Hypo | FALSE |
| KRTAP19-2 | cg09828634 | 21 | TGGCTACGGCTGTGGATGTGGCAGCTTCTGCAGACTGGGCTATGGCTGCG | Hypo | FALSE |
| KRTAP19-3 | cg06748315 | 21 | CGGATATGGCTGCTACCGCCCATCATACTATGGAGGATATGGATTCTCTG | Hypo | FALSE |
| KRTAP19-5 | cg07374637 | 21 | AGAAGTTTATTGCATACATTCCCTCTGTCTTCCATCGACTTATCTCAACG | Hypo | FALSE |
| KRTAP19-6 | cg17503750 | 21 | CGGGCAAGATCTTGGAGTTAGAGTATGAGAATCAGCAAGTTTTTTAGTAG | Hypo | FALSE |
| KRTAP20-1 | cg25388528 | 21 | CGAAGCACACCTCAGGCAGAGAATGAGGAGTGGTAATGTCTTTATTGCAA | Hypo | FALSE |
| KRTAP20-1 | cg26565975 | 21 | AGGCAATGTTGCTCTTATTATGAATTATTTTGGGTTGACCGCTAACACCG | Hypo | FALSE |
| KRTAP21-1 | cg06222800 | 21 | TCCTGCTAAAACATCACTGTCGGAGGACCATTTGCTTCTAAAATGACACG | Hypo | FALSE |
| KRTAP21-2 | cg14021698 | 21 | ATTGGATATCCATAATAATTGGACCACTCTGATGTTTATGCTGTACATCG | Hypo | FALSE |
| KRTAP21-2 | cg23581186 | 21 | CGGTAGCCACAGCAGCTAGAGCTGTATCCACAGCCATATCCACAGCCAGA | Hypo | FALSE |
| KRTAP22-1 | cg27456885 | 21 | TCCTGGATTCTCTGCCTCAGCCTTATGAATAGCTGGTGCGTGCCACCACG | Hypo | FALSE |
| KRTAP26-1 | cg18822544 | 21 | CGCAGAAGCACCACCTTCTAGGGATAAATAAAGGGTCAAGCTAAGGAAGG | Hypo | FALSE |
| KRTAP6-1 | cg03029616 | 21 | CGGCTCTGGCTCTGGCTACTATTATTGAGGATGCCATGGGAGACTCTCAC | Hypo | FALSE |
| MRAP | cg12014368 | 21 | ATATAGAAAATCTGCCCCTTTTTCTCAATTTTGCTATGAATATAAAACCG | Hypo | FALSE |
| NRIP1 | cg21021629 | 21 | GCAATGACAAGATAAATGCAGTCTGACCACAGTGCTGATCAACTTCTACG | Hypo | FALSE |
| PCP4 | cg01309152 | 21 | GCCAAATGTTTTATTCTCTTACGAAGATGCGTGTCTTTGCATGATTCCCG | Hypo | FALSE |
| PRSS7 | cg20839025 | 21 | CTACCATTCATTAATAACTGCACAAGGCCATAAAGAGTAGCCATAGAACG | Hypo | FALSE |
| TRPM2 | cg06812844 | 21 | GGCAACAATGACAAGGTAGGCTTTCTGCTGGTCAGCCTGCAGTTGGCACG | Hypo | FALSE |
| TTC3 | cg21832243 | 21 | TGAGAGGGTTTGGACCCGAGGAGCTTGTGATGTCACCAGTGTGCCCTGCG | Hypo | FALSE |
| APP | cg13169373 | 21 | CGGTGGGGACGCGATACCCCCCAAGACCTTAACCCAAGTCTTTAATGCAG | Hypo | TRUE |
| CBR1 | cg00695416 | 21 | CCATGTAGCGCTGGTGACTGGAGGCAACAAGGGCATCGGCTTGGCCATCG | Hypo | TRUE |
| CXADR | cg00744433 | 21 | CGCAACTGCAGTTTAGCCTGGTGAGTTGCAATTCTGGCTGCACATGAAAA | Hypo | TRUE |
| HMGN1 | cg13791713 | 21 | GGGAGGAGTGGCAGCGGCAAGGCAGCCCAGTTTCGCGAAGGCTGTCGGCG | Hypo | TRUE |
| IFNGR2 | cg17356733 | 21 | CACCGCGCCTGGCATCAGTGCATACTTTTTGAAGTGATTCCAAGTTATCG | Hypo | TRUE |
| KCNJ6 | cg05380982 | 21 | CAAATTTCACATCAGCACCGAGAGGCTGTTAGGAGACTCCATTCTGCTCG | Hypo | TRUE |
| KRTAP6-2 | cg19306866 | 21 | CGGTGTCCTCAATAGTAGTAGCCAGAGCCGCATCCATAGCCACAGCCACA | Hypo | TRUE |
| PDE9A | cg00516481 | 21 | CGGGGTAATCCTCGGTCCGGCCCCATACAGGACAGAAATAAAATCGCCAT | Hypo | TRUE |
| PKNOX1 | cg14204791 | 21 | TCAGTGTGATGAAGATTGGCACCCAGGTAAGCTGTCACTCAACCGCTCCG | Hypo | TRUE |
| WRB | cg13287780 | 21 | AGCCACCTCGCCCTGCTCACTTTGCATACATTTGAGTTGGGATTCTTTCG | Hypo | TRUE |
| PSCD4 | cg21736592 | 22 | CGGGGGTCTCGTGTGCAGGCTTTTGACAAAACAGCACTTCCTAAAAACTG | Hyper | FALSE |
| SFI1 | cg02404636 | 22 | CTTTCAAATAAATAACTACTGCTTTTAGTCTCTGCACCAGGAATCTCACG | Hyper | FALSE |
| APOBEC3G | cg04286933 | 22 | GACAGCAGGTGGGTGTGGGCCTCAGATGTCCCACCGGGATGCCATGCGCG | Hypo | FALSE |
| APOBEC3G | cg26022401 | 22 | ATCTTAGTCGGGACTAGCCGGCCAAGGATGAAGCCTCACTTCAGGTACCG | Hypo | FALSE |
| APOL3 | cg11835355 | 22 | TGATTCTACACAAGGTTACCGCGAGGTCTCAACCATGTCTGATATCTACG | Hypo | FALSE |
| ATXN10 | cg20269537 | 22 | GAAGCTGGAGCGGTCTGTCACTAGCTTGCAAGTCTCAGGCCCTGAAAACG | Hypo | FALSE |
| BPIL2 | cg14789590 | 22 | AGTCCTGCCTGCAAACAGACAACATCGTGTATCAGATGTTCTAATGGACG | Hypo | FALSE |
| BPIL2 | cg27195224 | 22 | GACCCAAACTGAACAGCTCATAACATGGGCTGTCTCCTGACTGAGAAACG | Hypo | FALSE |
| C1QTNF6 | cg11793380 | 22 | TCTCTGCACCAAACCCAAGAGACTCTAATAGTTAGGCAGGAATATCATCG | Hypo | FALSE |
| DNAJB7 | cg10115873 | 22 | CTAATAGCCACAGCATATCCCTTGCATAATATGACCTCTAGATTACTGCG | Hypo | FALSE |
| DNAJB7 | cg20655558 | 22 | CGAGGTATTATCAAATGATGAGAAACGGGACATTTATGATAAATATGGCA | Hypo | FALSE |
| FLJ25421 | cg00044729 | 22 | CTGGCTCAGCTTTCATGCCTTTACACATGATGTGTCCTTTGCCTCTTACG | Hypo | FALSE |
| HMOX1 | cg11458974 | 22 | GGGTTGCTAAGTTCCTGATGTTGCCCACCAGGCTATTGCTCTGAGCAGCG | Hypo | FALSE |
| HPS4 | cg19831369 | 22 | CTAGGCACATTCACTCTCACTGGCATCCTCTGAGAGCTTAAAAATAATCG | Hypo | FALSE |
| HSC20 | cg25112853 | 22 | AACAGGGAGTACTACGGAAAATTGCTTCCTTGGGAACTCCATATAGCTCG | Hypo | FALSE |
| MGC35206 | cg22088368 | 22 | AGCAACCCATCAGCAAGTCCTTCGAAGTACACTAGATTTGGATGCCTTCG | Hypo | FALSE |
| PARVB | cg00539955 | 22 | CGTGGGTGTTCCTGCAGCTGGGGCCTGTGCTCCCAGGCACTCATGGCTTC | Hypo | FALSE |
| PIK4CA | cg21244955 | 22 | CGGAGAGATGCAGTGATTGCATTGGGCATTTTTCTGATTGAATCTGATCT | Hypo | FALSE |
| SLC5A4 | cg13507893 | 22 | CATAAATAACGCTTACAATGAACTAATGTATTCTCCTAATAACCCCATCG | Hypo | FALSE |
| SYN3 | cg16894211 | 22 | GGAAAGCAAGCTCTCTGGCATCCTTTCTTATAAGGGCTGTACTTCCATCG | Hypo | FALSE |
| ARFGAP3 | cg10648908 | 22 | GAGGCGCTTGAAGATGGTCAAGATGTCCTGCTTGCTGGGGTCCCCCATCG | Hypo | TRUE |
| ATF4 | cg13462160 | 22 | ATGGCTTAAGCCGCTGGGGGTTGCCGCTGCAGAGCCTGGTGCTGCTGCCG | Hypo | TRUE |
| BIK | cg25018755 | 22 | AAGTGTGGGGAGCCGTGCCCAGGTTTTACCGCTCCAGCAAGTCGCTGGCG | Hypo | TRUE |
| CDC42EP1 | cg13951472 | 22 | GCCTGTAAACATCAAGGTTTAAAGGCCCAGGCATTCAAGGCCTCAGATCG | Hypo | TRUE |
| CSNK1E | cg01441777 | 22 | CGCAGGGCCTCAGGCATTTTGCGTGTCCACAGTCACAACTGTGTGAATAT | Hypo | TRUE |
| FLJ20699 | cg27118809 | 22 | GGGCCCGAGGGGGACCTGGTTGGGGGCAGCCTCCGTGTACCTGGCAGTCG | Hypo | TRUE |
| FLJ23588 | cg15819171 | 22 | CGGACCTCACTGCAGCCAATCCTGACCACAGGCCCCAGTGGGCACGCTTA | Hypo | TRUE |
| GNAZ | cg19764436 | 22 | CGGACAGCTAGCAGTTCTCGGTCACTGCTCTTGCAGCGAGCAGGTTCCTC | Hypo | TRUE |
| KDELR3 | cg20074795 | 22 | CGTGTTCCGAATCCTCGGCGACCTGAGCCACCTCCTGGCCATGATCTTGC | Hypo | TRUE |
| LARGE | cg05670348 | 22 | GCATGGGCAGGGGCCTGGGTCAGCCTCGGGTTGGGTCCAGGGAGCGACCG | Hypo | TRUE |
| LGALS2 | cg03835292 | 22 | CGCCTGGCCTAAGGTTCTAATTTTCTATGATGTTATGATTCATTGTCAGA | Hypo | TRUE |
| MAFF | cg18652852 | 22 | AAAGGAATCCTGTGAGTGAGTAATTCCGGGAAGCTCGCCTTACAACTCCG | Hypo | TRUE |
| PDGFB | cg19167673 | 22 | ATTTTTCATTCCCTAGATAGAGATACTTTGCGCGCACACACATACATACG | Hypo | TRUE |
| PKDREJ | cg11377136 | 22 | GGCAGGCGTTGGGCGCTGAGCAGGACGCGCAAGTCGAGGCAGTACCAGCG | Hypo | TRUE |
| PPARA | cg04280480 | 22 | AGTGGGAACCGTTCCTCAAAGGTGGTCGCAGCTGGAGGAACAAACACGCG | Hypo | TRUE |
| RABL4 | cg12924408 | 22 | GTAGGGCTGTGCTGAGGGGCTGGGCGGGGAGCACAGGCCGTGTCCGCTCG | Hypo | TRUE |
| RTDR1 | cg10575414 | 22 | CGGGAACAATCATTTACAGGGTTGCTGTGGAGACCAAAGGCAGCTCAGCT | Hypo | TRUE |
| TUBGCP6 | cg11808757 | 22 | CATCCTCACCTGGTGGCTTGAAATCGGCCAAGGTGGGAGCATTTACACCG | Hypo | TRUE |
| TUBGCP6 | cg21028326 | 22 | CGGTTCTGTGACTCCCTAAAGGTTGAGGGCTACTGAATTAGAAGAAACGC | Hypo | TRUE |
| USP18 | cg27281093 | 22 | AACGCCAAATGACTCTAACACGTAGGCTAATTGCAAGGACCTTAAAATCG | Hypo | TRUE |
| ZDHHC8 | cg16756998 | 22 | TCTGGTCTGAAGCCCCTTGGAATTCACGAGGGGGCGCGGGTGTGACACCG | Hypo | TRUE |
| ZDHHC8 | cg25650110 | 22 | GTACTTGGCGGGTTTGAGGCGCGTCCCGGGGCTGCGGGGCATCCTGGGCG | Hypo | TRUE |
| SELE | cg09784259 | 1 | GAAACTCTGTCTCTTGAAGCTACTTCACCTTTGTCCATGCCTTTATATCG | Hypo | FALSE |
| CXorf53 | cg25893483 | X | CGGCACGGCATATATTGTGCTTTGATTTAGAATCGCTTTCAAAATCCACG | Hyper | FALSE |
| CXorf41 | cg06350796 | X | CGCTCTGCACAGTCTATTTTCGGAGCCTAGCCAGAGACGGGAAAACTGAC | Hyper | TRUE |
| GAB3 | cg12938998 | X | CGAGTTACACTGTGTAGGGTTCCAGACAGCAGTGTCCGATGACAGCTACA | Hyper | TRUE |
| GPKOW | cg08324796 | X | TCTTGGTGACAGTGACCTGTTAAGCCTGAAACACAGCCTGAGTAAATTCG | Hyper | TRUE |
| NKAP | cg19410841 | X | AGAAGTACCCAGAACTGTGTCCAAGGTTTCCTCAGATTTGGGCTGTTCCG | Hyper | TRUE |
| NSBP1 | cg09086179 | X | GAAAGGTGTCTCCATGCTGAATTACAAACAGCCATAGCGCTGGGCTGTCG | Hyper | TRUE |
| NSBP1 | cg02132188 | X | AAAACTGATCAAGTCAGCTCTGGCTTTCCTGCTGTTCTTATTCCTGATCG | Hyper | TRUE |
| ACE2 | cg08559914 | X | TGATCTGTGGCACTCATACATACACTCTGGCAATGAGGACACTGAGCTCG | Hypo | FALSE |
| ACTRT1 | cg09840989 | X | GTCCCTTGCAATTCAGTATGCAATTTAGGATCAACTTTCCAATTCCTACG | Hypo | FALSE |
| AGTR2 | cg16191875 | X | GGAATTTTACTTGAAGTCTACCACTTCTAAAATTTCTCCCTTGCTTTGCG | Hypo | FALSE |
| AKAP4 | cg00941549 | X | AGAAGTCTCTCTCCTCTACTGCAGTGGCCTGAATAAAATCTGTCTTGCCG | Hypo | FALSE |
| ALAS2 | cg14168975 | X | CGGGGATCTAGTCTGTGGAAGCTGACTGTTTGAGCTCATAAGCACAACAC | Hypo | FALSE |
| ALAS2 | cg21045917 | X | AAGGGATAAATGCCAGGTCCTAACCCAAGTACCCACCTGTCATTCGTTCG | Hypo | FALSE |
| AMELX | cg04906538 | X | CGTGCACAGTCTACCTGGACATTGCTACTGTTAAAAACAAGGACTAATCA | Hypo | FALSE |
| AR | cg04755662 | X | CGGAATCTAAGGTTTCAGCAAGTATCTGCTGGCTTGGTCATGGCTTGCTC | Hypo | FALSE |
| ARSE | cg11964613 | X | GTTAATCATTCCCAGCTCAAAGCCTTGTGCAAGTGCTCTCTGCCTTCACG | Hypo | FALSE |
| ARSE | cg22376897 | X | CGGGGAGCTCTTTGTTCACCACGCTATTCATGCCTGGTCACGGAGCCCAA | Hypo | FALSE |
| ASB11 | cg12724466 | X | CGGCTAGGATAGCAGAAGAGATCTATGGTGGAATTTCAGGTAAAAGTACA | Hypo | FALSE |
| ASB9 | cg06942536 | X | CGGTGGGAGAAGAAAAATTAATAAATGGAAATTAAGACCTGGTGTACATT | Hypo | FALSE |
| ATG4A | cg18124706 | X | CGTCTGGTTCCTGATTTAAACAAACCAACTGCAAAAAGACATTTGGGAGA | Hypo | FALSE |
| ATP11C | cg18433694 | X | AGCATCAGATGACAGTCTATTCCTTAAGAGCTCAAAGCAGTACTCTGGCG | Hypo | FALSE |
| BRS3 | cg15016628 | X | CGAGATGGTATTAGGAGAACAGAACAGAACAGAATGGGAAGAAAATCCAA | Hypo | FALSE |
| BTK | cg00126698 | X | TAGGCCAGGGTGTAGGCTACCTGCCTTGAGCTGTACCAGGCCAAATGTCG | Hypo | FALSE |
| CCNB3 | cg00141550 | X | CGCTGCTATAAAGTGCCATGGACTGGGTGGCATTTAGTTCTCACAGTTCT | Hypo | FALSE |
| CCNB3 | cg09555679 | X | TACAGTTTCTTCTGATTGAACGCAGCCTTTGAATACTGCCTGGCCTATCG | Hypo | FALSE |
| CDR1 | cg02457752 | X | TTACCATTAGTTTGTTTCTAACCTCCAGCATCTACCTGCTTCAAATATCG | Hypo | FALSE |
| CDR1 | cg08214957 | X | CCAACAAAGGTACGTCTTCCAACAAAGGTATGTCTTCCAACAAAGGTACG | Hypo | FALSE |
| CHM | cg06340713 | X | CTATGTCTAACAGCTAACATAGCTCTCATAAGTATCTTCAAGGTCTGTCG | Hypo | FALSE |
| COL4A6 | cg11552293 | X | CGTATAAGATCTGGGAGCATTCAGCAGGTATTGGTAATTATTCTATGGTA | Hypo | FALSE |
| CPXCR1 | cg06590711 | X | TATGCTTTCTCTTTCACTTTCAACTCACAGTTTATCTTCATTCTCATTCG | Hypo | FALSE |
| CXorf23 | cg16561743 | X | TGGCCCTCCTCCAATGGGACAGGTGTGCTCAGCTCATTTGGATAAGCACG | Hypo | FALSE |
| CXorf23 | cg25257360 | X | AGGGAACACCCAGAGACCAGTTCAGCAACCAAAGTATCCTATGACTATCG | Hypo | FALSE |
| CXorf45 | cg21090723 | X | CGGAGATGGATGCTGAGGATGAAAATGTTCATTAGACATAACATTGCCAG | Hypo | FALSE |
| CXorf6 | cg00032666 | X | CGTCTGGATTTGCTTTTGTGTGATATGCAGTGAGATTCAGGAAAACTTCC | Hypo | FALSE |
| CYSLTR1 | cg02518339 | X | TTTGTATCTTTAGGTACAAGAATTACCTCACAACCAACCTGGGACAATCG | Hypo | FALSE |
| DRP2 | cg16716983 | X | CGCTTGTTAAAGAGAAGAGGGTATGAGCTCCAAACACCCTCAGAGACCTG | Hypo | FALSE |
| EDA2R | cg14372520 | X | CGGTGTGGTCCTGGACAGGAGCTATCCAAGGTAAGTTATCCTATTCAGTA | Hypo | FALSE |
| EDA2R | cg26328611 | X | CACATGGTCAGAGCTACATAAGCATTAACTCTTTTGTGTTGGCTTCCTCG | Hypo | FALSE |
| F9 | cg10339201 | X | ACTAATCGACCTTACCACTTTCACAATCTGCTAGCAAAGGTTATGCAGCG | Hypo | FALSE |
| FGF13 | cg07146718 | X | CGCCCAAGAGCTTCCAGCTCACGGAGAAAAACAAGCTGAGAGAAGGTTGC | Hypo | FALSE |
| FIGF | cg04545159 | X | CGGAAGAGCAGGTCTTGATGTGTCCTAGAATTTTGCCATTTCTGAGATTG | Hypo | FALSE |
| FSHPRH1 | cg12724827 | X | CGCCCGGCCGAGATGGATTAGTTTTGGACCCACTTATATGACATAGCCAT | Hypo | FALSE |
| GDPD2 | cg08254263 | X | TCCTACTTCTAATTCAGCAAGGTGCATGTATAAGAAGCTGCAGCCTGGCG | Hypo | FALSE |
| GPR174 | cg19388557 | X | TTGGTCTGCATCAGTGTGCGACGATTTTGGTTTCTCATGTACCCCTTTCG | Hypo | FALSE |
| GPR34 | cg22835805 | X | CGGGGGGAGGAAAACATTCCACAATTGTCAAGTTGGAAGGTATTCATAAA | Hypo | FALSE |
| GPR64 | cg03142203 | X | CCTCATTTCTACAACATTATCTCATAGAAATAGCATTACTCACCTGACCG | Hypo | FALSE |
| GSPT2 | cg21258987 | X | CGTGATCCACCATTGAATGGCAGGCCAGCCATTGTGCAGGCATCTGCATA | Hypo | FALSE |
| HEPH | cg08021299 | X | CGCCCCACTTGCTCTAGGAGTAATCAGCTATGTGGATTTTGTGGATTTGG | Hypo | FALSE |
| HUWE1 | cg04058675 | X | CGTAGCTGTGTGTGCCTGAAGTCAGCTCTCAGGCTGCTGTGCAATTCCTT | Hypo | FALSE |
| IL13RA2 | cg00488364 | X | CGAAGAGAAGTGTATGGAATTGGGAGTAGTAGTTTTTCCTGAAAAGCAAA | Hypo | FALSE |
| ITM2A | cg06208111 | X | TTTACCATCTACTCATCTACCTAAGAAACGGACTTAAATATGTTGAGTCG | Hypo | FALSE |
| LHFPL1 | cg00874863 | X | CGGTAAAAATTGCTGATGGAAAGTTGCTAGATAGACAAATACATGCATGA | Hypo | FALSE |
| MAGEA12 | cg11236244 | X | ATGTAAACTCAGCTTAAATTATTTACAATTTAGTGCCTTACCTGTAGTCG | Hypo | FALSE |
| MAGEA9 | cg09607232 | X | CGCGTGCAGCTGGGCAAATGCTCAAAGGTGACATAAACAGATCATCTCCC | Hypo | FALSE |
| MAGEB1 | cg13201322 | X | CTACTGGATGTGGCCCTGGAATACGCACTAGTCATGGCTGTAGTGCCACG | Hypo | FALSE |
| MAGEB3 | cg26895595 | X | CGCTGCCCAAGAGTTTGCAGGGATGTGGCATTTCCCAGGAAGCCTTTATT | Hypo | FALSE |
| MAGEB4 | cg05141400 | X | CCTGAGAACACCTTCAGCAGGCAGATACTACCTTGGCTTTTCAGAAGCCG | Hypo | FALSE |
| MAGEC3 | cg17474651 | X | GGGCTCTTCTCTCAAACTGTGACTGCAGCCTGAGTTAGACTTCTGCAACG | Hypo | FALSE |
| MBNL3 | cg02549418 | X | CGGCTGTCAATGTTGCCCTGATTCGTGATACCAAGTGGCTGACTTTAGAA | Hypo | FALSE |
| MORC4 | cg21067846 | X | CGGTTGAAAATGGAATAGTTCAAGATGGCTTCTAGGCTGGGCAATGAATC | Hypo | FALSE |
| NOX1 | cg27067621 | X | TGGCAACAGTTTGAAAAGTGCACTTTGAAACAGCTTCCTTACCACACACG | Hypo | FALSE |
| NSDHL | cg10349665 | X | CGATGCGGATGGAACTGGCACCATAGATGTTAAAGAACTGAAGGCAAGCT | Hypo | FALSE |
| NSDHL | cg10634358 | X | CGGATGGAACTGGCACCATAGATGTTAAAGAACTGAAGGCAAGCTCTGTG | Hypo | FALSE |
| NXF5 | cg03127543 | X | CTCTTCCTCTGACCATGCTGTTATTAAGGACACTTGAGACTCCCTAGACG | Hypo | FALSE |
| NXT2 | cg06041240 | X | CGGAGGAAATAATGAGTTTAAATTTTGGACGTACAAGTTTGAGAAGCCTA | Hypo | FALSE |
| OFD1 | cg05573563 | X | CGTGGAGCAATGTGGGAATCTTGAATACTAGTACATGATCCTGTAGCTGA | Hypo | FALSE |
| OTC | cg10537079 | X | TTTATTGCCTGGCCTCCTCATTTTTCATAATATATTTATACTGTCACACG | Hypo | FALSE |
| OTEX | cg27250462 | X | GAGAATATCTCATGGCCTGACCCTCCATATTTGGCAGCATGCACAGGGCG | Hypo | FALSE |
| PABPC5 | cg23407366 | X | CGGCAGCTCAACAGTTTCAACGTTTTGTGGCACTAAACACCATCAAAAGC | Hypo | FALSE |
| PEPP-2 | cg16499669 | X | CGCACCTCAGCAGGCCCAACCCACAGCAAATAGCGGGAAGCAGAAAAGCA | Hypo | FALSE |
| PLAC1 | cg17073891 | X | GCAGTGAGCTGGCCACTTGTAGTGCTTGCTGTTGCCAAGGCAGTCTTTCG | Hypo | FALSE |
| PPEF1 | cg17198372 | X | AATCTGCCTTTCAATAAGCAAGAAATAGTCCTCTCATCCAGGTCATGTCG | Hypo | FALSE |
| PRRG1 | cg00939965 | X | TCAACAGGTACATGAAGAAGCCATCTTGGGCTGGGCACCAGTAGCTCACG | Hypo | FALSE |
| PRRG3 | cg02020018 | X | CTTAACAGCTGGGCTTCCAGGGTGCCTGTGCTTGACTGGCAATAGTGACG | Hypo | FALSE |
| RP1311B7.1 | cg13792569 | X | TAATGCCAAACACATGAATCAGTCCTTTAACTACAAATATACAAATGACG | Hypo | FALSE |
| RS1 | cg17626563 | X | CTGGTAGGTTTAAGAGCACAGACTGCCAACCCAGACTGGGTGCCAAATCG | Hypo | FALSE |
| SLC6A8 | cg07446846 | X | TCTGGCTTGGGCCGGAACTGCTTTTCTTCCTAAAGCTGGACGGATGGCCG | Hypo | FALSE |
| STS | cg00596686 | X | CTGGCCTGTTCCTGCTGTAAGTTTCATAACACTGCTGCTAGCATAAACCG | Hypo | FALSE |
| SYTL5 | cg12731488 | X | TTATTCTCTTGTCCTCCACTTTTTTCAAATATTCATCTCTCTTTAGGACG | Hypo | FALSE |
| TAB3 | cg14186071 | X | CGGTCAGAACCTCAGAGTCCAAGTACAACATTCCTACTGGTTAGGTATGG | Hypo | FALSE |
| TGIF2LX | cg19140639 | X | TCACCAGTTTCCACTAACTGACGAACTCTATTTCTATTAGTGTAAATACG | Hypo | FALSE |
| TLR8 | cg00741717 | X | CGAGTGAGTCAATGGCTGAGCATTCGTGAGGCTGGAAAATTTAATCTTCC | Hypo | FALSE |
| TLR8 | cg07759587 | X | CGCTGCTGCAAGTTACGGAATGAAAAATTAGAACAACAGAAACATGGTAA | Hypo | FALSE |
| TMEM27 | cg13876499 | X | CCTGTAGTAGCTGCCATATTGGATAGTACAGACACAGAACATTCCCATCG | Hypo | FALSE |
| USP9X | cg12330929 | X | GACAAAATTGCAAAGATCTGCCCTGTGTCGAGTATGACAGCCACGACTCG | Hypo | FALSE |
| VCX | cg09018040 | X | AGCCTGATACAAATACCCAGCTGAGCGAGTGTCTTTGCTGATCTTCACCG | Hypo | FALSE |
| VSIG4 | cg16786117 | X | CGCAGTGCCAAACCTAGTTAGACTGCTGATGAAATTACAGTCACTCTGGG | Hypo | FALSE |
| VSIG4 | cg26561773 | X | TAGGTTACTTCTATAGTCCTATCCAACTCTTAGAAAACACTCCTTCTTCG | Hypo | FALSE |
| XAGE5 | cg22562335 | X | CGACTTGCTCAGCTGGTTGGGCCTATGCTTGTGAGTGACTTCACATTCGA | Hypo | FALSE |
| ZNF645 | cg01909378 | X | CGAGGTTCTGTCTTCATGTGTAGTATTGTTCAGCAGTGCAAGAGAACATA | Hypo | FALSE |
| ZXDA | cg18628674 | X | CTCATCTCAGATATTTCACCCTATATTTGTGTCAATTCCAAACTCATTCG | Hypo | FALSE |
| ASB11 | cg05655041 | X | CGCCCGGCCAGGTAAATGGTCTTTTTTAACTGGTCATATTTTAGATTTGG | Hypo | TRUE |
| BIRC4 | cg09950034 | X | CGGCCCGAGCCCCAATCTGGAAATGCCAACTCCGCTCTGCGGCTTGGCCC | Hypo | TRUE |
| BMX | cg24643262 | X | AACACGTTTATTGTCCTACAGAGCCTTACACAATCCCACAGGAAACCACG | Hypo | TRUE |
| CUL4B | cg13174077 | X | CGGGCTAGGTTCTGCCCGCCGAGGCTGGCTTTCATGTGTATTTAACACCT | Hypo | TRUE |
| CXorf2 | cg07356189 | X | CGCCGTGCCCAAGTCCAGACATTCCGGATCCCAAGTGCTGTCTCTTGGTT | Hypo | TRUE |
| CXorf20 | cg19845843 | X | AGAGATAATGAACTGGAAGCCAACAGTGTAATTCTGCTCGTCCCAAAACG | Hypo | TRUE |
| EIF2S3 | cg00060882 | X | CCTGGTAGATATTTGTGCAGGCAATACTGAGGGCAGCCACCAAACCCCCG | Hypo | TRUE |
| FLJ20130 | cg05163206 | X | CGCCTGCCTGTCTGGATGCTGAGGTGGGAGAATCACCTGAGCCCTGGAGA | Hypo | TRUE |
| GABRQ | cg06177698 | X | CGGAGTCACCAGCCGTTGGGTACCTCCTGACGCCCAAAATTGTCCAAGTC | Hypo | TRUE |
| GYG2 | cg03506684 | X | TTTCTAGGTTTGGACATTTAACCTTTAATCAGCCAGCCCCAAAGTAAACG | Hypo | TRUE |
| H2AFB3 | cg15082782 | X | TTGAGAGCCATCTTGCCTAGCTGGGCCAAGCCGAGATAGCACACTCAACG | Hypo | TRUE |
| HPRT1 | cg10584819 | X | CGCCGGGCTAATATGCTCATTTTAGTGAGGCAAAAATAGAGGCTCAGAGT | Hypo | TRUE |
| LANCL3 | cg01975392 | X | CGGAGCTGAGGACCGCTTGAAGTCGTGCCCTGCAGCCCCGCACACCACCT | Hypo | TRUE |
| LW-1 | cg08420900 | X | CGCAGATGCCCGACAGCCCCTTAGGCAAATGGCTTAGCTGACTGCCCCAC | Hypo | TRUE |
| MAGEC2 | cg23813564 | X | CGCCTCCTCACAAATGCCTTCGATCCGTCAGATTCCCAAGATGGCCGTCG | Hypo | TRUE |
| MID1IP1 | cg21888438 | X | CGGGGAGCGCGCGCAAGGCCCGCCCAGCCCCCACATGCCAGCCCCACCCT | Hypo | TRUE |
| PAGE1 | cg23937047 | X | CGCACTGAGGCTAGCACCCAAAGGTGGGGAGGGCTGCAGTTCCCAGCCCC | Hypo | TRUE |
| PAGE5 | cg13837202 | X | CGGACTGTGCCACGGGACCTGTCCTAAGCCCGCTGGCTCCTCCACACATT | Hypo | TRUE |
| PAGE5 | cg13991029 | X | TTAATACCCATTTTATATCTGCTTTCATAAATCATTTTCTTGTGCCTTCG | Hypo | TRUE |
| PRPS1 | cg26053787 | X | CGGCAGCTCCCACCAGGACTTATCTCAGAAAATTGCTGACCGCCTGGGCC | Hypo | TRUE |
| RBBP7 | cg14719055 | X | CGGCATCTGCAAGATAGCATCTGAGCATGAAGGCACTTGGAAAGGTATCA | Hypo | TRUE |
| RNF12 | cg26751631 | X | CTTCACTTACTAGGTTTTAGGGTCAGGATCCGACTCGGTTGGTTCGGCCG | Hypo | TRUE |
| SLC25A5 | cg02718563 | X | CGGCCACTCCACCTGCCAGGAAGTCCTTGGCGAAGGACACAGCGGCATCT | Hypo | TRUE |
| SMPX | cg05856884 | X | CGGTCAAGCCTTTCGGAGGCAGCCAGCGTATGGCTTGTATCAAACTCTAT | Hypo | TRUE |
| SMPX | cg19002579 | X | CGGGAGAGGCACAGAGCTATTTCAGCCACATGAAAAGCATCGGAATTGAG | Hypo | TRUE |
| XAGE3 | cg20611872 | X | CGCCACAGCCCACTAGGCAGGCACCGACCTCACTGCGCATGTCCACTGGG | Hypo | TRUE |
| XAGE5 | cg25993152 | X | ACAGAGGACAAATTCCAGACTCCTCAAGGGACATCAAGGCTGGAATGTCG | Hypo | TRUE |
| YY2 | cg01662650 | X | GGCGCAGGTGCTTCTGGGATAGCCAGACGCATGCGCCTAGGCAACTGGCG | Hypo | TRUE |
| YY2 | cg13928866 | X | CCACAATATCTGCCGGGATCTCCAGGTCTTGTGTGATGGAGAAATCTTCG | Hypo | TRUE |
| ZNF645 | cg20063650 | X | GATCCAAGTTTCGGCTCACAAGGGACCGGGAGTCATGTGCCAGTAACACG | Hypo | TRUE |
| TGIF2LY | cg03515901 | Y | ACCAGCTCGGCTGTTAGCAACTCTGTTAGCAAAGCTGTTTGTCTTTCTCG | Hypo | TRUE |

Gene symbol refers to the nearest annotated gene to the interrogated CpG dinucleotide.
A unique identification (Unique Id.) is given to each locus by Illumina Corporation.
Chr = Chromosome and refers to the chromosomal location of the CpG dinucleotide.
The Sources Sequence column contains the flanking genomic sequence of the interrogated CpG dinucleotide.
The Proband M1 column refers to the probands' methylation status compared with their discordant brothers; Hyper (hypermethylated) means the proband has more methylation and Hypo (hypomethylated) means the proband has less methylation.
The CpG Island columns depicts whether the interrogated CpG dinucleotide resides in a CpG island (TRUE = Yes and FALSE = No).

TABLE 4
Table 4: Summary of Gene ontology (GO) analysis.

| | | | | Permutation | | | | |
|---|---|---|---|---|---|---|---|---|
| GO: ID | Category | Term | Pvalue | Pvalue | OddsRatio | ExpCount | Count | Size |
| GO: 0007338 | BP | single fertilization | 9.203E−06 | 0 | 4.57 | 4.811636 | 16 | 47 |
| GO: 0009566 | BP | fertilization | 1.682E−05 | 0 | 4.29 | 5.016386 | 16 | 49 |
| GO: 0008527 | MF | taste receptor activity | 3.162E−05 | 0 | 10.4 | 1.490348 | 8 | 15 |
| GO: 0007599 | BP | hemostasis | 4.597E−05 | 0 | 2.91 | 9.520896 | 23 | 93 |
| GO: 0050878 | BP | regulation of body fluid levels | 9.806E−05 | 0 | 2.61 | 11.26127 | 25 | 110 |
| GO: 0006071 | BP | glycerol metabolic process | 0.0001735 | 0 | 6.1 | 2.252255 | 9 | 22 |
| GO: 0008194 | MF | UDP-glycosyltransferase activity | 0.0001922 | 0 | 2.53 | 11.02858 | 24 | 111 |
| GO: 0007596 | BP | blood coagulation | 0.0001983 | 0 | 2.73 | 9.111395 | 21 | 89 |
| GO: 0050817 | BP | coagulation | 0.0002341 | 0 | 2.69 | 9.21377 | 21 | 90 |
| GO: 0005882 | CC | intermediate filament | 0.0004295 | 0 | 2.16 | 15.10203 | 29 | 151 |
| GO: 0045111 | CC | intermediate filament cytoskeleton | 0.0004295 | 0 | 2.16 | 15.10203 | 29 | 151 |
| GO: 0006814 | BP | sodium ion transport | 0.0006091 | 0 | 2.26 | 12.59215 | 25 | 123 |
| GO: 0006957 | BP | complement activation, alternative | 0.0006102 | 0 | 8.8 | 1.228503 | 6 | 12 |
| | | pathway | | | | | | |
| GO: 0044254 | BP | multicellular organismal protein | 0.0007089 | 0 | 5.42 | 2.14988 | 8 | 21 |
| | | catabolic process | | | | | | |
| GO: 0044256 | BP | protein digestion | 0.0007089 | 0 | 5.42 | 2.14988 | 8 | 21 |
| GO: 0044259 | BP | multicellular organismal | 0.0007089 | 0 | 5.42 | 2.14988 | 8 | 21 |
| | | macromolecule metabolic process | | | | | | |
| GO: 0044266 | BP | multicellular organismal | 0.0007089 | 0 | 5.42 | 2.14988 | 8 | 21 |
| | | macromolecule catabolic process | | | | | | |
| GO: 0044268 | BP | multicellular organismal protein | 0.0007089 | 0 | 5.42 | 2.14988 | 8 | 21 |
| | | metabolic process | | | | | | |
| GO: 0019953 | BP | sexual reproduction | 0.0007375 | 0 | 1.74 | 30.09832 | 48 | 294 |
| GO: 0042060 | BP | wound healing | 0.0008706 | 0 | 2.24 | 12.18265 | 24 | 119 |
| GO: 0030195 | BP | negative regulation of blood | 0.0008945 | 0 | 6.16 | 1.740379 | 7 | 17 |
| | | coagulation | | | | | | |
| GO: 0004024 | MF | alcohol dehydrogenase activity, zinc- | 0.0012349 | 0 | 18.2 | 0.596139 | 4 | 6 |
| | | dependent | | | | | | |
| GO: 0004888 | MF | transmembrane receptor activity | 0.0013152 | 0 | 1.34 | 116.1478 | 147 | 1169 |
| GO: 0009068 | BP | aspartate family amino acid catabolic | 0.0013844 | 0 | 17.6 | 0.614251 | 4 | 6 |
| | | process | | | | | | |
| GO: 0030168 | BP | platelet activation | 0.0014179 | 0 | 4.7 | 2.35463 | 8 | 23 |
| GO: 0016614 | MF | oxidoreductase activity, acting on | 0.001554 | 0 | 2.26 | 10.53179 | 21 | 106 |
| | | CH—OH group of donors | | | | | | |
| GO: 0004114 | MF | 3′,5′-cyclic-nucleotide | 0.001598 | 0 | 4.55 | 2.384557 | 8 | 24 |
| | | phosphodiesterase activity | | | | | | |
| GO: 0015291 | MF | secondary active transmembrane | 0.0017573 | 0 | 1.85 | 19.47388 | 33 | 196 |
| | | transporter activity | | | | | | |
| GO: 0002455 | BP | humoral immune response mediated | 0.0018048 | 0 | 3.97 | 2.968882 | 9 | 29 |
| | | by circulating immunoglobulin | | | | | | |
| GO: 0019835 | BP | cytolysis | 0.0019292 | 0 | 5.14 | 1.945129 | 7 | 19 |
| GO: 0050819 | BP | negative regulation of coagulation | 0.0019292 | 0 | 5.14 | 1.945129 | 7 | 19 |
| GO: 0044243 | BP | multicellular organismal catabolic | 0.0019382 | 0 | 4.4 | 2.457005 | 8 | 24 |
| | | process | | | | | | |
| GO: 0004112 | MF | cyclic-nucleotide phosphodiesterase | 0.0021477 | 0 | 4.28 | 2.483913 | 8 | 25 |
| | | activity | | | | | | |
| GO: 0006721 | BP | terpenoid metabolic process | 0.0025223 | 0 | 5.87 | 1.535628 | 6 | 15 |
| GO: 0005132 | MF | interferon-alpha/beta receptor | 0.0026546 | 0 | 12.1 | 0.695496 | 4 | 7 |
| | | binding | | | | | | |
| GO: 0030193 | BP | regulation of blood coagulation | 0.0027085 | 0 | 4.74 | 2.047505 | 7 | 20 |
| GO: 0001871 | MF | pattern binding | 0.0028052 | 0 | 2.13 | 11.02858 | 21 | 111 |
| GO: 0006568 | BP | tryptophan metabolic process | 0.0029684 | 0 | 11.7 | 0.716627 | 4 | 7 |
| GO: 0007340 | BP | acrosome reaction | 0.0029684 | 0 | 11.7 | 0.716627 | 4 | 7 |
| GO: 0032963 | BP | collagen metabolic process | 0.0034205 | 0 | 3.91 | 2.661756 | 8 | 26 |
| GO: 0004974 | MF | leukotriene receptor activity | 0.0036246 | 0 | 27.2 | 0.397426 | 3 | 4 |
| GO: 0022804 | MF | active transmembrane transporter | 0.0038666 | 0 | 1.56 | 34.17865 | 50 | 344 |
| | | activity | | | | | | |
| GO: 0001782 | BP | B cell homeostasis | 0.0039551 | 0 | 26.4 | 0.409501 | 3 | 4 |
| GO: 0006569 | BP | tryptophan catabolic process | 0.0039551 | 0 | 26.4 | 0.409501 | 3 | 4 |
| GO: 0031640 | BP | killing of cells of another organism | 0.0039551 | 0 | 26.4 | 0.409501 | 3 | 4 |
| GO: 0034097 | BP | response to cytokine stimulus | 0.0039551 | 0 | 26.4 | 0.409501 | 3 | 4 |
| GO: 0042436 | BP | indole derivative catabolic process | 0.0039551 | 0 | 26.4 | 0.409501 | 3 | 4 |
| GO: 0046218 | BP | indolalkylamine catabolic process | 0.0039551 | 0 | 26.4 | 0.409501 | 3 | 4 |
| GO: 0004180 | MF | carboxypeptidase activity | 0.0047158 | 0 | 3.64 | 2.781983 | 8 | 28 |
| GO: 0050818 | BP | regulation of coagulation | 0.0049653 | 0 | 4.11 | 2.252255 | 7 | 22 |
| GO: 0031092 | CC | platelet alpha granule membrane | 0.0050126 | 0 | 9.02 | 0.800107 | 4 | 8 |
| GO: 0019724 | BP | B cell mediated immunity | 0.0053848 | 0 | 2.64 | 5.323512 | 12 | 52 |
| GO: 0006661 | BP | phosphatidylinositol biosynthetic | 0.0054574 | 0 | 8.79 | 0.819002 | 4 | 8 |
| | | process | | | | | | |
| GO: 0006820 | BP | anion transport | 0.00585 | 0 | 1.75 | 18.63229 | 30 | 182 |
| GO: 0015672 | BP | monovalent inorganic cation | 0.005963 | 0 | 1.55 | 31.63394 | 46 | 309 |
| | | transport | | | | | | |
| GO: 0016758 | MF | transferase activity, transferring | 0.0060555 | 0 | 1.78 | 17.08932 | 28 | 172 |
| | | hexosyl groups | | | | | | |
| GO: 0019748 | BP | secondary metabolic process | 0.0067639 | 0 | 2.69 | 4.811636 | 11 | 47 |
| GO: 0001523 | BP | retinoid metabolic process | 0.0071117 | 0 | 5.5 | 1.330878 | 5 | 13 |
| GO: 0016101 | BP | diterpenoid metabolic process | 0.0071117 | 0 | 5.5 | 1.330878 | 5 | 13 |
| GO: 0016298 | MF | lipase activity | 0.0074298 | 0 | 2.05 | 9.73694 | 18 | 98 |
| GO: 0004022 | MF | alcohol dehydrogenase activity | 0.0081188 | 0 | 7.27 | 0.894209 | 4 | 9 |
| GO: 0019966 | MF | interleukin-1 binding | 0.0081188 | 0 | 7.27 | 0.894209 | 4 | 9 |
| GO: 0030345 | MF | structural constituent of tooth | 0.0083912 | 0 | 13.6 | 0.496783 | 3 | 5 |
| | | enamel | | | | | | |
| GO: 0007602 | BP | phototransduction | 0.0084028 | 0 | 3.62 | 2.457005 | 7 | 24 |
| GO: 0005577 | CC | fibrinogen complex | 0.0085502 | 0 | 13.5 | 0.500067 | 3 | 5 |
| GO: 0042827 | CC | platelet dense granule | 0.0085502 | 0 | 13.5 | 0.500067 | 3 | 5 |
| GO: 0004806 | MF | triacylglycerol lipase activity | 0.0089474 | 0 | 5.05 | 1.390991 | 5 | 14 |
| GO: 0015114 | MF | phosphate transmembrane | 0.0089474 | 0 | 5.05 | 1.390991 | 5 | 14 |
| | | transporter activity | | | | | | |
| GO: 0002260 | BP | lymphocyte homeostasis | 0.0090329 | 0 | 7.03 | 0.921377 | 4 | 9 |
| GO: 0006586 | BP | indolalkylamine metabolic process | 0.0090329 | 0 | 7.03 | 0.921377 | 4 | 9 |
| GO: 0007342 | BP | fusion of sperm to egg plasma | 0.0090329 | 0 | 7.03 | 0.921377 | 4 | 9 |
| | | membrane | | | | | | |
| GO: 0042430 | BP | indole and derivative metabolic | 0.0090329 | 0 | 7.03 | 0.921377 | 4 | 9 |
| | | process | | | | | | |
| GO: 0042434 | BP | indole derivative metabolic process | 0.0090329 | 0 | 7.03 | 0.921377 | 4 | 9 |
| GO: 0006067 | BP | ethanol metabolic process | 0.0091343 | 0 | 13.2 | 0.511876 | 3 | 5 |
| GO: 0006069 | BP | ethanol oxidation | 0.0091343 | 0 | 13.2 | 0.511876 | 3 | 5 |
| GO: 0030728 | BP | ovulation | 0.0091343 | 0 | 13.2 | 0.511876 | 3 | 5 |
| GO: 0031638 | BP | zymogen activation | 0.0091343 | 0 | 13.2 | 0.511876 | 3 | 5 |
| GO: 0034308 | BP | monohydric alcohol metabolic | 0.0091343 | 0 | 13.2 | 0.511876 | 3 | 5 |
| | | process | | | | | | |
| GO: 0030247 | MF | polysaccharide binding | 0.0091655 | 0 | 2 | 9.935653 | 18 | 100 |
| GO: 0030667 | CC | secretory granule membrane | 0.0092003 | 0 | 5.01 | 1.400188 | 5 | 14 |
| GO: 0016798 | MF | hydrolase activity, acting on glycosyl | 0.0096534 | 0 | 1.95 | 10.73051 | 19 | 108 |
| | | bonds | | | | | | |
| GO: 0003973 | MF | (S)-2-hydroxy-acid oxidase activity | 0.0098655 | 0 | Inf | 0.198713 | 2 | 2 |
| GO: 0004833 | MF | tryptophan 2,3-dioxygenase activity | 0.0098655 | 0 | Inf | 0.198713 | 2 | 2 |
| GO: 0016899 | MF | oxidoreductase activity, acting on the | 0.0098655 | 0 | Inf | 0.198713 | 2 | 2 |
| | | CH—OH group of donors, oxygen as | | | | | | |
| | | acceptor | | | | | | |
| GO: 0031089 | CC | platelet dense granule lumen | 0.0099966 | 0 | Inf | 0.200027 | 2 | 2 |
| GO: 0001614 | MF | purinergic nucleotide receptor activity | 1.41E−07 | 0.01 | 6.97 | 3.676192 | 16 | 37 |
| GO: 0016502 | MF | nucleotide receptor activity | 1.41E−07 | 0.01 | 6.97 | 3.676192 | 16 | 37 |
| GO: 0007586 | BP | digestion | 5.277E−06 | 0.01 | 3.33 | 9.00902 | 24 | 88 |
| GO: 0050909 | BP | sensory perception of taste | 1.513E−05 | 0.01 | 5.47 | 3.480758 | 13 | 34 |
| GO: 0002541 | BP | activation of plasma proteins during | 5.771E−05 | 0.01 | 5.05 | 3.378382 | 12 | 33 |
| | | acute inflammatory response | | | | | | |
| GO: 0006956 | BP | complement activation | 5.771E−05 | 0.01 | 5.05 | 3.378382 | 12 | 33 |
| GO: 0030547 | MF | receptor inhibitor activity | 6.139E−05 | 0.01 | 18.2 | 0.894209 | 6 | 9 |
| GO: 0048019 | MF | receptor antagonist activity | 6.139E−05 | 0.01 | 18.2 | 0.894209 | 6 | 9 |
| GO: 0005179 | MF | hormone activity | 0.000166 | 0.01 | 2.56 | 10.92922 | 24 | 110 |
| GO: 0031402 | MF | sodium ion binding | 0.000166 | 0.01 | 2.56 | 10.92922 | 24 | 110 |
| GO: 0065008 | BP | regulation of biological quality | 0.0001732 | 0.01 | 1.45 | 98.79209 | 133 | 965 |
| GO: 0005579 | CC | membrane attack complex | 0.0001756 | 0.01 | 22.6 | 0.700094 | 5 | 7 |
| GO: 0051241 | BP | negative regulation of multicellular | 0.000381 | 0.01 | 3.07 | 6.347264 | 16 | 62 |
| | | organismal process | | | | | | |
| GO: 0005152 | MF | interleukin-1 receptor antagonist | 0.0004469 | 0.01 | 36.4 | 0.496783 | 4 | 5 |
| | | activity | | | | | | |
| GO: 0030353 | MF | fibroblast growth factor receptor | 0.0004469 | 0.01 | 36.4 | 0.496783 | 4 | 5 |
| | | antagonist activity | | | | | | |
| GO: 0015293 | MF | symporter activity | 0.0005615 | 0.01 | 2.19 | 13.90991 | 27 | 140 |
| GO: 0004867 | MF | serine-type endopeptidase inhibitor | 0.0006511 | 0.01 | 2.59 | 8.544662 | 19 | 86 |
| | | activity | | | | | | |
| GO: 0030141 | CC | secretory granule | 0.0007046 | 0.01 | 2.75 | 7.300981 | 17 | 73 |
| GO: 0031420 | MF | alkali metal ion binding | 0.0007553 | 0.01 | 1.89 | 21.56037 | 37 | 217 |
| GO: 0019959 | MF | interleukin-8 binding | 0.000979 | 0.01 | Inf | 0.29807 | 3 | 3 |
| GO: 0030354 | MF | melanin-concentrating hormone | 0.000979 | 0.01 | Inf | 0.29807 | 3 | 3 |
| | | activity | | | | | | |
| GO: 0006958 | BP | complement activation, classical | 0.0010194 | 0.01 | 4.41 | 2.764131 | 9 | 27 |
| | | pathway | | | | | | |
| GO: 0050776 | BP | regulation of immune response | 0.0011441 | 0.01 | 2.39 | 9.623271 | 20 | 94 |
| GO: 0005104 | MF | fibroblast growth factor receptor | 0.0012349 | 0.01 | 18.2 | 0.596139 | 4 | 6 |
| | | binding | | | | | | |
| GO: 0030545 | MF | receptor regulator activity | 0.0014151 | 0.01 | 6.82 | 1.390991 | 6 | 14 |
| GO: 0002253 | BP | activation of immune response | 0.0024663 | 0.01 | 2.69 | 6.142514 | 14 | 60 |
| GO: 0022414 | BP | reproductive process | 0.0025285 | 0.01 | 1.68 | 27.02706 | 42 | 264 |
| GO: 0030574 | BP | collagen catabolic process | 0.0027085 | 0.01 | 4.74 | 2.047505 | 7 | 20 |
| GO: 0051055 | BP | negative regulation of lipid | 0.0029684 | 0.01 | 11.7 | 0.716627 | 4 | 7 |
| | | biosynthetic process | | | | | | |
| GO: 0019751 | BP | polyol metabolic process | 0.0030119 | 0.01 | 3.6 | 3.173632 | 9 | 31 |
| GO: 0003008 | BP | system process | 0.0031331 | 0.01 | 1.3 | 126.1263 | 155 | 1232 |
| GO: 0044236 | BP | multicellular organismal metabolic | 0.0034205 | 0.01 | 3.91 | 2.661756 | 8 | 26 |
| | | process | | | | | | |
| GO: 0051707 | BP | response to other organism | 0.0035111 | 0.01 | 1.78 | 19.55367 | 32 | 191 |
| GO: 0030492 | MF | hemoglobin binding | 0.0036246 | 0.01 | 27.2 | 0.397426 | 3 | 4 |
| GO: 0005149 | MF | interleukin-1 receptor binding | 0.0041901 | 0.01 | 6.49 | 1.192278 | 5 | 12 |
| GO: 0007601 | BP | visual perception | 0.0042401 | 0.01 | 1.74 | 20.57742 | 33 | 201 |
| GO: 0050953 | BP | sensory perception of light stimulus | 0.0042401 | 0.01 | 1.74 | 20.57742 | 33 | 201 |
| GO: 0002252 | BP | immune effector process | 0.0043558 | 0.01 | 2 | 12.18265 | 22 | 119 |
| GO: 0016064 | BP | immunoglobulin mediated immune | 0.0045572 | 0.01 | 2.71 | 5.221137 | 12 | 51 |
| | | response | | | | | | |
| GO: 0015893 | BP | drug transport | 0.0047747 | 0.01 | 6.28 | 1.228503 | 5 | 12 |
| GO: 0042592 | BP | homeostatic process | 0.0057015 | 0.01 | 1.44 | 49.34486 | 67 | 482 |
| GO: 0002682 | BP | regulation of immune system process | 0.0065095 | 0.01 | 1.77 | 17.19904 | 28 | 168 |
| GO: 0005509 | MF | calcium ion binding | 0.006686 | 0.01 | 1.32 | 87.63246 | 110 | 882 |
| GO: 0005539 | MF | glycosaminoglycan binding | 0.0074298 | 0.01 | 2.05 | 9.73694 | 18 | 98 |
| GO: 0045177 | CC | apical part of cell | 0.0079448 | 0.01 | 2.04 | 9.801316 | 18 | 98 |
| GO: 0051704 | BP | multi-organism process | 0.0080386 | 0.01 | 1.42 | 47.5021 | 64 | 464 |
| GO: 0003796 | MF | lysozyme activity | 0.0081188 | 0.01 | 7.27 | 0.894209 | 4 | 9 |
| GO: 0008375 | MF | acetylglucosaminyltransferase | 0.0087986 | 0.01 | 2.93 | 3.676192 | 9 | 37 |
| | | activity | | | | | | |
| GO: 0015103 | MF | inorganic anion transmembrane | 0.0087986 | 0.01 | 2.93 | 3.676192 | 9 | 37 |
| | | transporter activity | | | | | | |
| GO: 0008209 | BP | androgen metabolic process | 0.0090329 | 0.01 | 7.03 | 0.921377 | 4 | 9 |
| GO: 0008210 | BP | estrogen metabolic process | 0.0090329 | 0.01 | 7.03 | 0.921377 | 4 | 9 |
| GO: 0004368 | MF | glycerol-3-phosphate dehydrogenase | 0.0098655 | 0.01 | Inf | 0.198713 | 2 | 2 |
| | | activity | | | | | | |
| GO: 0008269 | MF | JAK pathway signal transduction | 0.0098655 | 0.01 | Inf | 0.198713 | 2 | 2 |
| | | adaptor activity | | | | | | |
| GO: 0016316 | MF | phosphatidylinositol-3,4- | 0.0098655 | 0.01 | Inf | 0.198713 | 2 | 2 |
| | | bisphosphate 4-phosphatase activity | | | | | | |
| GO: 0034596 | MF | phosphoinositide 4-phosphatase | 0.0098655 | 0.01 | Inf | 0.198713 | 2 | 2 |
| | | activity | | | | | | |
| GO: 0051371 | MF | muscle alpha-actinin binding | 0.0098655 | 0.01 | Inf | 0.198713 | 2 | 2 |
| GO: 0004553 | MF | hydrolase activity, hydrolyzing O- | 0.0099239 | 0.01 | 2.08 | 8.544662 | 16 | 86 |
| | | glycosyl compounds | | | | | | |
| GO: 0005125 | MF | cytokine activity | 2.03E−07 | 0.02 | 2.56 | 21.56037 | 47 | 217 |
| GO: 0001608 | MF | nucleotide receptor activity, G- | 4.467E−07 | 0.02 | 7.53 | 3.080053 | 14 | 31 |
| | | protein coupled | | | | | | |
| GO: 0045028 | MF | purinergic nucleotide receptor | 4.467E−07 | 0.02 | 7.53 | 3.080053 | 14 | 31 |
| | | activity, G-protein coupled | | | | | | |
| GO: 0005126 | MF | hematopoietin/interferon-class | 1.198E−05 | 0.02 | 4.73 | 4.371688 | 15 | 44 |
| | | (D200-domain) cytokine receptor | | | | | | |
| | | binding | | | | | | |
| GO: 0008081 | MF | phosphoric diester hydrolase activity | 1.991E−05 | 0.02 | 3.2 | 8.445305 | 22 | 85 |
| GO: 0030246 | MF | carbohydrate binding | 2.037E−05 | 0.02 | 2.05 | 26.72691 | 49 | 269 |
| GO: 0002526 | BP | acute inflammatory response | 0.0001448 | 0.02 | 3.12 | 7.063891 | 18 | 69 |
| GO: 0008544 | BP | epidermis development | 0.0003935 | 0.02 | 2.18 | 15.04916 | 29 | 147 |
| GO: 0000267 | CC | cell fraction | 0.0005771 | 0.02 | 1.47 | 71.90966 | 99 | 719 |
| GO: 0031012 | CC | extracellular matrix | 0.0005929 | 0.02 | 1.78 | 28.20379 | 46 | 282 |
| GO: 0005578 | CC | proteinaceous extracellular matrix | 0.0006831 | 0.02 | 1.78 | 27.60371 | 45 | 276 |
| GO: 0015020 | MF | glucuronosyltransferase activity | 0.0008211 | 0.02 | 4.55 | 2.682626 | 9 | 27 |
| GO: 0005626 | CC | insoluble fraction | 0.001032 | 0.02 | 1.51 | 55.20742 | 78 | 552 |
| GO: 0007398 | BP | ectoderm development | 0.0011887 | 0.02 | 2.01 | 16.07291 | 29 | 157 |
| GO: 0006508 | BP | proteolysis | 0.0017347 | 0.02 | 1.42 | 70.94603 | 95 | 693 |
| GO: 0030414 | MF | protease inhibitor activity | 0.0017912 | 0.02 | 2.06 | 13.51249 | 25 | 136 |
| GO: 0005624 | CC | membrane fraction | 0.0018504 | 0.02 | 1.48 | 53.80723 | 75 | 538 |
| GO: 0000003 | BP | reproduction | 0.0026082 | 0.02 | 1.49 | 49.44723 | 69 | 483 |
| GO: 0051018 | MF | protein kinase A binding | 0.0026546 | 0.02 | 12.1 | 0.695496 | 4 | 7 |
| GO: 0022857 | MF | transmembrane transporter activity | 0.0028168 | 0.02 | 1.36 | 83.45949 | 108 | 840 |
| GO: 0031224 | CC | intrinsic to membrane | 0.00433 | 0.02 | 1.16 | 491.066 | 537 | 4910 |
| GO: 0045834 | BP | positive regulation of lipid metabolic | 0.0071117 | 0.02 | 5.5 | 1.330878 | 5 | 13 |
| | | process | | | | | | |
| GO: 0001942 | BP | hair follicle development | 0.0071535 | 0.02 | 4.4 | 1.842754 | 6 | 18 |
| GO: 0022404 | BP | molting cycle process | 0.0071535 | 0.02 | 4.4 | 1.842754 | 6 | 18 |
| GO: 0022405 | BP | hair cycle process | 0.0071535 | 0.02 | 4.4 | 1.842754 | 6 | 18 |
| GO: 0042303 | BP | molting cycle | 0.0071535 | 0.02 | 4.4 | 1.842754 | 6 | 18 |
| GO: 0042633 | BP | hair cycle | 0.0071535 | 0.02 | 4.4 | 1.842754 | 6 | 18 |
| GO: 0002684 | BP | positive regulation of immune system | 0.0071865 | 0.02 | 1.91 | 12.69453 | 22 | 124 |
| | | process | | | | | | |
| GO: 0048872 | BP | homeostasis of number of cells | 0.0079824 | 0.02 | 2.62 | 4.914011 | 11 | 48 |
| GO: 0002250 | BP | adaptive immune response | 0.009308 | 0.02 | 2.17 | 7.780517 | 15 | 76 |
| GO: 0002460 | BP | adaptive immune response based on | 0.009308 | 0.02 | 2.17 | 7.780517 | 15 | 76 |
| | | somatic recombination of immune | | | | | | |
| | | receptors built from immunoglobulin | | | | | | |
| | | superfamily domains | | | | | | |
| GO: 0005215 | MF | transporter activity | 0.0096813 | 0.02 | 1.26 | 114.26 | 138 | 1150 |
| GO: 0005615 | CC | extracellular space | 1.038E−13 | 0.03 | 2.59 | 44.80602 | 97 | 448 |
| GO: 0005886 | CC | plasma membrane | 5.032E−06 | 0.03 | 1.33 | 303.0407 | 370 | 3030 |
| GO: 0009410 | BP | response to xenobiotic stimulus | 1.245E−05 | 0.03 | 6.24 | 2.968882 | 12 | 29 |
| GO: 0004872 | MF | receptor activity | 5.569E−05 | 0.03 | 1.38 | 161.2557 | 207 | 1623 |
| GO: 0045087 | BP | innate immune response | 0.0001145 | 0.03 | 2.58 | 11.36365 | 25 | 111 |
| GO: 0050778 | BP | positive regulation of immune | 0.0002119 | 0.03 | 2.9 | 7.882892 | 19 | 77 |
| | | response | | | | | | |
| GO: 0004866 | MF | endopeptidase inhibitor activity | 0.0010346 | 0.03 | 2.16 | 13.01571 | 25 | 131 |
| GO: 0008083 | MF | growth factor activity | 0.0011274 | 0.03 | 2.01 | 15.9964 | 29 | 161 |
| GO: 0006811 | BP | ion transport | 0.0043213 | 0.03 | 1.36 | 76.67904 | 99 | 749 |
| GO: 0005529 | MF | sugar binding | 0.0046295 | 0.03 | 1.84 | 15.9964 | 27 | 161 |
| GO: 0009888 | BP | tissue development | 0.0049476 | 0.03 | 1.56 | 32.14582 | 47 | 314 |
| GO: 0004918 | MF | interleukin-8 receptor activity | 0.0098655 | 0.03 | Inf | 0.198713 | 2 | 2 |
| GO: 0006954 | BP | inflammatory response | 1.934E−08 | 0.04 | 2.46 | 28.66506 | 60 | 280 |
| GO: 0031226 | CC | intrinsic to plasma membrane | 3.147E−06 | 0.04 | 1.54 | 111.0149 | 157 | 1110 |
| GO: 0004871 | MF | signal transducer activity | 1.905E−05 | 0.04 | 1.37 | 201.5944 | 255 | 2029 |
| GO: 0060089 | MF | molecular transducer activity | 1.905E−05 | 0.04 | 1.37 | 201.5944 | 255 | 2029 |
| GO: 0006805 | BP | xenobiotic metabolic process | 2.241E−05 | 0.04 | 6.47 | 2.661756 | 11 | 26 |
| GO: 0006955 | BP | immune response | 0.0001977 | 0.04 | 1.58 | 58.14913 | 85 | 568 |
| GO: 0004857 | MF | enzyme inhibitor activity | 0.0016363 | 0.04 | 1.78 | 23.24943 | 38 | 234 |
| GO: 0044421 | CC | extracellular region part | 1.067E−14 | 0.05 | 2.28 | 70.10942 | 136 | 701 |
| GO: 0009611 | BP | response to wounding | 1.007E−10 | 0.05 | 2.42 | 40.43821 | 83 | 395 |
| GO: 0006952 | BP | defense response | 3.426E−10 | 0.05 | 2.16 | 53.54224 | 100 | 523 |
| GO: 0005102 | MF | receptor binding | 7.852E−10 | 0.05 | 1.95 | 71.43735 | 123 | 719 |
| GO: 0005887 | CC | integral to plasma membrane | 2.106E−06 | 0.05 | 1.55 | 109.4147 | 156 | 1094 |
| GO: 0006959 | BP | humoral immune response | 6.093E−06 | 0.05 | 4.01 | 6.244889 | 19 | 61 |
| GO: 0006950 | BP | response to stress | 2.824E−05 | 0.05 | 1.45 | 124.3859 | 167 | 1215 |
| GO: 0048584 | BP | positive regulation of response to | 0.0002812 | 0.05 | 2.52 | 10.64702 | 23 | 104 |
| | | stimulus | | | | | | |
| GO: 0042221 | BP | response to chemical stimulus | 0.0004869 | 0.05 | 1.52 | 60.60613 | 86 | 592 |
| GO: 0007155 | BP | cell adhesion | 0.008667 | 0.05 | 1.34 | 70.53653 | 90 | 689 |
| GO: 0022610 | BP | biological adhesion | 0.008667 | 0.05 | 1.34 | 70.53653 | 90 | 689 |
| GO: 0050896 | BP | response to stimulus | 5.15E−07 | 0.06 | 1.41 | 251.4336 | 320 | 2456 |
| GO: 0002376 | BP | immune system process | 0.005515 | 0.06 | 1.35 | 78.21467 | 100 | 764 |
| GO: 0032501 | BP | multicellular organismal process | 2.61E−08 | 0.07 | 1.42 | 333.8456 | 418 | 3261 |
| GO: 0044459 | CC | plasma membrane part | 2.904E−06 | 0.07 | 1.45 | 166.3223 | 221 | 1663 |
| GO: 0009605 | BP | response to external stimulus | 3.877E−10 | 0.08 | 2.05 | 63.26789 | 113 | 618 |
| GO: 0005576 | CC | extracellular region | 2.044E−25 | 0.1 | 2.16 | 172.6232 | 304 | 1726 |
| GO: 0048731 | BP | system development | 0.0056527 | 0.1 | 1.24 | 160.422 | 190 | 1567 |
| GO: 0007275 | BP | multicellular organismal development | 0.0031112 | 0.12 | 1.23 | 216.9331 | 253 | 2119 |
| GO: 0032502 | BP | developmental process | 0.0006822 | 0.13 | 1.24 | 298.5262 | 346 | 2916 |
| GO: 0048856 | BP | anatomical structure development | 0.0035421 | 0.13 | 1.24 | 184.6849 | 218 | 1804 |

GO: ID is the GO identifier for the GO term listed in its respective column.
The category indicates whether the GO term is associated with a Biological Process (BP), Cellular Component (CC) or Molecular Function (MF).
Pvalue is the level of significance found by the Hypergeometric test using GOstats R package and lumiHumanAll.db annotation file.
The Permutation Pvalue is the level of significance following 100 permutations of differential gene lists generated by random Autistic and non-Autistic class assignments for the 110 discordant sib-pairs.
The OddsRatio provides a likelihood that each term would have been found.
The ExpCount is the expected number of genes that should be found given the 2,338 differentially methylated loci.
The Count is that actual number of genes found to be associated with the methylation data and ASD.
The Size is the total number of genes associated with the term and in the lumiHumanAll.db package.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim:

1. A method comprising:
contacting a sample including one or more target nucleic acid sequences with an agent that modifies unmethylated cytosine to uracil to form a number of methylated target nucleic acids, while still including a number of unmethylated target nucleic acids, wherein the sample is from a subject;
contacting the methylated target nucleic acids and the unmethylated target nucleic acids with a pool of allele-differentiating probes,
wherein the allele-differentiating probes include:
a first allele-differentiating probe specific for the unmethylated target nucleic acid sequence, and
a second allele-differentiating probe specific for the methylated target nucleic acid sequence;
quantifying an amount of the methylated target nucleic acid sequence and an amount of the unmethylated target nucleic acid sequence using the first and second allele-differentiating probes, wherein the first allele-differentiating probe has a first characteristic and the second allele-differentiating probe has a second characteristic, wherein the first characteristic and the second characteristic are different and are detectably distinguishable; and
screening for a condition associated with abnormal methylation of the target nucleic acid sequence in at least one specific gene indicated by the ratio of the methylated target nucleic acid compared to the total target nucleic acid.

2. The method of claim 1, wherein the condition is autism spectrum disorders.

3. The method of claim 2, wherein the gene is selected from genes such as those numbered 1-2338, and each target nucleic acid sequence is located within about 5 kilobases of the corresponding gene being tested.

4. The method of claim 3, wherein the first allele-differentiating probe and the second allele-differentiating probe are complementary to a nucleic acid sequence, such as those numbered 1-2338 in Table 4, wherein the first allele-differentiating probe is complementary to the unmethlyated target nucleic acid sequence and the second allele-differentiating probe is complementary to methylated target nucleic acid sequence.

5. The method of claim 4, further comprising a plurality of a set of probes that include the first allele-differentiating probe and the second allele-differentiating probe, wherein each probe in a set is complementary to target nucleic acid sequences, such as those numbered 1-2338 in Table 4, wherein the method includes 1 to 2338 sets of probes.

6. The method of claim 1, further comprising:
labeling the first allele-differentiating probe with a first reporter molecule having the first characteristic, and
labeling the second allele-differentiating probe with a second reporter molecule having the second characteristic.

7. The method of claim 1, wherein the first allele-differentiating probe includes a first reporter molecule having the first characteristic and optionally a first quencher molecule; and wherein the second allele-differentiating probe includes a second reporter molecule having the second characteristic and optionally a second quencher molecule, wherein the first and second reporter molecules are detectably distinguishable.

8. The method of claim 1, wherein the agent is sodium bisulfate.

9. The method of claim 8, wherein the agent further comprises hydroquinone.

10. The method of claim 1, wherein the target nucleic acid sequence is amplified by polymerase chain reaction with primers specific for the target nucleic acid sequence.

11. The method of claim 1, wherein quantifying the amount of the methylated and unmethylated target nucleic acid sequences comprises correlating an intensity of a signal produced by the first allele-differentiating probe to an amount of the unmethylated target nucleic acid sequence and correlating an intensity of a signal produced by the second allele-differentiating probe to an amount of the methylated target sequence.

12. The method of claim 1, wherein the nucleic acid containing sample is selected from the group consisting of a cell-line or tissue such as blood.

13. The method of claim 1, further comprising: determining the methylation index, which is a ratio of methylated cytosines to total cytosines in the target nucleic acid sequences.

14. A kit for screening or diagnosing subjects for at least one condition associated with abnormal DNA methylation comprising:
a plurality of a set of probes that include a first allele-differentiating probe and a second allele-differentiating probe; for each set of probes the first allele-differentiating probe has a first characteristic and the second allele-differentiating probe has a second characteristic, wherein the first characteristic and the second characteristic are different and are detectably distinguishable from one another and from other sets of probes; for each set of probes the first allele-differentiating probe and the second allele-differentiating probe are complementary to a target nucleic acid sequences, such as those numbered 1-2338 in Table 4, wherein the first allele-differentiating probe is complementary to the unmethlyated target nucleic acid sequence and the second allele-differentiating probe is complementary to methylated target nucleic acid sequence; and wherein each target nucleic acid sequence is associated with a condition.

15. The method of claim 14, wherein the condition is autism spectrum disorders.
